(19) United States
(12) Patent Application Publication
(10) Pub. No.: US 2024/0384642 A1
(43) Pub. Date: Nov. 21, 2024

(54) INTEGRATED WELL CONSTRUCTION SYSTEM OPERATIONS

(71) Applicant: Schlumberger Technology Corporation, Sugar Land, TX (US)

(72) Inventors: Espen Botnan, Kristiansand (NO); Anstein Jorud, Kristiansand (NO); Njál AARSLAND, Vigrestad (NO); Christian Doennestad Nilssen, Kristiansand (NO)

(21) Appl. No.: 18/789,192

(22) Filed: Jul. 30, 2024

Related U.S. Application Data
(62) Division of application No. 16/979,439, filed on Sep. 9, 2020, now Pat. No. 12,049,811.
(60) Provisional application No. 62/640,976, filed on Mar. 9, 2018.
(60) Provisional application No. 62/640,999, filed on Mar. 9, 2018.
(60) Provisional application No. 62/641,021, filed on Mar. 9, 2018.

(51) Int. Cl. E21B 44/00; E21B 19/15; E21B 19/16; E21B 19/20; E21B 21/08; E21B 44/02; E21B 47/06; E21B 47/117; G08B 21/18

(52) U.S. Cl. CPC E21B 44/00; E21B 19/155; E21B 19/165; E21B 19/20; E21B 21/08; E21B 44/02; E21B 47/06; E21B 47/117; G08B 21/18

(57) ABSTRACT

An integrated well construction system (IWCS) operable for constructing a well via integrated control of integrated control devices that collectively control integrated subsystems of the IWCS. The IWCS includes an IWCS communication network, the integrated control devices (each directly connected with the IWCS communication network), the integrated subsystems, and a control workstation directly connected with the IWCS communication network and operable to control each of the integrated control devices to thereby control the integrated subsystems.

### CROSS-REFERENCE TO RELATED APPLICATIONS

This is a divisional application of co-pending U.S. patent application Ser. No. 16/979,439 filed on Sep. 9, 2020, now U.S. Pat. No. 12,049,811, which is a National Stage Entry of International Application No. PCT/US2019/021691, entitled, “INTEGRATED WELL CONSTRUCTION SYSTEM OPERATIONS,” filed Mar. 11, 2019, which claims priority to and the benefit of U.S. Provisional Application No. 62/640,999, titled “SYSTEM AND METHOD FOR REAL-TIME ANALYSIS OF DRILLING OPERATIONS”, filed Mar. 9, 2018, U.S. Provisional Application No. 62/641,021, titled “SYSTEM AND METHOD FOR INTEGRATING MULTIPLE DRILLING EQUIPMENT INTO A SINGLE CONTROL NETWORK”, filed Mar. 9, 2018, and U.S. Provisional Application No. 62/640,976, titled “SYSTEM AND METHOD FOR CONTROLLING DRILLING OPERATIONS”, filed Mar. 9, 2018. Each of the above applications is hereby incorporated by reference in its entirety.

### BACKGROUND OF THE DISCLOSURE

Wells are generally drilled into the ground or ocean bed to recover natural deposits of oil, gas, and other materials that are trapped in subterranean formations. Such wells are drilled into the subterranean formations at the wellsite utilizing a well construction system having various surface and subterranean wellsite equipment operating in a coordinated manner. The wellsite equipment may be grouped into various subsystems, wherein each subsystem performs a different operation controlled by a corresponding local and/or a remotely located controller. The subsystems may include a rig control system, a fluid control system, a managed pressure drilling control system, a gas monitoring system, a closed-circuit television system, a choke pressure control system, and a well pressure control system, among other examples.

The wellsite equipment is monitored and controlled from a control center located at a wellsite surface. A typical control center contains a wellsite control station utilized by several human wellsite operators (e.g., drillers) to monitor and control the wellsite equipment. Although the equipment subsystems may operate in a coordinated manner, there is little or no communication between the subsystems and their controllers. Accordingly, monitoring and control of the wellsite equipment or equipment subsystems may be performed via corresponding control panels of the wellsite control station. Each control panel comprises an associated video output device (e.g., a video monitor) and a plurality of input devices (e.g., buttons, switches, joysticks, etc.).

Because there is no communication between the equipment subsystems, interactions and coordination between the various wellsite equipment are typically initiated by the wellsite operators. For example, the wellsite operators may monitor the equipment subsystems to identify operational and safety events and manually implement processes to counteract such events. Accordingly, a typical wellsite control center may be manned by multiple wellsite operators, each monitoring and controlling different wellsite equipment or equipment subsystem via a corresponding control panel. Relying on multiple wellsite operators to monitor and manually control the wellsite equipment increases cost and limits speed, efficiency, and safety of well construction operations.

### SUMMARY OF THE DISCLOSURE

This summary is provided to introduce a selection of concepts that are further described below in the detailed description. This summary is not intended to identify indispensable features of the claimed subject matter, nor is it intended for use as an aid in limiting the scope of the claimed subject matter.

The present disclosure introduces an integrated well construction system (IWCS) operable for constructing a well via integrated control of integrated control devices that collectively control integrated subsystems of the IWCS. The IWCS includes an IWCS communication network; the integrated control devices, each directly connected with the IWCS communication network; the integrated subsystems; and a control workstation directly connected with the IWCS communication network and operable to control each of the integrated control devices to thereby control the integrated subsystems.

The present disclosure also introduces a control workstation directly connected with a communication network and operable to control each of multiple integrated control devices each directly connected with the communication network. Each integrated control device controls a corresponding component of an IWCS, whereby control of the integrated control devices, via operations of the control workstation, controls the IWCS.

The present disclosure also introduces a computer program product including a tangible, computer-readable, non-transitory medium having instructions stored thereon for: automatically controlling integrated control devices that control integrated subsystems of an IWCS to perform combinations of predetermined operational sequences for constructing a well; receiving, via operation of a control workstation by a human operator, a selection of one of the operational sequences to be performed by the IWCS; receiving, via operation of the control workstation by the human operator, settings for first machines of the IWCS to be operated during the selected operational sequence; and in response to receiving a single commencement input via operation of the control workstation by the human operator, automatically starting and controlling the first machines and second machines of the IWCS to perform the selected operational sequence using the received settings.

The present disclosure also introduces a method including operating an IWCS that includes a fiberoptic ring network. Nodes of the fiberoptic ring network include: programmable logic controllers (PLCs) of individual pieces of machinery forming the IWCS; video feed; drilling operator control; high-level supervisory control; and combinations thereof.

The present disclosure also introduces an apparatus that includes a communication network and integrated control devices each directly connected with the communication network. Each integrated control device controls a corresponding component of an IWCS. The IWCS is operable for constructing a well without other components not controlled by any of the integrated control devices. The apparatus also includes a control workstation directly connected with the communication network and operable to control each of the integrated control devices to thereby control the IWCS.

The present disclosure also introduces an apparatus including a communication network and integrated control devices each directly connected with the communication network. The integrated control devices control corresponding IWCS components. The IWCS components are collectively operable for constructing a well exclusive of any component not controlled by any of the integrated control devices. The apparatus also includes a control workstation directly connected with the communication network and operable to control each of the integrated control devices to thereby control the IWCS.

The present disclosure also introduces an apparatus including a communication network and integrated control devices each directly connected with the communication network. Each integrated control device controls a corresponding one or more of integrated well construction components. The integrated well construction components form an integrated well construction system operable for constructing a well without any other components. A control workstation is directly connected with the communication network and is operable to control each integrated control device to thereby control the integrated well construction components.

The present disclosure also introduces a method including causing a well construction system to perform a well construction operation, whereby data associated with the well construction operation is automatically collected and analyzed in real-time to determine parameters based on the data, and at least some of the determined parameters are used for controlling the well construction operation.

The present disclosure also introduces a method including causing a well construction system to perform a well construction operation, whereby data associated with the well construction operation is automatically collected and analyzed in real-time to determine parameters based on the data, and at least some of the determined parameters each provide a basis for triggering at least one real-time well construction operation alarm.

The present disclosure also introduces an apparatus that includes an analysis-while-drilling (AWD) control system utilized in conjunction with a well construction system during a well construction operation. Inputs for the AWD control system include: intended configuration of a well being constructed by the well construction system during the well construction operation; configuration of a drill string being used by the well construction system during the well construction operation; signals from drilling parameter sensors; and drilling equipment parameters. Outputs from the AWD control system include real-time determination of: depth and trajectory of the well; bit depth; number of drill string tubulars and/or stands in the well; drill string volume, displacements, and weight; drilling fluid tank volumes and tank selections; drilling fluid loss and/or gain; trip tank difference volume; trip tank accumulated volume; total and/or per-section strokes and/or strokes-to-go of drilling fluid pumping system; total stroke rate of drilling fluid pumping system; drilling fluid pumping system liner capacities and efficiencies; individual and total drilling fluid flow into the well; annular drilling fluid velocity; total and/or per-section drilling fluid volumes; total minutes and/or minutes-to-go per section; drilling fluid return flow; bit runtime and revolutions; weight-on-bit; rate of penetration; hook load; and standpipe pressure. The outputs from the AWD control system may further include a kick calculator and a kill sheet. The outputs from the AWD control system may further include sensors and calculations for storage in a historian associated with the well construction system. The outputs from the AWD control system may further include well construction operation warnings and alarms.

The present disclosure also introduces an apparatus that includes a control workstation directly connected with a communication network and operable to control multiple control devices each directly connected with the communication network. Each control device controls a corresponding component of an IWCS, whereby control of the control devices, via operations of the control workstation, controls the IWCS. The control workstation includes a display, a processor, and a memory storing: a construction program that, when executed by the processor, controls each control device; and an AWD program. Inputs for the AWD system include intended configuration of a well being constructed by the well construction system during the well construction operation, configuration of a drill string being used by the well construction system during the well construction operation, signals from drilling parameter sensors, and drilling equipment parameters. When executed by the processor, the AWD program generates in real-time, and displays in real-time in an AWD screen on the display, one or more of: a graphic display of the intended configuration and/or an actual configuration of the well, including depths; a graphic display of a shoe in the well; an animation of the intended and actual configurations of the well; an animation of the drill string in the well; value textual and/or graphic display of drilling fluid front tracking and/or depth; annular velocity per section; open hole volume; total strokes and minutes, strokes and minutes-to-go, and volume for one or more of: surface to bit; bit to shoe; bit to blow-out preventer; bit to surface; well circulation; full circulation; drill string displacement, open end and closed end; drill string weight; number of tubulars in the well; active volume; drilling fluid flow into the well; bit revolutions; and bit runtime.

The present disclosure also introduces an apparatus including a control workstation for use with an IWCS. The IWCS is operable for constructing a well via integrated control of integrated control devices that collectively control integrated subsystems of the IWCS. The control workstation includes a human-machine interface (HMI) that includes a display, a touchscreen, a joystick, and a processing system that includes a processor and a memory having a construction program thereon that, when executed by the processor: presents a human operator of the control workstation with a setup wizard guiding the operator through entering operating parameters for one or more well construction machines of the integrated subsystems to perform a well construction sequence; and controls the integrated control devices, and thus the integrated subsystems, to perform the well construction sequence based on the entered operating parameters.

The present disclosure also introduces an apparatus including an IWCS operable for constructing a well via integrated control of integrated control devices that collectively control integrated subsystems of the IWCS. The IWCS includes a processing system including a processor and a memory having a construction program thereon that, when executed by the processor: controls each integrated control device, and thus each integrated subsystem, during each of multiple predetermined operational sequences; and prevents collisions between machines of the IWCS.

The present disclosure also introduces a method including constructing a well utilizing each of multiple automatically controlled well construction machines, including: a drawworks; an iron roughneck; a tong-handling trolley; a tong-handling arm; a catwalk; a tubular delivery arm; a lower stabilizing arm; an upper tubular restraint; an intermediate tubular restraint; a lower tubular restraint; a top drive; a top drive elevator; a fingerboard; a transfer bridge racker; a setback guide arm; a mousehole; a mousehole; a drilling fluid pumping system; and a drilling fluid recondition system.

The present disclosure also introduces a system operable to completely control each of multiple predetermined operational sequences of a well construction operation. The sequences include: picking up single tubulars; making drilling connections; building tubular stands; tripping-in drill collar stands; tripping-out drill collar stands; tripping-out wet; backreaming; moving single tubulars from a well center to a catwalk using a top drive; moving tubular stands from the well center to the catwalk; moving casing from the catwalk to the well center using a casing tong; moving casing from the catwalk to the well center using a tubular delivery arm and a casing running tool; moving large diameter casing from the catwalk to the well center using the top drive and the casing running tool; building casing stands; and tripping-in casing stands without using the casing running tool.

These and additional aspects of the present disclosure are set forth in the description that follows, and/or may be learned by a person having ordinary skill in the art by reading the materials herein and/or practicing the principles described herein. At least some aspects of the present disclosure may be achieved via means recited in the attached claims.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a schematic view of at least a portion of an example implementation of apparatus or a system according to one or more aspects of the present disclosure.

FIG. 2 is a schematic view of at least a portion of an example implementation of apparatus or a system according to one or more aspects of the present disclosure.

FIG. 3 is a schematic view of at least a portion of an example implementation of apparatus or a system according to one or more aspects of the present disclosure.

FIG. 4 is a schematic view of at least a portion of an example implementation of apparatus or a system according to one or more aspects of the present disclosure.

FIG. 5 is a perspective view of at least a portion of an example implementation of apparatus according to one or more aspects of the present disclosure.

FIG. 6 is a perspective view of a portion of the apparatus shown in FIG. 5 according to one or more aspects of the present disclosure.

FIG. 7 is a top view of a portion of an example implementation of the apparatus shown in FIG. 6 according to one or more aspects of the present disclosure.

FIGS. 8-10 are example implementations of software controls displayed by the apparatus shown in FIG. 7 according to one or more aspects of the present disclosure.

FIGS. 11-21 are example implementations of screens displayed by the apparatus shown in FIG. 7 according to one or more aspects of the present disclosure.

FIG. 22 is a schematic view of at least a portion of an example implementation of apparatus or a system according to one or more aspects of the present disclosure.

FIG. 23 is a schematic view of at least a portion of an example implementation of apparatus or a system according to one or more aspects of the present disclosure.

FIG. 24 is a schematic view of at least a portion of an example implementation of apparatus or a system according to one or more aspects of the present disclosure.

### DETAILED DESCRIPTION

It is to be understood that the following disclosure describes many example implementations for different aspects introduced herein. Specific examples of components and arrangements are described below to simplify the present disclosure. These are merely examples, and are not intended to be limiting. In addition, the present disclosure may repeat reference numerals and/or letters in the various examples. This repetition is for simplicity and clarity, and does not in itself dictate a relationship between the various implementations described herein. Moreover, the formation of a first feature over or on a second feature in the description that follows may include implementations in which the first and second features are formed in direct contact, and may also include implementations in which additional features may be formed interposing the first and second features, such that the first and second features may not be in direct contact.

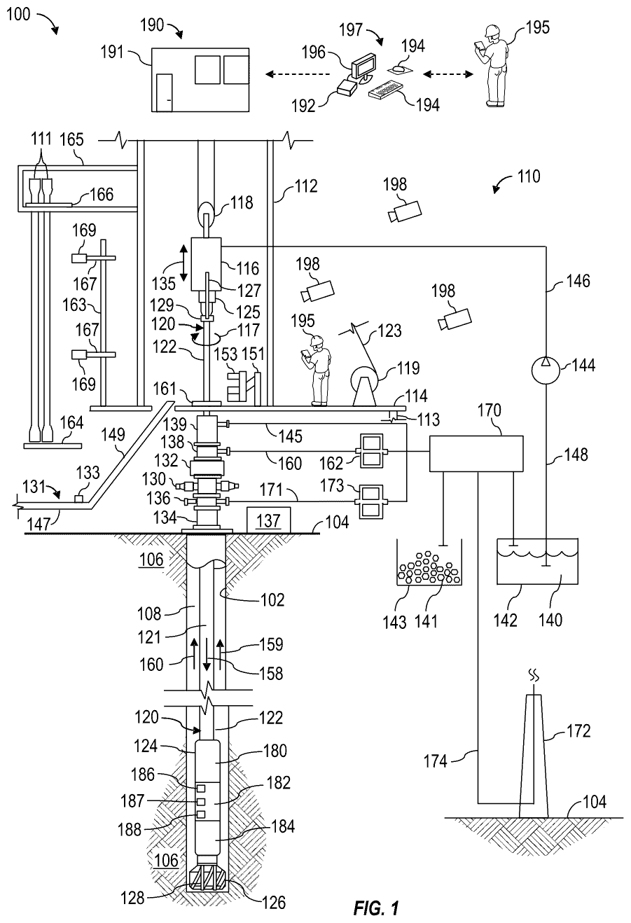

FIG. 1 is a schematic view of at least a portion of an example implementation of an integrated well construction system 100 (i.e., a drill rig) according to one or more aspects of the present disclosure. The well construction system 100 represents an example environment in which one or more aspects of the present disclosure described below may be implemented. Although the well construction system 100 is depicted as an onshore implementation, the aspects described below are also applicable to offshore implementations.

The well construction system 100 is depicted in relation to a wellbore 102 formed by rotary and/or directional drilling from a wellsite surface 104 and extending into a subterranean formation 106. The well construction system 100 includes surface equipment 110 located at the wellsite surface 104 and a drill string 120 suspended within the wellbore 102. The surface equipment 110 may include a mast, a derrick, and/or other support structure 112 disposed over a rig floor 114. The drill string 120 may be suspended within the wellbore 102 from the support structure 112. The support structure 112 and the rig floor 114 are collectively supported over the wellbore 102 by legs and/or other support structures 113.

The drill string 120 may comprise a bottom-hole assembly (BHA) 124 and means 122 for conveying the BHA 124 within the wellbore 102. The conveyance means 122 may comprise drill pipe, heavy-weight drill pipe (HWDP), wired drill pipe (WDP), and/or other means for conveying the BHA 124 within the wellbore 102. A downhole end of the BHA 124 may include or be coupled to a drill bit 126. Rotation of the drill bit 126 and the weight of the drill string 120 collectively operate to form the wellbore 102. The drill bit 126 may be rotated from the wellsite surface 104 and/or via a downhole mud motor (not shown) connected with the drill bit 126.

The BHA 124 may also include various downhole tools 180, 182, 184. One or more of such downhole tools 180, 182, 184 may be or comprise an acoustic tool, a density tool, a directional drilling tool, an electromagnetic (EM) tool, a formation sampling tool, a formation testing tool, a gravity tool, a monitoring tool, a neutron tool, a nuclear tool, a photoelectric factor tool, a porosity tool, a reservoir characterization tool, a resistivity tool, a rotational speed sensing tool, a sampling-while-drilling (SWD) tool, a seismic tool, a surveying tool, a torsion sensing tool, and/or other measuring-while-drilling (MWD) or logging-while-drilling (LWD) tools.

One or more of the downhole tools 180, 182, 184 may be or comprise an MWD or LWD tool comprising a sensor package 186 operable for the acquisition of measurement data pertaining to the BHA 124, the wellbore 102, and/or the formation 106. One or more of the downhole tools 180, 182, 184 and/or another portion of the BHA 124 may also comprise a telemetry device 187 operable for communication with the surface equipment 110, such as via mud-pulse telemetry. One or more of the downhole tools 180, 182, 184 and/or another portion of the BHA 124 may also comprise a downhole processing device 188 operable to receive, process, and/or store information received from the surface equipment 110, the sensor package 186, and/or other portions of the BHA 124. The processing device 188 may also store executable computer programs (e.g., program code instructions), including for implementing one or more aspects of the operations described herein.

The support structure 112 may support a driver, such as a top drive 116, operable to connect (perhaps indirectly) with an uphole end of the conveyance means 122, and to impart rotary motion 117 to the drill string 120 and the drill bit 126. However, another driver, such as a kelly and rotary table (neither shown), may be utilized instead of or in addition to the top drive 116 to impart the rotary motion 117. The top drive 116 and the connected drill string 120 may be suspended from the support structure 112 via hoisting equipment, which may include a traveling block 118, a crown block (not shown), and a draw works (DW) 119 storing a support cable or line 123. The crown block may be connected to or otherwise supported by the support structure 112, and the traveling block 118 may be coupled with the top drive 116, such as via a hook. The DW 119 may be mounted on or otherwise supported by the rig floor 114. The crown block and traveling block 118 comprise pulleys or sheaves around which the support line 123 is reeved to operatively connect the crown block, the traveling block 118, and the DW 119 (and perhaps an anchor). The DW 119 may thus selectively impart tension to the support line 123 to lift and lower the top drive 116, resulting in vertical motion 135. The DW 119 may comprise a drum, a frame, and a prime mover (e.g., an engine or motor) (not shown) operable to drive the drum to rotate and reel in the support line 123, causing the traveling block 118 and the top drive 116 to move upward. The DW 119 is also operable to reel out the support line 123 via a controlled rotation of the drum, causing the traveling block 118 and the top drive 116 to move downward.

The top drive 116 may comprise a grabber, a swivel (neither shown), tubular handling assembly links 127 terminating with an elevator 129, and a drive shaft 125 operatively connected with a prime mover (not shown), such as via a gear box or transmission (not shown). The drill string 120 may be mechanically coupled to the drive shaft 125 with or without a saver sub between the drill string 120 and the drive shaft 125. The prime mover of the top drive 116 is selectively operable to rotate the drive shaft 125 and the drill string 120 coupled with the drive shaft 125. Hence, the top drive 116 and the DW 119 cooperate to advance the drill string 120 into the formation 106 to form the wellbore 102. The tubular handling assembly links 127 and the elevator 129 of the top drive 116 may handle tubulars (e.g., drill pipes, drill collars, casing joints, etc.) that are not mechanically coupled to the drive shaft 125. For example, when the drill string 120 is being tripped into or out of the wellbore 102, the elevator 129 may grasp the tubulars of the drill string 120 such that the tubulars may be raised and/or lowered via the hoisting equipment mechanically coupled to the top drive 116. The grabber may include a clamp that clamps onto a tubular when making-up and/or breaking-out a connection of a tubular with the drive shaft 125. The top drive 116 may have a guide system (not shown), such as rollers that track up and down a guide rail on the support structure 112. The guide system may aid in keeping the top drive 116 aligned with the wellbore 102, and in preventing the top drive 116 from rotating during drilling by transferring reactive torque to the support structure 112.

The well construction system 100 may further include a well control system for maintaining well pressure control. For example, the drill string 120 may be conveyed within the wellbore 102 through various blowout preventer (BOP) equipment disposed at the wellsite surface 104 on top of the wellbore 102 and perhaps below the rig floor 114. The BOP equipment may be operable to control pressure within the wellbore 102 via a series of pressure barriers (e.g., rams) between the wellbore 102 and the wellsite surface 104. The BOP equipment may include a BOP stack 130, an annular preventer 132, and/or a rotating control device (RCD) 138 mounted above the annular preventer 132. The BOP equipment 130, 132, 138 may be mounted on top of a wellhead 134. The well control system may further include a BOP control unit 137 (i.e., a BOP closing unit) operatively connected with the BOP equipment 130, 132, 138 and operable to actuate, drive, operate, or otherwise control the BOP equipment 130, 132, 138. The BOP control unit 137 may be or comprise a hydraulic fluid power unit fluidly connected with the BOP equipment 130, 132, 138 and selectively operable to hydraulically drive various portions (e.g., rams, valves, seals) of the BOP equipment 130, 132, 138.

The well construction system 100 may further include a drilling fluid circulation system operable to circulate fluids between the surface equipment 110 and the drill bit 126 during drilling and other operations. For example, the drilling fluid circulation system may be operable to inject a drilling fluid from the wellsite surface 104 into the wellbore 102 via an internal fluid passage 121 extending longitudinally through the drill string 120. The drilling fluid circulation system may comprise a pit, a tank, and/or other fluid container 142 holding the drilling fluid (i.e., mud) 140, and a pump 144 operable to move the drilling fluid 140 from the container 142 into the fluid passage 121 of the drill string 120 via a fluid conduit 146 extending from the pump 144 to the top drive 116 and an internal passage extending through the top drive 116. The fluid conduit 146 may comprise one or more of a pump discharge line, a stand pipe, a rotary hose, and a gooseneck (not shown) connected with a fluid inlet of the top drive 116. The pump 144 and the container 142 may be fluidly connected by a fluid conduit 148, such as a suction line.

During drilling operations, the drilling fluid may continue to flow downhole through the internal passage 121 of the drill string 120, as indicated by directional arrow 158. The drilling fluid may exit the BHA 124 via ports 128 in the drill bit 126 and then circulate uphole through an annular space (annulus) 108 of the wellbore 102 defined between an exterior of the drill string 120 and the wall of the wellbore 102, such flow being indicated in FIG. 1 by directional arrows 159. In this manner, the drilling fluid lubricates the drill bit 126 and carries formation cuttings uphole to the wellsite surface 104. The returning drilling fluid may exit the annulus 108 via a bell nipple 139, the RCD 138, and/or a ported adapter 136 (e.g., a spool, a wing valve, etc.) located below one or more portions of the BOP stack 130.

The drilling fluid exiting the annulus 108 via the bell nipple 139 may be directed toward drilling fluid reconditioning equipment 170 via a fluid conduit 145 (e.g., gravity return line) to be cleaned and/or reconditioned, as described below, prior to being returned to the container 142 for recirculation. The drilling fluid exiting the annulus 108 via the RCD 138 may be directed into a fluid conduit 160 (e.g., a drilling pressure control line), and may pass through various wellsite equipment fluidly connected along the conduit 160 prior to being returned to the container 142 for recirculation. For example, the drilling fluid may pass through a choke manifold 162 (e.g., a drilling pressure control choke manifold) and then through the drilling fluid reconditioning equipment 170. The choke manifold 162 may include at least one choke and a plurality of fluid valves (neither shown) collectively operable to control the flow through and out of the choke manifold 162. Backpressure may be applied to the annulus 108 by variably restricting flow of the drilling fluid or other fluids flowing through the choke manifold 162. The greater the restriction to flow through the choke manifold 162, the greater the backpressure applied to the annulus 108. The drilling fluid exiting the annulus 108 via the ported adapter 136 may be directed into a fluid conduit 171 (e.g., rig choke line), and may pass through various equipment fluidly connected along the conduit 171 prior to being returned to the container 142 for recirculation. For example, the drilling fluid may pass through a choke manifold 173 (e.g., a rig choke manifold, well control choke manifold, etc.) and then through the drilling fluid reconditioning equipment 170. The choke manifold 173 may include at least one choke and a plurality of fluid valves (neither shown) collectively operable to control the flow through the choke manifold 173. Backpressure may be applied to the annulus 108 by variably restricting flow of the drilling fluid or other fluids flowing through the choke manifold 173.

Before being returned to the container 142, the drilling fluid returning to the wellsite surface 104 may be cleaned and/or reconditioned via the drilling fluid reconditioning equipment 170, which may include one or more of liquid gas separators, shale shakers, centrifuges, and other drilling fluid cleaning equipment. The liquid gas separators may remove formation gasses entrained in the drilling fluid discharged from the wellbore 102, and the shale shakers may separate and remove solid particles 141 (e.g., drill cuttings) from the drilling fluid. The drilling fluid reconditioning equipment 170 may further comprise equipment operable to remove additional gas and finer formation cuttings from the drilling fluid and/or modify physical properties or characteristics (e.g., rheology) of the drilling fluid. For example, the drilling fluid reconditioning equipment 170 may include a degasser, a desander, a desilter, a mud cleaner, and/or a decanter, among other examples. Intermediate tanks/containers (not shown) may be utilized to hold the drilling fluid while the drilling fluid progresses through the various stages or portions of the drilling fluid reconditioning equipment 170. The cleaned/reconditioned drilling fluid may be transferred to the fluid container 142, the solid particles 141 removed from the drilling fluid may be transferred to a solids container 143 (e.g., a reserve pit), and the removed gas may be transferred to a flare stack 172 via a conduit 174 (e.g., a flare line) to be burned or to a container (not shown) for storage and removal from the wellsite.

The surface equipment 110 may include tubular handling equipment operable to store, move, connect, and disconnect tubulars (e.g., drill pipes) to assemble and disassemble the conveyance means 122 of the drill string 120 during drilling operations. For example, a catwalk 131 may be utilized to convey tubulars from a ground level, such as along the wellsite surface 104, to the rig floor 114, permitting the tubular handling assembly links 127 to grab and lift the tubulars above the wellbore 102 for connection with previously deployed tubulars. The catwalk 131 may have a horizontal portion 147 and a ramp or inclined portion 149, wherein the inclined portion extends between the horizontal portion and the rig floor 114. The catwalk 131 may comprise a skate 133 movable along a groove (not shown) extending longitudinally along the horizontal and inclined portions of the catwalk 131. The skate 133 may be operable to convey (e.g., push) the tubulars along the catwalk 131 to the rig floor 114. The skate 133 may be driven along the groove by a drive system (not shown), such as a pulley system or a hydraulic system. Additionally, one or more racks (not shown) may adjoin the horizontal portion of the catwalk 131. The racks may be feeding tables (not shown), such as may have a spinner unit and/or other means for transferring tubulars to the groove of the catwalk 131.

An iron roughneck (RN) 151 may be positioned on the rig floor 114. The RN 151 may comprise a torqueing portion 153, such as may include a spinner and a torque wrench comprising a lower tong and an upper tong. The torqueing portion 153 of the RN 151 may be moveable toward and at least partially around the drill string 120, such as may permit the RN 151 to make-up and break-out connections of the drill string 120. The torqueing portion 153 may also be moveable away from the drill string 120, such as may permit the RN 151 to move clear of the drill string 120 during drilling operations. The spinner of the RN 151 may be utilized to apply low torque to make-up and break-out threaded connections between tubulars of the drill string 120, and the torque wrench may be utilized to apply a higher torque to tighten and loosen the threaded connections. The system 100 may include more than one instance of the RN 151.

Reciprocating slips 161 may be located on the rig floor 114, such as may accommodate therethrough the downhole tubulars during make-up and break-out operations and during the drilling operations. The reciprocating slips 161 may be in an open position during drilling operations to permit advancement of the drill string 120 therethrough, and in a closed position to clamp near an upper end of the conveyance means 122 (e.g., assembled tubulars) to thereby suspend and prevent advancement of the drill string 120 within the wellbore 102, such as during the make-up and break-out operations.

During drilling operations, the hoisting equipment lowers the drill string 120 while the top drive 116 rotates the drill string 120 to advance the drill string 120 within the wellbore 102 and into the formation 106. During the advancement of the drill string 120, the reciprocating slips 161 are in an open position, and the RN 151 is moved away or is otherwise clear of the drill string 120. When the upper portion of the tubular in the drill string 120 that is made up to the drive shaft 125 is near the reciprocating slips 161 and/or the rig floor 114, the top drive 116 ceases rotating and the reciprocating slips 161 close to clamp the tubular made up to the drive shaft 125. The grabber of the top drive 116 then clamps the upper portion of the tubular made up to the drive shaft 125, and the drive shaft 125 rotates in a direction reverse from the drilling rotation to break-out the connection between the drive shaft 125 and the made up tubular. The grabber of the top drive 116 may then release the tubular of the drill string 120.

Multiple tubulars may be loaded on the rack of the catwalk 131 and individual tubulars may be transferred from the rack to the groove in the catwalk 131. The tubular positioned in the groove may be conveyed along the groove by the skate 133 until an end of the tubular projects above the rig floor 114. The elevator 129 of the top drive 116 may then grasp the protruding end, and the DW 119 is operated to lift the top drive 116, the elevator 129, and the new tubular.

The hoisting equipment then raises the top drive 116, the elevator 129, and the tubular until the tubular is aligned with the upper portion of the drill string 120 clamped by the slips 161. The RN 151 is moved toward the drill string 120, and the lower tong of the torqueing portion 153 clamps onto the upper portion of the drill string 120. The spinning system rotates the new tubular into the upper portion of the drill string 120. The upper tong then clamps onto the new tubular and rotates with high torque to complete making-up the connection with the drill string 120. In this manner, the new tubular becomes part of the drill string 120. The RN 151 then releases and moves clear of the drill string 120.

The grabber of the top drive 116 may then clamp onto the drill string 120. The drive shaft 125 (or a saver sub or other device extending from the drive shaft 125) is brought into contact with the drill string 120 and rotated to make-up a connection between the drill string 120 and the drive shaft 125. The grabber then releases the drill string 120, and the reciprocating slips 161 are moved to the open position. The drilling operations may then resume.

The tubular handling equipment may further include a pipe handling manipulator (PHM) 163 disposed in association with a vertical pipe rack 165 for storing tubulars 111 (or stands of two or three tubulars). The vertical pipe rack 165 may comprise or support a fingerboard (FIB) 166 defining a plurality of slots configured to support or otherwise hold the tubulars 111 within or above a setback 164 (e.g., a platform or another area) located adjacent to, along, or below the rig floor 114. The FIB 166 may comprise a plurality of fingers (not shown), each associated with a corresponding slot and operable to close around and/or otherwise interpose individual tubulars 111 to maintain the tubulars 111 within corresponding slots of the setback 164. The vertical pipe rack 165 may be connected with and supported by the support structure 112 or another portion of the wellsite system 100. The FIB 166/setback 164 provide storage (e.g., temporary storage) of tubulars 111 during various operations, such as during and between tripping out and tripping of the drill string 120. The PHM 163 may be operable to transfer the tubulars 111 between the FIB 166/setback 164 and the drill string 120 (i.e., space above the suspended drill string 120). For example, the PHM 163 may include arms 167 terminating with clamps 169, such as may be operable to grasp and/or clamp onto one of the tubulars 111. The arms 167 of the PHM 163 may extend and retract, and/or at least a portion of the PHM 163 may be rotatable and/or movable toward and away from the drill string 120, such as may permit the PHM 163 to transfer the tubular 111 between the FIB 166/setback 164 and the drill string 120.

The surface equipment 110 of the well construction system 100 may also comprise a control center 190 from which various portions of the well construction system 100, such as the top drive 116, the hoisting system, the tubular handling system, the drilling fluid circulation system, the well control system, and the BHA 124, among other examples, may be monitored and controlled. The control center 190 may be located on the rig floor 114 or another location of the well construction system 100, such as the wellsite surface 104. The control center 190 may comprise a facility 191 (e.g., a room, a cabin, a trailer, etc.) containing a control workstation 197, which may be operated by a human wellsite operator 195 to monitor and control various wellsite equipment or portions of the well construction system 100. The control workstation 197 may comprise or be communicatively connected with a processing device 192 (e.g., a controller, a computer, etc.), such as may be operable to receive, process, and output information to monitor and/or control operations of one or more portions of the well construction system 100. For example, the processing device 192 may be communicatively connected with the various surface and downhole equipment described herein, and may be operable to receive signals from and transmit signals to such equipment to perform various operations described herein. The processing device 192 may store executable program code, instructions, and/or operational parameters or set-points, including for implementing one or more aspects of methods and operations described herein. The processing device 192 may be located within and/or outside of the facility 191.

The control workstation 197 may be operable for entering or otherwise communicating control commands to the processing device 192 by the wellsite operator 195, and for displaying or otherwise communicating information from the processing device 192 to the wellsite operator 195. The control workstation 197 may comprise a plurality of human-machine interface (HMI) devices, including one or more input devices 194 (e.g., a keyboard, a mouse, a joystick, a touchscreen, etc.) and one or more output devices 196 (e.g., a video monitor, a touchscreen, a printer, audio speakers, etc.). Communication between the processing device 192, the input and output devices 194, 196, and the various wellsite equipment may be via wired and/or wireless communication means. However, for clarity and ease of understanding, such communication means are not depicted, and a person having ordinary skill in the art will appreciate that such communication means are within the scope of the present disclosure.

Well construction systems within the scope of the present disclosure may include more or fewer components than as described above and depicted in FIG. 1. Additionally, various equipment and/or subsystems of the well construction system 100 shown in FIG. 1 may include more or fewer components than as described above and depicted in FIG. 1. For example, various engines, motors, hydraulics, actuators, valves, and/or other components not explicitly described herein may be included in the well construction system 100, and are within the scope of the present disclosure.

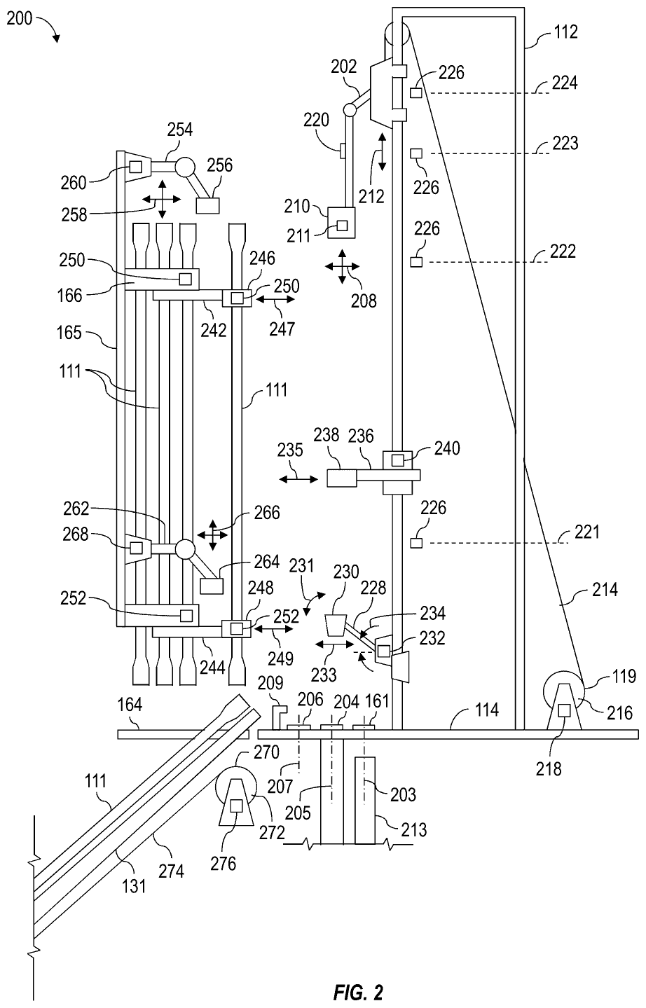

FIG. 2 is a schematic view of an example implementation of a wellsite system 200 comprising a plurality of pipe handling equipment, each comprising or carrying one or more sensors operable to generate sensor measurements indicative of corresponding operational parameters (e.g., position, speed, acceleration, etc.) of such equipment. According to one or more aspects of the present disclosure, the various pieces of equipment of the wellsite system 200 may be operable to move tubulars 111 between various positions of the wellsite system 200, to perform processes described herein, including assembly and disassembly of a drill string 120. The wellsite system 200 may form a portion of and/or operate in conjunction with the well construction system 100 shown in FIG. 1, including where indicated by the same numerals. Accordingly, the following description refers to FIGS. 1 and 2, collectively.

The wellsite system 200 may comprise a support structure 112 supporting various automated pipe handling equipment operable to transport tubulars 111 (e.g., drill pipes, stands of drill pipe, casing joints) between different areas of the wellsite system 200. The wellsite system 200 may further comprise a catwalk 131 operable to transport tubulars 111 from a storage area (not shown) at a ground level (e.g., wellsite surface 104) to a rig floor 114.

The support structure 112 or another portion of the wellsite system 200 may support a tubular delivery arm (TDA) 202 operable to grab the tubulars 111, one at a time, from an FIB 166 and/or the catwalk 131 and lift or otherwise move the tubulars 111 to predetermined positions. For example, the TDA 202 may move a tubular 111 over the wellbore 102, such that the tubular 111 is aligned with the wellbore center 203 above the reciprocating slips 161 and fluid control equipment 213 (e.g., BOP equipment 130, 132, 138 mounted on top of a wellhead 134, etc.) located below the rig floor 114. The TDA 202 may also move a tubular 111 over a mouse hole (MOH) 204, such that the tubular 111 is aligned with a mouse hole center 205, permitting one or more tubulars 111 to be disposed therein such that two or more tubulars 111 can be coupled together to form a stand.

The TDA 202 may also move a tubular 111 to a doping stand or area 206, such that the tubular 111 may be prepared for make-up operations by a washer/doper device (doper) 209. For example the doper 209 may apply dope to pin ends of tubulars 111 in preparation for being made-up, and/or may wash pin ends of tubulars 111 prior to transfer to the FIB 166/setback 164. Accordingly, the doper 209 may be positioned in conjunction with the doping area 206, the MOH 204, and/or other areas, such as for performing the washing/doping operations on a tubular 111 while the tubular 111 is engaged by the TDA 202. The doper 209 may also be positioned in conjunction with the TDA 202.

Portions of the TDA 202 may be operable to move horizontally and/or vertically, as indicated by arrows 208, such as may permit a grabber or clamp 210 of the TDA 202 to grab or otherwise receive a tubular 111 being transferred to the rig floor 114 by the catwalk 131. A DW 119 may be operable to move the TDA 202 vertically along the support structure 112, as indicated by arrows 212. The DW 119 may be operatively connected with the TDA 202 via a support line 214 extending between the TDA 202 and a drum 216 of the DW 119.

One or more sensors 211 may be disposed in association with the clamp 210, such as may permit the sensor 211 to generate sensor signals indicative of presence or proximity of a tubular 111 received by the clamp 210. One or more sensors 218 may be disposed in association with the DW 119, such as may permit the sensor 218 to generate sensor measurements (e.g., electrical sensor signals or data) indicative of rotational position of the drum 216. Such sensor measurements may be further indicative of vertical position of the TDA 202 along the support structure 112. The TDA 202 may carry or comprise one or more sensors 220 operable to generate sensor measurements indicative of tension applied to and, thus, weight supported by the TDA 202. The support structure 112 may further support a plurality of sensors 226, each located at a predetermined or otherwise known reference position 221-224 (i.e., height) along the support structure 112. Such known reference positions 221-224 may be known in the oil and gas industry as flags or targets. Each sensor 226 may be operable to generate a sensor signal indicative of presence or proximity of the TDA 202 when the TDA 202 passes the sensor 226, thereby indicating a corresponding known position 221-224 of the TDA 202 at such time.

The support structure 112 or another portion of the wellsite system 200 may further support a lower stabilization arm (LSA) 228 operable to receive (e.g., catch) and stabilize via a holding device 230 a tubular 111 supported by the TDA 202 after the tubular 111 is lifted off of the catwalk 131 and swings toward the support structure 112. The LSA 228 may then pivot 231 to horizontally move 233 the tubular 111 to align the tubular 111 with the mouse hole center 205 or the doping area 206. The holding device 230 may be extended around (at least partially) a tubular 111 to provide additional stability, such as during stabbing prior to make-up operations. The LSA 228 may carry or comprise one or more sensors 232 operable to generate sensor measurements indicative of stabilization arm extension (i.e., length) and/or angle 234 between the LSA 228 and the support structure 112 or a reference plane.

The support structure 112 or another portion of the wellsite system 200 may support a vertical rack 165 comprising or supporting the FIB 166 defining a plurality of slots configured to support or otherwise hold the tubulars 111 within or above a setback 164 located adjacent to, along, of below the rig floor 114. The support structure 112, the vertical rack 165, or another portion of the wellsite system 200, such as the PHM 163, may support an upper tubular constraint (UTC) 242 and a lower tubular constraint (LTC) 244, each operable to grab a corresponding upper and lower portion of a tubular 111 via a corresponding grabber or clamp 246, 248. The UTC 242 and LTC 244 may stabilize the tubular 111 and/or horizontally move the corresponding upper and/or lower portions of the tubular 111, as indicated by arrows 247, 249, to align the tubular 111 with the mouse hole center 205 or the doping area 206. The UTC 242 and LTC 244 may also horizontally move the corresponding upper and/or lower portions of the tubular 111, as indicated by arrows 247, 249, to position the tubular 111 along a tubular handoff position (THP) 207, at which the TDA 202 can grab and align the tubular 111 with the wellbore center 203 for connection with the drill string 120 or align the tubular 111 with a portion of the catwalk 131, permitting the tubular 111 to be lowered onto the catwalk 131, which may then move the tubular 111 from the rig floor 114 to the ground level (e.g., the wellsite surface 104). The THP 207 may be horizontally aligned with the doping area 206, such as may permit a tubular 111 to be doped and/or washed by the doper 209 before the TDA 202 aligns the tubular along the wellbore center 203 for connection with the drill string 120 or positions the tubular 111 to be lowered by the catwalk 131. The UTC 242 and LTC 244 may each carry or comprise one or more corresponding sensors 250, 252 operable to generate sensor measurements indicative of extension or horizontal positions 247, 249 of the corresponding clamps 246, 248.

The support structure 112, the vertical rack 165, or another portion of the wellsite system 200 may further support an intermediate tubular constraint (ITC) 236 operable to grab a tubular 111 supported by the TDA 202 via a grabber or clamp 238, stabilize the tubular 111, and/or horizontally move 235 the tubular 111 to align the tubular 111 with the mouse hole center 205 or the doping area 206. The ITC 236 may carry or comprise one or more sensors 240 operable to generate sensor measurements indicative of extension or horizontal position 235 of the clamp 238.

The support structure 112, the vertical rack 165, or another portion of the wellsite system 200 may further support a transfer bridge racker (TBR) 254 and a setback guide arm (SGA) 262, a collectively operable to store (e.g., hang, rack) the tubulars 111 in the FIB 166 of the vertical rack 165 within or above the setback 164. For example, the TBR 254 may be operable to grab an upper portion of a tubular 111 via a grabber or clamp 256 and move the tubular 111 horizontally and/or vertically between the FIB 166 and the THP 207, as indicated by arrows 258. The TBR 254 may carry or comprise one or more corresponding sensors 260 operable to generate sensor measurements indicative of the horizontal and/or vertical position 258 of the clamp 256. The SGA 262 may be operable to grab a lower portion of the tubular 111 via a grabber or clamp 264 and guide the lower portion of the tubular 111 horizontally and/or vertically between the setback 164 and the THP 207, as indicated by arrows 266, in unison (i.e., synchronously) with the TBR 254. The SGA 262 may carry or comprise one or more corresponding sensors 268 operable to generate sensor measurements indicative of the horizontal and/or vertical position 266 of the clamp 264. When the tubular 111 is aligned with the THP 207, the TDA 202 can grab and align the tubular 111 with the wellbore center 203 for connection with the drill string 120 or align the tubular with a portion of the catwalk 131, permitting the tubular 111 to be lowered onto the catwalk 131.

The UTC 242, the ITC 236, and the LTC 244 may temporarily grasp a tubular 111 while in the THP 207, such as while the TBR 254, the SGA 262, and the TDA 202 are performing other operations. One or more of the UTC 242, the ITC 236, and the LTC 244 may also be extendable to grasp a tubular 111 in (or move the tubular 111 to) the MOH 204. For example, the tubular 111 may be temporarily stored in the MOH 204 while awaiting addition to the drill string 120 or while awaiting transfer to the THP 207 and/or the FIB 166/setback 164.

The catwalk 131 may comprise a skate 133 movable along a groove (not shown) extending longitudinally along the catwalk 131. The skate 133 may be driven along the groove by a drive system 270, such as a winch system comprising a spool 272 driven by a motor (not shown). The drive system 270 may be selectively operable to pull the skate 133 in opposing directions along the catwalk 131 via a line 274 extending between the spool 272 and the skate 133. Actuated by the drive system 270, the skate 133 may be operable to convey (e.g., push) a tubular 111 along the catwalk 131 to the rig floor 114. The skate 133 may move the box end of the tubular 111 into the clamp 210 of the TDA 202, such that the tubular 111 can be lifted by the TDA 202. The drive system 270 may carry or comprise one or more corresponding sensors 276 operable to generate sensor measurements indicative of rotational position of the spool 272 and, thus, position of the skate 133 along the catwalk 131.

The sensors 218, 276 may be or comprise, for example, encoders, rotary potentiometers, and/or rotary variable-differential transformers (RVDTs). The sensors 220 may be or comprise, for example, strain gauges and/or load cells. The sensors 211, 226 may be or comprise, for example, proximity sensors and Hall effect sensors. The sensors 232, 240, 250, 252, 260, 268 may be or comprise, for example, encoders, rotary potentiometers, linear potentiometers, or rotary variable-differential transformers (RVDTs).

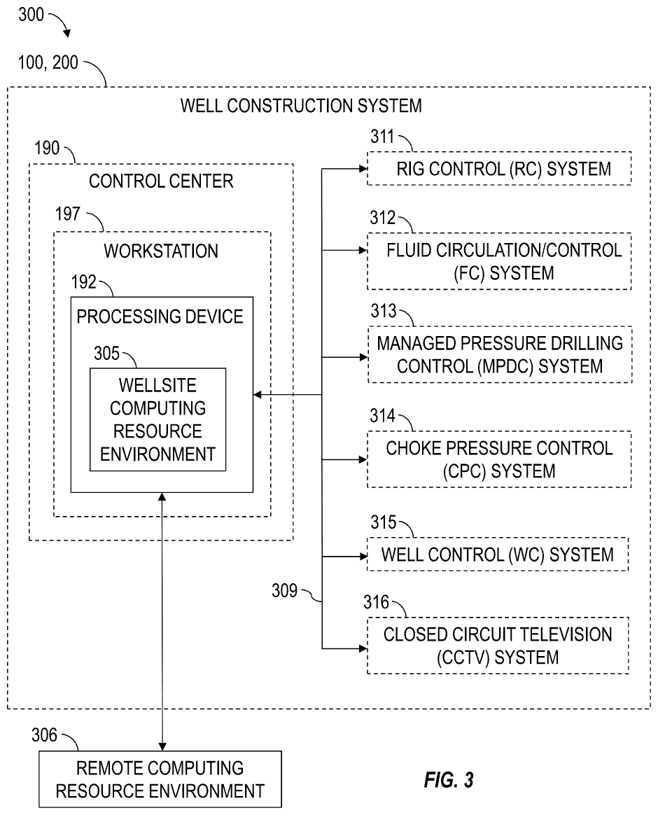

The present disclosure further provides various implementations of systems and/or methods for controlling one or more portions of the well construction system 100 and the wellsite system 200. Because the wellsite system 200 may form a portion of and/or operate in conjunction with the well construction system 100, the well construction system 100 and the wellsite system 200 are hereinafter referred to collectively as a well construction system 100, 200. FIG. 3 is a schematic view of at least a portion of an example implementation of a monitoring and control system 300 for monitoring and controlling various equipment, portions, and subsystems of the well construction system 100, 200 according to one or more aspects of the present disclosure. The following description refers to FIGS. 1-3, collectively.

The control system 300 may be in real-time communication with the well construction system 100, 200 and may be utilized to monitor and/or control various portions, components, and equipment of the well construction system 100, 200. The equipment of the well construction system 100, 200 may be grouped into several subsystems, each operable to perform a corresponding operation and/or a portion of the well construction operations described herein. The subsystems may include a rig control (RC) system 311, a fluid circulation (FC) system 312, a managed pressure drilling control (MPDC) system 313, a choke pressure control (CPC) system 314, a well pressure control (WC) system 315, and a closed-circuit television (CCTV) system 316, among other examples. The control workstation 197 may be utilized to monitor, configure, control, and/or otherwise operate one or more of the well construction subsystems 311-316.

The RC system 311 may include the support structure 112, the drill string hoisting system or equipment (e.g., the DW 119), the drill string rotational system (e.g., the top drive 116 and/or the rotary table and kelly), the reciprocating slips 161, the drill pipe handling system or equipment (e.g., the catwalk 131, the TDA 202, the setback 164, the FIB 166, the TBR 254, the SGA 262, the LTC 244, the ITC 236, the UTC 242, the LSA 228, and the RN 151), electrical generators, and other equipment. Accordingly, the RC system 311 may perform power generation and/or distribution, and may control drill pipe handling, hoisting, and rotation operations. The RC system 311 may also serve as a support platform for drilling equipment and staging ground for rig operations, such as connection make-up and break-out operations described above.

The FC system 312 may include the drilling fluid 140, the pumps 144, drilling fluid loading and/or mixing equipment, the drilling fluid reconditioning equipment 170, the flare stack 172, and/or other fluid control equipment. Accordingly, the FC system 312 may perform fluid operations of the well construction system 100.

The MPDC system 313 may include the RCD 138, the choke manifold 162, downhole pressure sensors 186, and/or other equipment. The CPC system 314 may comprise the choke manifold 173 and/or other equipment. The WC system 315 may comprise the BOP equipment 130, 132, 138, the BOP control unit 137, and a BOP control station (not shown) for controlling the BOP control unit 137.

The CCTV system 316 may include the video cameras 198 and corresponding actuators (e.g., motors) for moving or otherwise controlling direction of the video cameras 198. The CCTV system 316 may be utilized to capture real-time video of various portions or subsystems 311-315 of the well construction system 100 and display video signals from the video cameras 198 on the video output devices 196 to display in real-time the various portions or subsystems 311-315.

Each of the well construction subsystems 311-316 may further comprise various communication equipment (e.g., modems, network interface cards/circuits, etc.) and communication conductors (e.g., cables), communicatively connecting the equipment (e.g., sensors and actuators) of each subsystem 311-316 with the control workstation 197 and/or other equipment. Although the wellsite equipment listed above and shown in FIGS. 1 and 2 is associated with certain wellsite subsystems 311-316, such associations are merely examples that are not intended to limit or prevent such wellsite equipment from being associated with two or more wellsite subsystems 311-316 and/or different wellsite subsystems 311-316.

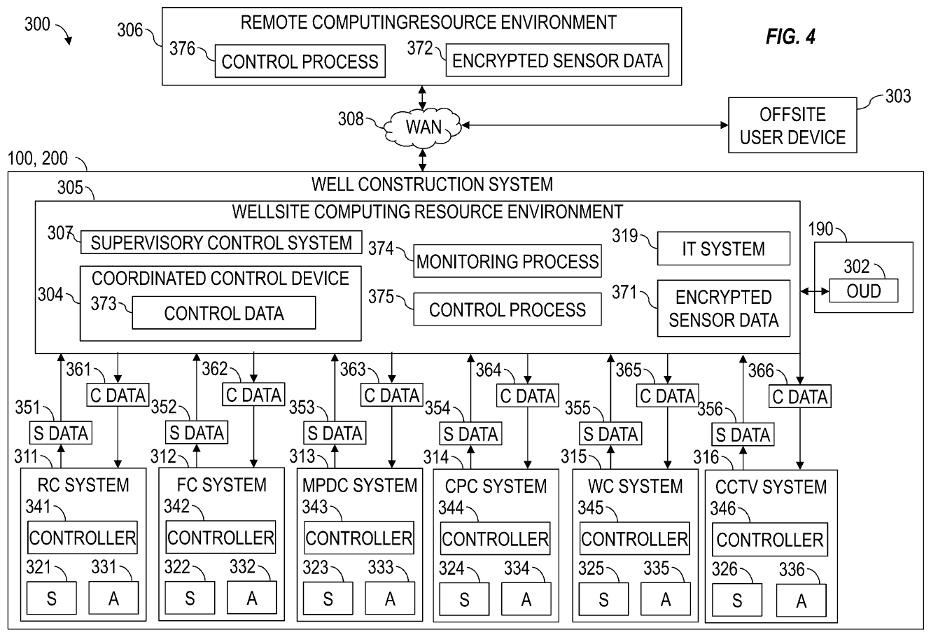

The control system 300 may include a wellsite computing resource environment 305, which may be located at the wellsite 104 as part of the well construction system 100, 200. The control system 300 may also include a remote computing resource environment 306, which may be located offsite (i.e., not at the wellsite 104). The control system 300 may also include various local controllers (e.g., controllers 341-346 shown in FIG. 4) associated with the subsystems 311-316 and/or individual components or equipment of the well construction system 100, 200. As described above, each subsystem 311-316 of the well construction system 100, 200 may include actuators (e.g., actuators 331-336 shown in FIG. 4) and sensors (e.g., sensors 321-326 shown in FIG. 4) for performing operations of the well construction system 100, 200. These actuators and sensors may be monitored and/or controlled via the wellsite computing resource environment 305, the remote computing resource environment 306, and/or the corresponding local controllers. For example, the wellsite computing resource environment 305 and/or the local controllers may be operable to monitor the sensors of the wellsite subsystems 311-316 in real-time, and to provide real-time control commands to the subsystems 311-316 based on the received sensor data. Data may be generated by sensors and/or computation and may be utilized for coordinated control among two or more of the subsystems 311-316.

The control system 300 may be in real-time communication with the various components of the well construction system 100, 200. For example, the local controllers may be in communication with various sensors and actuators of the corresponding subsystems 311-316 via local communication networks (not shown), and the wellsite computing resource environment 305 may be in communication with the subsystems 311-316 via a data bus or network 309. As described below, data or sensor signals generated by the sensors of the subsystems 311-316 may be made available for use by processes (e.g., processes 374, 375 shown in FIG. 4) and/or devices of the wellsite computing resource environment 305. Similarly, data or control signals generated by the processes and/or devices of the wellsite computing resource environment 305 may be automatically communicated to various actuators of the subsystems 311-316, perhaps pursuant to predetermined programming, such as to facilitate well construction operations and/or other operations described herein.

The remote computing resource environment 306, the wellsite computing resource environment 305, and the subsystems 311-316 of the well construction system 100, 200 may be communicatively connected with each other via a network connection, such as via a wide-area-network (WAN), a local-area-network (LAN), and/or other networks also within the scope of the present disclosure. A “cloud” computing environment is one example of a remote computing resource environment 306. The wellsite computing resource environment 305 may be or form at least a portion of the processing device 192 and, thus, may form a portion of or be communicatively connected with the control workstation 197.

FIG. 4 is a schematic view of an example implementation of the control system 300 shown in FIG. 3 communicatively connected with the subsystems 311-316 of the well construction system 100, 200, including the RC system 311, the FC system 312, the MPDC system 313, the CPC system 314, the WC system 315, and the CCTV system 316. The following description refers to FIGS. 1-4, collectively.

The well construction system 100, 200 may include one or more onsite user devices (OUD) 302 communicatively connected with the wellsite computing resource environment 305. The onsite user devices 302 may be or comprise stationary user devices intended to be stationed at the well construction system 100, 200 and/or portable user devices. For example, the onsite user devices 302 may include a desktop computer, a laptop computer, a smartphone and/or other portable smart device, a personal digital assistant (PDA), a tablet/touchscreen computer, a wearable computer, and/or other devices. The onsite user devices 302 may be operable to communicate with the wellsite computing resource environment 305 of the well construction system 100, 200 and/or the remote computing resource environment 306. At least one of the onsite user devices 302 may be or comprise at least a portion of the control workstation 197 shown in FIG. 1 and/or the processing device 192 shown in FIGS. 1 and 3, which may be located within the facility 191.

The wellsite computing resource environment 305 and/or other portions of the well construction system 100, 200 may further comprise an information technology (IT) system 319 operable to communicatively interconnect various portions of the wellsite computing resource environment 305 and/or to communicatively connect the wellsite computing resource environment 305 with other portions of the well construction system 100, 200. The IT system 319 may include communication conduits, software, computers, and/or other IT equipment facilitating communication among one or more portions of the wellsite computing resource environment 305 and/or between the wellsite computing resource environment 305 and another portion of the well construction system 100, 200, such as the remote computing resource environment 306, the onsite user device 302, and the subsystems 311-316.

The control system 300 may include (or otherwise be utilized in conjunction with) one or more offsite user devices 303. The offsite user devices 303 may be or comprise a desktop computer, a laptop computer, a smartphone and/or other portable smart device, a PDA, a tablet/touchscreen computer, a wearable computer, and/or other devices. The offsite user devices 303 may be operable to receive and/or transmit information (e.g., for monitoring functionality) from and/or to the well construction system 100, 200, such as by communication with the wellsite computing resource environment 305 via the network 308. The offsite user devices 303 may be utilized just for monitoring functions. However, one or more of the offsite user devices 303 may be utilized to provide control processes for controlling operation of the various subsystems 311-316 of the well construction system 100, 200. The offsite user devices 303 and/or the wellsite computing resource environment 305 may also be operable to communicate with the remote computing resource environment 306 via the network 308. The network 308 may be a WAN, such as the internet, a cellular network, a satellite network, other WANs, and/or combinations thereof.

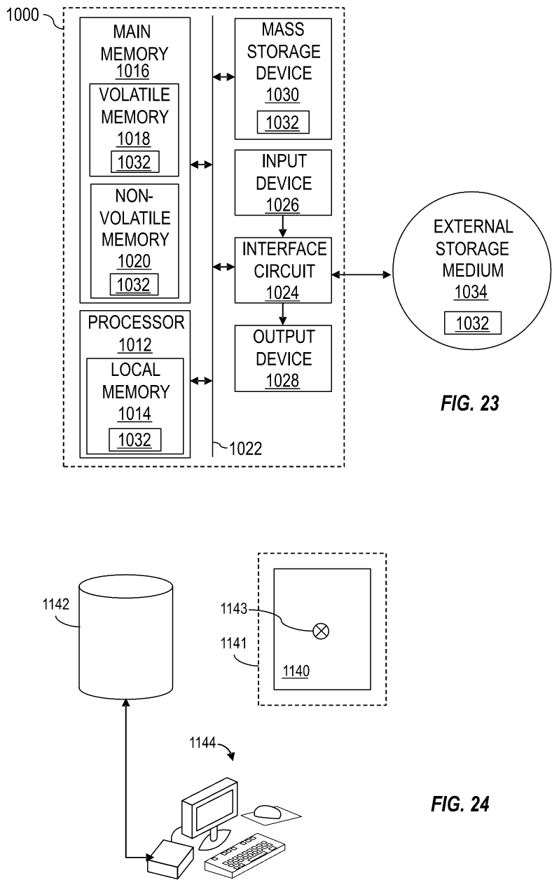

The subsystems 311-316 of the well construction system 100, 200 and the control system 300 may include sensors 321-326, actuators 331-336, and local controllers 341-346. The controllers 341-346 may be programmable logic controllers (PLCs) and/or other controllers having aspects similar to the example processing device 1000 shown in FIG. 23. The RC system 311 may include one or more sensors 321, one or more actuators 331, and one or more controllers 341. The FC system 312 may include one or more sensors 322, one or more actuators 332, and one or more controllers 342. The MPDC system 313 may include one or more sensors 323, one or more actuators 333, and one or more controllers 343. The CPC system 314 may include one or more sensors 324, one or more actuators 334, and one or more controllers 344 (e.g., a BOP control station 470 shown in FIG. 6). The WC system 315 may include one or more sensors 325, one or more actuators 335, and one or more controllers 345. The CCTV system 316 may include one or more sensors 326, one or more actuators 336, and one or more controllers 346.

The sensors 321-326 may include sensors utilized for operation of the various subsystems 311-316 of the well construction system 100, 200. For example, the sensors 321-326 may include cameras, position sensors, pressure sensors, temperature sensors, flow rate sensors, vibration sensors, current sensors, voltage sensors, resistance sensors, gesture detection sensors or devices, voice actuated or recognition devices or sensors, and/or other examples.

The sensors 321-326 may be operable to provide sensor data to the wellsite computing resource environment 305, such as to the coordinated control device 304. For example, the sensors 321-326 may provide sensor data 351-356, respectively. The sensor data 351-356 may include signals or information indicative of equipment operation status (e.g., on or off, up or down, set or release, etc.), drilling parameters (e.g., depth, hook load, torque, etc.), auxiliary parameters (e.g., vibration data of a pump), flow rate, temperature, operational speed, position, and pressure, among other examples. The acquired sensor data 351-356 may include or be associated with a timestamp (e.g., date and/or time) indicative of when the sensor data 351-356 was acquired. The sensor data 351-356 may also or instead be aligned with a depth, time, and/or other drilling parameter.

Acquiring the sensor data 351-356 at the coordinated control device 304 may facilitate measurement of the same physical properties at different locations of the well construction system 100, 200, wherein the sensor data 351-356 may be utilized for measurement redundancy to permit continued well construction operations. Measurements of the same physical properties at different locations may also be utilized for detecting equipment conditions among different physical locations at the wellsite surface 104 or within the wellbore 102. Variation in measurements at different wellsite locations over time may be utilized to determine equipment performance, system performance, scheduled maintenance due dates, and the like. For example, slip status (e.g., set or unset) may be acquired from the sensors 321 and communicated to the wellsite computing resource environment 305. Acquisition of fluid samples may be measured by a sensor, such as the sensors 186, 323, and related with bit depth and time measured by other sensors. Acquisition of data from the video cameras 198, 325 may facilitate detection of arrival and/or installation of materials or equipment at the well construction system 100, 200. The time of arrival and/or installation of materials or equipment may be utilized to evaluate degradation of material, scheduled maintenance of equipment, and other evaluations.

The coordinated control device 304 may facilitate control of one or more of the subsystems 311-316 at the level of each individual subsystem 311-316. For example, in the FC system 312, sensor data 352 may be fed into the controller 342, which may respond to control the actuators 332. However, for control operations that involve multiple systems, the control may be coordinated through the coordinated control device 304. For example, coordinated control operations may include the control of downhole pressure during tripping. The downhole pressure may be affected by each of the FC system 312 (e.g., pump rate), the MPDC 313 (e.g., choke position of the MPDC), and the RC system 311 (e.g., tripping speed). Thus, when it is intended to maintain certain downhole pressure during tripping, the coordinated control device 304 may be utilized to direct the appropriate control commands to two or more (or each) of the participating subsystems.

Control of the subsystems 311-316 of the well construction system 100, 200 may be provided via a three-tier control system that includes a first tier of the local controllers 341-346, a second tier of the coordinated control device 304, and a third tier of the supervisory control system 307. Coordinated control may also be provided by one or more controllers 341-346 of one or more of the subsystems 311-316 without the use of a coordinated control device 304. In such implementations of the control system 300, the wellsite computing resource environment 305 may provide control processes directly to these controllers 341-346 for coordinated control.

The sensor data 351-356 may be received by the coordinated control device 304 and utilized for control of the subsystems 311-316. The sensor data 351-356 may be encrypted to produce encrypted sensor data 371. For example, the wellsite computing resource environment 305 may encrypt sensor data from different types of sensors and systems to produce a set of encrypted sensor data 371. Thus, the encrypted sensor data 371 may not be viewable by unauthorized user devices (either offsite user devices 303 or onsite user devices 302) if such devices gain access to one or more networks of the well construction system 100, 200. The encrypted sensor data 371 may include a timestamp and an aligned drilling parameter (e.g., depth), as described above. The encrypted sensor data 371 may be communicated to the remote computing resource environment 306 via the network 308 and stored as encrypted sensor data 372.

The wellsite computing resource environment 305 may provide the encrypted sensor data 371, 372 available for viewing and processing offsite, such as via the offsite user devices 303. Access to the encrypted sensor data 371, 372 may be restricted via access control implemented in the wellsite computing resource environment 305. The encrypted sensor data 371, 372 may be provided in real-time to offsite user devices 303 such that offsite personnel may view real-time status of the well construction system 100, 200 and provide feedback based on the real-time sensor data. For example, different portions of the encrypted sensor data 371, 372 may be sent to the offsite user devices 303. The encrypted sensor data 371, 372 may be decrypted by the wellsite computing resource environment 305 before transmission, and/or decrypted on the offsite user device 303 after encrypted sensor data is received. The offsite user device 303 may include a thin client (not shown) configured to display data received from the wellsite computing resource environment 305 and/or the remote computing resource environment 306. For example, multiple types of thin clients (e.g., devices with display capability and minimal processing capability) may be utilized for certain functions or for viewing various sensor data 351-356.

The wellsite computing resource environment 305 may include various computing resources utilized for monitoring and controlling operations, such as one or more computers having a processor and a memory. For example, the coordinated control device 304 may include a processing device (e.g., processing device 1000 shown in FIG. 23) having a processor and memory for processing the sensor data, storing the sensor data, and issuing control commands responsive to the sensor data. As described above, the coordinated control device 304 may control various operations of the subsystems 311-316 via analysis of sensor data 351-356 from one or more of the wellsite subsystems 311-316 to facilitate coordinated control between the subsystems 311-316. The coordinated control device 304 may generate control data 373 (e.g., signals, commands, coded instructions) to execute control of the subsystems 311-316. The coordinated control device 304 may transmit the control data 373 to one or more subsystems 311-316. For example, control data 361 may be sent to the RC system 311, control data 362 may be sent to the FC system 312, control data 363 may be sent to the MPDC system 313, control data 364 may be sent to the CPC system 314, control data 365 may be sent to the WC system 315, and control data 366 may be sent to the CCTV system 316. The control data 361-366 may include, for example, wellsite operator commands (e.g., turn on or off a pump, switch on or off a valve, update a physical property set-point, etc.). The coordinated control device 304 may include a fast control loop that directly obtains sensor data 351-356 and executes, for example, a control algorithm. The coordinated control device 304 may include a slow control loop that obtains data via the wellsite computing resource environment 305 to generate control commands.

The coordinated control device 304 may intermediate between the supervisory control system 307 and the local controllers 341-346 of the subsystems 311-316, such as may permit the supervisory control system 307 to control the subsystems 311-316. The supervisory control system 307 may include, for example, devices for entering control commands to perform operations of the subsystems 311-316. The coordinated control device 304 may receive commands from the supervisory control system 307, process such commands according to a rule (e.g., an algorithm based upon the laws of physics for drilling operations), and provide control data to one or more subsystems 311-316. The supervisory control system 307 may be provided by the wellsite operator 195 and/or process monitoring and control program. In such implementations, the coordinated control device 304 may coordinate control between discrete supervisory control systems and the subsystems 311-316 while utilizing control data 361-366 that may be generated based on the sensor data 351-356 received from the subsystems 311-316 and analyzed via the wellsite computing resource environment 305. The coordinated control device 304 may receive the control data 351-356 and then dispatch control data 361, including interlock commands, to each subsystem 311-316. The coordinated control device 304 may also or instead just monitor the control data 351-356 being dispatched to each subsystem 321-326 and then initiate the machine interlock commands to the relevant local controller 341-346.

The coordinated control device 304 may run with different levels of autonomy. For example, the coordinated control device 304 may operate in an advice mode to inform the wellsite operators 195 to perform a specific task or take specific corrective action based on sensor data 351-356 received from the various subsystems 311-316. While in the advice mode, the coordinated control device 304 may, for example, advise or instruct the wellsite operator 195 to perform a standard work sequence when gas is detected on the rig floor 114, such as to close the annular BOP 132. Furthermore, if the wellbore 102 is gaining or losing drilling fluid 140, the coordinated control device 304 may, for example, advise or instruct the wellsite operator 195 to modify the density of the drilling fluid 140, modify the pumping rate of the drilling fluid 140, and/or modify the pressure of the drilling fluid within the wellbore 102.

The coordinated control device 304 may also operate in a system/equipment interlock mode, whereby certain operations or operational sequences are prevented based on the received sensor data 351-356. While operating in the interlock mode, the coordinated control device 304 may manage interlock operations among the various equipment of the subsystems 311-316. For example, if a pipe ram of the BOP stack 130 is activated, the coordinated control device 304 may issue an interlock command to the RC system controller 341 to stop the DW 119 from moving the drill string 120. However, if a shear ram of the BOP stack 130 is activated, the coordinated control device 304 may issue an interlock command to the controller 341 to operate the DW 119 to adjust the position of the drill string 120 within the BOP stack 130 before activating the shear ram, so that the shear ram does not align with a shoulder of the tubulars forming the drill string 120.

The coordinated control device 304 may also operate in an automated sequence mode, whereby certain operations or operational sequences are automatically performed based on the received sensor data 351-356. For example, the coordinated control device 304 may automatically activate an alarm and/or stop or reduce operating speed of the pipe handling equipment when a wellsite operator 195 is detected close to a moving RN 151, the TDA 202, the LSA 228, the LTC 244, or the catwalk 131. As another example, if the wellbore pressure increases rapidly, the coordinated control device 304 may automatically close the annular BOP 132, close one or more rams of the BOP stack 130, and/or adjust the choke manifold 162.

The wellsite computing resource environment 305 may comprise or execute a monitoring process 374 (e.g., an event detection process) that may utilize the sensor data 351-356 to determine information about status of the well construction system 100, 200 and automatically initiate an operational action, a process, and/or a sequence of one or more of the subsystems 311-316. The monitoring process 374 may initiate the operational action to be caused by the coordinated control device 304. Depending on the type and range of the sensor data 351-356 received, the operational actions may be executed in the advice mode, the interlock mode, or the automated sequence mode.

For example, the monitoring process 374 may determine a drilling state, equipment health, system health, a maintenance schedule, or combination thereof, and initiate an advice to be generated. The monitoring process 374 may also detect abnormal drilling events, such as a wellbore fluid loss and gain, a wellbore washout, a fluid quality issue, or an equipment event based on job design and execution parameters (e.g., wellbore, drilling fluid, and drill string parameters), current drilling state, and real-time sensor information from the surface equipment 110 (e.g., presence of hazardous gas at the rig floor, presence of wellsite operators in close proximity to moving pipe handling equipment, etc.) and the BHA 124, initiating an operational action in the automated mode. The monitoring process 374 may be connected to the real-time communication network 309. The coordinated control device 304 may initiate a counteractive measure (e.g., a predetermined action, process, or operation) based on the events detected by the monitoring process 374.

The term “event” as used herein may include, but not be limited to, an operational and/or safety related event described herein and/or another operational and safety related event that can take place at a well construction system 100, 200. The events described herein may be detected by the monitoring process 374 based on the sensor data 351-356 (e.g., sensor signals or information) received and analyzed by the monitoring process 374.

The wellsite computing resource environment 305 may also comprise or execute a control process 375 that may utilize the sensor data 351-356 to optimize drilling operations, such as the control of drilling equipment to improve drilling efficiency, equipment reliability, and the like. For example, the acquired sensor data 352 may be utilized to derive a noise cancellation scheme to improve electromagnetic and/or mud-pulse telemetry signal processing. The remote computing resource environment 306 may comprise or execute a control process 376 substantially similar to the control process 375 that may be provided to the wellsite computing resource environment 305. The monitoring and control processes 374, 375, 376 may be implemented via, for example, a control algorithm, a computer program, firmware, or other hardware and/or software.

The wellsite computing resource environment 305 may include various computing resources, such as a single computer or multiple computers. The wellsite computing resource environment 305 may further include a virtual computer system and a virtual database or other virtual structure for collected data, such as may include one or more resource interfaces (e.g., web interfaces) that facilitate the submission of application programming interface (API) calls to the various resources through a request. In addition, each of the resources may include one or more resource interfaces that facilitate the resources accessing each other (e.g., to facilitate a virtual computer system of the computing resource environment to store data in or retrieve data from the database or other structure for collected data). The virtual computer system may include a collection of computing resources configured to instantiate virtual machine instances. A wellsite operator 195 may interface with the virtual computer system via the offsite user device 303 or the onsite user device 302. Other computer systems or computer system services may be utilized in the wellsite computing resource environment 305, such as a computer system or computer system service that provides computing resources on dedicated or shared computers/servers and/or other physical devices. The wellsite computing resource environment 305 may include a single server (in a discrete hardware component or as a virtual server) or multiple servers (e.g., web servers, application servers, or other servers). The servers may be, for example, computers arranged in physical and/or virtual configuration.

The wellsite computing resource environment 305 may also include a database that may be or comprise a collection of computing resources that run one or more data collections. Such data collections may be operated and managed by utilizing API calls. The data collections, such as the sensor data 351-356, may be made available to other resources in the wellsite computing resource environment 305, or to user devices (e.g., onsite user device 302 and/or offsite user device 303) accessing the wellsite computing resource environment 305. The remote computing resource environment 306 may include computing resources similar to those described above, such as a single computer or multiple computers (in discrete hardware components or virtual computer systems).

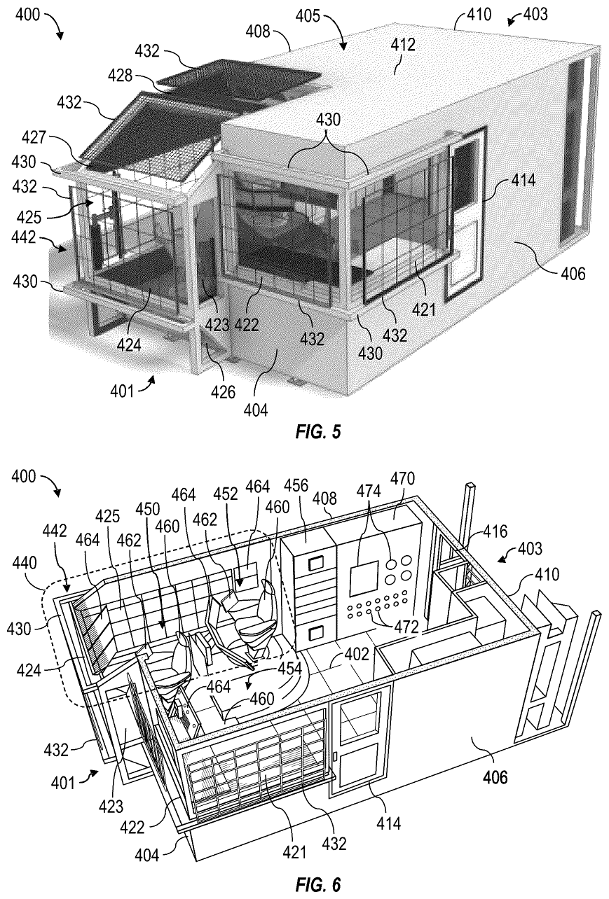

FIGS. 5 and 6 are perspective and sectional views of at least a portion of an example implementation of a control center 400 according to one or more aspects of the present disclosure. The control center 400 may be or form at least a portion of the control center 190 shown in FIG. 1. The following description refers to FIGS. 1-6, collectively.

The control center 400 comprises a facility 405 (e.g., a room, a cabin, a trailer, etc.) containing various control devices for monitoring and controlling the subsystems 311-316 and other portions of the well construction system 100, 200. The facility 405 may comprise a front side 401 and a rear side 403. The front side 401 may be directed toward or located closest to the drill string 120 being constructed by the well construction system 100, 200. The rear side 403 may be directed away from the drill string 120. The facility 405 may comprise a floor 402, a front wall 404, a left wall 406, a right wall 408, a rear wall 410, and a roof 412. The facility 405 may also have a side door 414, a rear door 416, and a plurality of windows 421-428 in one or more of the walls 404, 406, 408, 410 and/or the roof 412. Each of the windows 421-428 may be surrounded by structural framing 430 connected with the walls and supporting window safety guards 432 (e.g., bars, grills) in front of or along the windows 421-428.

The facility 405 may have an observation area 440 at the front side 401 of the facility 405 from which a wellsite operator 195 may have a direct view of the drill string 120, the rig floor 114, and/or other portions of the well construction system 100, 200. The observation area 440 may be surrounded or defined by windows 423-428 on several sides to increase the wellsite operator's 195 horizontal and vertical angle of view of the well constriction system 100. A portion 442 of the observation area 440 (e.g., windows 423-427) may protrude or extend out past other portions of the facility 405 (e.g., front wall 404) to facilitate the view of the well construction system 100, 200 by the wellsite operators 195. The observation area 440 may be located on a side of the facility 405. The observation area 440 may be surrounded by or at least partially defined by a front window 424 permitting the wellsite operator 195 to look forward, two side windows 423, 425 permitting the wellsite operator 195 to look sideways (i.e., left and right), a lower window 426 permitting the wellsite operator 195 to look downwards, and one or more upper windows 427, 428 permitting the wellsite operator 195 to look upwards. The lower window 426 and/or at least one upper window 427 may extend diagonally with respect to the front window 424.

The control center 400 may comprise one or more wellsite operator control workstations within the facility 405. The workstations may be utilized by the wellsite operators 195 to monitor and control the subsystems 311-316 and other portions of the well construction system 100, 200. For example, the observation area 440 may contain a first control workstation 450 located adjacent the windows 423, 424, 425, 426, 428 and at least partially within the extended portion 442 of the observation area 440, such as may permit the wellsite operator 195 utilizing the control workstation 450 to have an unobstructed view of the drill string 120, the rig floor 114, and/or other portions of the well construction system 100, 200. The observation area 440 may also contain a second control workstation 452 located adjacent (e.g., behind) the first control workstation 450 and adjacent the window 425, but perhaps not within the extended portion 442 of the observation area 440. The control workstation 452 may be elevated at least partially above the control workstation 450 to reduce the obstruction of view caused by the control workstation 450 and, thus, permit the wellsite operator 195 utilizing the control workstation 452 to view the drill string 120, the rig floor 114, and/or other portions of the well construction system 100, 200 over the control workstation 450 via the front window 424. The control center 400 may also comprise a third control workstation 454 located adjacent the control workstations 450, 452 and adjacent the windows 421, 422, but not within the observation area 440.

The control center 400 may further comprise a processing device 456 (e.g., a controller, a computer, a server, etc.) operable to provide control to one or more portions of the well construction system 100, 200 and/or operable to monitor operations of one or more portions of the well construction system 100, 200. For example, the processing device 456 may be communicatively connected with the various surface and downhole equipment described herein, and may be operable to receive signals from and transmit signals to such equipment to perform various operations described herein or otherwise within the scope of the present disclosure. The processing device 456 may store executable programs, instructions, and/or operational parameters or set-points, including for implementing one or more aspects of the operations described herein. The processing device 456 may be communicatively connected with the control workstations 450, 452, 454. Although the processing device 456 is shown located within the facility 405, the processing device 456 may be located outside of the facility 405. Furthermore, although the processing device 456 is shown as a single device that is separate and distinct from the control workstations 450, 452, 454, one or more of the control workstations 450, 452, 454 may comprise a corresponding processing device 456 disposed in association with or forming at least a portion of such corresponding processing device 456.

The control workstations 450, 452, 454 may be operable to enter or otherwise communicate commands to the processing device 456 by the wellsite operator 195 and to display or otherwise communicate information from the processing device 456 to the wellsite operator 195. One or more of the control workstations 450, 452, 454 may comprise an operator chair 460 and an HMI system comprising one or more input devices 462 (e.g., a keyboard, a mouse, a joystick, a touchscreen, a microphone, etc.) and one or more output devices 464 (e.g., a video monitor, a printer, audio speakers, a touchscreen, etc.). The input and output devices 462, 464 may be disposed in association with and/or integrated with the operator chair 460 to permit the wellsite operator 195 to enter commands or other information to the processing device 456, and to view, hear, and/or otherwise receive information from the processing device 456 and other portions of the well construction system 100, 200. One or more of the control workstations 450, 452, 454 may be or form at least a portion of the control workstation 197 shown in FIG. 1, and the processing device 456 may be or form at least a portion of the processing device 192 shown in FIG. 1.

The control center 400 may further contain a BOP control station 470 (e.g., control panel) of the WC system 315 operable to monitor and control one or more portions of the WC system 315. For example, the BOP control station 470 may be communicatively connected with the BOP control unit 137 and the BOP equipment 130, 132, and may be operable to monitor and control operations of the BOP control unit 137 and the BOP equipment 130, 132.

The BOP control station 470 may be operable communicate to the BOP control unit 137 control commands entered by the wellsite operator 195 for controlling the BOP equipment 130, 132 and to display or otherwise communicate information indicative of operational status of the BOP equipment 130, 132 and the BOP control unit 137 to the wellsite operator 195. The BOP control station 470 may comprise a processing device (e.g., processing device 1000 shown in FIG. 23) operable to store executable programs, instructions, and/or operational parameters or set-points, including for implementing one or more BOP operations described herein. The BOP control station 470 may further comprise an HMI system comprising one or more input devices 472 (e.g., buttons, keys, a touchscreen, etc.) and one or more output devices 474 (e.g., a video monitor, gauges, audio speakers, a touchscreen, etc.). The input and output devices 472, 474 may be disposed in association with and/or integrated with a housing or enclosure of the BOP control station 470 to permit the wellsite operator 195 to enter commands or other information to the BOP control station 470 to control the BOP equipment 130, 132 and receive information from the BOP control station 470 to monitor operational status of the BOP equipment 130, 132.

The BOP control unit 470 may be communicatively connected with one or more of the control workstations 450, 452, 454, such as may permit monitoring and control of one or more portions of the WC system 315 via the control workstations 450, 452, 454. For example, one or more of the control workstations 450, 452, 454 or the processing device 456 may be communicatively connected directly with the processing device of the BOP control station 470 or indirectly, such as via the input and output devices 472, 474 of the BOP control station 470. Such connection may permit the control workstations 450, 452, 454 to receive information indicative of operational status of the BOP control unit 137 and the BOP equipment 130, 132 via the BOP control station 470. Such connection may further permit the control workstations 450, 452, 454 to transmit control commands to the BOP control unit 137 and the BOP equipment 130, 132 via the BOP control station 470. Such connection may also or instead facilitate control of the BOP control station 470 via the control workstations 450, 452, 454, such as may cause the BOP control station 470 to control the BOP control unit 137 and the BOP equipment 130, 132 as directed by or from the control workstations 450, 452, 454.

The control workstations 450, 452, 454 may be operable to display the information indicative of operational status of the BOP control unit 137 and the BOP equipment 130, 132 to the wellsite operator 195 via the output devices 464 to permit the wellsite operator to monitor the operational status of the BOP control unit 137 and the BOP equipment 130, 132 while sitting in the corresponding operator chair 460. The control workstations 450, 452, 454 may be further operable to receive the control commands from the wellsite operator 195 via the input devices 462 while sitting in the corresponding operator chair 460 for transmission to the BOP control station 470 to control the BOP control unit 137 and the BOP equipment 130, 132.

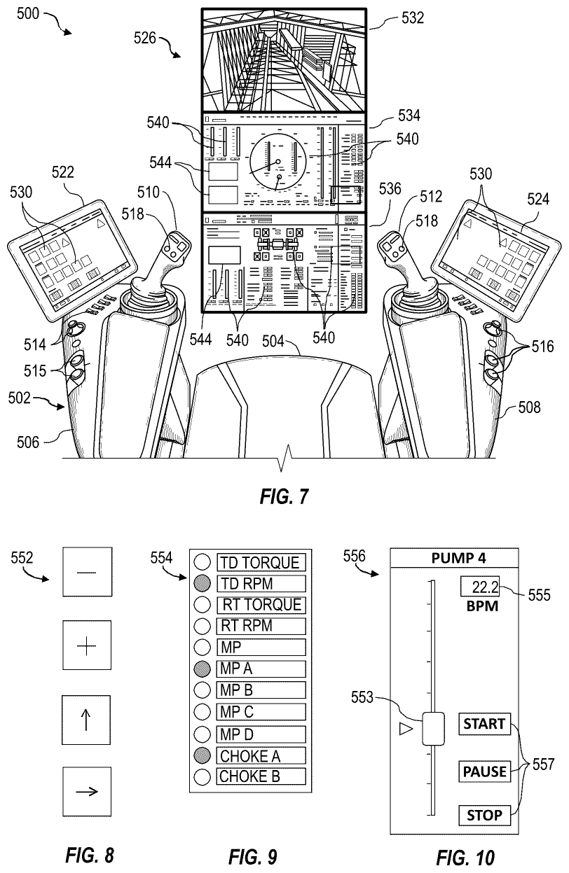

FIG. 7 is a top view of a portion of an example implementation of a wellsite operator control workstation 500 communicatively connected with and operable to control the well construction system 100, 200 according to one or more aspects of the present disclosure. The control workstation 500 depicted in FIG. 7 is an example implementation of the control workstations 450, 452, 454 described above. The control workstation 500 may facilitate receiving and displaying various information, such as sensor signals or information (e.g., sensor data 351-356), control commands (e.g., control data 361-366), processes taking place, events being detected, and operational status of various equipment of the subsystems 311-316 of the well construction system 100, 200. The following description refers to FIGS. 1-7, collectively.

The control workstation 500 comprises an operator chair 502 (e.g., driller's chair) and an HMI system comprising a plurality of input and output devices integrated with, supported by, or otherwise disposed in association with the operator chair 502. The input devices permit the wellsite operator 195 to enter commands or other information to control the wellsite equipment of the well construction system 100, 200, and the output devices permit the wellsite operator 195 to receive sensor signals and other information indicative of operational status of the wellsite equipment. The operator chair 502 may include a seat 504, a left armrest 506, and a right armrest 508.

The input devices of the control workstation 500 may include a plurality of physical controls, such as a left joystick 510, a right joystick 512, and/or other physical controls 514, 515, 516, 518, such as buttons, keys, switches, knobs, dials, slider bars, a mouse, a keyboard, and a microphone. One or more of the joysticks 510, 512 and/or the physical controls 514, 515, 516 may be integrated into or otherwise supported by the corresponding armrests 506, 508 of the operator chair 502 to permit the wellsite operator 195 to operate these input devices from the operator chair 502. Furthermore, one or more of the physical controls 518 may be integrated into the corresponding joysticks 510, 512 to permit the wellsite operator 195 to operate these physical controls 518 while operating the joysticks 510, 512. The physical controls may comprise emergency stop (E-stop) buttons 515, which may be electrically connected to E-stop relays of one or more pieces of wellsite equipment (e.g., the RN 151, the TDA 202, the DW 119, the LSA 228, the LTC 244, the SGA 262, the top drive 116, etc.), such that the wellsite operator 195 can shut down the wellsite equipment during emergencies and other situations.

The output devices of the control workstation 500 may include one or more video output devices 526 (e.g., video monitors), printers, speakers, and other output devices disposed in association with the operator chair 502 and operable to display to the wellsite operator 195 sensor signals and other information indicative of operational status of the well construction system 100, 200. The video output devices 526 may be implemented as one or more LCD displays, LED displays, plasma displays, cathode ray tube displays, and/or other types of displays.

The video output devices 526 may be disposed in front of or otherwise adjacent the operator chair 502. The video output devices 526 may include a plurality of video output devices 532, 534, 536, each dedicated to displaying predetermined information in a predetermined (e.g., programmed) manner. Although the video output devices 526 are shown comprising three video output devices 532, 534, 536, the video output devices 526 may be or comprise one, two, four, or more video output devices.

The video output devices 532, 534, 536 may each display in a predetermined manner selected sensor signals or information indicative of operational status of a selected portion of the well construction system 100, 200. For example, the video output devices 534, 536 may display sensor signals or information 540 (e.g., sensor data 351-356) generated by the various sensors (e.g., sensors 321-326) of the well construction system 100, 200 to permit the wellsite operator 195 to monitor operational status of the subsystems 311-316. The information 540 may be displayed in the form of virtual or computer-generated lists, menus, tables, graphs, bars, gauges, lights, and schematics, among other examples.

One or more of the video output devices 526 may be configured to display video signals (i.e., video feeds) generated by one or more of the video cameras 198. For example, the video output device 532 may be dedicated for displaying the video signals generated by one or more of the video cameras 198. When displaying the video signals from multiple video cameras 198, the video output device 532 may display multiple video windows, each displaying a corresponding video signal. Furthermore, one or more of the other video output devices 534, 536 may also display the video signals from one or more of the video cameras 198. For example, one or both of the video output devices 534, 536 may display one or more picture-in-picture (PIP) video windows 544, each displaying a video signal from a corresponding one of the video cameras 198. The PIP video windows 544 may be embedded or inset along or adjacent the sensor information 540. Sourcing (i.e., selection) of the video cameras 198 whose video signals are to be displayed on the video output devices 526 may be selected manually by the wellsite operator 195 or automated via the control system 300, such as based on operational events (e.g., drilling events, well construction operation stage, etc.) at the well construction system 100, 200, such that video signals relevant to an event currently taking place are displayed.

The control workstation 500 may further comprise combination devices operable as both input and output devices to display information to the wellsite operator 195 and receive commands or information from the wellsite operator 195. Such devices may be or comprise touchscreens 522, 524 operable to display a plurality of software (e.g., virtual, computer generated) buttons, switches, knobs, dials, icons, and/or other software controls 530 permitting the wellsite operator 195 to operate (e.g., click, select, move) the software controls 530 via finger contact with the touchscreens 522, 524 to control the various wellsite equipment of the subsystems 311-316. The software controls 530 may also be operated by the physical controls 514, 516, the joysticks 510, 512, or other input devices of the control workstation 500. The software controls 530 and/or other features displayed on the touchscreens 522, 524 may also display sensor signals or information (e.g., sensor data 351-356), operational settings, set-points, and/or status of selected wellsite equipment for viewing by the wellsite operator 195. For example, the software controls 530 may change color, move in position or direction, and/or display the sensor information, set-points, and/or operational values (e.g., temperature, pressure, position). The touchscreens 522, 524 may be disposed on, supported by, or integrated into the armrests 506, 508 or other parts of the operator chair 502 to permit the wellsite operator 195 to operate the software controls 530 displayed on the touchscreens 522, 524 from the operator chair 502.

Each video output device 526 and touchscreen 522, 524 may display (i.e., generate) a plurality of display screens (i.e., an integrated display system), each displaying to the wellsite operator 195 selected sensor signals or information 540 indicative of operational status of the well construction system 100, 200 and software controls 530 for controlling selected portions of the well construction system, respectively. Each display screen may integrate the software controls 530 and/or sensor information 540 from one or more pieces of wellsite equipment (e.g., subsystems 311-316) with information generated by the control system 300 (e.g., the monitoring process 374, the control process 375, and the control data 361-366, 373) for viewing and/or operating by the wellsite operator 195. The display screens may be shown or displayed alternately on one or more of the video output devices 526 and/or the touchscreens 522, 524 or simultaneously on one or more of these devices. The display screens intended to be displayed on the video output devices 526 and/or the touchscreens 522, 524 may be selected by the wellsite operator 195 via the physical controls 514, 516, 518 and/or software controls 530. The display screens intended to be displayed on the video output devices 526 and/or the touchscreens 522, 524 may also or instead be selected automatically by the control system 300 based on operational events detected (e.g., equipment failures, hazardous drilling conditions) or planned (e.g., changing phases or stages of the well construction operations) at the well construction system 100, 200, such that information relevant to the event currently taking place is displayed. Each display screen generated by the touchscreens 522, 524 may display software controls 530 operable by the wellsite operator 195 to control the wellsite equipment associated with the software controls 530, and each display screen generated by the video output devices 526 may display information 540 indicative of operational status of the wellsite equipment associated with the information 540. Accordingly, the display screens displayed on the touchscreens 522, 524 may be referred to hereinafter as control screens, and the display screens displayed on the video output devices 526 may be referred to hereinafter as status screens.

The touchscreens 522, 524 may be operable to display one or more control screens (e.g., configuration screens), which may be utilized to operate, set, adjust, configure, or otherwise control the subsystems 311-316 or other wellsite equipment. Each control screen may display one or more software controls 530, such as may permit the wellsite operator 195 to operate, set, adjust, configure, or otherwise control the subsystems 311-316 or other wellsite equipment via finger contact with the touchscreens 522, 524 from the operator chair 502. FIGS. 8-10 are example implementations of software controls 552, 554, 556 that may be displayed on the touchscreens 522, 524 and operated by the wellsite operator 195 to operate, set, adjust, configure, or otherwise control the subsystems 311-316 or other wellsite equipment of the well construction system 100, 200. The following description refers to FIGS. 7-10, collectively.

The software controls 552, 554, 556 may be pressed, clicked, selected, moved, or otherwise operated via the physical controls 514, 516 and/or via finger contact by the wellsite operator 195 to increase, decrease, change, or otherwise enter operational parameters, set-points, and/or instructions for controlling one or more pieces of wellsite equipment of the well construction system 100, 200. The software controls 552, 554, 556 may also display the entered and/or current operational parameters on or in association with the software controls 552, 554, 556 for viewing by the wellsite operator 195. The operational parameters, set-points, and/or instructions associated with the software controls 552, 554, 556 may include equipment operational status (e.g., on or off, up or down, set or release, position, speed, temperature, etc.), drilling parameters (e.g., depth, hook load, torque, etc.), auxiliary parameters (e.g., vibration data of a pump), and fluid parameters (e.g., flow rate, pressure, temperature, etc.), among other examples.

The software controls 552 may be or comprise software buttons, which may be operated to increase, decrease, change, or otherwise enter different operational parameters, set-points, and/or instructions for controlling one or more portions of the well construction system 100, 200 associated with the software controls 552. The software controls 554 may be or comprise a list or menu of items (e.g., equipment, processes, operational stages, equipment subsystems, etc.) related to one or more aspects of the well construction system 100, 200, which may be operated to select one or more items on the list. The selected items may be highlighted, differently colored, or otherwise indicated, such as via a checkmark, a circle, a dot, or other characters/icons appearing in association with the selected items. The software controls 556 may be or comprise a combination of different software controls, which may be operated to increase, decrease, change, or otherwise enter different operational parameters, set-points, and/or instructions for controlling one or more portions of the well construction system 100, 200 associated with the software controls 556, such as a pump of the well construction system 100, 200. The software controls 556 may include a slider 553, which may be moved or otherwise operated along a graduated bar to increase, decrease, or otherwise change pump speed or another operational parameter associated with the slider bar 553. The entered pump speed may be shown in a display window 555. The software controls 556 may also include software buttons 557, such as may be operated to start, pause, and stop operation of the pump or another portion of the well construction system 100, 200 associated with the software buttons 557.

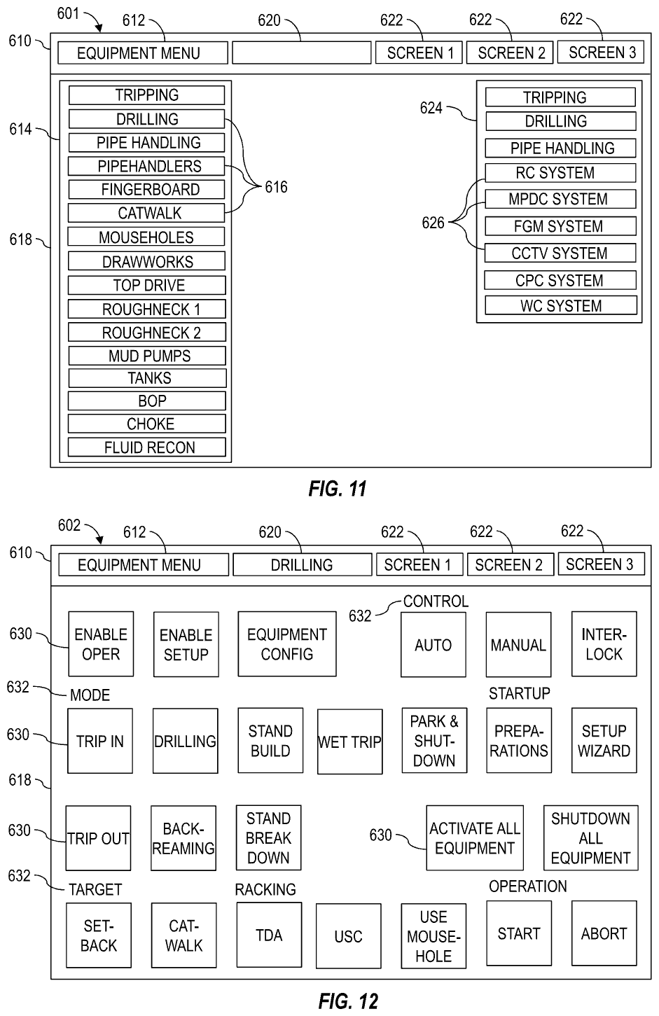

FIGS. 11-15 are example implementations of control screens 601-605 (e.g., configuration screens or menus) that may be displayed on the touchscreens 522, 524 according to one or more aspects of the present disclosure. Each control screen 601-605 may be operated via finger contact with the touchscreens 522, 524 (and/or other input means) by the wellsite operator 195 to operate, set, adjust, configure, or otherwise control the subsystems 311-316 or other wellsite equipment of the well construction system 100, 200 associated with or displayed on the control screen 601-605. The following description refers to FIGS. 11-15, collectively.

Each control screen, including the control screens 601-605, may display a selection bar 610 for switching between or selecting which control screen is to be displayed on the corresponding touchscreen 522, 524 and/or which status screen is to be displayed on each of the video output devices 526. Each control screen may also comprise an equipment control area 618 for displaying software controls for controlling well construction operations and/or wellsite equipment associated with the control screen. The selection bar 610 may comprise an equipment menu button 612, which when operated by the wellsite operator 195, may cause a control screen selection menu 614 (e.g., a dropdown or pop-up menu) to appear. The selection menu 614 may contain a plurality of buttons 616, each associated with and listing a corresponding well construction operation or wellsite equipment to be controlled. The wellsite operator 195 may operate (e.g., click on, touch, and/or otherwise select) one of the buttons 616 to select a well construction operation or wellsite equipment, thereby causing a corresponding control screen for controlling the associated well construction operation or wellsite equipment to be displayed.

After one of the buttons 616 is selected, a plurality of software controls 630 (shown in FIGS. 12-15) may appear in the equipment control area 618, and the well construction operation or wellsite equipment that is selected may be listed or otherwise identified in a control screen identification area 620. The software controls 630 or other information displayed in the equipment control area 618 will change when the wellsite operator 195 switches between the various control screens by selecting different buttons 616. As shown in FIG. 11, example control screens that may be selected for display on the touchscreens 522, 524 may include a tripping control screen displaying software controls for controlling automatic operation of wellsite equipment collectively operable to perform tripping operations, a drilling control screen displaying software controls for controlling automatic operation of wellsite equipment collectively operable to perform drilling operations, a drill pipe handling control screen displaying software controls for controlling automatic operation of wellsite equipment collectively operable to move drill pipes at the wellsite, and a plurality of individual equipment control screens each displaying software controls for automatically and/or manually controlling operation of individual wellsite equipment, such as the catwalk 131, the TDA 202, the setback 164, the FIB 166, the TBR 254, the SGA 262, the LTC 244, the ITC 236, the UTC 242, the LSA 228, the setback 164, the catwalk 131, the top drive 116, the RN 151, the choke 162, and fluid reconditioning equipment 170, among other examples. Although not described herein, the control screens within the scope of the present disclosure may include control screens displaying software controls of other individual wellsite equipment and/or wellsite equipment subsystems (e.g., subsystems 311-316).

Each control screen, including the control screens 601-605, may also be utilized to switch between or select which status screen is to be displayed on which video output device 532, 534, 536. For example, the selection bar 610 may comprise status screen selection buttons 622, each associated with a corresponding one of the video output devices 532, 534, 536 and, when operated by the wellsite operator 195, operable to cause a corresponding status screen selection menu 624 (e.g., a dropdown or pop-up menu) to appear. Each selection menu 624 may contain a plurality of buttons 626, each associated with and listing a corresponding well construction operation, wellsite equipment, and/or subsystem (e.g., subsystem 311-316) of the well construction system 100, 200 to be displayed. The wellsite operator 195 may operate (e.g., click on, touch, and/or otherwise select) one of the buttons 622 and buttons 626 to select one of the video output devices 532, 534, 536 and a well construction operation, wellsite equipment, or subsystem, thereby causing a corresponding status screen displaying sensor signals or information 540 indicative of operational status of the selected well construction operation, wellsite equipment, or subsystem to be displayed on the selected video output device 532, 534, 536. The status screens that may be displayed on the video output devices 532, 534, 536 are described in more detail below.

When operated, the software controls 630 may activate, deactivate, start, stop, configure, or otherwise control operation of the wellsite equipment associated with the software controls 630. The software controls 630 may initiate automatic operation of the wellsite equipment associated with the control screen, such as by operating an “AUTO” software button. The software controls 630 may also cause manual control of the wellsite equipment associated with the control screen to be given to the wellsite operator 195, such as by operating a “MANUAL” software button. The software controls 630 may be grouped by related equipment and/or related operations, which may be identified by text 632 associated with each group of software controls 632.

Furthermore, each software control 630 may list or otherwise identify the piece of equipment or operation that is controlled or otherwise associated with the software control 630. One or more of the software controls 630 may list or otherwise indicate the operational status (i.e., feedback) of the wellsite equipment or operation associated with the software control 630. For example, one or more of the software controls 630 may change color, text, shape, or otherwise change to indicate that a piece of wellsite equipment associated with the software control 630 is activated, deactivated, or in a predetermined position, or that an operation associated with the software control 630 has commenced, stopped, or is in a particular stage.

FIG. 12 is an example implementation of a “DRILLING” control screen 602 that may be utilized to control automated, semi-automated, and/or manual operation of wellsite equipment associated with and/or collectively operable to perform drilling operations according to one or more aspects of the present disclosure. The control screen 602 may display in the equipment control area 618 various software controls 630 for controlling various wellsite equipment and/or operational parameters of the drilling operations performed by well construction system 100, 200. For example, when operated, the software controls 630 may activate, deactivate, start, stop, configure, or otherwise control automated, semi-automated, and/or manual operation of the wellsite equipment associated with the drilling operations. Such wellsite equipment may include the top drive 116, the DW 119, the pump 144, and the BOP equipment 130, 132, among other examples.

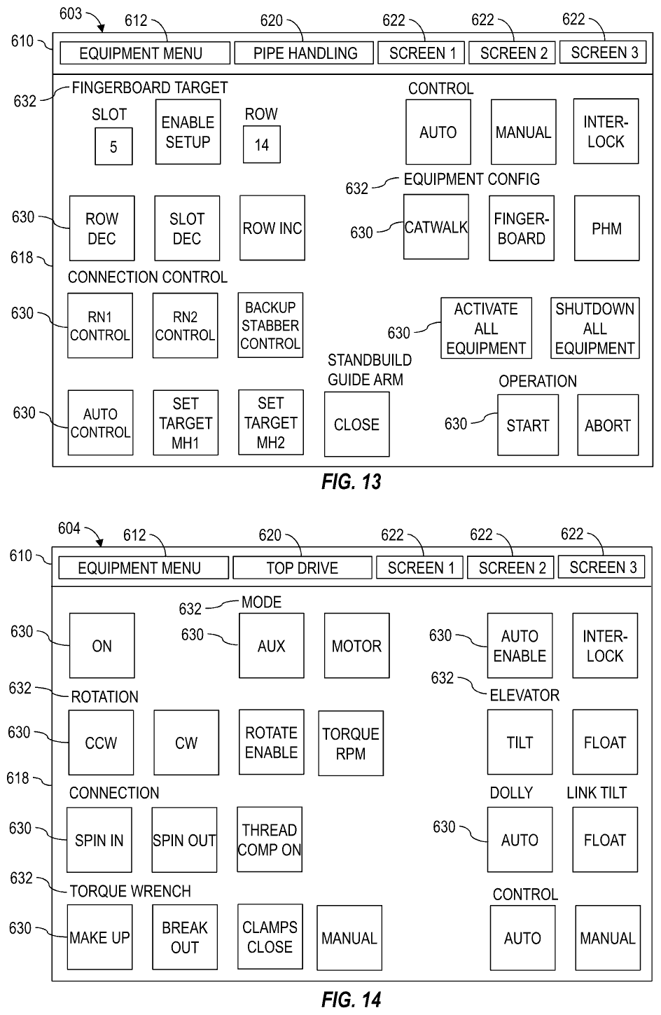

FIG. 13 is an example implementation of an “PIPE HANDLING” control screen 603 that may be utilized to control automated, semi-automated, and/or manual operation of wellsite equipment associated with and/or collectively operable to perform drill pipe handling (e.g., moving, storing) operations according to one or more aspects of the present disclosure. The control screen 603 may display in the equipment control area 618 various software controls 630 for controlling various wellsite equipment and/or operational parameters of the drill pipe handling operations performed by well construction system 100, 200. For example, when operated, the software controls 630 may activate, deactivate, start, stop, configure, or otherwise control automated, semi-automated, and/or manual operation of the wellsite equipment associated with the drill pipe handling operations. Such wellsite equipment may include the catwalk 131, the TDA 202, the setback 164, the FIB 166, the TBR 254, the SGA 262, the LTC 244, the ITC 236, the UTC 242, the LSA 228, the RN 151, and the reciprocating slips 161, among other examples.

FIG. 14 is an example implementation of a “TOP DRIVE” control screen 604 that may be utilized to control automated, semi-automated, and/or manual operation of the top drive 116 according to one or more aspects of the present disclosure. The control screen 604 may display in the equipment control area 618 various software controls 630 for configuring and/or controlling automated, semi-automated, and/or manual operations performed by the top drive 116 and/or operational parameters associated with the top drive 116. For example, when operated, the software controls 630 may activate, deactivate, start, stop, configure, or otherwise control operation of one or more portions of the top drive 116, such as the drive shaft 125, the grabber, the swivel, the tubular handling assembly 127, and other portions of the top drive 116. The software controls 630 may also be utilized to control other wellsite equipment that may be directly or closely associated with or operate in close association with the top drive 116, such as the RN 151.

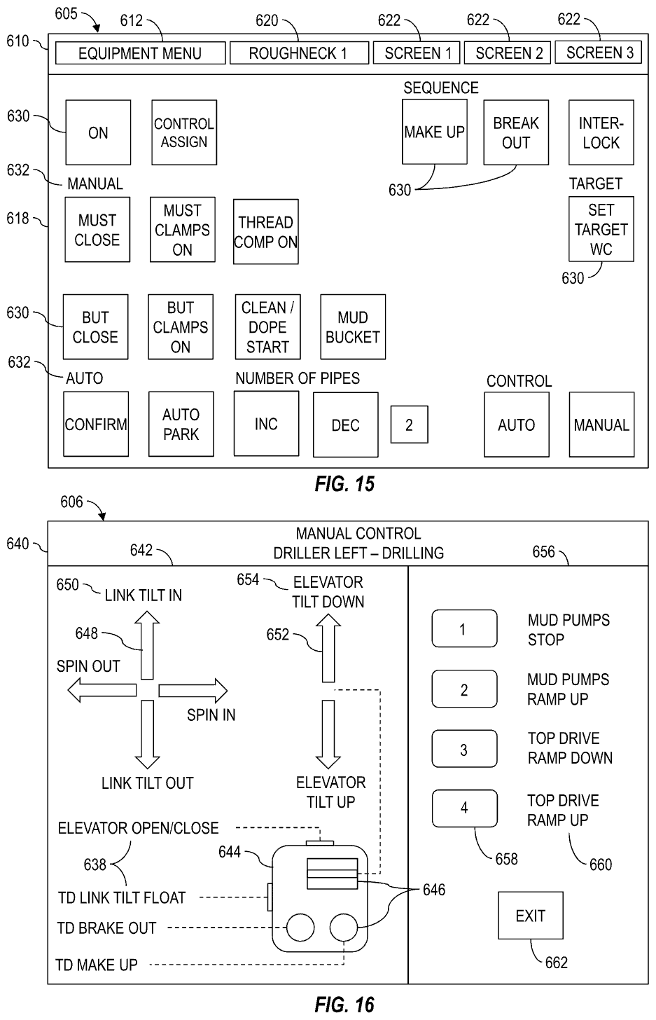

FIG. 15 is an example implementation of a “ROUGHNECK 1” control screen 605 that may be utilized to control automated, semi-automated, and/or manual operation of one of the RNs 151 according to one or more aspects of the present disclosure. The control screen 605 may display in the equipment control area 618 various software controls 630 for configuring or controlling automated, semi-automated, and/or manual operations performed by the RN 151 and/or operational parameters associated with the RN 151. For example, when operated, the software controls 630 may activate, deactivate, start, stop, configure, or otherwise control operation of one or more portions of the RN 151, such as the spinner and the torque wrench, including the upper and lower tongs and the associated clamps. The software controls 630 may also be utilized to control other wellsite equipment that may be directly or closely associated with or operate in close association with the RN 151.

The video output devices 126 and/or the touchscreens 522, 524 may also display manual control guide menus or screens utilized by the wellsite operator 195 to guide or assist the wellsite operator 195 to manually control selected operations of the well construction system 100, 200 or an individual piece of wellsite equipment. The guide screens may display control functions of a selected one of the joysticks 510, 512, the associated physical controls 518, and/or other physical controls 514, 516 with respect to a selected operation or a piece of wellsite equipment. Manual control may be initiated, for example, when the “MANUAL” software control 630 button is selected on one of the control screens displayed on one of the touchscreens 522, 524. Thereafter, the control system 300 may abort automatic operation of the associated wellsite equipment, transfer operational control to a predetermined joystick 510, 512 and/or other physical controls 514, 516, and display a corresponding manual control guide listing the control functions for manually controlling the wellsite equipment associated with the control screen.

FIG. 16 is an example implementation of a manual control guide screen 606 displaying control functions for controlling drilling operations via the left joystick 510 and physical controls 514. The guide screen 606 may display a title bar 640 identifying an operation or wellsite equipment to be controlled and the joystick 510 and/or physical controls 514 for controlling such operation or wellsite equipment. The guide screen 606 may comprise a joystick control area 642 displaying a schematic view 644 of the joystick 510 and a schematic view 646 of the associated physical controls 518 (e.g., joystick buttons and thumb lever). Each schematic button 646 is associated with text 638 describing control functions of each corresponding physical button 518 of the joystick 510. The joystick control area 642 may further display arrows 648 and corresponding text 650 describing control functions associated with movements of the joystick 510, and arrows 652 and corresponding text 654 describing control functions associated with movement of the joystick thumb lever 518. The guide screen 606 may also comprise a button control area 656 displaying schematic views 658 of the corresponding physical controls 514. The button control area 656 may further display text 660 describing control functions associated with operation of each of the corresponding physical controls 514. The guide screen 606 may further display an “EXIT” software control 662, which may be operated to abort manual control of the drilling operations and close the guide screen 606.

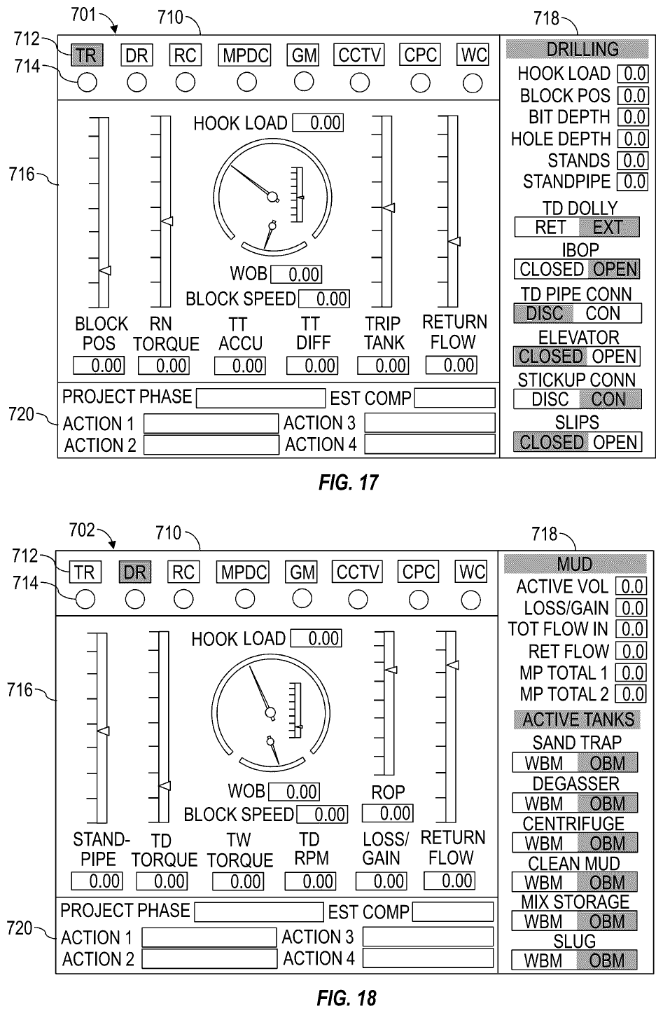

As described above with respect to FIG. 7, an operator workstation within the scope of the present disclosure may display on one or more of the video output devices 526 a plurality of status screens, each displaying selected sensor signals or information (e.g., sensor data 351-356) generated by various sensors (e.g., sensors 321-326) of the wellsite construction system 100, such as may permit the wellsite operator to monitor operations, wellsite equipment, and/or equipment subsystems (e.g., subsystems 311-316) described herein. FIGS. 17-21 are views of example implementations of status screens 701-706 displayed on one or more of the video output devices 526 according to one or more aspects of the present disclosure. The following description refers to FIGS. 1-4, 7, and 17-21, collectively.

The status screens, including the status screens 701-706, may be displayed alternatingly on one of the video output devices 526. Some of the status screens may display operational status of a well construction operation (e.g., tripping, drilling, pipe handling, etc.) involving a plurality of pieces of wellsite equipment operating in a coordinated manner to perform such operation, which may permit the wellsite operator 195 to monitor operational status or parameters of such operation on a single status screen. Some of the status screens may display operational status of a single piece of wellsite equipment or a subsystem (e.g., subsystem 311-316) of wellsite equipment, such as may also permit the wellsite operator 195 to monitor operational status or parameters of a single piece of equipment or an equipment subsystem. As described above, the status screen and the corresponding operation, wellsite equipment, or equipment subsystem may be selected via the touchscreens 522, 524. As shown in FIG. 11, example status screens that may be selected for display may include a tripping status screen displaying information indicative of operational status of the tripping operations, a drilling status screen displaying information indicative of operational status of the drilling operations, a pipe handing status screen displaying information indicative of operational status of the drill pipe handling operations, and a plurality of subsystem status screens each displaying information indicative of operational status of the corresponding subsystem of the well construction system 100, 200. Although not described herein, the status screens within the scope of the present disclosure may also or instead include status screens displaying information indicative of operational status of individual pieces of wellsite equipment described herein.

The status screens, including the status screens 701-706, may comprise a wellsite status screen indicator and alarm window or area 710, which may visually indicate which operation or wellsite equipment is being displayed on a selected video output device 526 and if safety or operational alarms associated with an operation or wellsite equipment are active. For example, the area 710 may include a plurality of indicators 712 (e.g., text, icons, graphics, etc.) listing operations, wellsite equipment, and/or equipment subsystems that may be displayed via corresponding status screens. The indicator 712 corresponding to the operation, wellsite equipment, or equipment subsystem of the currently displayed status screen may appear or become lit, highlighted, or otherwise marked to indicate to the wellsite operator 195 which status screen is displayed. The area 710 may further include a plurality of alarm or event indicators 714 (e.g., lights), each associated with a corresponding operation, wellsite equipment, or equipment subsystem indicator 712. One or more of the indicators 714 may activate (e.g., light up, change color, etc.), such as via operation of the control system 300 (shown in FIG. 4), to visually inform the wellsite operator 195 of an alarm or operational event taking place at or associated with a corresponding operation, wellsite equipment, or equipment subsystem. Responsive to the event indicator 714 being activated, the wellsite operator 195 may switch to a status screen corresponding to the activated event indicator 714 to assess the event and/or implement appropriate counteractive measures or actions. Instead of manually changing between the status screens, the status screens may change automatically to show the status screen corresponding to the operation, wellsite equipment, or equipment subsystem experiencing the event.

The status screens, including the status screens 701-706, may further comprise a primary operational status window or area 716, displaying selected sensor signals or information indicative of operational status of the operation, wellsite equipment, or equipment subsystem associated with the displayed status screen. The information displayed in the primary operational status area 716 may be generated by the actual wellsite equipment performing the operation or forming the equipment subsystem associated with the displayed status screen. The information displayed in the primary operational status area 716 may change when a different display screen is displayed. The information in the primary operational status area 716 may be displayed in the form of lists, menus, tables, graphs, bars, gauges, lights, and/or schematics, among other examples.

The status screens, including the status screens 701-706, may further comprise a secondary operational status window or area 718, displaying selected sensor signals or information indicative of operational status of drilling operations and/or general status of the well construction operations, such as may permit the wellsite operator to monitor progress of the drilling operations and/or other well construction operations while monitoring a specific operation, wellsite equipment, or equipment subsystem displayed in the primary operational status area 716. The secondary operational status area 718 may also display sensor signals or information indicative of operational status of other wellsite equipment that is related to, but not necessarily performing, the drilling operations. The information that is displayed in the secondary operational status area 718 may remain unchanged or change partially when a different status screen is displayed, such as may permit the wellsite operator 195 to monitor progress of the drilling operations and/or other well construction operations while monitoring different operations, wellsite equipment, or equipment subsystems associated with the different status screens.

However, the information that is displayed in the secondary operational status area 718 may change when a different status screen is displayed. The changing information may permit the wellsite operator 195 to monitor operational status of other wellsite equipment that is related to, but not necessarily directly performing, the operation displayed in the primary operational status area 716, and/or to monitor operational status of other wellsite equipment that is related to the wellsite equipment or equipment subsystem displayed in the primary operational status area 716. The information in the secondary operational status area 718 may be displayed in the form of lists, menus, tables, graphs, bars, gauges, lights, and/or schematics, among other examples.

Each status screen, including the status screens 701-706, may also comprise a detailed description window or area 720 listing and/or describing one or more aspects related to the operation, wellsite equipment, or equipment subsystem displayed in the primary operational status area 716 or another aspect of the well construction operations. For example, as shown in FIGS. 17 and 18, the description area 720 may display general and/or detailed description of work or activities (e.g., a construction or job plan) that was, is, or will be performed or overseen at the wellsite by the wellsite operator 195. The description area 720 may display proactive information regarding the work and/or call-to-actions guiding future work. The description of work may include a title or name of the project stage or phase, an estimated completion date (i.e., deadline) for completing the project stage, and/or a list of operational steps or actions to be implemented by the wellsite operator 195 during the project stage. However, the control system 300 may automatically operate the wellsite equipment or subsystem to automatically implement such steps or actions pursuant to the construction or job plan, such as by transmitting predetermined control commands to a corresponding piece of wellsite equipment or subsystem. Such automated operations may be initiated, for example, by operating an “AUTO” software button 630 on an associated control screen, as described above.

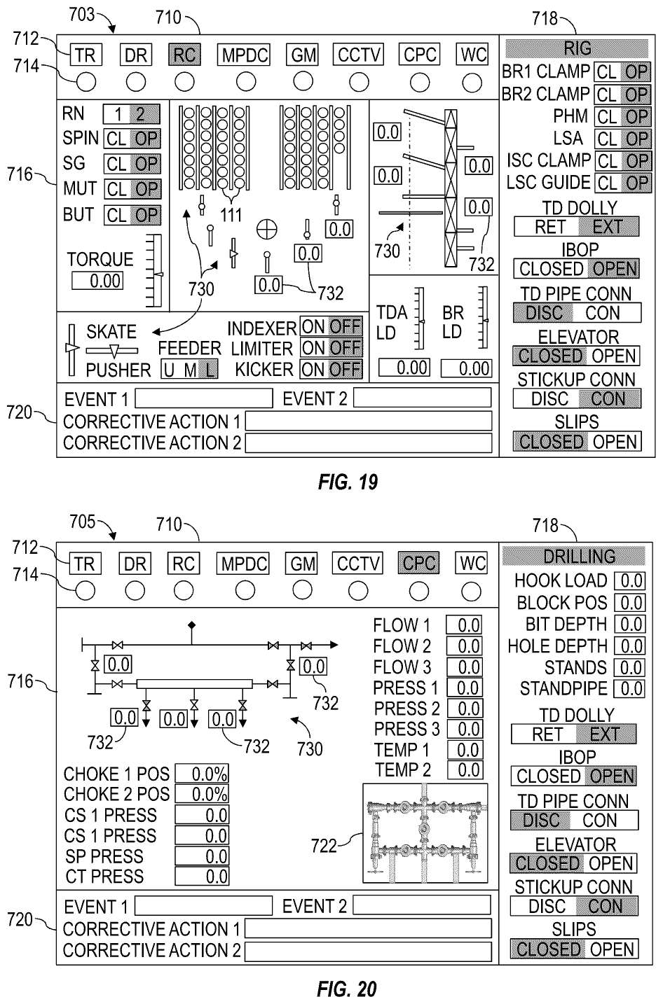

As shown in FIGS. 19-21, the description area 720 may also or instead display detailed description or information related to the events detected or otherwise taking place at the well construction system 100, 200. The description area 720 may also list and/or describe one or more counteractive measures (e.g., corrective actions, operational sequences) related to the event that may be performed or otherwise implemented in response to the event. Depending on the event and/or mode (e.g., advice, interlock, automated) in which the control system 300 (e.g., the computing resource environment 305) is operating, the description area 720 may describe the corrective action to be initiated or otherwise implemented by the wellsite operator 195. However, the control system 300 may automatically implement the corrective action, or cause the corrective action to be automatically implemented, such as by transmitting predetermined control commands to a corresponding piece of wellsite equipment or subsystem. The information displayed in the description area 720 may just display events and/or corrective actions related to the operation, wellsite equipment, or equipment subsystem shown in the primary operational status area 716 and, thus, change when switching between the status screens. However, the information displayed in the description area 720 may not change when switching between the status screens, and may list each detected event and/or corresponding corrective action, such as in chronological order or in the order of importance. As described above, the control system 300 may automatically change the status screen to show the operation, wellsite equipment, or equipment subsystem experiencing the event.

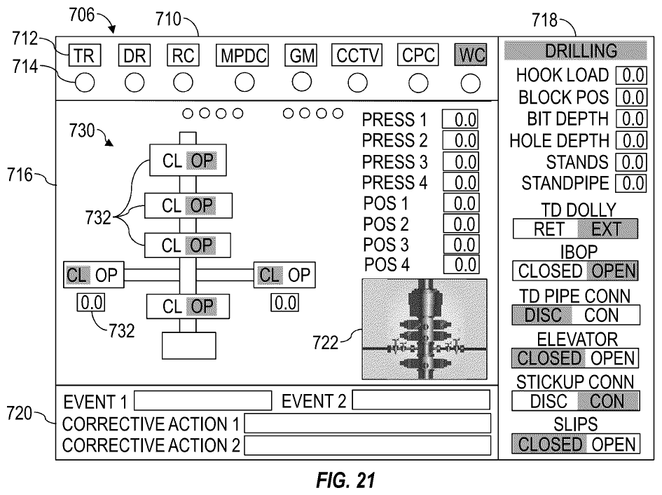

Each status screen, including the status screens 701-706, may further include one or more PIP video windows 722 (shown in FIGS. 20 and 21), each displaying in real-time a video signal from a predetermined video camera 198 to display wellsite equipment associated with the operation, wellsite equipment, or equipment subsystem displayed in the primary operational status area 716. The PIP video windows 722 may be embedded or inset on the corresponding status screens, such as within the primary operational status area 716. The view shown in the PIP video window 722 may be manually or automatically switched between different video cameras 198 to show different wellsite equipment or different views of the wellsite equipment.

As described above, the status screens to be displayed on the video output devices 526 may be selected via the touchscreens 522, 524. However, the status screens, including the sensor signals or information displayed in the indicator and alarm area 710, the primary operational status area 716, the secondary operational status area 718, the detailed description area 720, and/or the PIP windows 722, may automatically change based on successive stages of the well construction operations. For example, while the well construction operations progress through successive stages (e.g., tripping, drilling, pipe handling, etc.), the control system 300 may cause the video output devices 526 to automatically change and display a status screen comprising information indicative of operational status of wellsite equipment performing or otherwise associated with a current stage of the well construction operations.

Each status screen, including the status screens 701-706, may be adjusted or otherwise configured by the wellsite operator 195 to display one or more of the various information areas 710, 716, 718, 720 in a chosen position on each status screen. For example, the indicator and alarm area 710 may be displayed at the top of the status screens, the detailed description area 720 may be displayed at the bottom of the status screens, the primary operational status area 716 may be displayed in the middle on the left side of the status screens, and the secondary operational status area 718 may be displayed on the right side of the status screens. Furthermore, the location and/or size (i.e., dimensions) of the PIP video windows 722 displayed on each status screen may also be adjusted or otherwise selected. The relative location of the information areas 710, 716, 718, 720 and the PIP video windows 722 on the status screens may also be selected, for example, via one or more of the physical controls 514, 516, 518, such as by dragging and dropping the information areas 710, 716, 718, 720 and/or the PIP video windows 722 to a chosen location on the status screens.

FIG. 17 is an example implementation of a status screen 701 displaying sensor signals or information indicative of operational status of various wellsite equipment associated with and collectively operable to perform drill pipe tripping operations according to one or more aspects of the present disclosure. When the wellsite operator 195 or the control system 300 causes the tripping operations status screen 701 to be displayed on one of the video output devices 526, the indicator 712 associated with the tripping operations, such as letters “TR,” may appear or become highlighted to visually indicate to the wellsite operator 195 that the tripping operations status screen is being displayed. The primary operational status area 716 may display information, such as hook load, weight-on-bit, travelling block position, roughneck torque, trip tank accumulation or volume, and return flow, among other examples. The secondary operational status area 718 may display information related to drilling operations, such as hook load, traveling block position, drill bit depth, wellbore depth, number of stands or tubulars in the wellbore, standpipe pressure, top drive dolly location, inside BOP position, top drive pipe connection status, elevator status, stick-up connection status, and slips status, among other examples. The description area 720 may display a work plan (i.e., well construction plan) related to the tripping operations, including actions or steps that will be performed or overseen at the wellsite by the wellsite operator 195 during the tripping operations. However, the description area 720 may also or instead display information indicative of operational events, as described above.

FIG. 18 is an example implementation of a status screen 702 displaying sensor signals or information indicative of operational status of various wellsite equipment associated with and collectively operable to perform drilling operations according to one or more aspects of the present disclosure. When the wellsite operator 195 or the control system 300 causes the drilling operations status screen 702 to be displayed on one of the video output devices 526, the indicator 712 associated with the drilling operations, such as letters “DR,” may appear or become highlighted to visually indicate to the wellsite operator 195 that the drilling operations status screen is being displayed. The primary operational status area 716 may display information, such as hook load, travelling block speed, weight-on-bit, rate of penetration, standpipe pressure, top drive torque, torque wrench torque, top drive rotational speed, drilling fluid loss/gain, and drilling fluid return flow, among other examples. The secondary operational status area 718 may display information related to drilling operations, such as information related to or indicative of drilling fluid (i.e., mud) operational status and/or active tank operational status. The description area 720 may display a work plan (i.e., well construction plan) related to the drilling operations, including actions or steps that will be performed or overseen at the wellsite by the wellsite operator 195 during the drilling operations. However, the description area 720 may also or instead display information indicative of operational events, as described above.

As described above, the status screens may display sensor signals or information indicative of operational status of wellsite equipment subsystems (e.g., subsystems 311-316). FIG. 19 is an example implementation of an RC system status screen 703 displaying sensor signals or information indicative of operational status of the RC system 311 according to one or more aspects of the present disclosure. When the wellsite operator 195 or the control system 300 causes the RC system status screen 703 to be displayed on one of the video output devices 526, the indicator 712 associated with the RC system 311, such as letters “RC,” may appear or become highlighted to visually indicate to the wellsite operator 195 that the RC system status screen 703 is being displayed. The primary operational status area 716 may display sensor signals or information related to various pieces of wellsite equipment forming the RC system 311, such as the catwalk 131, the TDA 202, the setback 164, the FIB 166, the TBR 254, the SGA 262, the LTC 244, the ITC 236, the UTC 242, the LSA 228, and the RN 151, among other examples. The primary operational status area 716 may also display schematic representations 730 of such wellsite equipment to visually display to the wellsite operator 195 operational status (e.g., position) of such wellsite equipment. For example, the schematic representations 730 of the drill floor 114, catwalk 131, the setback 164, the FIB 166, the RN 151, and the TDA 202 may visually indicate to the wellsite operator 195 in real-time movements and positions of various portions of such wellsite equipment. The RC system status screen 703 may include schematic representations 730 of the skate 133 of the catwalk 131, the TDA 202, the LSA 228, the SGA 262, the ITC 236, and the LTC 244, and of the vertical pipe rack assembly 165 (e.g., setback 164 and FIB 166) containing the tubulars 111, among other examples. Portions of the schematic representations 730 (e.g., various arms of the TDA 202) may change position and/or color to visually indicate to the wellsite operator 195 various positions and movements of the represented wellsite equipment. The primary operational status area 716 may also display sensor signals or information indicative of operational status of the wellsite equipment within text boxes 732 located in association with the schematic representations 730 of the wellsite equipment. The secondary operational status area 718 may display information related to drilling operations and/or additional information related to operational status of the RC system 311, such as additional information that is not displayed in the primary operational status area 716. The description area 720 may display information indicative of operational events, as described above. However, the description area 720 may also or instead display a work plan related to tripping, drilling, or other wellsite construction operations.

FIG. 20 is an example implementation of a CPC system status screen 705 displaying sensor signals or information indicative of operational status of the CPC system 314 according to one or more aspects of the present disclosure. When the wellsite operator 195 or the control system 300 causes the CPC system status screen 705 to be displayed on one of the video output devices 526, the indicator 712 associated with the CPC system 314, such as letters “CPC,” may appear or become highlighted to visually indicate to the wellsite operator 195 that the CPC system status screen 705 is being displayed. The primary operational status area 716 may display sensor signals or information related to various pieces of wellsite equipment forming the CPC system 314, such as the choke manifold 162 and related wellsite equipment. The primary operational status area 716 may also display schematic representations 730 of the wellsite equipment to visually display to the wellsite operator 195 operational status of such wellsite equipment. The schematic representations 730 may include, for example, various fluid control valves (e.g., ball valves, adjustable chokes) of the choke manifold 162 and a plurality of fluid control valves fluidly connected with the choke manifold 162. The primary operational status area 716 may visually indicate to the wellsite operator 195 in real-time operational status, fluid flow rates, fluid pressures, and valve positions of the wellsite equipment forming the CPC system 314. Portions of the schematic representations 730 (e.g., fluid valves) may change position and/or color to indicate to the wellsite operator 195 operational status (e.g., positions) of such wellsite equipment. The primary operational status area 716 may also display sensor signals or information indicative of operational status of the wellsite equipment within text boxes 732 located in association with the schematic representations 730 of the wellsite equipment. The secondary operational status area 718 may display information related to drilling operations and/or additional information related to operational status of the CPC system 314, such as additional information that is not displayed in the primary operational status area 716. The description area 720 may display information indicative of operational events, as described above. However, the description area 720 may also or instead display a work plan related to tripping, drilling, or other wellsite construction operations. A PIP video window 722 showing a real-time view of the choke manifold 162 or another portion of the CPC system 314 may be displayed in the primary operational status area 716 or another area of the CPC system status screen 705.

FIG. 21 is an example implementation of a WC system status screen 706 displaying sensor signals or information indicative of operational status of the WC system 315 according to one or more aspects of the present disclosure. When the wellsite operator 195 or the control system 300 causes the WC system status screen 706 to be displayed on one of the video output devices 526, the indicator 712 associated with the WC system 315, such as letters “WC,” may appear or become highlighted to visually indicate to the wellsite operator 195 that the WC system status screen 706 is being displayed. The primary operational status area 716 may display sensor signals or information related to various pieces of wellsite equipment forming the WC system 315, such as the BOP equipment 130, 132. Information displayed in the primary operational status area 716 may include, for example, information related to risers/diverters, POD controls, POD regulators, analog sensor values (e.g., pressure, position), BOP event alarm signals, and inclination sensors. The primary operational status area 716 may visually indicate to the wellsite operator 195 in real-time operational status, fluid pressures, and operational positions of the wellsite equipment forming the CPC system 314. The primary operational status area 716 may also display schematic representations 730 of the wellsite equipment to visually display to the wellsite operator 195 operational status of such wellsite equipment. The schematic representations 730 may include, for example, the BOP stack 130 and the annular fluid control device 132, and visually indicate to the wellsite operator 195 operational status (e.g., position) of the various rams and valves of the BOP stack 130 and the annular fluid control device 132. Portions of the schematic representations 730 (e.g., fluid valves, rams) may change position and/or color to indicate to the wellsite operator 195 operational status (e.g., positions) of such wellsite equipment. The primary operational status area 716 may also display sensor signals or information indicative of operational status of the wellsite equipment within text boxes 732 located in association with the schematic representations 730 of the wellsite equipment. The secondary operational status area 718 may display information related to drilling operations and/or additional information related to operational status of the WC system 315, such as additional information that is not displayed in the primary operational status area 716. The description area 720 may display information indicative of operational events, as described above. However, the description area 720 may also or instead display a work plan related to tripping, drilling, or other wellsite construction operations. A PIP video window 722 showing a real-time view of the BOP equipment 130, 132 or another portion of the WC system 315 may be displayed in the primary operational status area 716 or another area of the WC system status screen 706.

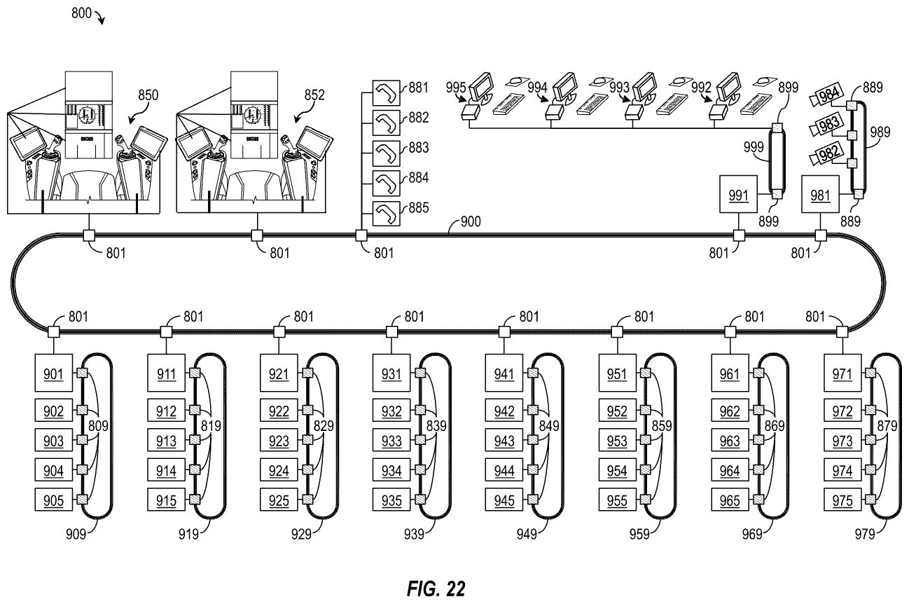

FIG. 22 is a schematic view of at least a portion of an example implementation of a system (or processing device) 800 according to one or more aspects of the present disclosure. The system 800 may form at least a portion of one or more electronic devices utilized at the well construction system 100, 200. For example, the system 800 may be or form at least a portion of the processing devices 188, 192, 456, and the control workstations 450, 452, 454, 500. The system 800 may form at least a portion of the control system 300, including the wellsite computing resource environment 305, the coordinated control device 304, the supervisory control system 307, the local controllers 341-346, the onsite user devices 302, and the offsite user devices 303. The following description refers to FIGS. 1-7 and 22, collectively.

The well construction system 100, 200 also includes stationary and/or mobile video cameras 198 disposed or utilized at various locations within the well construction system 100, 200. The video cameras 198 capture videos of various portions, equipment, or subsystems of the well construction system 100, 200, and perhaps the wellsite operators 195 and the actions they perform, during or otherwise in association with the wellsite operations, including while performing repairs to the well construction system 100, 200. For example, the video cameras 198 may capture digital images (or video frames) of the entire well construction system 100, 200 and/or specific portions of the well construction system 100, 200, such as the top drive 116, the RN 151, the TDA 202, the FIB 166, the setback 164, the catwalk 131, and/or the areas through which tubulars 111 are transferred between components of the well construction system 100, 200, among other examples. The video cameras 198 generate corresponding video signals (i.e., feeds) comprising or otherwise indicative of the captured digital images. The video cameras 198 may be in signal communication with the processing device 192, such as may permit the video signals to be processed and transmitted to the control workstation 197 and, thus, permit the wellsite operators 195 to view various portions or components of the well construction system 100, 200 on one or more of the output devices 196. The processing device 192 or another portion of the control workstation 197 may be operable to record the video signals generated by the video cameras 198.

The system 800 may include a network ring 900 that electronically interconnects multiple drilling/analysis apparatus and/or control mechanisms for at least partially automating such apparatus. On the network ring 900, there may be a plurality of ring network nodes 801 that electronically connect various elements of the well construction system 100, 200 or the control system 300 to each other. For example, a first control workstation 850 (e.g., which may include or be the first control workstation 450 shown in FIGS. 5 and 6 and/or the wellsite operator control workstation 500 shown in FIG. 7) and optionally a second control workstation 852 (e.g., which may include or be the second control workstation 452 shown in FIGS. 5 and 6 and/or the wellsite operator control workstation 500 shown in FIG. 7) may be electronically connected to the network ring 900 through one or more of the plurality of ring network nodes 801. Optionally, the network ring 900 may be electronically interconnected, via one or more ring network nodes 801, to a phone system comprising one or more phone lines. For example, five VOIP (Voice over Internet Protocol) lines 881-885 are represented in FIG. 22, but there may be more or fewer phone lines to accommodate various numbers of users, workstations, or the like.

Programmable logic controllers (PLCs) 901, 911, 921, 931, 941, 951, 961, 971, 981, 991 are also connected to the network ring 900, each through a corresponding ring network node 801, thus facilitating communication between the first and second control workstations 850, 852 and the well construction and/or control subsystems (e.g., the RC subsystem 311, the FC subsystem 312, the MPDC subsystem 313, the CPC subsystem 314, the WC subsystem 315, and the CCTV subsystem 316, inter alia). Each PLC 901, 911, 921, 931, 941, 951, 961, 971, 981, 991 may be electronically connected to its own subsystem network ring 909, 919, 929, 939, 949, 959, 969, 979, 989, 999, each of which electronically connect to its corresponding PLC and/or to one or more other pieces of equipment via subsystem ring network nodes 809, 819, 829, 839, 849, 859, 869, 879, 889, 899. For example, programmable logic subsystem controllers, processing devices, and/or sensors 902, 903, 904, 905 may be electronically connected, each through a corresponding subsystem ring network node 809, to the subsystem network ring 909 that is also electronically connected to the PLC 901 through its own subsystem ring network node 809, thereby forming a ring network subsystem. Although four PLCs/sensors/processing devices 902-905 are represented as being connected to PLC 901 via the subsystem network ring 909 in FIG. 22, it should be understood that more or fewer such devices may be electronically connected thereto and/or that there may be more than one class of such devices electronically connected thereto in a given ring network subsystem. Similar ring network subsystems are shown in FIG. 22 as being connected to the network ring 900, each via a corresponding ring network node 801 electronically connecting additional PLCs 911, 921, 931, 941, 951, 961, 971, 981, 991 and additional PLCs/sensors/processing devices 912-915, 922-925, 932-935, 942-945, 952-955, 962-965, 972-975, 982-924, 992-995, through corresponding subsystem ring network nodes 819, 829, 839, 849, 859, 869, 879, 889, 899 via their corresponding subsystem network rings 919, 929, 939, 949, 959, 969, 979, 989, 999. Again, although four workstations 992-995 are represented as being connected to PLC 991 via subsystem network ring 999 and although three cameras 982-984 are represented as being connected to PLC 981 via subsystem network ring 989 in FIG. 22, it should be understood that more or fewer such devices may be electronically connected thereto and/or that there may be more than one class of such devices electronically connected thereto in any given ring network subsystem.

FIG. 23 is a schematic view of at least a portion of an example implementation of a processing device 1000 according to one or more aspects of the present disclosure. One or more electronic devices utilized at the well construction system 100, 200 may each be, comprise, or be formed by at least a portion of the processing device 1000. For example, the processing devices 188, 192, 456, the BOP control station 470, the control workstations 450, 452, 454, 500, 850, 852, 992, and the CPUs 901-981, may each be, comprise, or be formed by at least a portion of an instance the processing device 1000. Instances of the processing device 1000, or portions thereof, may form at least a portion of the control system 300, including the wellsite computing resource environment 305, the coordinated control device 304, the supervisory control system 307, the local controllers 341-346, the onsite user devices 302, and the offsite user devices 303.

The processing device 1000 may be in communication with various sensors, actuators, controllers, and other devices of the subsystems 311-316 and/or other portions of the well construction system 100, 200. The processing device 1000 may be operable to receive coded instructions 1032 from the wellsite operators 195 via the wellsite control workstation 500, 850, 852 and the sensor data 351-356 generated by the sensors 321-326, process the coded instructions 1032 and the sensor data 351-356, and communicate the control data 361-366 to the local controllers 341-346 and/or the actuators 331-336 of the subsystems 311-316 to execute the coded instructions 1032 to implement at least a portion of one or more example methods and/or operations described herein, and/or to implement at least a portion of one or more of the example systems described herein.

The processing device 1000 may be or comprise, for example, one or more processors, special-purpose computing devices, servers, personal computers (e.g., desktop, laptop, and/or tablet computers), personal digital assistants, smartphones, internet appliances, and/or other types of computing devices. The processing device 1000 may comprise a processor 1012, such as a general-purpose programmable processor. The processor 1012 may comprise a local memory 1014, and may execute coded instructions 1032 present in the local memory 1014 and/or another memory device. The processor 1012 may execute, among other things, the machine-readable coded instructions 1032 and/or other instructions and/or programs to implement the example methods and/or operations described herein. The programs stored in the local memory 1014 may include program instructions or computer program code that, when executed by the processor 1012 of the processing device 1000, may cause the subsystems 311-316 and/or individual pieces of wellsite equipment of the well construction system 100, 200 to perform the example methods and/or operations described herein. The processor 1012 may be, comprise, or be implemented by one or more processors of various types suitable to the local application environment, and may include one or more of general-purpose computers, special-purpose computers, microprocessors, digital signal processors (DSPs), field-programmable gate arrays (FPGAs), application-specific integrated circuits (ASICs), and processors based on a multi-core processor architecture, as non-limiting examples. Of course, other processors from other families are also appropriate.

The processor 1012 may be in communication with a main memory 1016, such as may include a volatile memory 1018 and a non-volatile memory 1020, perhaps via a bus 1022 and/or other communication means. The volatile memory 1018 may be, comprise, or be implemented by random access memory (RAM), static random access memory (SRAM), synchronous dynamic random access memory (SDRAM), dynamic random access memory (DRAM), RAMBUS dynamic random access memory (RDRAM), and/or other types of random access memory devices. The non-volatile memory 1020 may be, comprise, or be implemented by read-only memory, flash memory, and/or other types of memory devices. One or more memory controllers (not shown) may control access to the volatile memory 1018 and/or non-volatile memory 1020.

The processing device 1000 may also comprise an interface circuit 1024. The interface circuit 1024 may be, comprise, or be implemented by various types of standard interfaces, such as an Ethernet interface, a universal serial bus (USB), a third generation input/output (3GIO) interface, a wireless interface, a cellular interface, and/or a satellite interface, among others. The interface circuit 1024 may also comprise a graphics driver card. The interface circuit 1024 may also comprise a communication device, such as a modem or network interface card to facilitate exchange of data with external computing devices via a network (e.g., Ethernet connection, digital subscriber line (DSL), telephone line, coaxial cable, cellular telephone system, satellite, etc.). One or more of the local controllers 341-346, the sensors 321-326, and the actuators 331-336 may be connected with the processing device 1000 via the interface circuit 1024, such as may facilitate communication between the processing device 1000 and the local controllers 341-346, the sensors 321-326, and/or the actuators 331-336.

One or more input devices 1026 may also be connected to the interface circuit 1024. The input devices 1026 may permit the wellsite operators 195 to enter the coded instructions 1032, such as control commands, processing routines, and/or operational settings and set-points. The input devices 1026 may be, comprise, or be implemented by a keyboard, a mouse, a joystick, a touchscreen, a track-pad, a trackball, an isopoint, and/or a voice recognition system, among other examples. One or more output devices 1028 may also be connected to the interface circuit 1024. The output devices 1028 may be, comprise, or be implemented by video output devices (e.g., an LCD, an LED display, a touchscreen, etc.), printers, and/or speakers, among other examples. The processing device 1000 may also communicate with one or more mass storage devices 1030 and/or a removable storage medium 1034, such as may be or include floppy disk drives, hard drive disks, compact disk (CD) drives, digital versatile disk (DVD) drives, and/or USB and/or other flash drives, among other examples.

The coded instructions 1032 may be stored in the mass storage device 1030, the main memory 1016, the local memory 1014, and/or the removable storage medium 1034. Thus, the processing device 1000 may be implemented in accordance with hardware (perhaps implemented in one or more chips including an integrated circuit, such as an ASIC), or may be implemented as software or firmware for execution by the processor 1012. In the case of firmware or software, the implementation may be provided as a computer program product including a non-transitory, computer-readable medium or storage structure embodying computer program code (i.e., software or firmware) thereon for execution by the processor 1012. The coded instructions 1032 may include program instructions or computer program code that, when executed by the processor 1012, may cause the various subsystems 311-316 or individual pieces of wellsite equipment of the well construction system 100, 200 to perform intended methods, processes, and/or operations disclosed herein.

In the example operations sequences described below, among others within the scope of the present disclosure, the pipe handling equipment may be operated automatically via the Construction Program, and the step execution of the pipe handling equipment may be controlled automatically by one or two operators 195 at the associated workstation(s) 450, 452, 454. The Construction Program may also feature configurable step confirmations. Each sequence controlled by the Construction Program may be stopped or interrupted at any time, and some or all functions may be operated manually by the one or two operators 195 at the associated workstation(s) 450, 452, 454.

Various well construction operations may be performed utilizing different combinations of the aspects described above. For example, when a tripping-in operation is to be performed, an operator 195 on the rig floor 114 may verify that various pieces of equipment are properly shut down and locked out, and then perhaps perform other preparations such as the examples set forth below in Table 1A.

TABLE 1A
Tripping-In Preparations

| Equipment | Responsible | Verifications |
|---|---|---|
| FIB 166 | Operator 195 on rig floor 114. | Tubulars 111 exist per HMI/tally. |
| Setback 164 | | Fingers are closed. |
| | | Travel path is unobstructed. |
| TBR 254 | Operator 195 on rig floor 114. | Travel path is unobstructed. |
| SGA 262 | | Gripper inserts/dies are clean, not worn. |
| LTC 244 | Operator 195 on rig floor 114. | Travel path is unobstructed. |
| ITC 236 | | Gripper inserts/dies are clean, not worn. |
| UTC 242 | | ITC 236 is open and retracted. |
| THP | Operator 195 on rig floor 114. | Travel path is unobstructed. |
| Doper 209 | | Water, correct dope available for doper |
| | | 209. |
| LSA 228 | Operator 195 on rig floor 114. | Travel path is unobstructed. |
| TDA 202 | Operator 195 on rig floor 114. | Travel path is unobstructed. |
| | | Correct dope available for doper 209. |
| | | Correct inserts/dies in gripper/elevator. |
| | | Inserts/dies are clean, not worn. |
| RN 151 | Operator 195 on rig floor 114. | Drill pipe tong (DPT) is connected. |
| | | Gripper dies are clean, not worn. |
| | | Travel path is unobstructed. |
| Slips 161 | Operator 195 on rig floor 114; and/or | Correct inserts/dies. |
| | “Driller” 195 at workstation 452. | Inserts/dies are clean, not worn. |
| TD 116 | Operator 195 on rig floor 114; and/or | Correct inserts/dies in elevator. |
| | “Driller” 195 at workstation 452. | Correct saver sub status. |
| | | Travel path is unobstructed. |
| DW 119 | Operator 195 on rig floor 114; and/or | Checked. |
| | “Driller” 195 at workstation 452. | |

The well construction system 100, 200 can then be set-up for the trip-in sequence. Examples of such set-up may be as set forth below in Table 1B.

TABLE 1B
Tripping-In Set-Up

| Equipment | Responsible | Set-Up | HMI |
|---|---|---|---|
| Pipe | Driller/ | Verify operator 195 on rig floor 114 | Verify Setback screen. |
| handling: | Pipe | completed pre-checks and deactivated | Construction Program |
| TBR 254, | Handler | emergency stop for all pipe handling | setup wizard. |
| SGA 262, | | equipment. | After startup: Check for |
| UTC 242, | | Open Construction Program screen on | green light in |
| LTC 244, | | touchscreen 522, 524. | Construction Program |
| ITC 236, | | Select Trip In mode. | status header on front |
| THP 207, | | Select setup wizard to open pop-up on | screen 532, 534, 536. |
| TDA 202, | | front screen 532, 534, 536. Verify | |
| LSA 228, | | settings: | |
| RN 151 | | Select slot, direction for picking | |
| | | pipe. | |
| | | Select Pipe type. | |
| | | Select RN 151 to use in the | |
| | | operations. | |
| | | RN 151 MU torque. | |
| | | Select pin/box doping. | |
| | | Stick-up target. | |
| | | Select “activate all machines” to startup | |
| | | and prepare all machines. | |
| TD 116, | Driller | Verify operator 195 on rig floor 114 | Verify Setback screen. |
| DW 119, | | completed pre-checks and deactivated | Construction Program |
| MP 144, | | emergency stop for all pipe handling | setup wizard. |
| Trip tank | | equipment. | After startup: Check for |
| | | Open Construction Program screen on | green light in |
| | | touchscreen 522, 524. | Construction Program |
| | | Select Trip In mode. | status header on front |
| | | Select setup wizard to open pop-up on | screen 532, 534, 536. |
| | | front screen 532, 534, 536. Verify | |
| | | settings: | |
| | | Stick-up target. | |
| | | Set DW 119 upper/lower stops. | |
| | | Set maximum lowering speed. | |
| | | Set minimum slack off weight. | |
| | | Trip tank 1/2/auto. | |
| | | Trip tank low/high levels. | |
| | | Select “activate all machines” to startup | |
| | | and prepare all machines. | |
| TD 116 | Driller | Verify operator 195 on rig floor 114 | Verify operator screen, |
| | | completed pre-checks. | system status/alarms. |
| | | Activate TD 116 from touchscreen 522, | |
| | | 524. | |
| | | Select Operation screen on touchscreen | |
| | | 522, 524. | |
| DW 119 | Driller | Activate DW 119 from touchscreen 522, | Verify operator screen, |
| | | 524. | system status/alarms. |
| All | Driller | Verify all relevant machines are enabled | Verify operator screen, |
| machines | | in zone management system and | system status/alarms. |
| | | tubular interlock system. | |

After such preparations and set-up, the operator 195 may vacate the rig floor 114, and the equipment may be configured to be ready for remote control (e.g., by deactivating emergency stops). The tripping-in sequence starts with the top drive 116 in a lower position with the elevator 129 closed, with the slips 161 closed, and with a portion (e.g., about one meter) of the drill string 120 (referred to as “stick-up”) protruding above the slips 161. A tubular 111 has been lifted by the TDA 202 (and perhaps the LSA 228) from the THP 207 to stick-up level above the MOH 204. The THP 207 is empty, and the UTC 242 and the LTC 244 are open and retracted. The TBR 254 and the SGA 262 may also be empty and perhaps moving to pick up a new tubular 111 from the vertical pipe rack assembly 165. The top drive elevator 129 is then opened and retracted from the stick-up.

The top drive 116 is then moved to an upper stop via operation of the DW 119. The TDA 202 (perhaps with cooperation from the LSA 228) then moves the new tubular 111 to over the well center 203 (WC). The RN 151 also moves toward the WC 203. During this time, the TBR 254 and the SGA 262 operate to remove another tubular 111 from the setback 164 and the FIB 166. The position from which this additional tubular 111 is removed may be selected automatically or via input from the operator 195 at a control workstation 450, 452, 454. For example, a “Pipe Handler” operator 195 seated at control workstation 450 may generally control/monitor pipe handling equipment (e.g., equipment that is handling tubulars 111 that not connected to the drill string 120), while a “driller” operator 195 seated at control workstation 452 may generally control/monitor the remaining equipment (or at least the equipment that is handling the drill string 120).

The TBR 254 and the SGA 262 then cooperate to move the currently held tubular 111 to the THP 207. The UTC 242 and the LTC 244 then close to hold the new tubular 111. The doper 209 may be integrated in or otherwise associated with the THP 207 may then wash and dope the pin end of the new tubular 111. The TBR 254 and the SGA 262 may then return to select the next tubular 111 from the vertical pipe rack assembly.

A stabbing guide and/or back up tong (BUT) of the RN 151 may then be closed to assist stabbing. The TDA 202 then lowers the new tubular 111 to stab into the stick-up, perhaps continuing a short distance (e.g., about one meter) after stabbing to provide room for the top drive elevator 129. The LSA 228 may then open and retract from WC 203. The RN 151 then performs low-torque spinning and subsequent high-torque “wrenching” to make-up the tubular 111 to the drill string 120.

The top drive 116, which during this time was hoisted to an elevation generally near the top end of the new tubular 111, then extends to WC 203 and closes the elevator 129 around the new tubular 111. At the same time, the TDA 202 and (perhaps) the LSA 228 move to the THP 207 for the next tubular 111, and the RN 151 opens and retracts away from the WC 203 to a standby position.

The DW 119 then lifts the top drive 116 to pick up the now-extended drill string 120 and open the slips 161, and then lowers the top 116 to lower the drill string 120 into the wellbore 102. The slips 161 are closed again, leaving a stick-up ready for the next tubular 111. During this time that the drill string 120 is being lowered into the wellbore, the TDA 202 and (perhaps) the LSA 228 extend and latch onto another new tubular 111 currently in the THP 207, and then the UTC 242 and the LTC 244 and opened and retracted. The new tubular 111 is lifted from setback level to drill (rig) floor level (e.g., about 9 meters), perhaps guided by the LSA 228. The box (top) end of the new tubular 111 can be doped by another washing/doping device, if selected.

This trip-in sequence is summarized in Table 1C set forth below.

TABLE IC
Tripping-In Operation

| | Operator | | Line of | Equipment | Equipment | |
|---|---|---|---|---|---|---|
| | 195 | Operation | Sight | Precondition | Functionality | HMI |
| 1. | Driller | Open elevator 129: | Visual/ | Slips 161 closed. | Elevator open is not | Elevator 129 to |
| | | Verify slips 161 are | CCTV | | selectable if slips | Open state. |
| | | closed. | | | 161 are not closed. | |
| | | Open elevator 129. | | | | |
| 1.1. | Pipe | TBR 254 and SGA 262 | Visual/ | TBR 254 and | TBR 254 will move | TBR 254 and |
| | Handler | pick up new tubular 111: | CCTV | SGA 262 are open. | above open latches. | SGA 262 grip/ |
| | | Move TBR 254 and | | Position selected | TBR 254 and SGA | guide to Closed |
| | | SGA 262 to selected | | in FIB 166 is “valid.” | 262 grip/guide will | state. |
| | | finger/slot in FIB 166. | | | close. | |
| | | Close guides and | | | | |
| | | clamp on tubular 111. | | | | |
| 2. | Driller | Retract and move TD | Visual/ | TD 116 pipe | | DW 119 upper |
| | | 116 to latching height: | CCTV | handler position | | stop setting. |
| | | Verify elevator 129 is | | facing TDA 202. | | |
| | | open. | | | | |
| | | Retract TD 116 to | | | | |
| | | clear tool joint (TJ). | | | | |
| | | Hoist elevator 129 to | | | | |
| | | tubular latch height | | | | |
| | | (upper stop or | | | | |
| | | calculated stop point). | | | | |
| 2.1. | Pipe | Move RN 151 to WC | Visual/ | Only possible with | RN 151 will move | TJ (stick-up) |
| | Handler | 203: | CCTV | tong handling | to WC 203. | assist indication. |
| | | Verify TD 116 is | | trolley (THT). If | Elevate to stick-up. | |
| | | hoisted above working | | tong handling arm | | |
| | | area of RN 151. | | (THA) is used, then | | |
| | | Start RN 151 make-up | | wait for tubular 111 | | |
| | | sequence to move RN | | located above stick-up. | | |
| | | 151 to WC 203. | | RN 151 tongs are | | |
| | | | | open. | | |
| | | | | WC 203 is | | |
| | | | | selected. | | |
| 2.2 | Pipe | TDA 202 moves tubular | Visual/ | TD 116 is retracted. | Tilt towards WC | TDA 202 load |
| | Handler | 111 to WC 203: | CCTV | | 203. | indication. |
| | | TDA 202 moves | | | TDA 202 dope | |
| | | tubular 111 to WC 203. | | | top box if | |
| | | LSA 228 guides to WC | | | preselected | |
| | | 203. | | | (automatic). | |
| 2.3. | Pipe | Guide tubular 111 with | CCTV | Tubular 111 is held | Close RN 151 | Stabbing guide |
| | Handler | RN 151 in WC 203: | | by TDA 202/LSA | BUT. | Closed indication. |
| | | Verify tubular 111 is | | 228 above stick-up | Close stabbing | BUT Closed |
| | | over WC 203. | | at WC 203. | guide. | indication. |
| | | Adjust elevation if | | | | |
| | | needed. | | | | |
| | | Continue RN 151 | | | | |
| | | sequence. | | | | |
| 2.4. | Pipe | TDA 202 stabs tubular | Visual/ | RN 151 is at WC | Continue lowering | TDA 202 load |
| | Handler | 111 in stick-up: | CCTV | 203 with stabbing | (e.g., about two | indication |
| | | Lower tubular 111 to | | guide closed. | meters) after verify | (unloading). |
| | | stab into stick-up. | | | set of weight. | |
| | | Continue lowering to | | | | |
| | | permit room for elevator | | | | |
| | | 129. | | | | |
| | | LSA 228 opens and | | | | |
| | | retracts when RB 151 | | | | |
| | | stabbing guide is closed | | | | |
| | | on tubular 111. | | | | |
| 2.5. | Pipe | RN 151 spin-in and | Visual/ | Tubular 111 is | Spin-in and make- | Torque log |
| | Handler | make-up: | CCTV | stabbed in stick-up. | up connection. | updated. |
| | | Verify RN 151 is in | | TDA 202 is | Open spinner, | Make-up (MU) |
| | | correct elevation. | | unloaded. | guide, and clamps. | torque presented |
| | | Continue RN 151 | | | RN 151 returns to | to driller. |
| | | sequence to spin-in and | | | park position. | |
| | | make-up. | | | | |
| 2.6. | Pipe | TBR 254 and SGA 262 | Visual/ | THP 207 is empty. | TBR 254 cannot | Indicate FIB 166 |
| | Handler | move tubular 111 to | CCTV | UTC 242 and LTC | open with weight. | latches Open. |
| | | THP 207: | | 244 are open. | TBR 254 opens | TBR 254 load |
| | | Open FIB 166 latches | | Correct pipe | when unloaded. | indication. |
| | | for selected row. | | detected in TBR | FIB 166 latches will | |
| | | Verify latches open. | | 254 and SGA 262. | not open with TBR | |
| | | TBR 254 and SGA 262 | | | 254 in low position. | |
| | | move tubular 111 to | | | | |
| | | THP 207. | | | | |
| | | FIB 166 latches will | | | | |
| | | close as the tubular 111 | | | | |
| | | is moved out. | | | | |
| | | Wash and/or dope pin | | | | |
| | | of tubular 111 if | | | | |
| | | preselected. | | | | |
| 2.7. | Pipe | UTC 242 and LTC 244 | Visual/ | TBR 254 and SGA | UTC 242 and LTC | UTC 242 and |
| | Handler | extend to THP 207 and | CCTV | 262 have tubular | 244 extend and | LTC 244 to |
| | | then close. | | 111 in THP 207. | close. | Closed state. |
| 2.8. | Pipe | TBR 254 and SGA 262 | Visual/ | UTC 242 and LTC | | |
| | Handler | open and move towards | CCTV | 244 closed on | | |
| | | FIB 166: | | tubular 111. | | |
| | | Open TBR 254 and | | | | |
| | | SGA 262 clamps/ | | | | |
| | | guides. | | | | |
| | | Move TBR 254 and | | | | |
| | | SGA 262 toward FIB | | | | |
| | | 166 (next tubular 111). | | | | |
| | | Continue step 1.1. | | | | |
| 3. | Driller | Extend TD 116 and latch | Visual/ | TDA 202 below TJ. | | Elevator 129 to |
| | | elevator 129: | CCTV | | | Closed state. |
| | | Extend TD 116 to WC | | | | Indicate TD |
| | | 203. | | | | 116 at WC 203. |
| | | Latch elevator 129 | | | | |
| | | (automatic close on | | | | |
| | | impact). | | | | |
| 3.1. | Pipe | TDA 202 opens and | Visual/ | TD elevator 129 is | TDA 202 will rotate | TDA 202 to |
| | Handler | moves to THP 207: | CCTV | closed. | and lower when | Open state. |
| | | Verify elevator 129 is | | | vertical until facing | |
| | | closed. | | | toward THP 207. | |
| | | Move TDA 202 to | | | | |
| | | tubular 111 in THP 207. | | | | |
| 4. | Driller | Open slips 161: | Visual | TD elevator 129 | | Slips 161 to |
| | | Open slips 161 | | is closed. | | Open state. |
| | | (command). | | RN 151 has | | DW 119 load. |
| | | Hoist to open slips | | completed the | | |
| | | 161. | | make-up | | |
| | | | | sequence with | | |
| | | | | correct torque. | | |
| 5. | Driller | Lower drill string 120: | Visual | Slips 161 are | | Settings: DW 119 |
| | | Verify slips 161 are | | open. | | lowering speed |
| | | open before lowering | | | | and minimum |
| | | drill string 120. | | | | slack-off weight. |
| 5.1. | Pipe | TDA 202 and LSA 228 | Visual/ | TDA 202 is | TDA 202 moves | |
| | Handler | extend to tubular 111 in | CCTV | open. | until contact with | |
| | | THP 207: | | LSA 228 guide | tubular 111 in THP | |
| | | Move TDA 202 until | | funnel is open. | 207. | |
| | | contact with tubular 111 | | | | |
| | | in THP 207, below TJ. | | | | |
| 5.2. | Pipe | TDA 202 and LSA 228 | Visual/ | TDA 202 is at | The closing | Confirm TDA |
| | Handler | latch onto tubular 111 in | CCTV | THP 207. | sequence is | 202 is closed on |
| | | THP 207: | | | verified to assure | tubular 111. |
| | | Close TDA 202. | | | proper grip on | LSA 228 guide |
| | | Close LSA 228 guide | | | tubular 111. | is closed. |
| | | funnel. | | | | |
| 5.3. | Pipe | UTC 242 and LTC 244 | Visual/ | TDA 202 is | UTC 242 and LTC | UTC 242 and |
| | Handler | open and retract. | CCTV | closed. | 244 open and | LTC 244 to Open |
| | | | | | retract. | state. |
| 5.4. | Pipe | TDA 202 moves tubular | Visual/ | UTC 242 and LTC | TDA 202 hoists, | TDA 202 load |
| | Handler | 111 to THP 207: | CCTV | 244 are open. | tilts to vertical, | indication. |
| | | TDA 202 lifts tubular | | | rotates 180 | |
| | | 111, guided by LSA | | | degrees to face TD | |
| | | 228, to THP 207. | | | 116. | |
| | | Continue step 2.2. | | | TDA 202 dopes | |
| | | | | | top box if | |
| | | | | | preselected | |
| | | | | | (automatic). | |
| 6. | Driller | Set slips 161: | Visual | Stick-up at correct | | Slips 161 to |
| | | Set slips 161 at correct | | height. | | Closed state. |
| | | stick-up height. | | | | DW 119 load |
| | | Set off weight. | | | | indicator. |
| | | | | | | Tally update. |
| 7. | Driller | Check trip tank volume, | Visual | Slips 161 are | Trip tank gain/loss is | Trip sheet/ |
| | | gain/loss: | | closed. | calculated and | volume control. |
| | | Determine trip tank | | | displayed. | |
| | | gain/loss. | | | | |
| | | Repeat all steps for | | | | |
| | | next tubular 111. | | | | |

When a tripping-out operation is to be performed, an operator 195 on the rig floor 114 may verify that various pieces of equipment are properly shut down and locked out, and then perhaps perform other preparations such as the examples set forth above in Table 1A. The well construction system 100, 200 can then be set-up for the trip-out sequence. Examples of such set-up may be as set forth below in Table 2A.

TABLE 2A
Tripping-Out Set-Up

| Equipment | Responsible | Set-Up | HMI |
|---|---|---|---|
| Pipe | Driller/ | Verify operator 195 on rig floor 114 | Verify Setback screen. |
| handling: | Pipe | completed pre-checks and deactivated | Construction Program |
| TBR 254, | Handler | emergency stop for all pipe handling | setup wizard. |
| SGA 262, | | equipment. | After startup: Check for |
| UTC 242, | | Select Trip Out mode. | green light in |
| LTC 244, | | Select setup wizard to open pop-up on | Construction Program |
| ITC 236, | | front screen 532, 534, 536. Verify | status header on front |
| THP 207, | | settings: | screen 532, 534, 536. |
| TDA 202, | | Select slot, direction for picking | |
| LSA 228, | | pipe. | |
| RN 151 | | Select pipe type. | |
| | | Select RN 151 to use in the | |
| | | operations. | |
| | | Select pin/box doping. | |
| | | Stick-up target. | |
| | | Select “activate all machines” to startup | |
| | | and prepare all machines. | |
| TD 116, | Driller | Verify operator 195 on rig floor 114 | Verify Setback screen. |
| DW 119, | | completed pre-checks and deactivated | Construction Program |
| MP 144, | | emergency stop for all pipe handling | setup wizard. |
| Trip tank | | equipment. | After startup: Check for |
| | | Open Construction Program screen on | green light in |
| | | touchscreen 522, 524. | Construction Program |
| | | Select Trip Out mode. | status header on front |
| | | Select setup wizard to open pop-up on | screen 532, 534, 536. |
| | | front screen 532, 534, 536. Verify | |
| | | settings: | |
| | | Stick-up target. | |
| | | Set DW 119 upper/lower stops. | |
| | | Set maximum lowering speed. | |
| | | Set over pull. | |
| | | Trip tank 1/2/auto. | |
| | | Trip tank low/high levels. | |
| | | Select “activate all machines” to startup | |
| | | and prepare all machines. | |
| TD 116 | Driller | Verify operator 195 on rig floor 114 | Verify operator screen, |
| | | completed pre-checks. | system status/alarms. |
| | | Activate TD 116 from touchscreen 522, | |
| | | 524. | |
| | | Select Operation screen on touchscreen | |
| | | 522, 524. | |
| DW 119 | Driller | Activate DW 119 from touchscreen 522, | Verify operator screen, |
| | | 524. | system status/alarms. |
| All | Driller | Verify all relevant machines are enabled | Verify operator screen, |
| machines | | in zone management system and | system status/alarms. |
| | | tubular interlock system. | |

After such preparations and set-up, the operator 195 may vacate the rig floor 114, and the equipment may be configured to be ready for remote control (e.g., by deactivating emergency stops). An example trip-out sequence may start with the TD 116 in lower position over WC 203 with closed slips 161 and elevator 129, with a stick-up of about one meter. The TDA 202 and LSA 228 are open in THP position 207 (tubular 111 delivered from WC 203 to THP 207). The UTC 242 and LTC 244 are closed on the tubular 111 in the THP 207. The TBR 254 and SGA 262 are empty, on the way from the FIB 166 to get a new tubular 111 in the THP 207. Example steps of the trip-out sequence may be as set forth below in Table 2B.

TABLE 2B
Tripping-Out Operation

| | Operator | | Line of | Equipment | Equipment | |
|---|---|---|---|---|---|---|
| | 195 | Operation | Sight | precondition | Functionality | HMI |
| 1. | Driller | Open slips 161 and | Visual/ | Elevator 129 must be | Slips 161 Open is | Slips 161 to |
| | | hoist to upper stop: | CCTV | closed before opening | not selectable if | Open state. |
| | | Verify that elevator 129 | | slips 161. | elevator 129 is not | Settings: |
| | | is closed. | | | closed. | DW 119 |
| | | Open slips 161 | | | The slips 161 | hoisting |
| | | (command). | | | Open command is | speed and |
| | | Hoist to take weight | | | reset after a set time | maximum |
| | | and verify slips 161 | | | if the slips 161 are | overpull. |
| | | opening. | | | not opened. | |
| 1.1. | Pipe | TBR 254 and SGA 262 | Visual/ | TBR 254 and | | TBR 254 and |
| | Handler | pick up next tubular 111 | CCTV | SGA 262 | | SGA 262 grips/ |
| | | from THP 207: | | open. | | guides to Closed |
| | | TBR 254 and SGA 262 | | | | state. |
| | | move to tubular 111 in | | | | |
| | | THP 207. | | | | |
| | | Close TBR 254 and | | | | |
| | | SGA 262 guides/clamps | | | | |
| | | on tubular 111. | | | | |
| 1.2. | Pipe | UTC 242 and LTC 244 | Visual/ | TBR 254 and | UTC 242 and LTC 244 | UTC 242 and |
| | Handler | open and retract: | CCTV | SGA 262 | open and retract. | LTC 244 to Open |
| | | UTC 242 and LTC | | closed on tubular | | state-retracted. |
| | | 244 open. | | 111 in THP 207. | | |
| | | UTC 242 and LTC | | | | |
| | | 244 retract from THP | | | | |
| | | 207. | | | | |
| 1.3. | Pipe | TBR 254 and SGA 262 | Visual/ | Valid FIB 166 position | TBR 254 and SGA | TBR 254 load. |
| | Handler | move toward FIB 166 | CCTV | selected. | 262 will follow | |
| | | with tubular 111: | | | predefined path. | |
| | | Lift tubular 111 from | | | FIB 166 latches will | |
| | | THP 207. | | | open when tubular 111 | |
| | | Move to selected | | | is outside selected FIB | |
| | | position in FIB 166. | | | 166 row. | |
| | | | | | FIB 166 latches will | |
| | | | | | close prior to setting | |
| | | | | | down the tubular 111. | |
| | | | | | Set down tubular 111 | |
| | | | | | on selected position. | |
| 1.4. | Pipe | TDA 202 and LSA 228 | Visual/ | | TDA 202 retract to | TDA 202 load |
| | Handler | move to WC 203: | CCTV | | vertical, hoist, and | indication. |
| | | TDA 202 move to WC | | | rotate, extend to WC | |
| | | 203. | | | 203 at about two | |
| | | LSA 228 move to WC | | | meters below stick-up. | |
| | | 203. | | | TDA 202 and LSA | |
| | | | | | 228 will stop/wait | |
| | | | | | outside WC 203 area | |
| | | | | | if TD 116 is moving. | |
| 1.5. | Pipe | Move RN1 51 to WC | | RN 151 tongs open. | RN 151 will move to | TJ (Stick-up) |
| | Handler | 203: Verify TD 116 is | | WC 203 selected. | WC 203. | assist indication. |
| | | hoisted above RN 151 | | | Elevate RN 151 to | |
| | | working area. | | | stick-up. | |
| | | Start 151 RN break- | | | RN 151 will stop/ | |
| | | out sequence to move | | | wait outside WC 203 | |
| | | RN 151 to WC 203. | | | area if TD 116 is | |
| | | | | | moving. | |
| 2. | Driller | Set slips 161: | Visual/ | | | DW 119 upper |
| | | Verify required stick-up | CCTV | | | stop setting. |
| | | height. | | | | |
| | | Set slips 161 | | | | |
| | | (command). | | | | |
| | | Set off weight. | | | | |
| 2.1. | Pipe | TDA 202 close and LSA | Visual/ | Slips 161 closed. | TDA 202 and LSA 228 | TDA 202 to |
| | Handler | 228 guide close: | CCTV | | will not close in WC | Closed state. |
| | | Verify TDA 202 and | | | 203 if slips 161 are not | TDA 202 and |
| | | LSA 228 at WC 203. | | | closed. | LSA 228 in WC |
| | | Close TDA 202. | | | | 203. |
| | | Close LSA 228 guide | | | | LSA 228 guide |
| | | funnel. | | | | funnel to Closed |
| | | | | | | state. |
| 2.2. | Pipe | RN 151 break-out and | CCTV | Slips 161 closed. | Break-out and spin | RN 151 |
| | Handler | spin-out: | | | out. Double break-out | indication. |
| | | Verify slips 161 closed | | | available if required. | |
| | | and weight set off. | | | Open RN 151 | |
| | | Adjust RN 151 | | | spinner, guide, and | |
| | | elevation if required. | | | clamps. | |
| | | Continue RN 151 | | | Return RN 151 to | |
| | | sequence. | | | park position. | |
| | | | | | RN 151 may wait in | |
| | | | | | WC 203 until TDA 202 | |
| | | | | | has lifted tubular 111. | |
| 3. | Driller | Open TD elevator 129, | Visual/ | TDA 202 closed. | | TD elevator |
| | | retract, and lower: | CCTV | Slips 161 closed. | | 129 to Closed |
| | | Verify TDA 202 is | | | | state. |
| | | closed. | | | | TD 116 |
| | | Open TD elevator 129 | | | | retracted |
| | | and retract. | | | | position. |
| | | Lower TD 116 (e.g., to | | | | |
| | | rig floor 114. | | | | |
| 3.1. | Pipe | TDA 202 lift tubular 111 | Visual/ | RN 151 finished | TDA 202 will hoist | TDA 202 load |
| | Handler | out of stick-up: | CCTV | spin-out, RN 151 | about two meters | indication. |
| | | Hoist TDA 202 to pick | | BUT is open. | before lifting tubular 111. | LSA 228 |
| | | up weight. | | TD 116 retracted. | Tubular 111 is lifted | centralizer. |
| | | LSA 228 centralizer | | | carefully. Lifting is | |
| | | will close on tubular 111 | | | stopped if tubular | |
| | | above stick-up. | | | 111 is catching on | |
| | | RN 151 may return to | | | threads in TJ. | |
| | | park position when | | | LSA 228 centralizer | |
| | | tubular1 11 is lifted. | | | closes after lifted | |
| | | | | | above the box. | |
| 3.2. | Pipe | TDA 202 and LSA 228 | Visual/ | TDA 202 closed. | TDA 202 will retract | TDA 202 load |
| | Handler | move tubular 111 to | CCTV | LTC 244 closed | when to vertical position | indication. |
| | | THP 207: | | tubular 111 is below | above MOH (or rig | TDA 202 and |
| | | TDA 202 and LSA 228 | | LTC 244. | floor 114), then rotate, | LSA 228 |
| | | move toward THP 207. | | | lower, and extend to | position. |
| | | LTC 244 extends to | | | THP 207. | LSA 228 |
| | | THP 207 and closes | | | TDA 202 will slow | extend. |
| | | guide when tubular is | | | down above THP 207. | LTC 244 to |
| | | close to THP 207. | | | LTC 244 is extended | Closed state. |
| | | Set down tubular at | | | and closed. | |
| | | THP 207. | | | LSA 228 is open. | |
| | | Wash and dope pin if | | | | |
| | | preselected. | | | | |
| 3.3. | Pipe | UTC 242 extend to | Visual/ | TDA 202 and LSA 228 | UTC 242 extend to | UTC 242 and |
| | Handler | THP 207 and close. | CCTV | in THP 207 with | THP 207. | LTC 244 to |
| | | | | tubular 111. | UTC 242 guide | closed state. |
| | | | | | close. | |
| 4. | Driller | Extend TD 116 and | Visual | RN 151 parked. | | Elevator 129 |
| | | latch elevator 129: | | | | Closed state. |
| | | Extend TD 116 to WC | | | | Indicate TD |
| | | 203. | | | | 116 in WC 203. |
| | | Latch elevator 129 | | | | |
| | | (automatic close on | | | | |
| | | impact). | | | | |
| 5. | Driller | Check trip tank volume, | Visual | | Trip tank gain/loss is | Trip sheet/ |
| | | Gain/Loss: | | | determined and | volume control. |
| | | Determine trip tank | | | displayed. | |
| | | gain/loss. | | | | |
| | | Repeat all steps for | | | | |
| | | next tubular 111. | | | | |
| | | Continue on step 1. | | | | |
| 5.1. | Pipe | TDA 202 open and | Visual/ | UTC 242 closed. | | TDA 202 to |
| | Handler | retract from THP 207: | CCTV | | | Open state. |
| | | Verify UTC 242 and | | | | |
| | | LTC 244 are closed. | | | | |
| | | Open TDA 202. | | | | |
| | | Open LSA 228 guide | | | | |
| | | funnel. | | | | |
| | | Continue on step 1.4. | | | | |
| 5.2. | Pipe | TBR 254 and SGA 262 | | UTC 242 and LTC 244 | TBR 254 clamp and | TBR 254 clamp |
| | Handler | move to THP 207: | | closed on tubular 111. | guide and SGA 262 | and guide and |
| | | Open TBR 254 and | | | guide will open. | SGA 262 guide |
| | | SGA 262. | | | TBR 254 will hoist | to Open state. |
| | | Move TBR 254 and | | | before it retracts out of | |
| | | SGA 262 toward THP | | | FIB 166. | |
| | | 207/ next tubular. | | | | |
| | | Continue step 1.1. | | | | |

When a drilling connection is to be made, an operator 195 on the rig floor 114 may verify that various pieces of equipment are properly shut down and locked out, and then perhaps perform other preparations such as the examples set forth above in Table 1A. The well construction system 100, 200 can then be set-up for making the drilling connection. Examples of such set-up may be as set forth below in Table 3A.

TABLE 3A
Drilling Connection Set-Up

| Equipment | Responsible | Set-Up | HMI |
|---|---|---|---|
| Pipe | Driller/ | Verify operator 195 on rig floor 114 | Verify Setback |
| handling: | Pipe | completed pre-checks and deactivated | screen. |
| TBR 254, | Handler | emergency stop for all pipe handling | Construction |
| SGA 262, | | equipment. | Program setup |
| UTC 242, | | Open Construction Program screen on | wizard. |
| LTC 244, | | touchscreen 522, 524. | After startup: Check |
| ITC 236, | | Select Drilling Connection mode. | for green light in |
| THP 207, | | Select setup wizard to open pop-up on | Construction |
| TDA 202, | | front screen 532, 534, 536. Verify settings: | Program status |
| LSA 228, | | Select slot, direction for picking pipe. | header on front |
| RN 151 | | Select pipe type. | screen 532, 534, |
| | | Select RN 151 to use in the operations. | 536. |
| | | Select RN 151 as back-up only (only | |
| | | selectable for THT). | |
| | | RN 151 MU torque. | |
| | | Select pin/box doping. | |
| | | Stick-up target. | |
| | | Select “activate all machines” to startup | |
| | | and prepare all machines. | |
| TD 116, | Driller | Verify operator 195 on rig floor 114 | Verify Setback |
| DW 119, | | completed pre-checks and deactivated | screen. |
| MP 144 | | emergency stop for all pipe handling | Construction |
| | | equipment. | Program setup |
| | | Open Construction Program screen on | wizard. |
| | | touchscreen 522, 524. | After startup: Check |
| | | Select Drilling mode. | for green light in |
| | | Select setup wizard to open pop-up on | Construction |
| | | front screen 532, 534, 536. Verify settings: | Program status |
| | | Stick-up target. | header on front |
| | | Set DW 119 upper/lower stops. | screen 532, 534, |
| | | Set relevant Autodriller parameters | 536. |
| | | (ROP, WOB, delta-P, torque, etc.) | |
| | | Verify correct TD 116 make-up torque | |
| | | setting. | |
| | | Assign TD 116 rotation to armrest | |
| | | control 514, 515, 516. | |
| | | Verify/set TD 116 ramp parameters. | |
| | | Verify correct drilling torque setting. | |
| | | Verify liner size setting and pump | |
| | | efficiency. | |
| | | Verify MP 144 pressure limit setting. | |
| | | Assign pumps to MP 144 master slider. | |
| | | Verify/set MP 144 ramp-up parameters. | |
| | | Verify active tanks are selected and | |
| | | lined up. | |
| | | Select “activate all machines” to startup | |
| | | and prepare all machines. | |
| All | Driller | Verify all relevant machines are enabled | Verify operator |
| machines | | in zone management system and tubular | screen, system |
| | | interlock system. | settings. |

After such preparations and set-up, the operator 195 may vacate the rig floor 114, and the equipment may be configured to be ready for remote control (e.g., by deactivating emergency stops). An example drilling connection sequence may start with the drill string 120 drilled all the way down, reaming, survey, up/down weights, etc., performed according to drilling program. A tubular 111 to be added to the drill string 120 and in the TDA 202/LSA 228 is lifted from stick-up level above the MOH 204. The THP 207 is empty, and the UTC 242 and LTC 244 are open and retracted. The TBR 254 and SGA 262 are empty, on the way to pick a new tubular 111 from the FIB 166. Example steps of the drilling connection sequence may be as set forth below in Table 3B.

TABLE 3B
Drilling Connection Operation

| | Operator | | Line of | Equipment | Equipment | |
|---|---|---|---|---|---|---|
| | 195 | Operation | Sight | precondition | Functionality | HMI |
| 1. | Driller | Set slips 161: | Visual | | | Slips 161 to |
| | | Verify MPs 144 are | | | | Closed state. |
| | | stopped and torque is | | | | DW 119 hook |
| | | released from drill | | | | load. |
| | | string 120. | | | | TD 116 torque |
| | | Set slips 161 at | | | | release. |
| | | required stick-up | | | | |
| | | height. | | | | |
| | | Set off weight. | | | | |
| 2. | Driller | TD 116 break-out | Visual | Slips 161 must be | TD 116 Break-Out | TD 116 thread |
| | | connection: | | closed before TD 116 | function will activate | compensator |
| | | Verify slips 161 are | | BUT Break-Out | the clamp and | indication. |
| | | closed. | | function is available. | increase the torque to | TD 116 not |
| | | Break-out connection | | | break the connection. | connected. |
| | | (joystick button + | | | TD 116 break-out | TD 116 Break- |
| | | joystick). | | | will activate the TD | Out function- |
| | | Deactivate break-out | | | 116 thread | joystick button- |
| | | button when | | | compensator and | push and hold. |
| | | connection is broken | | | pipe handler lock. | Clamp on/ |
| | | (torque dropping and | | | When connection is | break-out may |
| | | shaft rotating). | | | broken, release | be operated |
| | | | | | button. The torque will | separately on |
| | | | | | be released and | touch screen |
| | | | | | backup clamp (BUC) | 522, 524. |
| | | | | | opened. | TD 116 torque |
| | | | | | DW 119 is | dropping and |
| | | | | | interlocked from | shaft rotating. |
| | | | | | hoisting when the | |
| | | | | | BUC is closed. | |
| 3. | Driller | TD 116 spin-out: | Visual | Slips 161 must be | Spin-Out will | TD 116 thread |
| | | Verify break-out is | | closed. | activate the TD 116 | compensator |
| | | completed. | | Break-Out not | thread compensator | indication. |
| | | Spin-out. (Direct | | active. | system. | |
| | | continue from break- | | BUC open. | Spin-Out function | |
| | | out). | | | will spin-out per | |
| | | Hoist out of stick-up. | | | settings. | |
| | | | | | Deactivate TD 116 | |
| | | | | | thread compensator. | |
| 4. | Driller | Retract and move TD | Visual/ | Hoisting will be | TD 116 pipe handler | Indicate upper |
| | | 116 to connection | CCTV | stopped if TD 116 is | has pre-set position | stop position. |
| | | height: | | retracted and links | facing TDA 202. | Link tilt |
| | | Verify TD 116 is | | tilted to parked | | position. |
| | | above stick-up. | | position. | | |
| | | Retract TD 116 and | | | | |
| | | activate link tilt float. | | | | |
| | | Hoist TD 116 to | | | | |
| | | tubular 111 connection | | | | |
| | | height (upper stop). | | | | |
| 4.1. | Pipe | Move RN 151 to WC | | Only possible with | RN 151 will move to | TJ assist |
| | Handler | 203: | | THT. If THA is used, | WC 203. | indication. |
| | | Verify TD 116 is | | then wait for tubular | Elevate to stick-up. | |
| | | hoisted above RN 151 | | 111 located above | | |
| | | working area. | | stick-up. | | |
| | | Start RN 151 make- | | RN 151 tongs open. | | |
| | | up sequence to move | | WC 203 selected. | | |
| | | RN 151 to WC 203. | | | | |
| 4.2. | Pipe | TDA 202 move tubular | Visual/ | TD 116 retracted. | Tilt towards WC | TDA 202 Load |
| | Handler | 111 to WC 203: | CCTV | | 203. | indication. |
| | | Continue to lift TDA | | | TDA 1613 dope | |
| | | 202 and extend to WC | | | top box. | |
| | | 203 (above stick-up). | | | | |
| | | LSA 228 guide to WC | | | | |
| | | 203 when pin end | | | | |
| | | above rig floor 114. | | | | |
| 4.3. | Pipe | Guide tubular 111 with | CCTV | Tubular 111 held by | Close RN 151 BUT. | Stabbing |
| | Handler | RN 151 in WC 203: | | TDA 202/LSA 228 | Close stabbing | guide closed |
| | | Verify tubular 111 is | | above stick-up in WC | guide. | indication. |
| | | located in WC 203. | | 203. | | BUT closed |
| | | Adjust RN 151 | | | | indication. |
| | | elevation if required. | | | | |
| | | Continue RN 151 | | | | |
| | | sequence. | | | | |
| 4.4. | Pipe | TDA 202 lower to stab | Visual/ | RN 151 in WC 203 | Continue lowering | TDA load |
| | Handler | tubular 111 in stick-up: | CCTV | with stabbing guide | about two meters | indication |
| | | Lower tubular 111 to | | closed. | after verifying set of | (unloading). |
| | | stab into stick-up. | | | weight (to allow room | |
| | | Continue lowering | | | for TD 116 to latch on | |
| | | about two meters after | | | top). | |
| | | stabbing complete. | | | | |
| | | LSA 228 open and | | | | |
| | | retract when RN 151 | | | | |
| | | stabbing guide closed | | | | |
| | | on tubular 111. | | | | |
| 4.5. | Pipe | RN 151 back-up (pre- | Visual/ | Tubular 111 stabbed | Option: | Torque log |
| | Handler | selected): | CCTV | in stick-up. | Spin-in and make-up | updated. |
| | | Option: Spin-in and | | TDA 202 unloaded. | connection. | MU torque |
| | | make-up with RN 151: | | | Open spinner, | presented to |
| | | RN 151 BUT will stay | | | guide, and clamps. | driller. |
| | | on for back-up. | | | Return to park | |
| | | Option: Make-Up with | | | position. | |
| | | RN 151: | | | | |
| | | Continue RN 151 | | | | |
| | | sequence to spin-in | | | | |
| | | and make-up. | | | | |
| 5. | Driller | Extend TD 116 to WC | Visual/ | TDA 202 below TJ. | | Indicate TD |
| | | 203: | CCTV | | | 116 in WC 203. |
| | | Extend TD 116 to | | | | Link tilt. |
| | | WC 203. | | | | |
| | | Deactivate link tilt | | | | |
| | | float. | | | | |
| | | Tilt elevator 129 to | | | | |
| | | parked position. | | | | |
| 6. | Driller | TD 116 spin-in (both | Visual/ | TD 116 in WC 203. | Spin-in with spin-in | Thread |
| | | connections): | CCTV | THT/DPT BUC on. | settings (RPM/ | compensator |
| | | Verify RN 151/THT | | | torque). | indication |
| | | BUT closed. | | | Spin-in will activate | (mid stroke). |
| | | Activate TD 116 spin- | | | the TD 116 thread | |
| | | in. | | | compensator system. | |
| | | Lower TD 116 to stab | | | | |
| | | and spin-in. | | | | |
| | | Optional: Lower | | | | |
| | | connection | | | | |
| | | made-up by | | | | |
| | | RN 151: See step 7. | | | | |
| 7. | Driller | TD 116 make-up (both | Visual/ | TD 116 spin-in | TD 116 Make-up | RN 151 BUC |
| | | connections): | CCTV | completed. | function will change | on. |
| | | Verify TD 116 spin-in | | THT BUT closed. | TD 116 torque to set | TD 116 make- |
| | | function is finished. | | | make-up torque. | up torque. |
| | | Make-up the | | | Release torque | TD 116/ RN |
| | | connection(s) (joystick | | | when button is | 151 torque log |
| | | button + joystick). | | | released and joystick | updated (both |
| | | Release button when | | | to center. | connections). |
| | | make-up torque is | | | DW 119 is | TD 116 |
| | | reached. | | | interlocked from | connected state |
| | | | | | hoisting when RN 151 | when make-up |
| | | | | | BUC is closed. (Rig | torque is |
| | | | | | tong or slips 161 may | reached. |
| | | | | | be used as backup | Make-up |
| | | | | | per setting). | function may be |
| | | | | | TD 116 thread | operated |
| | | | | | compensator system | manually from |
| | | | | | is deactivated. | touchscreen |
| | | | | | | 522, 524. |
| 8. | Driller | Option: TD 116 spin-in | Visual/ | TD 116 in WC 203. | Spin-in with spin-in | Thread |
| | | upper connection | CCTV | RN 151 finished/ | settings (RPM/ | compensator |
| | | (lower connection | | open (retracted). | torque). | (mid stoke). |
| | | made-up by RN 151): | | | Spin-in will activate | |
| | | Verify RN 151/THT | | | the TD 116 thread | |
| | | finished (tubular 111 | | | compensator system. | |
| | | connected). | | | | |
| | | Activate TD 116 Spin- | | | | |
| | | in. | | | | |
| | | Lower TD 116 to stab | | | | |
| | | and spin-in. | | | | |
| 9. | Driller | Option: TD 116 make- | Visual/ | RN 151 make-up | TD 116 make-up will | TD 116 BUC |
| | | up upper connection | CCTV | finished. | automatically activate | on. |
| | | (lower connection | | TD 116 spin-in | pipe handler lock, | TD 116 MU |
| | | made-up by RN 151): | | finished. | close the TD 116 | torque. |
| | | Verify TD 116 spin-in | | Clamp on make- | BUC, and increase | TD 116 torque |
| | | is finished. | | up available from | TD 116 torque to set | updated. |
| | | Make-up connection | | touch panel 522, 524 | make-up torque. | TD 116 |
| | | (joystick button + | | without spin-in. | Release button (and | Connected |
| | | joystick). | | | joystick to center) to | state when MU |
| | | Release button when | | | open BUC and | torque is |
| | | make-up torque is | | | release torque. | reached. |
| | | reached. | | | DW 119 is | TD 116 MU |
| | | | | | interlocked from | may be |
| | | | | | moving when BUC is | operated |
| | | | | | closed. | manually on |
| | | | | | TD thread | touchscreen |
| | | | | | compensator system | 522, 524. |
| | | | | | is deactivated. | |
| 9.1. | Pipe | TDA 202 open and | | TD 116 spin-in | TDA 202 will tilt to | TDA 202 to |
| | Handler | move to THP 207: | | finished. | vertical, rotate to face | Open state. |
| | | Verify TD 116 is | | | toward THP 207, and | |
| | | connected. | | | lower to pick up next | |
| | | Open TDA 202. | | | tubular 111. | |
| | | Retract and rotate | | | | |
| | | TDA 202 towards THP | | | | |
| | | 207. | | | | |
| 10. | Driller | Open slips 161: | Visual/ | TD 116 connected. | | Slips 161 to |
| | | Open slips 161. | CCTV | | | Open state. |
| | | Hoist to open slips | | | | DW 119 hook |
| | | 161. | | | | load. |
| 11. | Driller | Continue drilling per | Visual | Slips 161 open. | | IBOP to Open |
| | | drilling program: | | | | status. |
| | | Open IBOP. | | | | TD 116 RPM. |
| | | Continue drilling per | | | | TD 116 |
| | | drilling program. | | | | torque. |
| | | | | | | MP 144 |
| | | | | | | strokes per |
| | | | | | | minute (SPM). |
| | | | | | | Standpipe |
| | | | | | | pressure. |
| 11.1. | Pipe | TBR 254 and SGA 262 | Visual/ | TBR 254 and SGA | TBR 254 will move | TBR 254 and |
| | Handler | pick up new tubular | CCTV | 262 grip/guide open. | into FIB 166 elevated | SGA 262 grip/ |
| | | 111: | | Selected FIB 166 | above open latches. | guide to Closed |
| | | Move TBR 254 and | | position is “valid.” | Adjustments | state. |
| | | SGA 262 to selected | | | available. | |
| | | finger/slot in FIB 166. | | | TBR 254 and SGA | |
| | | Close guides and | | | 262 grip/guide will | |
| | | clamp on tubular 111. | | | close. | |
| 11.2. | Pipe | TBR 254 and SGA 262 | Visual/ | THP 207 empty. | TBR 254 cannot | Indicate open |
| | Handler | move tubular 111 to | CCTV | UTC 242 and LTC | open with weight. | FIB 166 latches. |
| | | THP 207: | | 244 are open. | TBR 254 gripper | TBR 254 load |
| | | Open FIB 166 latches | | Correct pipe | open when unloaded. | indication. |
| | | for selected row. | | detected in TBR 254 | FIB 166 latches will | |
| | | Verify latches open | | and SGA 262. | not open with TBR | |
| | | (visual/CCTV). | | | 254 head in low | |
| | | TBR 254 lifts tubular | | | position. | |
| | | 111 and moves to THP | | | | |
| | | 207. | | | | |
| | | FIB 166 latches will | | | | |
| | | close as the tubular | | | | |
| | | 111 moves out of FIB | | | | |
| | | 166. | | | | |
| | | Set down tubular in | | | | |
| | | THP 207. | | | | |
| | | Wash and dope pin if | | | | |
| | | preselected. | | | | |
| 11.3. | Pipe | UTC 242 and LTC 244 | Visual/ | TBR 254 and SGA | UTC 242 and LTC | UTC 242 and |
| | Handler | extend to THP 207 and | CCTV | 262 with tubular in | 244 extend and close. | LTC 244 to |
| | | close. | | THP 207. | | Closed state. |
| 11.4. | Pipe | TBR 254 and SGA 262 | | UTC 242 and LTC | | |
| | Handler | open and move toward | | 244 closed on tubular | | |
| | | FIB 166: | | 111. | | |
| | | Open TBR 254 | | | | |
| | | clamps and guide and | | | | |
| | | SGA 262 guide. | | | | |
| | | Move toward FIB 166/ | | | | |
| | | next tubular 111. | | | | |

It is noted that the example drilling connection sequence set forth above describes the RN 151 and THT used as the BUT for the TD 116 during make-up, as well as the option of making-up the lower connection with the RN 151 and the upper connection with the TD 116.

Different combinations of the aspects described above may also be utilized for building stands of two or more tubulars 111. Such stand building may be performed during drilling and other operations performed at WC 203. Such simultaneous operations, however, are coordinated to avoid conflicts and obstructions between the different machines and systems. For example, the elevator of the TDA 202 may have two different sizes of inserts to permit building casing stands while drilling. The change of head size may be done remote from the Pipe Handler's workstation 450 (or 452 or 454). When a stand building operation is to be performed, an operator 195 on the rig floor 114 may verify that various pieces of equipment are properly shut down and locked out, and then perhaps perform other preparations such as the examples set forth below in Table 4A.

TABLE 4A
Stand Building Preparations

| Equipment | Responsible | Verifications |
|---|---|---|
| Catwalk | Operator 195 on | Travel path is unobstructed. |
| (CW) 131 | rig floor 114. | Feeding table (FT) indexer pins. |
| FIB 166 | Pipe Handler | Stands in FIB 166 slots per HMI. |
| | | Fingers closed. |
| | | Travel path is unobstructed. |
| TBR 254 | Pipe Handler | Travel path is unobstructed. |
| SGA 262 | Pipe Handler | Travel path is unobstructed. |
| LTC 244 | Operator 195 on | Travel path is unobstructed. |
| ITC 236 | rig floor 114. | Dies are clean and not worn. |
| UTC 242 | | |
| THP | Operator 195 on | Travel path is unobstructed. |
| Doper 209 | rig floor 114. | Water and correct dope available |
| | | for doper 209. |
| LSA 228 | Operator 195 on | Travel path is unobstructed. |
| | rig floor 114. | |
| TDA 202 | Operator 195 on | Travel path is unobstructed. |
| | rig floor 114. | Correct dope is available for |
| | | associated doper 209. |
| | | Correct inserts installed. |
| RN 151: | Operator 195 on | DPT is assembled. |
| THA-DPT | rig floor 114. | Dies are clean and not worn. |
| | | Travel path is unobstructed. |
| Tubulars | Operator 195 on | Tubular 111 to be loaded on FT. |
| 111 | rig floor 114. | Tubulars 111 to be cleaned and |
| | | doped, protectors removed. |

The well construction system 100, 200 can then be set-up for the stand building operation. Examples of such set-up may be as set forth below in Table 4B.

TABLE 4B
Stand Building Set-Up

| Equipment | Responsible | Set-Up | HMI |
|---|---|---|---|
| Pipe | Pipe | Verify operator 195 on rig floor 114 | Verify Setback |
| handling: | Handler | completed pre-checks and deactivated | screen. |
| TBR 254, | | emergency stop for all pipe handling | Construction |
| SGA 262, | | equipment. | Program setup |
| UTC 242, | | Open Construction Program screen on | wizard. |
| LTC 244, | | touchscreen 522, 524. | After startup: Check |
| ITC 236, | | Select Stand Building mode. | for green light in |
| THP 207, | | Select setup wizard to open pop-up on front | Construction |
| TDA 202, | | screen 532, 534, 536. Verify settings: | Program status |
| LSA 228, | | Select slot, direction for racking stands | header on front |
| RN 151, | | 111. | screen 532, 534, |
| CW 131 | | Select pipe size/type. | 536. |
| | | Select RN 151 (with THA) to use in the | |
| | | operations. | |
| | | RN 151 MU torque. | |
| | | Perform pin/box doping. | |
| | | Stick-up target. | |
| | | Select “activate all machines” to startup and | |
| | | prepare all machines. | |
| All | Pipe | Verify all relevant machines are enabled in | |
| machines | Handler | zone management system and tubular | |
| | | interlock system. | |
| Tubulars | Pipe | All tubulars 111 to be registered in | |
| 111 | Handler | electronic tally system. | |

After such preparations and set-up, the operator 195 may vacate the rig floor 114, and the equipment may be configured to be ready for remote control (e.g., by deactivating emergency stops). An example stand building sequence may start with the MOH 204 and THP 207 empty, the ITC 236 retracted, and the CW 131 feeding table pre-loaded with tubulars (perhaps already cleaned and doped). Example steps of the stand building sequence may be as set forth below in Table 4C. In such example, among others within the scope of the present disclosure, the pipe handling equipment may be operated automatically via the Construction Program, and the step execution of the pipe handling equipment may be controlled automatically by one or two operators 195 at the associated workstation(s) 450, 452, 454. The Construction Program may also feature configurable step confirmations. The stand building sequence controlled by the Construction Program may be stopped or interrupted at any time, and some or all functions may be operated manually by the one or two operators 195 at the associated workstation(s) 450, 452, 454.

TABLE 4C
Stand Building Operation

| | Operator | | Line of | Equipment | Equipment | |
|---|---|---|---|---|---|---|
| | 195 | Operation | Sight | precondition | Functionality | HMI |
| 1. | Pipe | Load tubular 111 into | Visual/ | FT pre-loaded with | | |
| | Handler | the CW 131: | CCTV | pipe (cleaned and | | |
| | | Verify that CW 131 is | | doped). | | |
| | | empty and in position. | | CWM in loading | | |
| | | Use FT of CW 131 to | | position. | | |
| | | load tubular 111 into | | | | |
| | | CW 131. | | | | |
| 2. | Pipe | Run tubular 111 in CW | Visual/ | Tubular 111 loaded in | Ramp 149 will tilt to | |
| | Handler | 131 to pick-up position: | CCTV | ramp 149. | rig floor 114 tubular | |
| | | Verify tubular 111 is | | | position. | |
| | | loaded in ramp 149. | | | Skate 133 will move | |
| | | Move skate 133 to | | | towards rig floor 114. | |
| | | move tubular 111 | | | Skate 133 will stop | |
| | | toward pick-up | | | with tubular 111 box | |
| | | position. | | | on ramp 149. | |
| 3. | Pipe | Move TDA 202 to pick- | Visual | TDA 202 open. | | |
| | Handler | up position: | | | | |
| | | Tilt TDA 202. | | | | |
| | | Lower and extend | | | | |
| | | TDA 202 to CW 131 | | | | |
| | | pick-up position (above | | | | |
| | | THP 207). | | | | |
| 4. | Pipe | Present tubular 111 for | Visual | Ramp 149 in pick-up | Skate 133 will move | CW 131 |
| | Handler | TDA 202: | | position. | forward a defined | position. |
| | | Run skate 133 until | | TDA 202 in pipe- | distance depending | |
| | | tubular 111 is | | receive position. | on pipe size. | |
| | | positionedf or TDA | | | | |
| | | 202. | | | | |
| 5. | Pipe | Latch TDA 202: | Visual | Tubular 111 is | Tubular interlock | TDA 202 |
| | Handler | Hoist TDA 202 to | | positioned correctly | prevents hoisting | to Closed state. |
| | | latch onto tubular 111. | | for TDA 202. | without closed TDA | |
| | | Close TDA 202. | | | 202 (above preset | |
| | | | | | height). | |
| 6. | Pipe | Lift tubular 111 to | Visual | TDA 202 closed. | Hoisting will stop | LSA 228 guide |
| | Handler | vertical position above | | Verify LSA 228 is | prior to lifting tubular | to Closed state. |
| | | MOH 204: | | positioned to receive | 111 out of CW 131 | LSA 228 |
| | | Verify TDA 202 is | | pipe bottom before | without guiding. | centralizer to |
| | | closed. | | hoisting. | LSA 228 centralizer | Closed state. |
| | | Hoist TDA 202 to pick | | TDA 202 above LSA | closes when tubular | Indicate TDA |
| | | up single tubular joint | | 228 operating area. | 111 nears vertical. | 202/LSA 228 in |
| | | from CW 131. | | | TDA 202 and LSA | MOH 204 |
| | | Move LSA 228 to | | | 228 will position | position. |
| | | preset position to | | | tubular 111 above | |
| | | prepare for guiding. | | | MOH 204/ITC 236. | |
| | | Before the tubular | | | | |
| | | 111 lower end leaves | | | | |
| | | CW 131, close LSA | | | | |
| | | 228 funnel. | | | | |
| | | Dope box when pipe | | | | |
| | | is vertical (If selected). | | | | |
| | | Continue hoisting | | | | |
| | | TDA 202 until tubular | | | | |
| | | 111 is above MOH | | | | |
| | | 204. | | | | |
| 6.1. | Pipe | Skate 133 retract to | Visual/ | | Skate 133 will move | |
| | Handler | loading position: | CCTV | | to loading position. | |
| | | Verify tubular 111 pin | | | Ramp 149 will tilt to | |
| | | end is clear of ramp | | | loading position. | |
| | | 149. | | | | |
| | | Move skate 133 | | | | |
| | | toward FT loading | | | | |
| | | position. | | | | |
| 6.2. | Pipe | CW 131 load and | Visual/ | | See steps 1 and 2. | |
| | Handler | present next tubular | CCTV | | | |
| | | 111: | | | | |
| | | Pick up next tubular | | | | |
| | | 111 per steps 1 and 2. | | | | |
| 7. | Pipe | Stab/position first | Visual | Pipe bottom clear of | TDA 202 is rotated | Indicate LSA |
| | Handler | tubular 111 in MOH | | CW 131. | when the single 111 | 228, ITC 236, |
| | | 204/ITC 236: | | LSA 228 close when | is lowered into the | LTC 244 guide/ |
| | | If THP 207 (pin) | | tubular 111 nears | MOH 204 to permit | grip states. |
| | | doping is selected: | | vertical. | open and retract | Indicated LSA |
| | | Move single 111 to | | | outside WC 203 | 228, ITC 236, |
| | | THP 207. | | | area. | LTC 244 |
| | | Extend and close | | | | positions. |
| | | LSC 228 for guiding. | | | | |
| | | Open and retract | | | | |
| | | LSA 228. | | | | |
| | | Wash and dope | | | | |
| | | pin. | | | | |
| | | TDA 202 move | | | | |
| | | single 111 to ITC | | | | |
| | | 236/MOH 204. | | | | |
| | | LSC 228 guide | | | | |
| | | open and retract. | | | | |
| | | Verify TDA 202/LSA | | | | |
| | | 228 is above MOH | | | | |
| | | 204. | | | | |
| | | Lower single 111 into | | | | |
| | | LSC 228. | | | | |
| | | Open LSA 228 and | | | | |
| | | retract. | | | | |
| | | Close LSC 228 guide | | | | |
| | | when pin end below | | | | |
| | | guide. | | | | |
| | | Continue lowering | | | | |
| | | tubular 111 inside | | | | |
| | | MOH 204 until stick-up | | | | |
| | | of about one meter. | | | | |
| 8. | Pipe | Close ITC 236 on | Visual/ | | | ITC 236 head |
| | Handler | tubular 111: | CCTV | | | extend. |
| | | Verify tubular 111 | | | | ITC 236/LTC |
| | | inside ITC 236/LTC | | | | 244 Closed |
| | | 244. | | | | state. |
| | | Extend ITC 236 head. | | | | |
| | | Close ITC 236 guide | | | | |
| | | and clamps. | | | | |
| | | Open and retract LTC | | | | |
| | | 244 (if doping next | | | | |
| | | pin). | | | | |
| 9. | Pipe | Transfer weight to ITC | Visual/ | ITC 236 closed. | Verify weight | TDA 202 load |
| | Handler | 236 and open TDA | CCTV | | transferred prior to | indicator. |
| | | 202: | | | open TDA 202. | TDA 202 to |
| | | Lower TDA 202 to | | | | Open state. |
| | | transfer tubular 111 | | | | |
| | | weight to ITC 236. | | | | |
| | | Open TDA 202 and | | | | |
| | | retract from stick-up. | | | | |
| | | Move TDA 202 to CW | | | | |
| | | 131 pick-up position. | | | | |
| 10. | Pipe | Present second tubular | Visual | Ramp 149 in tubular | Skate 133 will move | |
| | Handler | 111 above TDA 202: | | 111 pick-up position. | forward a | |
| | | Verify TDA 202 open | | TDA 202 in tubular | predetermined | |
| | | and below tubular 111 | | 111 pick-up position. | distance depending | |
| | | pick-up position. | | | on tubular 111 size | |
| | | Move skate 133 until | | | (see step 4). | |
| | | tubular 111 is | | | | |
| | | positioned above TDA | | | | |
| | | 202 elevator. | | | | |
| 11. | Pipe | Latch TDA 202 on | Visual | Tubular 111 is | Tubular interlock to | TDA 202 to |
| | Handler | second tubular 111: | | positioned correctly | prevent hoisting | Closed state. |
| | | Hoist TDA 202 to | | for TDA 202. | without closed TDA | |
| | | latch onto tubular 111. | | | 202 (above preset | |
| | | Close TDA 202. | | | height). | |
| 12. | Pipe | Lift tubular 111 to | Visual | TDA 202 closed. | Hoisting will stop | Indicate LSA |
| | Handler | vertical above MOH | | Verify LSA 228 is | prior to lifting tubular | 228 guide |
| | | 204: | | positioned to receive | 111 out of CW 131 | position. |
| | | Verify TDA 202 is | | tubular 111 bottom | without guiding. | Indicate TDA |
| | | closed. | | before hoisting. | LSA 228 centralizer | 202/LSA 228 in |
| | | Hoist TDA 202 to | | TDA 202 above LSA | closes when tubular | MOH 204 |
| | | pick-up single 111 from | | 228 operating area. | 111 nears vertical. | position. |
| | | CW 131. | | | TDA 202 and LSA | |
| | | Move LSA 228 to | | | 228 will position | |
| | | preset position to | | | tubular 111 above | |
| | | prepare for guiding. | | | MOH 204/ITC 236. | |
| | | Before the tubular | | | | |
| | | 111 lower end leaves | | | | |
| | | CW 131, close LSA | | | | |
| | | 228 funnel. | | | | |
| | | Dope box when | | | | |
| | | tubular 111 is vertical | | | | |
| | | (if selected). | | | | |
| | | Continue hoisting | | | | |
| | | TDA 202 until tubular | | | | |
| | | 111 is above MOH | | | | |
| | | 204. | | | | |
| 13. | Pipe | CW 131 retract to | Visual/ | | Skate 133 will move | |
| | Handler | loading position: | CCTV | | to loading position. | |
| | | Verify tubular 111 pin | | | Ramp 149 will tilt to | |
| | | end is clear of ramp | | | loading position. | |
| | | 149. | | | | |
| | | Move CW 131 toward | | | | |
| | | FT loading position. | | | | |
| 14. | Pipe | CW 131 load and | Visual/ | | Reference steps 1 | |
| | Handler | present third tubular | CCTV | | and 2. | |
| | | 111 (if needed): | | | | |
| | | Pick up next tubular | | | | |
| | | 111 per steps land 2. | | | | |
| 15. | Pipe | Move RN 151 to MOH | Visual | TDA 202/LSA 228 in | RN 151 (THA) will | |
| | Handler | 204 position: | | move to MOH 204 | MOH 204 and | |
| | | Activate RN 151 | | position. | elevate to | |
| | | sequence. | | | selected stick-up | |
| | | Activate RN 151 | | | height. | |
| | | stabbing guide. | | | | |
| 16. | Pipe | Stab second tubular | Visual | Tubular 111 bottom | | Indicate weight |
| | Handler | 111 in MOH 204 stick- | | clear of CW 131. | | transfer. |
| | | up: | | LSA 228 open, RN | | |
| | | Open and retract LSA | | 151 stabbing guide | | |
| | | 228. | | active. | | |
| | | Lower single 111 into | | | | |
| | | MOH 204 stick-up. | | | | |
| | | Continue lowering | | | | |
| | | (e.g., at least about 0.2 | | | | |
| | | meters to permit spin- | | | | |
| | | in). | | | | |
| 17. | Pipe | RN 151 spin-in and | Visual/ | Single 111 stabbed in | RN 151 will | Torque log |
| | Handler | make-up: | CCTV | stick-up (TDA 202 | automatically spin-in | updated. |
| | | Verify pin is stabbed | | unloaded, elevator | and make-up to | |
| | | in the box. | | below TJ). | preset torque. | |
| | | Activate RN 151 | | | Open RN 151 | |
| | | sequence to continue | | | spinner, guide, and | |
| | | make-up sequence. | | | clamps. | |
| | | | | | Return RN 151 to | |
| | | | | | park position. | |
| 18. | Pipe | Lower double 111 into | Visual/ | RN 151 has | | TDA 202/LSA |
| | Handler | MOH 204 (if needed): | CCTV | completed MU | | 228 Closed/ |
| | | Verify connection is | | sequence with correct | | Open status. |
| | | made-up. | | torque. | | TDA 202 load. |
| | | Hoist TDA 202 to pick | | | | LTC 244/ITC |
| | | up weight. | | | | 236 status. |
| | | Open ITC 236 guide | | | | |
| | | and clamps. | | | | |
| | | Lower double 111 to | | | | |
| | | correct stick-up. | | | | |
| | | LTC 244 in position | | | | |
| | | for guiding if doping not | | | | |
| | | selected (else, LTC | | | | |
| | | 244 retracted). | | | | |
| | | Stop at selected stick- | | | | |
| | | up (e.g., about one | | | | |
| | | meter). | | | | |
| | | Close ITC 236 guide | | | | |
| | | and clamps. | | | | |
| | | Lower TDA 202 to | | | | |
| | | transfer tubular 111 | | | | |
| | | weight to ITC 236. | | | | |
| | | Open TDA 202 and | | | | |
| | | retract from stick-up. | | | | |
| 19. | Pipe | Repeat steps 10-17 for | | | | |
| | Handler | third single 111 (if | | | | |
| | | needed) | | | | |
| 20. | Pipe | Move stand 111 to | Visual/ | RN 151 has | | Weight |
| | Handler | THP 207: | CCTV | completed MU | | transfer. |
| | | LTC 244 extends to | | sequence with correct | | ITC 236 |
| | | stand 111 in MOH 204 | | torque. | | Retracted. |
| | | position and closes | | Complete stand 111 | | LTC 244 |
| | | guide. | | in MOH 204. | | Extended. |
| | | Hoist TDA 202 to pick | | | | LTC 244 |
| | | up stand 111 weight. | | | | Closed. |
| | | Open ITC 236 guide | | | | ITC 236 Open. |
| | | and clamps. | | | | UTC 242 |
| | | ITC 236 head | | | | Extended. |
| | | retracted. | | | | UTC 242 |
| | | TDA 202 will lift stand | | | | Closed. |
| | | 111 from MOH 204 | | | | TDA 202 |
| | | until pin end above | | | | Open. |
| | | THP doper 209. | | | | |
| | | TDA 202 and LTC | | | | |
| | | 244 move stand 111 | | | | |
| | | above THP 207. | | | | |
| | | Stab stand 111 in | | | | |
| | | THP 207 and initiate | | | | |
| | | wash and dope, if | | | | |
| | | selected. | | | | |
| | | UTC 242 extends to | | | | |
| | | stand 111 and closes | | | | |
| | | guide. | | | | |
| | | TDA 202 opens and | | | | |
| | | retracts from stand | | | | |
| | | 111. | | | | |
| 21. | Pipe | Set back stand 111: | Visual/ | UTC 242 and LTC | | TBR 254/SGA |
| | Handler | TBR 254 and SGA | CCTV | 244 closed on stand | | 262 status. |
| | | 262 move to THP 207 | | 111 in THP 207. | | TBR 254 load. |
| | | and close guide and | | TDA 202 retracted | | |
| | | clamps on stand 111. | | from stand 111 in | | |
| | | UTC 242 and LTC | | THP 207. | | |
| | | 244 open and retract. | | | | |
| | | TBR 254 and SGA | | | | |
| | | 262 set back stand 111 | | | | |
| | | to selected position in | | | | |
| | | FIB 166. | | | | |

To lay down stands (offline), an operator 195 on the rig floor 114 may verify that various pieces of equipment are properly shut down and locked out, and then perhaps perform other preparations such as the examples set forth above in Table 4A. The well construction system 100, 200 can then be set-up for performing the lay-down operation. Examples of such set-up may be as set forth below in Table 5A.

TABLE 5A
Stand Lay-Down Set-Up

| Equipment | Responsible | Set-Up | HMI |
|---|---|---|---|
| Pipe | Pipe | Verify operator 195 on rig floor 114 | Verify Setback |
| handling: | Handler | completed pre-checks and deactivated | screen. |
| TBR 254, | | emergency stop for all pipe handling | Construction |
| SGA 262, | | equipment. | Program setup |
| UTC 242, | | Open Construction Program screen on | wizard. |
| LTC 244, | | touchscreen 522, 524. | After startup: Check |
| ITC 236, | | Select Stand Building mode. | for green light in |
| THP 207, | | Select setup wizard to open pop-up on front | Construction |
| TDA 202, | | screen 532, 534, 536. Verify settings: | Program status |
| LSA 228, | | Select slot, direction for racking stands | header on front |
| RN 151, | | 111. | screen 532, 534, |
| CW 131 | | Select Pipe size/type. | 536. |
| | | Select RN 151 (with THA) to use in the | |
| | | operations. | |
| | | Select pin/box doping. | |
| | | Stick-up target. | |
| | | Select “activate all machines” to startup and | |
| | | prepare all machines. | |
| All | Pipe | Verify all relevant machines are enabled in | |
| machines | Handler | zone management system and tubular | |
| | | interlock system. | |
| Tubulars | Pipe | Electronic tally system to be updated. | |
| 111 | Handler | | |

After such preparations and set-up, the operator 195 may vacate the rig floor 114, and the equipment may be configured to be ready for remote control (e.g., by deactivating emergency stops). An example stand lay-down sequence may start with all machines empty, the ITC 236 retracted, and the CW 131 FT empty and ready to receive single tubulars 111. Example steps of the stand lay-down sequence may be as set forth below in Table 5B.

TABLE 5B
Stand Lay-Down Operation

| | | | |
|---|---|---|---|
| Operator | Line of | Equipment | Equipment |

| | 195 | Operation | Sight | precondition | Functionality | HMI |
|---|---|---|---|---|---|---|
| 1. | Pipe | TBR 254 and SGA 262 | Visual/ | TBR 254 and SGA | TBR 254 will move | TBR 254 and |
| | Handler | pick up new stand 111: | CCTV | 262 grip/guide open. | into FIB 166 elevated | SGA 262 grip/ |
| | | Move TBR 254 and | | Selected FIB 166 | above open latches. | guide to Closed |
| | | SGA 262 to selected | | position “valid.” | Adjustments available, | state. |
| | | finger/slot in FIB 166. | | | TBR 254 and SGA | |
| | | Close guides and | | | 262 grip/guide will | |
| | | clamp on stand 111. | | | close. | |
| 2. | Pipe | TBR 254 and SGA 262 | Visual/ | THP 207 empty. | TBR 254 cannot | Indicate open |
| | Handler | move stand 111 to THP | CCTV | UTC 242 and LTC | open with weight. | latches. |
| | | 207: | | 244 open. | TBR 254 grip open | TBR 254 load |
| | | Open FIB 166 latches | | Correct pipe | when unloaded, | indication. |
| | | for selected row. | | detected in TBR 254 | FIB 166 latches will | |
| | | Verify latches open | | and SGA 262. | not open with TBR | |
| | | (Visual/CCTV). | | | 254 head in low | |
| | | TBR 254 lift stand | | | position. | |
| | | 111 and move out of | | | | |
| | | FIB 166 to THP 207. | | | | |
| | | FIB 166 latches will | | | | |
| | | close as the stand 111 | | | | |
| | | moves out of FIB 166. | | | | |
| | | Set stand 111 on | | | | |
| | | THP 207. | | | | |
| | | Wash and dope pin if | | | | |
| | | preselected. | | | | |
| 3. | Pipe | UTC 242 and LTC 244 | Visual/ | TBR 254 and SGA | UTC 242 and LTC | UTC 242 and |
| | Handler | extend to THP 207 and | CCTV | 262 with stand 111 in | 244 extend and | LTC 244 to |
| | | close: | | THP 207. | close. | Closed state. |
| | | UTC 242 and LTC | | | | |
| | | 244 extend to THP | | | | |
| | | 207. | | | | |
| | | UTC 242 and LTC | | | | |
| | | 244 close. | | | | |
| 4. | Pipe | TBR 254 and SGA 262 | | UTC 242 and LTC | | |
| | Handler | open and move toward | | 244 closed on stand | | |
| | | FIB 166: | | 111. | | |
| | | Open TBR 254 | | | | |
| | | clamps and guide and | | | | |
| | | SGA 262 guide. | | | | |
| | | Move toward FIB 166 | | | | |
| | | (next stand 111). | | | | |
| | | Continue step 1. | | | | |
| 5. | Pipe | TDA 202 extend to | Visual/ | TDA 202 must be | TDA 202 tilt/extend | |
| | Handler | stand 111 in THP 207: | CCTV | open. | until contact with | |
| | | Tilt/extend TDA 202 | | | stand 111 in THP | |
| | | until contact with stand | | | 207. | |
| | | 111 in THP 207, below | | | | |
| | | TJ. Note: LSA 228 | | | | |
| | | used for guiding pin | | | | |
| | | end. | | | | |
| 6. | Pipe | TDA 202 latch onto | Visual/ | TDA 202 must be in | The closing sequence | Confirm TDA |
| | Handler | stand 111 in THP 207: | CCTV | THP 207 position. | is verified to assure | 202 closed on |
| | | Close TDA 202. | | | proper grip. | tubular 111. |
| 7. | Pipe | UTC 242 open and | Visual/ | TDA 202 must be | UTC 242 open and | UTC 242 to |
| | Handler | retract: | CCTV | closed. | retract. | Open state. |
| | | UTC 242 opens. | | | | LSA 228 to |
| | | UTC 242 retracts. | | | | Guide mode. |
| | | LSA 228 to guide | | | | |
| | | mode. | | | | |
| 8. | Pipe | TDA 202 and LSA 228 | Visual/ | UTC 242 open. | TDA 202 hoist, tilt to | TDA 202 Load |
| | Handler | move stand 111 to MOH | CCTV | | vertical. | indication. |
| | | 204: | | | TDA 202 dope top | |
| | | TDA 202 lift stand | | | box if preselected | |
| | | 111 guided by the LSA | | | (automatic). | |
| | | 228 to MOH 204. | | | | |
| 9. | Pipe | Lower stand 111 in | Visual/ | LSA 228 guide mode. | | Indicate ITC |
| | Handler | MOH 204/ITC 236: | CCTV | | | 236 and LSA |
| | | Verify LSA 228 is | | | | 228 position |
| | | guiding above MOH | | | | and guide/grip |
| | | 204. | | | | states. |
| | | TDA 202 lowers | | | | |
| | | stand 111 into MOH | | | | |
| | | 204. | | | | |
| | | Stop with one single | | | | |
| | | 111 above rig floor 114 | | | | |
| | | and stick-up of about | | | | |
| | | one meter. | | | | |
| 10. | Pipe | Close ITC 236 on | Visual/ | | | ITC 236 |
| | Handler | stand 111: | CCTV | | | Extended. |
| | | Verify stand 111 | | | | ITC 236 in |
| | | inside ITC 236. | | | | Closed state. |
| | | Extend ITC 236. | | | | |
| | | Close ITC 236. | | | | |
| 11. | Pipe | Transfer stand 111 | Visual/ | ITC 236 closed. | | TDA 202 load |
| | Handler | weight to ITC 236: | CCTV | | | indicator. |
| | | Lower TDA 202 to | | | | TDA 202 to |
| | | transfer stand 111 | | | | Open state. |
| | | weight to ITC 236. | | | | |
| 12. | Pipe | Open and retract LTC | Visual/ | | | LTC 244 in |
| | Handler | 244: | CCTV | | | Open and |
| | | Open and retract LTC | | | | Retracted state. |
| | | 244 to THP 207. | | | | |
| 13. | Pipe | Move second RN 151 | Visual | ITC 236 closed. | Second RN 151 | |
| | Handler | to MOH 204 (stand): | | | (with THA) will | |
| | | Verify TDA 202 | | | move to MOH 204 | |
| | | unloaded in MOH 204. | | | and elevate to | |
| | | Move second RN 151 | | | selected stick-up | |
| | | to MOH 204. | | | height. | |
| 14. | Pipe | Move LSA 228 to MOH | Visual | ITC 236 closed. | | |
| | Handler | 204 (stand): | | | | |
| | | Move LSA 228 to | | | | |
| | | MOH 204. | | | | |
| | | Close LSA 228 guide | | | | |
| | | funnel. | | | | |
| 15. | Pipe | Tilt CW 131 ramp 149 | Visual/ | Tubular 111 loaded | | |
| | Handler | and move skate 133 to | CCTV | onto ramp 149. | | |
| | | rig floor 114 lay-down | | | | |
| | | position: | | | | |
| | | Verify tubular 111 is | | | | |
| | | unloaded from ramp | | | | |
| | | 149 (CW 131 ready). | | | | |
| | | Activate CW 131 | | | | |
| | | sequence. | | | | |
| 16. | Driller | RN 151 break-out and | Visual/ | ITC 236 closed (TDA | RN 151 will | |
| | | spin-out (upper single | CCTV | 202 unloaded, gripper | automatically break- | |
| | | 111): | | below TJ). | out and spin-out the | |
| | | Verify ITC 236 is | | | upper single 111. | |
| | | closed and TDA 202 | | | Open RN 151 | |
| | | unloaded, | | | spinner, guide, and | |
| | | Activate RN 151 | | | clamps. | |
| | | sequence to continue | | | Return RN 151 to | |
| | | break-out sequence. | | | park position. | |
| 17. | Pipe | TDA 202 and LSA 228 | Visual/ | RN 151 has | | |
| | Handler | move upper single 111 | CCTV | completed break-out | | |
| | | from MOH 204 to CW | | sequence. | | |
| | | 131: | | CW 131 in lay-down | | |
| | | Verify connection is | | position. | | |
| | | spun-out. | | | | |
| | | Hoist TDA 202 to lift | | | | |
| | | upper tubular 111 from | | | | |
| | | stick-up and above | | | | |
| | | CW 131, guided by | | | | |
| | | LSA 228. | | | | |
| | | Rotate TDA 202 to | | | | |
| | | face CW 131. | | | | |
| | | Tilt TDA 202 toward | | | | |
| | | CW 131. | | | | |
| 18. | Pipe | LSA 228 guide upper | Visual/ | CW 131 in lay-down | | LSA 228 |
| | Handler | tubular 111 pin to CW | CCTV | position. | | position. |
| | | 131: | | | | |
| | | Verify pin is above | | | | |
| | | CW 131. | | | | |
| | | Guide pin above | | | | |
| | | skate 133. | | | | |
| 19. | Pipe | Lay down upper single | Visual/ | CW 131 in lay-down | | |
| | Handler | 111 on CW131: | CCTV | position. | | |
| | | Verify TDA 202 is | | | | |
| | | rotated and tilted | | | | |
| | | toward CW 131. | | | | |
| | | Lower TDA 202 and | | | | |
| | | set upper tubular 111 | | | | |
| | | pin on skate 133. | | | | |
| | | Continue lowering | | | | |
| | | until upper tubular 111 | | | | |
| | | rests on CW 131. | | | | |
| 20. | Pipe | Open and retract LSA | Visual/ | | | LSA 228 to |
| | Handler | (upper single 111): | CCTV | | | Open state. |
| | | Verify pin rests on | | | | |
| | | CW 131. | | | | |
| | | Open and retract LSA | | | | |
| | | 228. | | | | |
| 21. | Pipe | Lay down upper single | Visual/ | | Skate 133 will move | |
| | Handler | 111 on CW 131 and | CCTV | | out synchronized | |
| | | open TDA 202: | | | with TDA 202. | |
| | | Verify TDA 202 is | | | | |
| | | tilted toward CW 131 | | | | |
| | | and LSA 228 is out of | | | | |
| | | TDA 202 area. | | | | |
| | | Lower TDA 202 until | | | | |
| | | upper single 111 rests | | | | |
| | | on ramp 149. | | | | |
| 22. | Pipe | Open TDA 202: | Visual | | | TDA 202 to |
| | Handler | Verify upper single | | | | Open state. |
| | | 111 is resting on CW | | | | |
| | | 131. | | | | |
| | | Open TDA 202. | | | | |
| | | Tilt TDA 202 to | | | | |
| | | vertical above MOH | | | | |
| | | 204 stick-up. | | | | |
| | | Rotate TDA 202 | | | | |
| | | (e.g., 90 degrees). | | | | |
| 23. | Pipe | Move upper tubular | Visual/ | TDA 202 open. | Skate 133 will pull | Skate 133 to |
| | Handler | 111 to FT and unload: | CCTV | | upper tubular 111 to | unloading |
| | | Activate CW 131 | | | unloading position. | position. |
| | | sequence to move out | | | Ramp 149 will tilt to | CW 131 to |
| | | and unload upper | | | unloading position. | unloading |
| | | tubular 111. | | | FT will unload upper | position. |
| | | | | | tubular 111. | FT unloading |
| | | | | | | active. |

Second Single 111 of Stand:

| | | | | | | |
|---|---|---|---|---|---|---|
| 24. | Pipe | Lower TDA 202 to | Visual | | | TDA 202 to |
| | Handler | stick-up and close: | | | | Closed state. |
| | | Lower TDA 202 to | | | | |
| | | stick-up. | | | | |
| | | Close TDA 202 on | | | | |
| | | stick-up. | | | | |
| 25. | Pipe | Hoist double in MOH | Visual/ | | | TDA 202/LSA |
| | Handler | 204 (not applicable for | CCTV | | | 228 close/open |
| | | tripe stands): | | | | status. |
| | | Hoist TDA 202 to pick | | | | TDA 202 load. |
| | | up weight. | | | | LTC 244/ITC |
| | | Open ITC 236 guide | | | | 236 status. |
| | | and clamps. | | | | |
| | | Stop at selected | | | | |
| | | stick-up (e.g., about | | | | |
| | | one meter). | | | | |
| | | Close ITC 236 guide | | | | |
| | | and clamps. | | | | |
| | | Lower TDA 202 to | | | | |
| | | transfer weight to ITC | | | | |
| | | 236. | | | | |
| 26. | Driller | Move second RN 151 | Visual | ITC 236 closed. | Second RN 151 (with | |
| | | to MOH 204: | | | THA) will move to | |
| | | Verify TDA 202 | | | MOH 204 and elevate | |
| | | unloaded in MOH 204. | | | to selected stick-up | |
| | | Move second RN2 to | | | height. | |
| | | MOH 204. | | | | |
| 27. | Pipe | Move LSA 228 to MOH | Visual | ITC 236 closed. | | |
| | Handler | 204: | | | | |
| | | Move LSA 228 to | | | | |
| | | MOH 204. | | | | |
| | | Close LSA 228 guide | | | | |
| | | funnel. | | | | |
| 28. | Pipe | Tilt ramp 149 and | Visual/ | Tubular 111 loaded | Skate 133 will move | CW 131 lay- |
| | Handler | move skate 133 to lay- | CCTV | onto ramp 149. | to lay-down position. | down ready. |
| | | down position: | | | | |
| | | Verify tubular 111 is | | | | |
| | | unloaded from ramp | | | | |
| | | 149 (CW 131 ready). | | | | |
| | | Activate CW 131 | | | | |
| | | sequence. | | | | |
| 29. | Driller | RN 151 break-out and | Visual/ | ITC 236 closed (TDA | RN 151 will | |
| | | spin-out: | CCTV | 202 unloaded, gripper | automatically break- | |
| | | Verify ITC 236 is | | below TJ). | out and spin-out the | |
| | | closed and TDA 202 is | | | single 111. | |
| | | unloaded. | | | Open RN 151 | |
| | | Activate RN 151 | | | spinner, guide, and | |
| | | sequence to continue | | | clamps. | |
| | | break-out sequence. | | | Return RN 151 to | |
| | | | | | park position. | |
| 30. | Pipe | TDA 202 and LSA 228 | Visual/ | RN 151 has | | |
| | Handler | move pipe from MOH | CCTV | completed break-out | | |
| | | 204 to CW 131: | | sequence. | | |
| | | Verify connection is | | CW 131 in lay-down | | |
| | | spun-out. | | position. | | |
| | | Hoist TDA 202 to lift | | | | |
| | | tubular 111 from stick- | | | | |
| | | up and above CW 131 | | | | |
| | | (guided by LSA 228). | | | | |
| | | Rotate TDA 202 to | | | | |
| | | face CW 131. | | | | |
| | | Tilt TDA 202 toward | | | | |
| | | CW 131. | | | | |
| 31. | Pipe | LSA 228 will guide pin | Visual/ | CW 131 in lay-down | | LSA 228 |
| | Handler | to CW 131: | CCTV | position. | | position. |
| | | Verify pin end is | | | | |
| | | above CW 131. | | | | |
| | | Guide pin to above | | | | |
| | | skate 133. | | | | |
| 32. | Pipe | Lay down pipe on CW | Visual/ | CW 131 in lay-down | | |
| | Handler | 131: | CCTV | position. | | |
| | | Verify TDA 202 is | | | | |
| | | rotated and tilted | | | | |
| | | toward CW 131. | | | | |
| | | Lower TDA 202 and | | | | |
| | | set pin on skate 133. | | | | |
| | | Continue lowering | | | | |
| | | until pipe rests on CW | | | | |
| | | 131. | | | | |
| 33. | Pipe | Open and retract LSA | Visual/ | | | LSA 228 to |
| | Handler | 228: | CCTV | | | Open state. |
| | | Verify pin is resting | | | | |
| | | on CW 131. | | | | |
| | | Open and retract LSA | | | | |
| | | 228. | | | | |
| 34. | Pipe | Move pipe to FT and | Visual/ | TDA 202 open. | Skate 133 will pull | Skate 133 to |
| | Handler | unload: | CCTV | | the pipe to unloading | unloading |
| | | Activate CW 131 | | | position. | position. |
| | | sequence to move out | | | Ramp 149 will tilt to | CW 131 to |
| | | and unload the pipe. | | | unloading position. | unloading |
| | | | | | FT will unload the | position. |
| | | | | | pipe. | FT unloading |
| | | | | | | active. |

Third Single 111 of Stand (If Applicable):

| | | | | | | |
|---|---|---|---|---|---|---|
| 35. | Pipe | Lower TDA 202 to | Visual | | | TDA to Closed |
| | Handler | stick-up and close: | | | | state. |
| | | Lower TDA 202 to | | | | |
| | | stick-up. | | | | |
| | | Close TDA 202 on | | | | |
| | | stick-up. | | | | |
| 36. | Pipe | Hoist single 111 from | Visual/ | | | TDA 202/LSA |
| | Handler | MOH 204: | CCTV | | | 228 close/open |
| | | Hoist TDA 202 to pick | | | | status. |
| | | up weight. | | | | TDA 202 load. |
| | | Open ITC 236 guide | | | | LTC 244 and |
| | | and clamps. | | | | ITC 236 status. |
| | | Retract ITC 236 | | | | |
| | | (Note: pipe not | | | | |
| | | guided). | | | | |
| 37. | Pipe | Move LSA 228 to MOH | Visual | ITC 236 closed. | | |
| | Handler | 204: | | | | |
| | | Verify TDA 202 | | | | |
| | | above LSA 228 | | | | |
| | | working height. | | | | |
| | | Move LSA 228 to | | | | |
| | | MOH 204. | | | | |
| | | Close LSA 228 guide | | | | |
| | | funnel. | | | | |
| 38. | Pipe | Tilt ramp 149 and | Visual/ | Tubular 111 loaded | Skate 133 will move | CW 131 lay- |
| | Handler | move skate 133 to lay- | CCTV | onto ramp 149. | to lay-down position. | down ready. |
| | | down position: | | | | |
| | | Verify tubular 111 is | | | | |
| | | unloaded from ramp | | | | |
| | | 149 (CW 131 ready). | | | | |
| | | Activate CW 131 | | | | |
| | | sequence. | | | | |
| 39. | Pipe | TDA 202 and LSA 228 | Visual/ | CW 131 in lay-down | | |
| | Handler | move pipe from MOH | CCTV | position. | | |
| | | 204 to CW 131: | | | | |
| | | Verify ITC 236 is | | | | |
| | | open. | | | | |
| | | Hoist TDA 202 to lift | | | | |
| | | tubular 111 above CW | | | | |
| | | 131 (guided by LSA | | | | |
| | | 228). | | | | |
| | | Rotate TDA 202 to | | | | |
| | | face CW 131. | | | | |
| | | Tilt TDA 202 toward | | | | |
| | | CW 131. | | | | |
| 40. | Pipe | LSA228 will guide pin | Visual/ | CW 131 in lay-down | | LSA 228 |
| | Handler | to CW 131: | CCTV | position. | | position. |
| | | Verify pin end is | | | | |
| | | above CW 131. | | | | |
| | | Guide pin end to | | | | |
| | | above skate 133. | | | | |
| 41. | Pipe | Lay down tubular 111 | Visual/ | CW 131 in lay-down | | |
| | Handler | on CW 131: | CCTV | position. | | |
| | | Verify TDA 202 is | | | | |
| | | rotated and tilted | | | | |
| | | toward CW 131. | | | | |
| | | Lower TDA 202 and | | | | |
| | | set pin on skate 133. | | | | |
| | | Continue lowering | | | | |
| | | until tubular 111 rests | | | | |
| | | on CW 131. | | | | |
| 42. | Pipe | Open and retract LSA | Visual/ | | | LSA 228 to |
| | Handler | 228: | CCTV | | | Open state. |
| | | Verify pin is resting | | | | |
| | | on CW 131. | | | | |
| | | Open and retract LSA | | | | |
| | | 228. | | | | |
| 43. | Pipe | Move tubular 111 to FT | Visual/ | TDA 202 open. | Skate 133 will pull | Skate 133 to |
| | Handler | and unload: | CCTV | | tubular 111 to | unloading |
| | | Activate CW 131 | | | unloading position. | position. |
| | | sequence to move out | | | Ramp 149 will tilt to | CW 131 to |
| | | and unload tubular | | | unloading position. | unloading |
| | | 111. | | | FT will unload the | position. |
| | | Continue step 1. | | | tubular 111. | FT unloading |
| | | | | | | active. |

Different combinations of the aspects described above may also be utilized for picking up single tubulars 111 before assembly into stands of two or more tubulars. Such operations may be performed during drilling and other operations performed at WC 203. Such simultaneous operations, however, are coordinated to avoid conflicts and obstructions between the different machines and systems. Preparations for picking up single tubulars 111 may include the examples set forth below in Table 6A.

TABLE 6A
Singles Pick-Up Preparations

| Equipment | Responsible | Verifications |
|---|---|---|
| CW 131 | Operator 195 on | Travel path is unobstructed. |
| | rig floor 114. | Feeding table (FT) indexer pins adjusted for pipe size. |
| | | Prepare to pick up pipe. |
| RN 151 | Operator 195 on | DPT is rigged up in THT. |
| (THT + DPT | rig floor 114. | Travel path is unobstructed. |
| as primary, | | Dies are clean and not worn. |
| THA + DPT | | |
| as backup) | | |
| LSA 228 | Operator 195 on | Travel path is unobstructed. |
| | rig floor 114. | |
| Slips 161 | Operator 195 on | Correct inserts in slips 161. |
| Rotary | rig floor 114. | Dies are clean and not worn. |
| Table | | Rotary table rotation lock activated. |
| TD 116 | Operator 195 on | Correct inserts in elevator 129. |
| | rig floor 114. | Elevator rotator (tilt) installed. |
| | | Operator screen, system status. |
| | | Travel path is unobstructed. |
| DW 119 | Operator 195 on | Checked. |
| | rig floor 114. | |
| Tubulars | Operator 195 on | Tubular 111 to be loaded on FT. |
| 111 | rig floor 114. | Tubulars 111 to be cleaned and doped, protectors |
| | | removed. |

The well construction system 100, 200 can then be set-up for the pick-up operation. Examples of such set-up may be as set forth below in Table 6B.

TABLE 6B
Singles Pick-Up Set-Up

| Equipment | Responsible | Set-Up | HMI |
|---|---|---|---|
| Pipe | Pipe | Verify operator 195 on rig floor 114 | Verify Setback |
| handling: | Handler | completed pre-checks and deactivated | screen. |
| LSA 228, | | emergency stop for all pipe handling | Construction |
| RN 151, | | equipment. | Program setup |
| CW 131 | | Open Construction Program screen on | wizard. |
| | | touchscreen 522, 524. | After startup: Check |
| | | Select Trip In mode. | for green light in |
| | | Select target: CW 131 | Construction |
| | | Select setup wizard to open pop-up on front | Program status |
| | | screen 532, 534, 536. Verify settings: | header on front |
| | | Select pipe size/type. | screen 532, 534, |
| | | Select RN 151 to use in the operations. | 536. |
| | | RN 151 MU torque. | |
| | | Stick-up target. | |
| | | Select “activate all machines” to startup and | |
| | | prepare all machines. | |
| TD 116, | Driller | Verify operator 195 on rig floor 114 | Verify Setback |
| DW 119, | | completed pre-checks and deactivated | screen. |
| MP 144, | | emergency stop for all pipe handling | Construction |
| Trip tank | | equipment. | Program setup |
| | | Open Construction Program screen on | wizard. |
| | | touchscreen 522, 524. | After startup: Check |
| | | Select Trip In mode. | for green light in |
| | | Select setup wizard to open pop-up on front | Construction |
| | | screen 532, 534, 536. Verify settings: | Program status |
| | | Stick-up target. | header on front |
| | | Set DW 119 upper/lower stops. | screen 532, 534, |
| | | Set maximum lowering speed. | 536. |
| | | Set minimum slack off weight. | |
| | | Trip tank 1/2/auto. | |
| | | Trip tank low/high levels. | |
| | | Select “activate all machines” to startup and | |
| | | prepare all machines. | |
| TD 116 | Driller | Verify operator 195 on rig floor 114 | Verify operator |
| | | completed pre-checks. | screen, system |
| | | Activate TD 116 from touchscreen 522, | status/alarms. |
| | | 524. | |
| | | Verify correct elevator 129 setting | |
| | | (manual/remote). | |
| | | Select Operation screen on touchscreen 522, | |
| | | 524. | |
| DW 119 | Driller | Activate DW 119 from touchscreen 522, | Verify operator |
| | | 524. | screen, system |
| | | Set maximum lowering speed. | status/alarms. |
| | | Set minimum slack off weight. | |
| Slips 161, | Driller | Verify correct setting for slips 161 | Verify operator |
| Rotary | | (manual/remote). | screen, system |
| table | | | status/alarms. |
| All | Driller | Verify all relevant machines are enabled in | |
| machines | | zone management system and tubular | |
| | | interlock system. | |
| Tubulars | Pipe | All types of tubulars 111 are registered. | |
| 111 | Handler | | |

After such preparations and set-up, the operator 195 may vacate the rig floor 114, and the equipment may be configured to be ready for remote control (e.g., by deactivating emergency stops). An example singles pick-up sequence may start with a stick-up at WC 203, and the CW 131 FT pre-loaded with a tubular 111, perhaps cleaned and doped. Example steps of the stand building sequence may be as set forth below in Table 6C.

TABLE 6C
Singles Pick-Up Operation

| | Operator | | Line of | Equipment | Equipment | |
|---|---|---|---|---|---|---|
| | 195 | Operation | Sight | precondition | Functionality | HMI |
| 1. | Pipe | Load tubular 111 to | Visual/ | FT pre-loaded with | | |
| | Handler | ramp 149: | CCTV | tubular 111 (e.g., | | |
| | | Use FT to load | | cleaned and doped). | | |
| | | tubular to ramp 149. | | CW 131 in loading | | |
| | | | | position. | | |
| 1.1. | Pipe | Move ramp 149 to rig | Visual/ | Tubular 111 loaded to | | CW 131 |
| | Handler | floor 114/WC 203: | CCTV | ramp 149. | | animated. |
| | | Verify tubular 111 is | | | | |
| | | loaded in ramp 149 | | | | |
| | | and run skate 133 | | | | |
| | | towards WC 203. | | | | |
| 2. | Driller | Open TD 116 elevator | Visual/ | Slips 161 must be | Elevator 129 Open not | Elevator 129 to |
| | | 129: | CCTV | closed before opening | selectable if slips 161 | Open state. |
| | | Verify slips 161 are | | elevator 129. | are not closed. | |
| | | closed. | | | | |
| | | Open elevator 129. | | | | |
| 3. | Driller | Move TD 116 to pick- | Visual | Elevator 129 is open. | TD 116 pipe handler | |
| | | up position: | | Elevator 129 is | has pre-set position | |
| | | Tilt links back to clear | | rotated to receive | facing CW 131. | |
| | | TJ. | | tubular 111. | | |
| | | Hoist elevator 129 | | | | |
| | | above stick-up. | | | | |
| | | Tilt out elevator 129 | | | | |
| | | and move TD 116 to | | | | |
| | | pick-up position. | | | | |
| 3.1. | Pipe | Push tubular 111 to | Visual | Ramp 149 in rig floor | CW 131 will push | CW 131 in pick- |
| | Handler | pick-up position: | | 114 position. | tubular 111 a preset | up position. |
| | | Run skate 133 until | | | distance forward (up | |
| | | tubular 111 is | | | ramp 149). | |
| | | positioned above | | | | |
| | | elevator 129. | | | | |
| 4. | Driller | Latch elevator 129: | Visual | Tubular 111 is | Tubular interlock will | Elevator 129 to |
| | | Hoist/tilt TD 116 to | | positioned correctly | prevent hoisting | Closed state. |
| | | latch elevator 129. | | above elevator 129. | without closed | |
| | | | | | elevator 129 (above | |
| | | | | | preset height). | |
| 5. | Driller | Lift tubular 111: | Visual | Elevator 129 closed. | Hoisting will stop prior | |
| | | Hoist TD 116 to pick | | Link tilt float: | to lifting tubular 111 | |
| | | up single 111 from CW | | elevator 129 above | out of CW 131 without | |
| | | 131. | | RN 151 working area. | guiding. | |
| | | Activate TD 116 to | | | | |
| | | move elevator 129 to | | | | |
| | | vertical position. | | | | |
| 5.1. | Pipe | LSA 228 extend to | Visual/ | TD 116 above LSA | | LSA 228 funnel |
| | Handler | guide tubular 111 | CCTV | 228 operating area. | | to Closed state. |
| | | above CW 131: | | | | |
| | | Move LSA 228 to | | | | |
| | | preset position to | | | | |
| | | receive tubular 111 | | | | |
| | | above CW 131. | | | | |
| | | Before tubular 111 | | | | |
| | | lower end leaves CW | | | | |
| | | 131, close LSA 228 | | | | |
| | | funnel. | | | | |
| 5.2. | Pipe | Move RN 151 to WC | | Only possible with | RN 151 will move to | |
| | Handler | 203: | | THT. If THA is used, | WC 203. | |
| | | Verify TD 116 above | | wait for stand located | Elevate RN 151 to | |
| | | RN 151 working area. | | above stick-up. | stick-up. | |
| | | Start RN 151 | | RN 151 clamps open. | ZMS will prevent RN | |
| | | sequence to move RN | | WC 203 selected. | 151 start if TD 116 is | |
| | | 151 to WC 203. | | | too low. | |
| 5.3. | Pipe | LSA 228 tail in tubular | Visual | Tubular 111 bottom | LSA 228 centralizer | LSA 228 |
| | Handler | 111 to WC 203: | | clear of CW 131 and | will close when | centralizer to |
| | | TD 116 continue | | elevated above stick- | tubular 111 nears | Closed state. |
| | | hoisting. | | up. | WC 203. | |
| | | LSA 228 guide closes | | LSA 228 centralizer | | |
| | | and tails in tubular 111 | | close: Tubular 111 | | |
| | | toward WC 203 when | | near vertical. | | |
| | | pin end is above stick- | | | | |
| | | up. | | | | |
| 5.4. | Pipe | Guide single 111 with | Visual/ | RN 151 in WC 203. | Close RN 151 BUT. | |
| | Handler | RN 111 in WC 203: | CCTV | LSA 228 in WC 203. | Close RN 151 | |
| | | Verify single 111 is | | | stabbing guide. | |
| | | located in WC 203. | | | | |
| | | Continue RN 151 | | | | |
| | | sequence. | | | | |
| 6. | Driller | Stab tubular 111: | Visual/ | TD 116 link tilt float. | | |
| | | Lower TD 116 to stab | CCTV | RN 151 in WC 203 | | |
| | | tubular 111. | | with stabbing guide | | |
| | | | | closed. | | |
| 6.1. | Pipe | Open and retract LSA | Visual/ | RN 151 stabbing | | LSA 228 to |
| | Handler | 228. | CCTV | guide closed. | | Open status. |
| 6.2. | Pipe | RN 151 spin-in and | Visual/ | Single 111 stabbed | RN 151 will | Tally update. |
| | Handler | make-up: | CCTV | in stick-up. | automatically spin-in | Torque log |
| | | Continue RN 151 | | TD 116 unloaded, | and make-up. | updated. |
| | | sequence. | | elevator 129 below TJ | Open RN 151 | MU torque |
| | | | | to permit spinning. | spinner, guide, and | presented to |
| | | | | | clamps. | Driller. |
| | | | | | Return RN 151 to | |
| | | | | | park position. | |
| 7. | Driller | Opening slips 161: | Visual | Elevator 129 must be | | Slips 161 to |
| | | Open slips 161 | | closed. | | Open state. |
| | | (command). | | RN 151 has | | DW 119 load. |
| | | Hoist to open slips | | completed MU | | |
| | | 161. | | sequence with correct | | |
| | | | | torque. | | |
| 8. | Driller | Lower drill string 120: | Visual | Slips 161 open. | | |
| | | Verify slips 161 are | | | | |
| | | open before lowering | | | | |
| | | drill string 120. | | | | |
| 9. | Driller | Set slips 161: | Visual | Stick-up at correct | | Slips 161 to |
| | | Set slips 161 at | | height. | | Closed state. |
| | | correct stick-up height. | | | | DW 119 load |
| | | Set-off weight. | | | | indicator. |
| | | | | | | Tally update. |
| 10. | Driller | Check trip tank | Visual | | Trip tank gain is | Volume control. |
| | | volume, gain/loss. | | | determined and | |
| | | | | | displayed. | |
| 11. | | Repeat sequence for | | | | |
| | | next single 111. | | | | |

Different combinations of the aspects described above may also be utilized for laying down single tubulars 111 from WC 203 using the top drive 116. Such operations may be performed during drilling and other operations performed at WC 203. Such simultaneous operations, however, are coordinated to avoid conflicts and obstructions between the different machines and systems. Preparations for this lay-down operation may include the examples set forth below in Table 7A.

TABLE 7A
Preparations for Singles Lay-Down from WC to CW with TD

| Equipment | Responsible | Verifications |
|---|---|---|
| CW 131 | Operator 195 on | Travel path is unobstructed. |
| | rig floor 114. | Feeding table (FT) indexer pins adjusted for pipe size. |
| | | Prepare for lay-down tubulars 111. |
| | | Adjust skate 133 and other aspects of CW 131 for tubulars 111. |
| RN 151 | Operator 195 on | DPT is rigged up in THT. |
| (THT + DPT) | rig floor 114. | Travel path is unobstructed. |
| | | Dies are clean and not worn. |
| THT + Mud | Operator 195 on | MB is connected. |
| bucket (MB) | rig floor 114. | Inserts are correct size, not worn or damaged. |
| | | Travel path is unobstructed. |
| LSA 228 | Operator 195 on | Travel path is unobstructed. |
| | rig floor 114. | |
| Slips 161 | Operator 195 on | Correct inserts in slips 161. |
| | rig floor 114. | Dies are clean and not worn. |
| | | Rotary table rotation lock activated. |
| | | Pipe viper mounted inside or on top of slips 161. |
| TD 116 | Operator 195 on | Correct inserts in elevator 129. |
| | rig floor 114. | Elevator rotator (tilt) installed. |
| | | Operator screen, system status. |
| | | Travel path is unobstructed. |
| DW 119 | Operator 195 on | Checked. |
| | rig floor 114. | |
| Tubulars | Operator 195 on | Tubular 111 to be loaded on FT. |
| 111 | rig floor 114. | |

The well construction system 100, 200 can then be set-up for the pick-up operation. Examples of such set-up may be as set forth below in Table 7B.

TABLE 7B
Set-Up for Singles Lay-Down from WC to CW with TD

| Equipment | Responsible | Set-Up | HMI |
|---|---|---|---|
| Pipe | Pipe | Verify operator 195 on rig floor 114 | Verify Setback |
| handling: | Handler | completed pre-checks and deactivated | screen. |
| LSA 228, | | emergency stop for all pipe handling | Construction |
| RN 151, | | equipment. | Program setup |
| CW 131 | | Open Construction Program screen on | wizard. |
| | | touchscreen 522, 524. | After startup: Check |
| | | Select Trip Out mode. | for green light in |
| | | Select target: CW 131 | Construction |
| | | Select setup wizard to open pop-up on front | Program status |
| | | screen 532, 534, 536. Verify settings: | header on front |
| | | Select pipe size/type. | screen 532, 534, |
| | | Select MB (THA), if applicable. | 536. |
| | | Select RN 151 to use in the operations. | |
| | | RN 151 MU torque. | |
| | | Stick-up target. | |
| | | Select “activate all machines” to startup and | |
| | | prepare all machines. | |
| TD 116, | Driller | Verify operator 195 on rig floor 114 | Verify Setback |
| DW 119, | | completed pre-checks and deactivated | screen. |
| MP 144, | | emergency stop for all pipe handling | Construction |
| Trip tank | | equipment. | Program setup |
| | | Open Construction Program screen on | wizard. |
| | | touchscreen 522, 524. | After startup: Check |
| | | Select Trip Out mode. | for green light in |
| | | Select setup wizard to open pop-up on front | Construction |
| | | screen 532, 534, 536. Verify settings: | Program status |
| | | Stick-up target. | header on front |
| | | Set DW 119 upper/lower stops. | screen 532, 534, |
| | | Set maximum hoisting speed. | 536. |
| | | Set maximum pull/overpull. | |
| | | Trip tank 1/2/auto. | |
| | | Trip tank low/high levels. | |
| | | Select “activate all machines” to startup and | |
| | | prepare all machines. | |
| TD 116 | Driller | Verify operator 195 on rig floor 114 | Verify operator |
| | | completed pre-checks. | screen, system |
| | | Activate TD 116 from touchscreen 522, | status/alarms. |
| | | 524. | |
| | | Verify correct elevator 129 setting | |
| | | (manual/remote). | |
| | | Select Operation screen on touchscreen 522, | |
| | | 524. | |
| DW 119 | Driller | Activate DW 119 from touchscreen 522, | Verify operator |
| | | 524. | screen, system |
| | | | status/alarms. |
| Slips 161, | Driller | Verify correct setting for slips 161 | Verify operator |
| Rotary | | (manual/remote). | screen, system |
| table | | | status/alarms. |
| All | Driller | Verify all relevant machines are enabled in | |
| machines | | zone management system and tubular | |
| | | interlock system. | |
| Tubulars | Pipe | All types of tubulars 111 are registered. | Verify operator |
| 111 | Handler | | screen, system |
| | | | settings. |

After such preparations and set-up, the operator 195 may vacate the rig floor 114, and the equipment may be configured to be ready for remote control (e.g., by deactivating emergency stops). This sequence may start with the top drive 116 in lower position at WC 203 with the elevator 129 closed, with the slips 161 closed, and with the catwalk ramp 149 empty and in rig floor 114 loading position (ready to move to the rig floor 114). The catwalk feeding table may be unloaded and ready to receive tubulars 111, and the TDA 202 may be parked outside of the potential collision area. Example steps of the sequence may be as set forth below in Table 7C.

TABLE 7C
Sequence for Set-Up for Singles Lay-Down from WC to CW with TD

| | Operator | | Line of | Equipment | Equipment | |
|---|---|---|---|---|---|---|
| | 195 | Operation | Sight | precondition | Functionality | HMI |
| 1. | Driller | Open slips 161 and | Visual/ | Elevator 129 must be | Slips 161 Open not | Slips 161 to |
| | | hoist drill string 120: | CCTV | closed before opening | selectable if elevator | Open state. |
| | | Verify elevator 129 is | | slips 161. | 129 is not closed. | Settings: DW |
| | | closed. | | | Slips 161 Open | 119 hoisting |
| | | Open slips 161 | | | command is reset | speed and |
| | | (command). | | | after a preset time if | maximum |
| | | Hoist to take weight | | | slips 161 are not | overpull. |
| | | and verify slips 161 | | | opened. | |
| | | opening. | | | | |
| | | Hoist one single 111. | | | | |
| | | Stop with required | | | | |
| | | stick-up. | | | | |
| 1.1. | Pipe | Tilt ramp 149 and | Visual/ | Tubular 111 loaded | Skate 133 will tilt | CW 131 lay- |
| | Handler | move skate 133 to lay- | CCTV | onto Ramp 149. | to WC 203 | down ready. |
| | | down position: | | | (straight). | |
| | | Verify tubular 111 is | | | CW 131 will | |
| | | unloaded from ramp | | | move to lay-down | |
| | | 149 (CW 131 ready). | | | position. | |
| | | Activate CW 131 | | | | |
| | | sequence. | | | | |
| 2. | Driller | Set slips 161: | Visual/ | | | DW 119 upper |
| | | Verify required stick- | CCTV | | | stop setting. |
| | | up height. | | | | Slips 161 to |
| | | Set slips 161 | | | | Closed state. |
| | | (command). | | | | |
| | | Set-off weight. | | | | |
| 2.1. | Pipe | Move RN 151 to WC | | RN 151 tongs open. | RN 151 will move to | TJ (stick-up) |
| | Handler | 203: | | WC 203 selected. | WC 203. | assist indication. |
| | | Verify TD 116 is | | LSA 228 outside | Elevate RN 1515 to | RN 151 in WC |
| | | hoisted above RN 151 | | working area. | stick-up. | 203. |
| | | working area. | | | Activate RN 151 BUC | RN 151 BUC |
| | | Start RN 151 break- | | | and position tong | to Closed state. |
| | | out sequence to move | | | (when slips 161 | |
| | | RN 151 to WC 203. | | | closed). | |
| | | | | | RN 151 will stop/wait | |
| | | | | | outside WC 203 area if | |
| | | | | | TD 116 is moving. | |
| 2.2. | Pipe | LSA 228 move to WC | Visual/ | TD 116 above | LSA 228 will stop/wait | LSA 228 funnel |
| | Handler | 203: | CCTV | working area. | outside WC 203 area | to Closed state. |
| | | Verify TD 116 is | | RN 151 outside | if TD 116 is moving. | |
| | | hoisted above LSA 228 | | working area. | | |
| | | working area. | | | | |
| | | LSA 228 move to WC | | | | |
| | | 203. | | | | |
| | | LSA 228 guide funnel | | | | |
| | | closes. | | | | |
| 2.3. | Pipe | RN 151 break-out and | CCTV | Slips 161 closed. | Break-out and spin- | RN 151 |
| | Handler | spin-out: | | | out. Double break-out | operation |
| | | Verify slips 161 | | | available if required | status. |
| | | closed and weight set- | | | (per set-up). | |
| | | off. | | | Open RN 151 | |
| | | Adjust RN 151 | | | spinner, guide, and | |
| | | elevation if required. | | | clamps. | |
| | | Continue RN 151 | | | Return RN 151 to | |
| | | sequence. | | | park position. | |
| | | | | | Option: RN 151 will | |
| | | | | | wait in WC 203 until | |
| | | | | | TDA 202 has lifted the | |
| | | | | | stand. | |
| 2.4. | Pipe | Option: Wet tubular | Visual | RN 151 sequence | | MB to WC 203. |
| | Handler | 111: | | finished. | | |
| | | Verify RN 151 is out | | LSA 228 above | | |
| | | of working area. | | THA/MB working | | |
| | | Extend MB to WC | | area. | | |
| | | 203. | | | | |
| | | Close MB. | | | | |
| | Driller | DW 119 hoist to drain | | | | MB to Closed |
| | | tubular 111. | | | | state. |
| | Pipe | Open and retract MB. | | | | MB to Open |
| | Handler | | | | | state |
| 3. | Driller | TD 116 and LSA 228 | Visual/ | Elevator 129 closed. | | TD 116 |
| | | move tubular 111 from | CCTV | Slips 161 closed. | | retracted |
| | | WC 203 to CW 131: | | | | position. |
| | | Verify connection is | | | | |
| | | spun-out. | | | | |
| | | Hoist TD 116 to lift | | | | |
| | | tubular 111 from stick- | | | | |
| | | up to above CW 131. | | | | |
| | | Tilt TD 116 links | | | | |
| | | toward CW131 (guided | | | | |
| | | by LSA 228). | | | | |
| 3.1. | Pipe | LSA 228 will guide | Visual/ | CW 131 in lay-down | | LSA 228 |
| | Handler | tubular 111 pin to CW | CCTV | position. | | position. |
| | | 131: | | | | |
| | | Verify pin end is | | | | |
| | | above CW 131. | | | | |
| | | Guide pin end to | | | | |
| | | above skate 133. | | | | |
| 4. | Driller | Set tubular 111 on CW | Visual/ | CW 131 in lay-down | Skate 133 will move | |
| | | 131: | CCTV | position. | out as TD 116 lowers. | |
| | | Verify elevator 129 is | | | | |
| | | tilted toward CW 131. | | | | |
| | | Lower TD 116 and | | | | |
| | | set tubular 111 pin on | | | | |
| | | skate 133. | | | | |
| | | Continue lowering | | | | |
| | | until tubular 111 rests | | | | |
| | | on CW 131. | | | | |
| 4.1. | Pipe | Open and retract LSA | Visual/ | | | LSA 228 to |
| | Handler | 228: | CCTV | | | Open state. |
| | | Verify tubular 111 pin | | | | |
| | | is resting in CW 131. | | | | |
| | | Open and retract LSA | | | | |
| | | 228. | | | | |
| 5. | Driller | Lay down tubular 111 | Visual/ | | Skate 133 will move | |
| | | on CW 131 and open | CCTV | | out as TD 116 lowers. | |
| | | elevator 129: | | | | |
| | | Verify elevator 129 is | | | | |
| | | tilted toward CW 131 | | | | |
| | | and LSA 228 is out of | | | | |
| | | TD 116 area. | | | | |
| | | Lower TD 116 until | | | | |
| | | tubular 111 rests on | | | | |
| | | ramp 149. | | | | |
| 6. | Driller | Open elevator 129: | Visual | | | Elevator 129 to |
| | | Verify tubular 111 is | | | | Open state. |
| | | resting on CW 131. | | | | |
| | | Open elevator 129. | | | | |
| | | Tilt TD 116 links back | | | | |
| | | (link tilt float). | | | | |
| 6.1. | Pipe | Move tubular 111 to FT | Visual/ | Elevator 129 open. | Skate 133 will pull | Skate 133 to |
| | Handler | and unload: | CCTV | | tubular 111 to | unloading |
| | | Activate CW 131 | | | unloading position. | position. |
| | | sequence to move out | | | Ramp 149 will tilt to | CW 131 to |
| | | and unload tubular | | | unloading position. | unloading |
| | | 111. | | | FT will unload | position. |
| | | Continue step 1.1. | | | tubular 111. | FT unloading |
| | | | | | | active. |
| 7. | Driller | Lower TD 116 to stick- | Visual | | | Elevator 129 to |
| | | up and close elevator | | | | Closed state. |
| | | 129: | | | | |
| | | TD 116 links are tilted | | | | |
| | | back to clear stick-up | | | | |
| | | (or retract TD 116 with | | | | |
| | | vertical links). | | | | |
| | | Lower TD 116 to | | | | |
| | | stick-up. | | | | |
| | | Tilt links (or extend | | | | |
| | | TD 116) to close | | | | |
| | | elevator 129. | | | | |
| 8. | Driller | Check trip tank | Visual | | Trip tank gain/loss is | Trip Sheet/ |
| | | volume, gain/loss: | | | determined and | Volume control. |
| | | Trip tank gain/loss. | | | displayed. | |
| | | Repeat all steps for | | | | |
| | | next tubular 111. | | | | |
| | | Continue on step 1. | | | | |

Table 7C: Sequence for Set-Up for Singles Lay-Down from WC to CW with TD

Different combinations of the aspects described above may also be utilized for running casing from the CW 131 with a casing tong (CTO). Preparations for such operation may include the examples set forth below in Table 8A.

TABLE 8A
Preparations for Running Casing from CW with CTO

| Equipment | Responsible | Verifications |
|---|---|---|
| CW 131 | Operator 195 on | Travel path is unobstructed. |
| | rig floor 114. | Casings are laid out correct with aft end in line with skate 133 |
| | | for correct loading. |
| | | Prepare to pick up casing. |
| CTO: | Operator 195 on | CTO is rigged up in THA (or THT). |
| THA + CTO | rig floor 114. | Correct adapters and stabbing guide funnel installed. |
| as primary, | | Dies are correct, clean, and not worn. |
| THT + CTO | | Travel path is unobstructed. |
| as backup | | |
| LSA 228 | Operator 195 on | Travel path is unobstructed. |
| | rig floor 114. | |
| Slips 161 | Operator 195 on | Correct inserts in slips 161. |
| Rotary | rig floor 114. | Dies are clean and not worn. |
| Table | | Rotary table rotation lock activated. |
| TD 116 | Operator 195 on | Correct inserts in elevator 129. |
| | rig floor 114. | Elevator rotator (tilt) installed. |
| | | Operator screen, system status. |
| | | Travel path is unobstructed. |
| DW 119 | Operator 195 on | Checked. |
| | rig floor 114. | |
| Tubulars | Operator 195 on | Tubulars 111 to be laid out on CW 131. |
| 111 | rig floor 114. | Tubulars 111 to be cleaned and doped, protectors removed |
| | | (other implementations may be used for casing with protectors). |
| | | Casings measured, marked, and tally updated. |

The well construction system 100, 200 can then be set-up for the operation. Examples of such set-up may be as set forth below in Table 8B.

TABLE 8B
Set-Up for Running Casing from CW with CTO

| Equipment | Responsible | Set-Up | HMI |
|---|---|---|---|
| Pipe | Pipe | Verify operator 195 on rig floor 114 | Verify Setback |
| handling: | Handler | completed pre-checks and deactivated | screen. |
| LSA 228, | | emergency stop for all pipe handling | Construction |
| CTO, | | equipment. | Program setup |
| CW 131 | | Open Construction Program screen on | wizard. |
| | | touchscreen 522, 524. | After startup: Check |
| | | Select Running Casing from CW with CTO | for green light in |
| | | mode. | Construction |
| | | Select setup wizard to open pop-up on front | Program status |
| | | screen 532, 534, 536. Verify settings: | header on front |
| | | Select casing type and verify casing | screen 532, 534, |
| | | data (size, weight, MU loss, torque | 536. |
| | | settings, weight, etc.). | |
| | | Select CTO to use in the operations. | |
| | | Stick-up target. | |
| | | Select “activate all machines” to startup and | |
| | | prepare all machines. | |
| TD 116, | Driller | Verify operator 195 on rig floor 114 | Verify Setback |
| DW 119, | | completed pre-checks and deactivated | screen. |
| MP 144 | | emergency stop for all pipe handling | Construction |
| | | equipment. | Program setup |
| | | Open Construction Program screen on | wizard. |
| | | touchscreen 522, 524. | After startup: Check |
| | | Select Running Casing from CW with CTO | for green light in |
| | | mode. | Construction |
| | | Select setup wizard to open pop-up on front | Program status |
| | | screen 532, 534, 536. Verify settings: | header on front |
| | | Stick-up target. | screen 532, 534, |
| | | Set DW 119 upper/lower stops. | 536. |
| | | Set maximum lowering speed. | |
| | | Set minimum slack off weight. | |
| | | Trip tank 1/2/auto. | |
| | | Trip tank low/high levels. | |
| | | Verify active tanks are selected and | |
| | | lined up. | |
| | | Select MP 144 (to fill casing, optional). | |
| | | Verify MP 144 pressure limit setting. | |
| | | Assign pumps to master slider. | |
| | | Set number of strokes and SPM to fill | |
| | | casing (optional). | |
| | | Set ramp-up parameters. | |
| | | Select “activate all machines” to startup and | |
| | | prepare all machines. | |
| TD 116 | Driller | Verify operator 195 on rig floor 114 | Verify operator |
| | | completed pre-checks. | screen, system |
| | | Activate TD 116 from touchscreen 522, | status/alarms. |
| | | 524. | |
| | | Verify correct elevator 129 setting | |
| | | (manual/remote). | |
| | | Select Operation screen on touchscreen 522, | |
| | | 524. | |
| DW 119 | Driller | Activate DW 119 from touchscreen 522, | Verify operator |
| | | 524. | screen, system |
| | | Set maximum lowering speed. | status/alarms. |
| | | Set minimum slack off weight. | |
| Slips 161, | Driller | Verify correct setting for slips 161 | Verify operator |
| Rotary | | (manual/remote). | screen, system |
| table | | | status/alarms. |
| All | Driller | Verify all relevant machines are enabled in | |
| machines | | zone management system and tubular | |
| | | interlock system. | |
| Tubulars | Pipe | All types of tubulars 111 are registered. | |
| 111 | Handler | | |

After such preparations and set-up, the operator 195 may vacate the rig floor 114, and the equipment may be configured to be ready for remote control (e.g., by deactivating emergency stops). An example of this sequence may start with a casing stick-up at WC 203, with the slips 161 and the TD 116 elevator 129 closed. Casing may be laid out on the CW 131 casing side (e.g., Driller's side), having been cleaned, doped, and tallied, and with protectors removed. The catwalk ramp 149 may be empty and in the loading position. Example steps of the sequence may be as set forth below in Table 8C.

TABLE 8C
Sequence for Running Casing from CW with CTO

| | Operator | | Line of | Equipment | Equipment | HMI |
|---|---|---|---|---|---|---|
| | 195 | Operation | Sight | precondition | Functionality | |
| 1.1. | Pipe | Load casing into ramp | Visual/ | Casing ready in | | |
| | Handler | 149: | CCTV | loading position. | | |
| | | Use loading fingers to | | CW 131 in loading | | |
| | | load casing into ramp | | position. | | |
| | | 149. | | | | |
| 1.2. | Pipe | Run ramp 149 to rig | Visual/ | Casing loaded onto | Ramp 149 will tilt to | CW 131 |
| | Handler | floor 114: | CCTV | ramp 149. | rig floor 114 casing | animated. |
| | | Verify casing is | | | position. | |
| | | loaded in ramp 149. | | | Skate 133 will move | |
| | | Move ramp 149 | | | towards rig floor 114. | |
| | | toward pick-up | | | Skate 133 will stop | |
| | | position. | | | with casing box inside | |
| | | | | | ramp. | |
| 2. | Driller | Open elevator 129: | Visual/ | Slips 161 must be | Elevator 129 Open not | Elevator 129 to |
| | | Verify slips 161 are | CCTV | closed before opening | selectable if slips 161 | Open state. |
| | | closed. | | elevator 129. | are not closed. | |
| | | Open elevator 129. | | | | |
| 3. | Driller | Move TD 116 to CW | Visual | Elevator 129 open. | TD 116 pipe handler | |
| | | 131 pick-up position: | | Elevator 129 rotated | has pre-set position | |
| | | Tilt links to clear TJ. | | to receive casing. | facing CW 131. | |
| | | Hoist elevator 129 | | | | |
| | | above stick-up. | | | | |
| | | Tilt out elevator 129 | | | | |
| | | and run TD 116 to CW | | | | |
| | | 131 pick-up position. | | | | |
| 3.1. | Pipe | Push casing to pick-up | Visual | Ramp 149 in rig floor | Skate 133 will push | CW 131 in pick- |
| | Handler | position: | | 114 position. | casing a defined | up position. |
| | | Run skate 133 until | | | distance forward. | |
| | | casing is positioned | | | | |
| | | above elevator 129. | | | | |
| 4. | Driller | Latch elevator 129: | Visual | Casing is positioned | Elevator 129 close on | Elevator 129 to |
| | | Hoist/tilt TD 116 to | | correctly above | mechanical impact. | Closed state. |
| | | latch elevator 129. | | elevator 129. | Tubular interlock | |
| | | | | | prevents hoisting | |
| | | | | | without closed elevator | |
| | | | | | 129 (above certain | |
| | | | | | height). | |
| 5. | Driller | Lift casing: | Visual | Elevator 129 closed. | Hoisting will stop prior | |
| | | Hoist TD 116 to pick | | Link tilt float: Elevator | to lifting casing out of | |
| | | up casing from CW | | 129 above RN 151 | CW 131 without | |
| | | 131. | | working area. | guiding. | |
| | | Activate link tilt float | | | | |
| | | to move elevator 129 | | | | |
| | | to vertical position. | | | | |
| 5.1. | Pipe | LSA 228 extend to | Visual/ | TD 116 above LSA 228 | | LSA 228 funnel |
| | Handler | guide casing above | CCTV | operating area. | | to Closed state. |
| | | CW 131: | | | | |
| | | Move LSA 228 to | | | | |
| | | preset position to | | | | |
| | | receive casing above | | | | |
| | | CW 131. | | | | |
| | | Before casing lower | | | | |
| | | end leaves CW 131, | | | | |
| | | close LSA 228 funnel. | | | | |
| 5.2. | Pipe | Option: Move | | Only possible with | CTO will move to WC | THT in WC 203. |
| | Handler | THT/CTO to WC 203: | | THT. If THA is used, | 203. | |
| | | Verify TD 116 hoisted | | wait for stand located | Elevate to stick-up. | |
| | | above CTO working | | above stick-up. | ZMS will prevent | |
| | | area. | | CTO open. | CTO start if TD 116 is | |
| | | Start CTO sequence | | WC 203 selected. | too low. | |
| | | to move THT to WC | | | | |
| | | 203. | | | | |
| 5.3. | Pipe | LSA 228 tail in casing | Visual | Casing bottom clear | LSA 228 centralizer | LSA 228 |
| | Handler | to WC 203: | | of CW 131 and | will close when casing | centralizer to |
| | | TD 116 continues | | elevated above stick- | nears WC 203. | Closed state. |
| | | hoisting. | | up. | | |
| | | LSA 228 guide closes | | LSA 228 centralizer | | |
| | | and tail in casing | | closes when casing | | |
| | | towards WC 203 when | | nears vertical. | | |
| | | pin end is above stick- | | | | |
| | | up. | | | | |
| 5.4. | Pipe | Move THA/CTO to WC | | CTO open. | CTO will move to WC | THA/CTO in |
| | Handler | 203: | | WC 203 selected. | 203. | WC 203. |
| | | Verify casing is in WC | | LSA 228 in WC 203. | Elevate to stick-up. | |
| | | 203 and LSA 228 is | | | ZMS will prevent | |
| | | above CTO working | | | CTO start if TD 116 or | |
| | | area. | | | LSA 228 is too low. | |
| | | Start CTO sequence | | | | |
| | | to move THT to WC | | | | |
| | | 203. | | | | |
| 5.5. | Pipe | Close CTO BUT: | Visual/ | CTO in WC 203. | Close CTO BUT. | CTO to closed |
| | Handler | Adjust/verify correct | CCTV | | Close stabbing guide. | state. |
| | | CTO elevation. | | | | |
| | | Continue CTO | | | | |
| | | sequence. | | | | |
| 5.6. | Pipe | Optional: Close make- | Visual/ | CTO in WC 203. | Close MUST. | MUST to |
| | Handler | up spinning tong | CCTV | | MUST will take some | Closed state. |
| | | (MUST) for soft | | | load if closed prior to | |
| | | stabbing: | | | stabbing casing. | |
| | | Adjust CTO elevation | | | | |
| | | and TD 116 elevation if | | | | |
| | | required. | | | | |
| | | Continue CTO | | | | |
| | | sequence. | | | | |
| 6. | Driller | Stab casing: | Visual/ | TD 116 link tilt float. | Weight transferred to | CTO to open |
| | | Lower TD 116 to stab | CCTV | CTO in WC 203 with | MUST per casing data | state. |
| | | casing (soft stab). | | stabbing guide closed. | input. | |
| | | Open CTO stabbing | | | | |
| | | guide. | | | | |
| 6.1. | Pipe | Open and retract LSA | Visual/ | CTO stabbing guide | | LSA 228 Open |
| | Handler | 228: | CCTV | closed. | | status. |
| | | Open and retract LSA | | | | |
| | | 228 when casing has | | | | |
| | | entered stabbing guide. | | | | |
| 6.2. | Pipe | CTO spin-in and make- | Visual/ | Single casing stabbed | CTO will | Casing |
| | Handler | up: | CCTV | in stick-up. | automatically spin-in | connected state. |
| | | Verify casing is | | TD 116 unloaded, | and make-up per | |
| | | stabbed. | | elevator 129 below TJ | casing data settings. | |
| | | Continue CTO | | to permit spinning. | If Accept: Open | |
| | | sequence. | | | spinner, guide, and | |
| | | Accept or reject | | | clamps. | |
| | | make-up. | | | Return to park | |
| | | | | | position. | |
| 7. | Driller | Open slips 161: | Visual | Elevator 129 must be | | Slips 161 to |
| | | Open slips 161 | | closed. | | Open state. |
| | | (command). | | CTO has completed | | DW 119 load. |
| | | Hoist to open slips | | MU sequence with | | |
| | | 161. | | accepted connection. | | |
| 8. | Driller | Lower casing string: | Visual | Slips 161 open. | Optional: Selected MP | MP 144 |
| | | Verify slips 161 are | | Optional: MP 144 | 144 will pump a set | strokes. |
| | | open before lowering | | ready. | number of strokes at | MP 144 |
| | | drill string 120. | | | set rate with selected | pressure. |
| | | Optional: Fill casing | | | MP 144 and stop. | IBOP to Open |
| | | volume if selected. | | | | state. |
| | | Extend fill-up tool, if | | | | |
| | | mounted. | | | | |
| | | Open IBOP. | | | | |
| | | Start MP 144. | | | | |
| | | Close IBOP. | | | | |
| 9. | Driller | Set slips: | Visual | Stick-up at correct | | Slips 161 to |
| | | Set slips 161 at | | height. | | Closed state. |
| | | correct stick-up height. | | | | DW 119 load |
| | | Set-off weight. | | | | indicator. |
| 10. | Driller | Check gain/loss: | Visual | | Trip tank or active | Volume control. |
| | | Check trip tank gain/ | | | tank gain is | |
| | | loss or active gain/loss | | | determined and | |
| | | depending on selected | | | displayed. | |
| | | operation. | | | | |
| 11. | | Repeat sequence for | | | | |
| | | next casing single. | | | | |

When a tripping-out “wet” (while the drill string 120 is full of mud) operation is to be performed, an operator 195 on the rig floor 114 may verify that various pieces of equipment are properly shut down and locked out, and then perhaps perform other preparations such as the examples set forth below in Table 9A.

TABLE 9A
Tripping-In Wet Preparations

| Equipment | Responsible | Verifications |
|---|---|---|
| FIB 166 | Operator 195 on rig floor 114. | Tubulars 111 exist per HMI/tally. |
| Setback 164 | | Fingers are closed. |
| | | Travel path is unobstructed. |
| TBR 254 | Operator 195 on rig floor 114. | Travel path is unobstructed. |
| SGA 262 | | Gripper inserts/dies are clean, not worn. |
| LTC 244 | Operator 195 on rig floor 114. | Travel path is unobstructed. |
| ITC 236 | | Gripper inserts/dies are clean, not worn. |
| UTC 242 | | ITC 236 is open and retracted. |
| THP | Operator 195 on rig floor 114. | Travel path is unobstructed. |
| Doper 209 | | Water, correct dope available for doper |
| | | 209. |
| LSA 228 | Operator 195 on rig floor 114. | Travel path is unobstructed. |
| TDA 202 | Operator 195 on rig floor 114. | Travel path is unobstructed. |
| | | Correct dope available for doper 209. |
| | | Correct inserts/dies in gripper/elevator. |
| | | Inserts/dies are clean, not worn. |
| RN 151 | Operator 195 on rig floor 114. | Drill pipe tong (DPT) is connected. |
| (THT + DPT) | | Gripper dies are clean, not worn. |
| | | Travel path is unobstructed. |
| THA + MB | Operator 195 on rig floor 114; and/or | MB is connected. |
| | “Driller” 195 at workstation 452. | Inserts correct size, not worn or |
| | | damaged. |
| | | Travel path is unobstructed. |
| Slips 161, | Operator 195 on rig floor 114; and/or | Correct inserts/dies. |
| Rotary | “Driller” 195 at workstation 452. | Inserts/dies are clean, not worn. |
| Table | | Pipe viper mounted inside or on top of |
| | | slips 161. |
| TD 116 | Operator 195 on rig floor; and/or | Correct inserts/dies in elevator 129. |
| | “Driller” 195 at workstation 452. | Correct saver sub status. |
| | | Travel path is unobstructed. |
| DW 119 | Operator 195 on rig floor; and/or | Checked. |
| | “Driller” 195 at workstation 452. | |

The well construction system 100, 200 can then be set-up for the trip-out wet sequence. Examples of such set-up may be as set forth below in Table 9B.

TABLE 9B
Tripping-Out Wet Set-Up

| Equipment | Responsible | Set-Up | HMI |
|---|---|---|---|
| Pipe | Driller/ | Verify operator 195 on rig floor 114 completed | Verify Setback |
| handling: | Pipe | pre-checks and deactivated emergency stop for | screen. |
| TBR 254, | Handler | all pipe handling equipment. | Construction |
| SGA 262, | | Open Construction Program screen on | Program |
| UTC 242, | | touchscreen 522, 524. | setup wizard. |
| LTC 244, | | Select Trip Out Wet mode. | After startup: |
| THP 207, | | Select setup wizard to open pop-up on front | Check for |
| TDA 202, | | screen 532, 534, 536. Verify settings: | green light in |
| LSA 228, | | Select slot, direction for storing tubulars 111. | Construction |
| RN 151 | | Select pipe type. | Program |
| | | Select RN 151 (THT) to use, check MU | status header |
| | | torque. | on front |
| | | Select MB (THA). | screen 532, |
| | | Select pin/box doping. | 534, 536. |
| | | Stick-up target. | |
| | | Select “activate all machines” to startup and | |
| | | prepare all machines. | |
| TD 116, | Driller | Verify operator 195 on rig floor 114 completed | Verify Setback |
| DW 119, | | pre-checks and deactivated emergency stop for | screen. |
| MP 144, | | all pipe handling equipment. | Construction |
| Trip tank | | Open Construction Program screen on | Program |
| | | touchscreen 522, 524. | setup wizard. |
| | | Select Trip Out Wet mode. | After startup: |
| | | Select setup wizard to open pop-up on front | Check for |
| | | screen 532, 534, 536. Verify settings: | green light in |
| | | Stick-up target. | Construction |
| | | Set DW 119 upper/lower stops. | Program |
| | | Set maximum lowering speed. | status header |
| | | Set over pull. | on front |
| | | Trip tank 1/2/auto. | screen 532, |
| | | Trip tank low/high levels. | 534, 536. |
| | | Select “activate all machines” to startup and | |
| | | prepare all machines. | |
| TD 116 | Driller | Verify operator 195 on rig floor 114 completed | Verify operator |
| | | pre-checks. | screen, system |
| | | Activate TD 116 from touchscreen 522, 524. | status/alarms. |
| | | Select Operation screen on touchscreen 522, | |
| | | 524. | |
| DW 119 | Driller | Activate DW 119 from touchscreen 522, 524. | Verify operator |
| | | | screen, system |
| | | | status/alarms. |
| All | Driller | Verify all relevant machines are enabled in zone | Verify operator |
| machines | | management system and tubular interlock | screen, system |
| | | system. | status/alarms. |

After such preparations and set-up, the operator 195 may vacate the rig floor 114, and the equipment may be configured to be ready for remote control (e.g., by deactivating emergency stops). An example trip-out wet sequence may start with the TD 116 in lower position over WC 203 with closed slips 161 and elevator 129, with a stick-up of about one meter. The TDA 202 and LSA 228 are open in THP 207 position (tubular 111 delivered from WC 203 to THP 207). The UTC 242 and LTC 244 are closed on the tubular 111 in the THP 207, and the ITC 236 is open and retracted. The TBR 254 and SGA 262 are empty, on the way from the FIB 166 to get a new tubular 111 in the THP 207. Example steps of the trip-out wet sequence may be as set forth below in Table 9C.

TABLE 9C
Tripping-Out Wet Operation

| | Operator | | Line of | Equipment | Equipment | |
|---|---|---|---|---|---|---|
| | 195 | Operation | Sight | precondition | Functionality | HMI |
| 1. | Driller | Open slips 161 and | Visual/ | Elevator 129 must be | Slips 161 Open is | Slips 161 to |
| | | hoist to upper stop: | CCTV | closed before opening | not selectable if | Open state. |
| | | Verify elevator 129 is | | slips 161. | elevator 129 is not | Settings: |
| | | closed. | | | closed. | DW 119 |
| | | Open slips 161 | | | Slips 161 Open | hoisting |
| | | (command). | | | command is reset | speed and |
| | | Hoist to take weight | | | after a set time if the | maximum |
| | | and verify slips 161 | | | slips 161 are not | overpull. |
| | | opening. | | | opened. | |
| 1.1. | Pipe | TBR 254 and SGA 262 | Visual/ | TBR 254 and SGA 262 | | TBR 254 and |
| | Handler | pick up next tubular 111 | CCTV | open. | | SGA 262 grips/ |
| | | from THP 207: | | | | guides to Closed |
| | | TBR 254 and SGA 262 | | | | state. |
| | | move to tubular 111 in | | | | |
| | | THP 207. | | | | |
| | | Close TBR 254 and | | | | |
| | | SGA 262 guides/clamps | | | | |
| | | on tubular 111. | | | | |
| 1.2. | Pipe | UTC 242 and LTC 244 | Visual/ | TBR 254 and SGA 262 | UTC 242 and LTC 244 | UTC 242 and |
| | Handler | open and retract: | CCTV | closed on tubular 111 | open and retract. | LTC 244 to Open |
| | | UTC 242 and LTC | | in THP 207. | | state-retracted. |
| | | 244 open. | | | | |
| | | UTC 242 and LTC | | | | |
| | | 244 retract from THP | | | | |
| | | 207. | | | | |
| 1.3. | Pipe | TBR 254 and SGA 262 | Visual/ | Valid FIB 166 position | TBR 254 and SGA | THP load. |
| | Handler | move toward FIB 166 | CCTV | selected. | 262 will follow | |
| | | with tubular 111: | | | predefined path. | |
| | | Lift tubular 111 from | | | FIB 166 latches will | |
| | | THP 207. | | | open when tubular 111 | |
| | | Move to selected | | | is outside selected FIB | |
| | | position in FIB 166. | | | 166 row. | |
| | | | | | FIB 166 latches will | |
| | | | | | close prior to setting | |
| | | | | | down tubular 111. | |
| | | | | | Set down tubular 111 | |
| | | | | | on selected position. | |
| 1.4. | Pipe | TDA 202 and LSA 228 | Visual/ | | TDA 202 retracts to | TDA 202 load |
| | Handler | move to WC 203: | CCTV | | vertical, hoists, and | indication. |
| | | TDA 202 moves to | | | rotates, extending to | |
| | | WC 203. | | | WC 203 at about two | |
| | | LSA 228 moves to | | | meters below stick-up. | |
| | | WC 203. | | | TDA 202 and LSA | |
| | | | | | 228 will stop/wait | |
| | | | | | outside WC 203 area | |
| | | | | | if TD 116 is moving. | |
| 1.5. | Pipe | Move RN 151 to WC | | RN 151 tongs open. | RN 151 will move to | TJ (Stick-up) |
| | Handler | 203: | | WC 203 selected. | WC 203. | assist indication. |
| | | Verify TD 116 is | | | Elevate RN 151 to | |
| | | hoisted above RN 151 | | | stick-up. | |
| | | working area. | | | RN 151 will stop/ | |
| | | Start 151 RN break- | | | wait outside WC 203 | |
| | | out sequence to move | | | area if TD 116 is | |
| | | RN 151 to WC 203. | | | moving. | |
| 2. | Driller | Set slips 161: | Visual/ | | | DW 119 upper |
| | | Verify required stick-up | CCTV | | | stop setting. |
| | | height. | | | | |
| | | Set slips 161 | | | | |
| | | (command). | | | | |
| | | Set off weight. | | | | |
| 2.1. | Pipe | TDA 202 close and LSA | Visual/ | Slips 161 closed. | TDA 202 and LSA 228 | TDA 202 to |
| | Handler | 228 guide close: | CCTV | | will not close in WC | Closed state. |
| | | Verify TDA 202 and | | | 203 if slips 161 are not | TDA 202 and |
| | | LSA 228 at WC 203. | | | closed. | LSA 228 in WC |
| | | Close TDA 202. | | | | 203. |
| | | Close LSA 228 guide | | | | LSA 228 guide |
| | | funnel. | | | | funnel to Closed |
| | | | | | | state. |
| 2.2. | Pipe | RN 151 break-out and | CCTV | Slips 161 closed. | Break-out and spin- | RN 151 |
| | Handler | spin-out: | | | out. Double break-out | indication. |
| | | Verify slips 161 closed | | | available if required. | |
| | | and weight set off. | | | Open RN 151 | |
| | | Adjust RN 151 | | | spinner, guide, and | |
| | | elevation if required. | | | clamps. | |
| | | Continue RN 151 | | | Return RN 151 to | |
| | | sequence. | | | park position. | |
| | | | | | RN 151 may wait in | |
| | | | | | WC 203 until TDA 202 | |
| | | | | | has lifted tubular 111. | |
| 3. | Driller | Open TD elevator 129, | Visual/ | TDA 202 closed. | | TD elevator |
| | | retract, and lower: | CCTV | Slips 161 closed. | | 129 to Closed |
| | | Verify TDA 202 is | | | | state. |
| | | closed. | | | | TD 116 |
| | | Open TD elevator 129 | | | | retracted |
| | | and retract. | | | | position. |
| | | Lower TD 116 (e.g., to | | | | |
| | | rig floor 114. | | | | |
| 3.1. | Pipe | MB (THA) extend to WC | Visual/ | RN 151/THT | MB will extend to | MB in WC |
| | Handler | 203: | CCTV | retracted. | WC 203 and close. | 203. |
| | | Verify THT is out of the | | MB open. | | MB to Closed |
| | | area. | | | | state. |
| | | Continue MB | | | | |
| | | sequence. | | | | |
| 3.2. | Pipe | TDA 202 lift tubular 111 | Visual/ | RN 151 in parked | TDA 202 will hoist | TDA 202 load |
| | Handler | out of stick-up: | CCTV | position. | about two meters | indication. |
| | | Hoist TDA 202 to pick | | MB in WC 203. | before lifting tubular | TDA 202 |
| | | up weight. | | TD 116 retracted. | 111. | position |
| | | LSA 228 centralizer | | | Tubular 111 is lifted | indicator. |
| | | will close on tubular 111 | | | carefully. Lifting is | LSA 228 |
| | | above stick-up. | | | stopped if tubular | centralizer. |
| | | Hold stand above | | | 111 is catching on | |
| | | stick-up until drained, | | | threads in TJ. | |
| | | | | | LSA 228 centralizer | |
| | | | | | closes after lifted | |
| | | | | | above the box. | |
| 3.3. | Pipe | MB open and retract: | Visual/ | | MB will open and | MB to Closed |
| | Handler | Verify tubular 111 is | CCTV | | retract. | state. |
| | | drained. | | | | MB parked. |
| | | Continue MB | | | | |
| | | sequence. | | | | |
| 3.4. | Pipe | TDA 202 and LSA 228 | Visual/ | TDA 202 closed. | TDA 202 will retract | TDA 202 load |
| | Handler | move tubular 111 to | CCTV | | to vertical position | indication. |
| | | THP 207: | | | above MOH 204 (or | TDA 202 |
| | | TDA 202 and LSA 228 | | | rig floor 114), then | position |
| | | move toward THP 207. | | | rotate, lower, and | indicator. |
| | | LTC 244 extends to | | | extend to THP 207. | LSA 228 |
| | | THP 207 and closes | | | TDA 202 will slow | extend. |
| | | guide when tubular 111 | | | down above THP | LTC 244 to |
| | | is close to THP 207. | | | 207. | Closed state. |
| | | Set down tubular 111 | | | LTC 244 is extended | |
| | | at THP 207. | | | and closed. | |
| | | Wash and dope pin if | | | LSA 228 is open. | |
| | | preselected. | | | | |
| 3.5. | Pipe | UTC 242 extend to THP | Visual/ | TDA 202 and LSA 228 | UTC 242 extend and | UTC 242 and |
| | Handler | 207 and close. | CCTV | in THP 207 with tubular | close. | LTC 244 to |
| | | UTC 242 extends to | | 111. | LTC 244 continue | Closed state. |
| | | THP 207. | | | close. | |
| | | UTC 242 and LTC 244 | | | | |
| | | close. | | | | |
| 4. | Driller | Extend TD 116 and | Visual | RN 151 parked. | | Elevator 129 |
| | | latch elevator 129: | | | | to Closed state. |
| | | Extend TD 116 to WC | | | | Indicate TD |
| | | 203. | | | | 116 in WC 203. |
| | | Latch elevator 129 | | | | |
| | | (automatic close on | | | | |
| | | impact). | | | | |
| 5. | Driller | Check trip tank volume, | Visual | | Trip tank gain/loss is | Trip sheet/ |
| | | gain/loss: | | | determined and | volume control. |
| | | Determine trip tank | | | displayed. | |
| | | gain/loss. | | | | |
| | | Repeat all steps for | | | | |
| | | next tubular 111. | | | | |
| | | Continue on step 1. | | | | |
| 5.1. | Pipe | TDA 202 open and | Visual/ | UTC 242 closed. | | TDA 202 to |
| | Handler | retract from THP 207: | CCTV | | | Open state. |
| | | Verify UTC 242 and | | | | LSA 228 open. |
| | | LTC 244 are closed. | | | | |
| | | Open TDA 202. | | | | |
| | | Open LSA 228 guide | | | | |
| | | funnel. | | | | |
| | | Continue on step 1.4. | | | | |
| 5.2. | Pipe | TBR 254 and SGA 262 | | UTC 242 and LTC 244 | | |
| | Handler | move to FIB 166: | | closed on tubular 111. | | |
| | | Open TBR 254 and | | | | |
| | | SGA 262. | | | | |
| | | Move TBR 254 and | | | | |
| | | SGA 262 toward THP | | | | |
| | | 207/next tubular 111. | | | | |
| | | Continue step 1.1. | | | | |

When a back-reaming operation is to be performed, an operator 195 on the rig floor 114 may verify that various pieces of equipment are properly shut down and locked out, and then perhaps perform other preparations such as the examples set forth above in Table 9A. The well construction system 100, 200 can then be set-up for the back-reaming sequence. Examples of such set-up may be as set forth below in Table 10A.

TABLE 10A
Back-Reaming Set-Up

| Equipment | Responsible | Set-Up | HMI |
|---|---|---|---|
| Pipe | Driller/ | Verify operator 195 on rig floor 114 | Verify Setback |
| handling: | Pipe | completed pre-checks and deactivated | screen. |
| TBR 254, | Handler | emergency stop for all pipe handling | Construction |
| SGA 262, | | equipment. | Program setup |
| UTC 242, | | Open Construction Program screen on | wizard. |
| LTC 244, | | touchscreen 522, 524. | After startup: Check |
| ITC 236, | | Select Back-Reaming mode. | for green light in |
| THP 207, | | Select setup wizard to open pop-up on front | Construction |
| TDA 202, | | screen 532, 534, 536. Verify settings: | Program status |
| LSA 228, | | Select slot, direction for setting back | header on front |
| RN 151 | | pipe. | screen 532, 534, |
| | | Select pipe type. | 536. |
| | | Select RN 151 (THT) and MB (THA). | |
| | | Check RN 151 MU torque. | |
| | | Select pin/box doping. | |
| | | Stick-up target. | |
| | | Select “activate all machines” to startup and | |
| | | prepare all machines. | |
| TD 116, | Driller | Verify operator 195 on rig floor 114 | Verify Setback |
| DW 119, | | completed pre-checks and deactivated | screen. |
| MP 144 | | emergency stop for all pipe handling | Construction |
| | | equipment. | Program setup |
| | | Open Construction Program screen on | wizard. |
| | | touchscreen 522, 524. | After startup: Check |
| | | Select Drilling mode. | for green light in |
| | | Select setup wizard to open pop-up on front | Construction |
| | | screen 532, 534, 536. Verify settings: | Program status |
| | | Stick-up target. | header on front |
| | | Set DW 119 upper/lower stops. | screen 532, 534, |
| | | Set relevant Autodriller parameters | 536. |
| | | (ROP, WOB, delta-P, torque, etc.) | |
| | | Set maximum pull. | |
| | | Verify correct TD 116 MU torque | |
| | | setting. | |
| | | Verify correct drilling torque setting. | |
| | | Verify spin-in speed and torque setting. | |
| | | Verify spin-out time. | |
| | | Verify MP 144 liner size setting and | |
| | | efficiency. | |
| | | Verify MP 144 pressure limit setting. | |
| | | Assign pumps to MP 144 master slider. | |
| | | Verify/set MP 144 ramp-up parameters. | |
| | | Verify active tanks are selected and | |
| | | lined up. | |
| | | Select “activate all machines” to startup and | |
| | | prepare all machines. | |
| All | Driller | Verify all relevant machines are enabled in | Verify operator |
| machines | | zone management system and tubular | screen, system |
| | | interlock system. | settings. |

After such preparations and set-up, the operator 195 may vacate the rig floor 114, and the equipment may be configured to be ready for remote control (e.g., by deactivating emergency stops). An example back-reaming sequence may start with the top drive 116 in lower position and retracted (with elevator links vertical), the slips 161 closed, and the TDA 202 and LSA 228 open in the THP 207. The UTC 242 and LTC 244 may be closed on a tubular 111 in the THP 207, with the ITO 236 being open and retracted, and the TBR 254 and SGA 262 empty (on the way from the FIB 166 to get the next tubular 111 in the THP 207). Example steps of the back-reaming sequence may be as set forth below in Table 10B.

TABLE 10B
Back-Reaming Operation

| | Operator | | Line of | Equipment | Equipment | |
|---|---|---|---|---|---|---|
| | 195 | Operation | Sight | precondition | Functionality | HMI |
| 1. | Driller | Extend TD 116, tilt up | Visual | | | TD 116 to WC |
| | | links: | | | | 203. |
| | | Verify tubular 111 is | | | | Links to |
| | | out of WC 203. | | | | parked position. |
| | | Extend TD 116 to WC | | | | |
| | | 203. | | | | |
| | | Tilt elevator 129 to | | | | |
| | | parked position. | | | | |
| 2. | Driller | TD 116 spin-in: | Visual | Slips 161 closed. | Spin-in will activate | TD 116 to WC |
| | | Apply dope on saver | | | TD 116 thread | 203. |
| | | sub (manual). | | | compensator system. | Links to |
| | | Start spin-in. | | | Spin-in with spin-in | parked position. |
| | | Lower TD 116 and | | | settings (e.g., RPM/ | Thread |
| | | spin to stick-up. | | | torque). | compensator. |
| | | | | | Spin-in will stop at | |
| | | | | | set torque and | |
| | | | | | release the spin-in | |
| | | | | | torque. | |
| 3. | Driller | TD 116 make-up: | Visual | TD 116 spin-in | TD 116 MU will | TD 116 BUC |
| | | Activate TD 116 MU | | finished. | automatically close | close. |
| | | (joystick button and | | | BUC and increase TD | TD 116 MU |
| | | joystick) (may be | | | 116 torque to set MU | torque. |
| | | operated manually on | | | torque. | TD 116 torque |
| | | touchscreen 522, 524). | | | Release torque and | log updated. |
| | | Release button when | | | open BUC when | TD 116 |
| | | MU torque is reached. | | | button is released. | connected state |
| | | | | | DW 119 is | when MU |
| | | | | | interlocked from | torque is |
| | | | | | moving when BUC is | reached. |
| | | | | | closed. | TD thread |
| | | | | | TD 116 thread | compensator |
| | | | | | compensator system | deactivated. |
| | | | | | is deactivated. | |
| 3.1. | Pipe | TDA 202 and LSA 228 | Visual/ | UTC 242 closed. | TDA 202 will retract, | TDA 202 to |
| | Handler | move from THP 207 to | CCTV | TDA 202 open. | hoist, and rotate when | Open state. |
| | | rig floor 114: | | LSA 228 open. | moving from THP 207 | LSA 228 to |
| | | Verify UTC 242 and | | ITC 236 open and | to rig floor 114 | Open state. |
| | | LTC 244 are closed, | | retracted. | standby. | |
| | | TDA 202 and LSA | | | | |
| | | 228 move to rig floor | | | | |
| | | 114 standby. | | | | |
| 3.2. | Pipe | TBR 254 and SGA 262 | Visual/ | TBR 254 and SGA | | TBR 254 and |
| | Handler | get tubular 111 from | CCTV | 262 open. | | SGA 262 to |
| | | THP 207: | | | | Closed states. |
| | | TBR 254 and SGA | | | | |
| | | 262 move to tubular | | | | |
| | | 111 in THP 207. | | | | |
| | | Close TBR 254 and | | | | |
| | | SGA 262 on tubular | | | | |
| | | 111. | | | | |
| 3.3. | Pipe | UTC 242 and LTC 244 | Visual/ | TBR 254 and SGA | UTC 242 and LTC | UTC 242 and |
| | Handler | open and retract: | CCTV | 262 closed on tubular | 244 open and retract. | LTC 244 to |
| | | UTC 242 and LTC | | 111 in THP 207. | | Open state- |
| | | 244 open. | | | | retracted. |
| | | UTC 242 and LTC | | | | |
| | | 244 retract from THP | | | | |
| | | 207. | | | | |
| 3.4. | Pipe | TBR 254 and SGA 262 | Visual/ | Valid FIB 166 position | TBR 254 and SGA | THP load. |
| | Handler | move toward FIB 166 | CCTV | selected. | 262 will follow | |
| | | with tubular 111: | | | predefined path. | |
| | | Lift tubular 111 from | | | FIB 166 latches will | |
| | | THP 207. | | | open when tubular | |
| | | Move to selected | | | 111 is outside | |
| | | position in FIB 166. | | | selected FIB 166 row. | |
| | | | | | FIB 166 latches will | |
| | | | | | close prior to setting | |
| | | | | | down tubular 111. | |
| | | | | | Set down tubular | |
| | | | | | 111 in selected | |
| | | | | | position. | |
| 4. | Driller | Open slips 161 and | Visual/ | TD 116 connected. | | Slips 161 to |
| | | ream out tubular 111: | CCTV | TD thread | | Open state. |
| | | Verify TD 116 is | | compensator | | IBOP to Open |
| | | connected. | | deactivated. | | state. |
| | | Open slips 161. | | | | TD 116 RPM. |
| | | Open IBOP. | | | | TD 116 |
| | | Continue to ream out | | | | torque. |
| | | tubular 111 per drilling | | | | MP 144 SPM. |
| | | program. | | | | Standpipe |
| | | | | | | pressure. |
| 5. | Driller | Set slips 161: | Visual | | | Slips 161 to |
| | | Stop rotation and | | | | Closed state. |
| | | release torque. | | | | |
| | | Stop MP 144 and | | | | |
| | | close IBOP. | | | | |
| | | Set slips 161 at | | | | |
| | | required stick-up (e.g., | | | | |
| | | about 1-2 meters). | | | | |
| 5.1. | Pipe | TDA 202 and LSA 228 | Visual/ | TDA 202 open. | TDA 202 retract to | TDA 202 Load |
| | Handler | move to WC 203 (from | CCTV | LSA 228 open. | vertical, hoist, rotate, | indication. |
| | | rig floor 114 standby). | | | and extend to WC | |
| | | | | | 203 about two meters | |
| | | | | | below stick-up. | |
| | | | | | TDA 202 and LSA | |
| | | | | | 228 will stop/wait | |
| | | | | | outside WC 203 area | |
| | | | | | if TD 116 is moving. | |
| 5.2. | Pipe | Move RN 151 to WC | | RN 151 clamps open. | RN 151 will move to | TJ (stick-up) |
| | Handler | 203: | | WC 203 selected. | WC 203. | assist |
| | | Start RN 151 break- | | | Elevate RN 151 to | indication. |
| | | out sequence to move | | | stick-up. | |
| | | RN 151 to WC 203. | | | RN 151 will stop/ | |
| | | | | | wait outside WC 203 | |
| | | | | | area if TD 116 is | |
| | | | | | moving. | |
| 5.3. | Pipe | TDA 202 and LSA 228 | Visual/ | Slips 161 closed. | TDA 202 and LSA | TDA 202 to |
| | Handler | guide close. | CCTV | | 228 will not close in | Closed state. |
| | | Verify TDA 202 and | | | WC 203 if slips 161 | TDA 202 and |
| | | LSA 228 in WC 203. | | | are not closed. | LSA 228 in WC |
| | | Close TDA 202. | | | | 203. |
| | | Close LSA 228 guide | | | | LSA 228 guide |
| | | funnel. | | | | funnel to Closed |
| | | | | | | state. |
| 6. | Driller | TD 116 break-out | Visual | Slips 161 must be | TD 116 Break-Out | TD 116 thread |
| | | connection: | | closed before TD 116 | function will activate | compensator. |
| | | Verify slips 161 are | | BUT/Break-Out | clamp and increase | TD 116 not |
| | | closed, | | function is available. | torque to break | connected. |
| | | Activate TD 116 | | | connection. | TD116 BUC. |
| | | break-out function | | | TD 116 break-out | |
| | | (joystick button + | | | will activate TD 116 | |
| | | joystick). (Clamp on/ | | | thread compensator | |
| | | break-out may be | | | and TD 116 pipe | |
| | | operated manually on | | | handler lock. | |
| | | touchscreen 522, 524). | | | When connection is | |
| | | Deactivate break-out | | | broken, release | |
| | | button when | | | button. Torque will be | |
| | | connection is broken | | | released and TD 116 | |
| | | (torque dropping and | | | BUC opened. | |
| | | shaft rotating). | | | DW 119 is | |
| | | | | | interlocked from | |
| | | | | | hoisting when TD 116 | |
| | | | | | BUC is closed. | |
| 7. | Driller | TD 116 spin-out: | Visual | Slips 161 must be | Spin-Out will | TD 116 thread |
| | | Verify break-out is | | closed. | activate TD 116 | compensator. |
| | | completed. | | Break-Out not active, | thread compensator | |
| | | Spin-out. | | TD 116 BUC open. | system. | |
| | | Hoist out of stick-up. | | | Spin-Out function | |
| | | | | | will spin-out per | |
| | | | | | settings. | |
| | | | | | TD 116 thread | |
| | | | | | compensator is | |
| | | | | | deactivated. | |
| 8. | Driller | Retract and lower TD | Visual/ | Lowering will be | Links will tilt down | TD 116 |
| | | 116 to stick-up: | CCTV | stopped if TD 116 is | when TD 116 is | retracted. |
| | | Verify TD 116 is | | retracted and links | retracted. | Indicate TD |
| | | above tubular 111. | | are tilted to parked | TD 116 pipe handler | 116 lower stop |
| | | Retract TD 116 and | | position. | has preset position | position. |
| | | tilt links down (float). | | | facing TDA 202. | Link tilt |
| | | Lower TD 116 to | | | | position. |
| | | stick-up (lower stop). | | | | |
| 8.1. | Pipe | RN 151 break-out and | CCTV | Slips 161 closed. | Break-out and spin- | RN 151 |
| | Handler | spin-out: | | | out. Double break- | indication. |
| | | TD 116 disconnected | | | out available if | |
| | | and hoisted above | | | required. | |
| | | tubular 111. | | | Open RN 151 | |
| | | Adjust RN 151 | | | spinner, guide, and | |
| | | elevation if required. | | | clamps. | |
| | | Continue RN 151 | | | Return RN 151 to | |
| | | sequence. | | | park position. | |
| 8.2. | Pipe | MB (THA) extend to | Visual/ | RN 151/THT | MB will extend to WC | MB in WC |
| | Handler | WC 203: | CCTV | retracted. | 203 and close. | 203. |
| | | Verify THT is out of | | MB open. | | MB to Closed |
| | | the area. | | | | state. |
| | | Continue the MB | | | | |
| | | sequence. | | | | |
| 8.3. | Pipe | TDA 202 lift tubular | Visual/ | RN 151 in parked | TDA 202 will hoist | TDA 202 load |
| | Handler | from stick-up: | CCTV | position. | about two meters | indication. |
| | | Hoist TDA 202 to pick | | MB in WC 203. | before lifting tubular | TDA 202 |
| | | up weight. | | TD 116 retracted. | 111. | position |
| | | LSA 228 centralizer | | | Tubular 111 is lifted | indicator. |
| | | closed on tubular 111 | | | carefully. Lifting is | LSA 228 |
| | | in WC 203. | | | stopped if tubular 111 | centralizer. |
| | | Hold tubular 111 | | | catches on TJ | |
| | | above stick-up until | | | threads. | |
| | | drained. | | | LSA 228 centralizer | |
| | | | | | closes after lifted | |
| | | | | | above box. | |
| 8.4. | Pipe | MB open and retract: | Visual/ | | MB will open and | MB to Open |
| | Handler | Verify tubular 111 is | CCTV | | retract. | state. |
| | | drained. | | | | MB parked. |
| | | Continue MB | | | | |
| | | sequence. | | | | |
| 8.5. | Pipe | TDA 202 and LSA 228 | Visual/ | TD 116 elevator 129 | TDA 202 will retract | TDA 202 load |
| | Handler | move tubular 111 to | CCTV | closed. | to vertical position | indication. |
| | | THP 207: | | | above MOH 204 (rig | TDA 202 |
| | | TDA 202 and LSA | | | floor 114 standby), | position |
| | | 228 will move towards | | | then rotate, lower, | indicator. |
| | | THP 207. | | | and extend to THP | LSA 228 |
| | | LTC 244 extends to | | | 207. | extend. |
| | | THP 207 and closes | | | TDA 202 will slow | LTC 244 to |
| | | guide when tubular 111 | | | down above THP | Closed state. |
| | | is close to THP 207. | | | 207. | Wash and |
| | | Set down tubular 111 | | | LTC 244 is extended | dope (if |
| | | on THP 207. | | | and closed. | selected). |
| | | Wash and dope pin if | | | LSA 228 open. | |
| | | preselected. | | | | |
| 8.6. | Pipe | UTC 242 extend THP | Visual/ | TDA 202 and LSA | UTC 242 extend and | UTC 242 and |
| | Handler | 207 and close: | CCTV | 228 in THP 207 with | close. | LTC 244 to |
| | | UTC 242 extends to | | tubular 111. | LTC 244 continue | Closed states. |
| | | THP 207. | | | close. | |
| | | UTC 242 and LTC | | | | |
| | | 244 close. | | | | |
| 8.7. | Pipe | TDA 202 open and | Visual/ | UTC 242 closed. | | TDA 202 to |
| | Handler | retract from THP 207: | CCTV | | | Open state. |
| | | Verify UTC 242 and | | | | LSA 228 open. |
| | | LTC 244 are closed. | | | | |
| | | Open TDA 202. | | | | |
| | | Open LSA 228 guide | | | | |
| | | funnel. | | | | |
| | | Continue on step 3.1. | | | | |
| 8.8. | Pipe | TBR 254 and SGA 262 | | FIB 166 latches | | FIB 166 |
| | Handler | move toward THP 207: | | closed. | | latches closed. |
| | | Open TBR 254 | | | | TBR 254 and |
| | | clamps and guide and | | | | SGA 262 open. |
| | | SGA 262 guide (in FIB | | | | |
| | | 166). | | | | |
| | | Move toward THP | | | | |
| | | 207/next tubular 111. | | | | |
| | | Continue step 3.2. | | | | |

For tripping-in drill collar stands, an operator 195 on the rig floor 114 may verify that various pieces of equipment are properly shut down and locked out, and then perhaps perform other preparations such as the examples set forth below in Table 11A.

TABLE 11A
Preparations for Tripping-In Drill Collar Stands

| Equipment | Responsible | Verifications |
|---|---|---|
| FIB 166 | Operator 195 on rig floor 114. | Tubulars 111 exist in FIB 166 slots per |
| Setback 164 | | HMI/tally. |
| | | Fingers are closed. |
| | | Travel path is unobstructed. |
| TBR 254 | Operator 195 on rig floor 114. | Travel path is unobstructed. |
| SGA 262 | | Gripper inserts/dies are clean, not worn. |
| LTC 244 | Operator 195 on rig floor 114. | Travel path is unobstructed. |
| ITC 236 | | Gripper inserts/dies are clean, not worn. |
| UTC 242 | | |
| THP | Operator 195 on rig floor 114. | Travel path is unobstructed. |
| Doper 209 | | Water, correct dope available for doper |
| | | 209. |
| LSA 228 | Operator 195 on rig floor 114. | Travel path is unobstructed. |
| TDA 202 | Operator 195 on rig floor 114. | TDA 202 is parked outside collision |
| | | area. |
| RN 151 | Operator 195 on rig floor 114. | DPT is connected. |
| THT-DPT | | Gripper dies are clean, not worn. |
| THA-DPT | | Travel path is unobstructed. |
| Slips 161 | Operator 195 on rig floor 114; and/or | Correct inserts/dies. |
| | “Driller” 195 at workstation 452. | Inserts/dies are clean, not worn. |
| TD 116 | Operator 195 on rig floor; and/or | Correct inserts/dies in elevator 129. |
| | “Driller” 195 at workstation 452. | Correct saver sub status. |
| | | Travel path is unobstructed. |
| DW 119 | Operator 195 on rig floor; and/or | Checked. |
| | “Driller” 195 at workstation 452. | |

The well construction system 100, 200 can then be set-up for the trip-in sequence. Examples of such set-up may be as set forth below in Table 11B.

TABLE 11B
Set-Up for Tripping-In Drill Collar Stands

| Equipment | Responsible | Set-Up | HMI |
|---|---|---|---|
| Pipe | Driller/ | Verify operator 195 on rig floor 114 | Verify Setback screen. |
| handling: | Pipe | completed pre-checks and deactivated | Construction Program |
| TBR 254, | Handler | emergency stop for all pipe handling | setup wizard. |
| SGA 262, | | equipment. | After startup: Check for |
| UTC 242, | | Open Construction Program screen on | green light in |
| LTC 244, | | touchscreen 522, 524. | Construction Program |
| THP 207, | | Select Trip In mode. | status header on front |
| LSA 228, | | Select setup wizard to open pop-up on | screen 532, 534, 536. |
| RN 151 | | front screen 532, 534, 536. Verify | |
| | | settings: | |
| | | Select slot, direction for picking | |
| | | pipe. | |
| | | Select pipe type. | |
| | | Select RN 151 to use. | |
| | | RN 151 MU torque. | |
| | | Select pin/box doping. | |
| | | Stick-up target. | |
| | | Select “activate all machines” to startup | |
| | | and prepare all machines. | |
| TD 116, | Driller | Verify operator 195 on rig floor 114 | Verify Setback screen. |
| DW 119, | | completed pre-checks and deactivated | Construction Program |
| MP 144, | | emergency stop for all pipe handling | setup wizard. |
| Trip tank | | equipment. | After startup: Check for |
| | | Open Construction Program screen on | green light in |
| | | touchscreen 522, 524. | Construction Program |
| | | Select Trip In mode. | status header on front |
| | | Select setup wizard to open pop-up on | screen 532, 534, 536. |
| | | front screen 532, 534, 536. Verify | |
| | | settings: | |
| | | Stick-up target. | |
| | | Set DW 119 upper/lower stops. | |
| | | Set maximum lowering speed. | |
| | | Set minimum slack off weight. | |
| | | Trip tank 1/2/auto. | |
| | | Trip tank low/high levels. | |
| | | Select “activate all machines” to startup | |
| | | and prepare all machines. | |
| TD 116 | Driller | Verify operator 195 on rig floor 114 | Verify operator screen, |
| | | completed pre-checks. | system status/alarms. |
| | | Activate TD 116 from touchscreen 522, | |
| | | 524. | |
| | | Select Operation screen on touchscreen | |
| | | 522, 524. | |
| DW 119 | Driller | Activate DW 119 from touchscreen 522, | Verify operator screen, |
| | | 524. | system status/alarms. |
| All | Driller | Verify all relevant machines are enabled | Verify operator screen, |
| machines | | in zone management system and | system status/alarms. |
| | | tubular interlock system. | |

After such preparations and set-up, the operator 195 may vacate the rig floor 114, and the equipment may be configured to be ready for remote control (e.g., by deactivating emergency stops). The sequence for tripping-in drill collar stands may start with a drill collar stand 111 stick-up at WC 203, with the top drive 116 elevator 129 closed on the stick-up and the slips 161 closed. The UTC 242 and LTC 244 may be closed on another drill collar stand 111 in the THP 207, with washing and doping of the pin already completed. The TDA 202, LSA 228, TBR 254, and SGA 262 may each be empty. Example steps of the drill collar stand tripping-in sequence may be as set forth below in Table 11C.

TABLE 11C
Tripping-In Drill Collar Stands Operation

| | Operator | | Line of | Equipment | Equipment | |
|---|---|---|---|---|---|---|
| | 195 | Operation | Sight | precondition | Functionality | HMI |
| 1. | Driller | Open elevator 129: | Visual/ | Slips 161 must be | Elevator 129 Open is | Elevator 129 to |
| | | Verify slips 161 are | CCTV | closed before opening | not selectable if slips | Open state. |
| | | closed. | | elevator 129. | 161 are not closed. | |
| | | Open elevator 129. | | | | |
| 1.1. | Pipe | TBR 254 and SGA 262 | Visual/ | TBR 254 and SGA | TBR 254 will move | TBR 254 and |
| | Handler | pick up new stand 111: | CCTV | 262 grip/guide open. | into FIB 166 elevated | SGA 262 grip/ |
| | | Move TBR 254 and | | Selected FIB 166 | above open latches. | guide to Closed |
| | | SGA 262 to selected | | position “valid.” | Adjustments available, | state. |
| | | finger/slot in FIB 166. | | | TBR 254 and SGA | |
| | | Close guides and | | | 262 grip/guide will | |
| | | clamp on stand 111. | | | close. | |
| 2. | Driller | Tilt back elevator 129 | Visual/ | TD 116 pipe handler | Elevator 129 will be | DW 119 upper |
| | | and move TD 116 to | CCTV | positioned facing UTC | tilted back and then | stop setting. |
| | | latching height: | | 242. | slide back to vertical | |
| | | Verify elevator 129 is | | | position (float). | |
| | | open. | | | | |
| | | Tilt back (or retract) | | | | |
| | | TD 116 to clear TJ. | | | | |
| | | Hoist elevator 129 to | | | | |
| | | stand 111 latch height | | | | |
| | | (upper stop). | | | | |
| 2.1. | Pipe | UTC 242 and LTC 244 | Visual/ | | UTC 242 and LTC | UTC 242 and |
| | Handler | tilt stand 111 to drill | CCTV | | 244 will stop at | LTC 244 closed. |
| | | collar handover | | | correct angle, DCH. | UTC 242 and |
| | | position (DCH): | | | | LTS 244 to DCH. |
| | | UTC 242 and LTC | | | | |
| | | 244 extend to tilt stand | | | | |
| | | 111 toward WC 203. | | | | |
| 2.2. | Pipe | LSA 228 extend to | Visual/ | LSA 228 guide funnel | | LSA 228 funnel |
| | Handler | stand 111 in THP 207: | CCTV | must be open. | | to Closed state. |
| | | Extend LSA 228 to | | UTC 242 and LTC | | |
| | | stand 111 in THP 207 | | 244 in DCH. | | |
| | | (tilted). | | | | |
| | | Close LSA 228 | | | | |
| | | funnel. | | | | |
| 3. | Driller | Extend TD 116 and | Visual/ | UTC 242 and LTC | | Elevator 129 to |
| | | latch elevator 129: | CCTV | 244 in DCH. | | Closed state. |
| | | Extend TD 116 to WC | | | | TD 116 in WC |
| | | 203. | | | | 203. |
| | | Latch elevator 129 | | | | UTC 242 and |
| | | (automatic close on | | | | LTC 244 in DCH. |
| | | impact). | | | | |
| 3.1. | Pipe | UTC 242 and LTC 244 | Visual/ | TD 116 elevator 129 | UTC 242 and LTC | UTC 242 and |
| | Handler | open and retract. | CCTV | must be closed. | 244 open and retract. | LTC 244 to |
| | | | | LSA 228 funnel must | | Open states. |
| | | | | be closed. | | |
| 3.2. | Pipe | Move RN 151 to WC | | Only possible with | RN 151 will move to | TJ (stick-up) |
| | Handler | 203: | | THT. If THA is used, | WC 203. | assist |
| | | Start RN 151 MU | | wait for stand 111 | Elevate RN 151 to | indication. |
| | | sequence to move RN | | located above stick-up. | stick-up. | |
| | | 151 to WC 203. | | RN 151 tongs open. | | |
| | | | | WC 203 selected. | | |
| 4. | Driller | TD 116 hoist stand 111 | Visual/ | UTC 242 or LTC 244 | Slips 161 Open will | TD 116 at WC |
| | | from THP 207: | CCTV | open. | be blocked with | 203. |
| | | TD 116/DW 119 lift | | | elevator 129 closed in | |
| | | stand 111 guided by | | | WC 203 until stand | |
| | | LSA 228 (e.g., about | | | 111 is connected. | |
| | | nine meters). Stop | | | | |
| | | when above stick-up. | | | | |
| | | Note: Drill collar stand | | | | |
| | | 111 to be lifted | | | | |
| | | carefully to avoid | | | | |
| | | damage to equipment. | | | | |
| | | Links tilt to WC 203 | | | | |
| | | (float). | | | | |
| 4.1. | Pipe | LSA 228 guide stand | Visual/ | | | LSA 228 |
| | Handler | 111 to WC 203: | CCTV | | | centralizer to |
| | | LSA 228 guides stand | | | | Closed state. |
| | | 111 to WC 203 when | | | | LSA 228 |
| | | pin is above stick-up | | | | adjustment |
| | | height. | | | | available. |
| | | LSA 228 centralizer | | | | |
| | | closes when stand 111 | | | | |
| | | is close to vertical | | | | |
| | | above stick-up. | | | | |
| 4.2. | Pipe | Guide stand 111 with | CCTV | Stand 111 positioned | Close RN 151 BUT. | Stabbing guide |
| | Handler | RN 151 in WC 203: | | by TD 116/LSA 228 | Close stabbing guide. | to Closed state. |
| | | Verify stand 111 is | | above stick-up in WC | | RN 151 BUT to |
| | | located in WC 203. | | 203. | | Closed state. |
| | | Adjust RN 151 | | | | |
| | | elevation if required. | | | | |
| | | Continue RN 151 | | | | |
| | | sequence. | | | | |
| 5. | Driller | TD 116 lower to stab | Visual/ | RN 151 in WC 203 | | |
| | | stand 111 in stick-up. | CCTV | with stabbing guide | | |
| | | | | closed. | | |
| 5.1. | Pipe | LSA 228 open and | Visual/ | RN 151 stabbing | | LSA 228 guide |
| | Handler | retract: | CCTV | guide closed on stand | | to Open state. |
| | | LSA 228 opens and | | 111. | | |
| | | retracts when RN 151 | | | | |
| | | stabbing guide closed | | | | |
| | | on stand 111. | | | | |
| 5.2. | Pipe | RN 151 spin-in and | Visual/ | Stand 111 stabbed in | Spin-in and MU | Torque log |
| | Handler | MU: | CCTV | stick-up. | connection. | updated. |
| | | Continue RN 151 | | TDA 202 unloaded. | Open RN 151 spinner | MU torque |
| | | sequence to spin-in | | | and tongs. | presented to |
| | | and MU. | | | Return RN 151 to | Driller. |
| | | | | | park position. | |
| 5.3. | Pipe | TBR 254 and SGA 262 | Visual/ | THP 207 empty. | TBR 254 cannot open | Indicate FIB |
| | Handler | move stand 111 to | CCTV | UTC 242 and LTC | with weight. | 166 open |
| | | THP 207: | | 244 open. | TBR 254 grip open | latches. |
| | | Open FIB 166 latches | | Correct pipe detected | when unloaded. | TBR 254 load |
| | | for selected row. | | in TBR 254 and SGA | FIB 166 latches will | indication. |
| | | Verify latches open. | | 262. | not open with TBR 254 | |
| | | TBR 254 lifts and | | | head in low position. | |
| | | moves stand 111 out of | | | | |
| | | FIB 166 to THP 207. | | | | |
| | | FIB 166 latches will | | | | |
| | | close as stand 111 | | | | |
| | | moves out of FIB 166. | | | | |
| | | Set stand 111 on | | | | |
| | | THP 207. | | | | |
| | | Wash and dope pin if | | | | |
| | | preselected. | | | | |
| 5.4. | Pipe | UTC 242 and LTC 244 | Visual/ | TBR 254 and SGA | UTC 242 and LTC | UTC 242 and |
| | Handler | extend to THP 207 and | CCTV | 262 with stand 111 in | 244 extend and close. | LTC 244 to |
| | | close. | | THP 207. | | Closed states. |
| 5.5. | Pipe | TBR 254 and SGA 262 | | UTC242 and LTC 244 | | |
| | Handler | open and move toward | | closed on stand 111. | | |
| | | FIB 166: | | | | |
| | | Open TBR 254 | | | | |
| | | clamps and guide and | | | | |
| | | SGA 262 guide. | | | | |
| | | Move toward FIB 166/ | | | | |
| | | next stand 111. | | | | |
| | | Continue step 1. | | | | |
| 6. | Driller | Opening slips: | Visual | TD 116 elevator 129 | | Slips 161 to |
| | | Open slips 161 | | closed. | | Open state. |
| | | (command). | | RN 151 MU | | DW 119 load. |
| | | Hoist to open slips | | sequence finished. | | |
| | | 161. | | Stand 111 connected | | |
| | | | | state. | | |
| 7. | Driller | Lower drill string 120: | Visual | Slips 161 open. | | Settings: DW |
| | | Verify slips 161 are | | | | 119 lowering |
| | | open before lowering | | | | speed and |
| | | drill string 120. | | | | minimum slack- |
| | | | | | | off weight. |
| 8. | Driller | Set slips 161: | Visual | Stick-up at correct | | Slips 161 to |
| | | Set slips 161 at | | height. | | Closed state. |
| | | correct stick-up height. | | | | DW 119 load |
| | | Set off weight. | | | | indicator. |
| 9. | Driller | Check trip tank | Visual | Slips 161 closed. | Trip tank gain/loss is | Trip sheet/ |
| | | volume, gain/loss: | | | determined and | volume control. |
| | | Trip tank gain/loss. | | | displayed. | |
| | | Repeat all steps for | | | | |
| | | next stand 111. | | | | |

Different combinations of the aspects described above may also be utilized for running casing from the CW 131 with the TDA 202 and a casing running tool (CRT). Preparations for such operation may include the examples set forth below in Table 12A.

TABLE 12A
Preparations for Running Casing from CW with TDA and CRT

| Equipment | Responsible | Verifications |
|---|---|---|
| CW 131 | Operator 195 on | Travel path is unobstructed. |
| | rig floor 114. | Casings are laid out correct with aft end in line with skate 133 |
| | | for correct loading. |
| | | Prepare to pick up casing. |
| CTO: | Operator 195 on | CTO is rigged up in THA (or THT). |
| THA + CTO | rig floor 114. | CTO adjusted for casing size. |
| as primary, | | Dies are correct, clean, and not worn. |
| THT + CTO | | Travel path is unobstructed. |
| as backup | | |
| LSA 228 | Operator 195 on | Travel path is unobstructed. |
| | rig floor 114. | |
| Slips 161 | Operator 195 on | Correct inserts in slips 161. |
| Rotary | rig floor 114. | Dies are clean and not worn. |
| Table | | Rotary table rotation lock activated. |
| TD 116, | Operator 195 on | Correct inserts in elevator 129 (or elevator 129 removed, if |
| CRT | rig floor 114. | required). |
| | | Operator screen, system status. |
| | | Travel path is unobstructed. |
| | | CRT installed and tested. |
| DW 119 | Operator 195 on | Checked. |
| | rig floor 114. | |
| Tubulars | Operator 195 on | Tubulars 111 to be laid out on CW 131. |
| 111 | rig floor 114. | Tubulars 111 to be cleaned and doped, protectors removed |
| | | (other implementations may be used for casing with protectors). |
| | | Casings measured, marked, and tally updated. |

The well construction system 100, 200 can then be set-up for the operation. Examples of such set-up may be as set forth below in Table 12B.

TABLE 12B
Set-Up for Running Casing from CW with TDA and CRT

| Equipment | Responsible | Set-Up | HMI |
|---|---|---|---|
| Pipe | Pipe | Verify operator 195 on rig floor 114 | Verify Setback |
| handling: | Handler | completed pre-checks and deactivated | screen. |
| LSA 228, | | emergency stop for all pipe handling | Construction |
| CTO, | | equipment. | Program setup |
| CW 131 | | Open Construction Program screen on | wizard. |
| | | touchscreen 522, 524. | After startup: Check |
| | | Select Running Casing from CW with TDA | for green light in |
| | | and CRT mode. | Construction |
| | | Select setup wizard to open pop-up on front | Program status |
| | | screen 532, 534, 536. Verify settings: | header on front |
| | | Select casing type and verify casing | screen 532, 534, |
| | | data (size, weight, MU loss, torque | 536. |
| | | settings, weight, etc.). | |
| | | Select CTO to use in the operations. | |
| | | Stick-up target. | |
| | | Select “activate all machines” to startup and | |
| | | prepare all machines. | |
| TD 116, | Driller | Verify operator 195 on rig floor 114 | Verify Setback |
| DW 119, | | completed pre-checks and deactivated | screen. |
| MP 144 | | emergency stop for all pipe handling | Construction |
| | | equipment. | Program setup |
| | | Open Construction Program screen on | wizard. |
| | | touchscreen 522, 524. | After startup: Check |
| | | Select Running Casing from CW with TDA | for green light in |
| | | and CRT mode. | Construction |
| | | Select setup wizard to open pop-up on front | Program status |
| | | screen 532, 534, 536. Verify settings: | header on front |
| | | Stick-up target. | screen 532, 534, |
| | | Set DW 119 upper/lower stops. | 536. |
| | | Set maximum lowering speed. | |
| | | Set minimum slack of weight. | |
| | | Trip tank 1/2/auto. | |
| | | Trip tank low/high levels. | |
| | | Verify active tanks are selected and | |
| | | lined up. | |
| | | Select MP 144 (to fill casing, optional). | |
| | | Verify MP 144 pressure limit setting. | |
| | | Assign pumps to master slider. | |
| | | Set number of strokes and SPM to fill | |
| | | casing (optional). | |
| | | Set ramp-up parameters. | |
| | | Select “activate all machines” to startup and | |
| | | prepare all machines. | |
| TD 116 | Driller | Verify operator 195 on rig floor 114 | Verify operator |
| | | completed pre-checks. | screen, system |
| | | Activate TD 116 from touchscreen 522, | status/alarms. |
| | | 524. | |
| | | Verify correct elevator 129 setting | |
| | | (manual/remote). | |
| | | Select Operation screen on touchscreen 522, | |
| | | 524. | |
| DW 119 | Driller | Activate DW 119 from touchscreen 522, | Verify operator |
| | | 524. | screen, system |
| | | Set maximum lowering speed. | status/alarms. |
| | | Set minimum slack off weight. | |
| Slips 161, | Driller | Verify correct setting for slips 161 | Verify operator |
| Rotary | | (manual/remote). | screen, system |
| table | | | status/alarms. |
| All | Driller | Verify all relevant machines are enabled in | |
| machines | | zone management system and tubular | |
| | | interlock system. | |
| Tubulars | Pipe | All types of tubulars 111 are registered. | |
| 111 | Handler | | |

After such preparations and set-up, the operator 195 may vacate the rig floor 114, and the equipment may be configured to be ready for remote control (e.g., by deactivating emergency stops). An example of this sequence may start with a casing stick-up at WC 203, with the slips 161 closed and the CRT engaged. Casing may be laid out on the CW 131 casing side (e.g., Driller's side), having been cleaned, doped, and tallied, and with protectors removed. The TDA 202 and LSA 228 may hold a casing 111 in the rig floor 114 standby position. Example steps of the sequence may be as set forth below in Table 12C.

TABLE 12C
Sequence for Running Casing from CW with CTO

| | Operator | | Line of | Equipment | Equipment | |
|---|---|---|---|---|---|---|
| | 195 | Operation | Sight | precondition | Functionality | HMI |
| 1. | Driller | Release CRT from | Visual/ | Slips 161 must be | | CRT to |
| | | stick-up: | CCTV | closed before releasing | | Disconnect |
| | | Verify slips 161 are | | CRT. | | state. |
| | | closed, MP 144 | | | | |
| | | stopped, and IBOP | | | | |
| | | closed. | | | | |
| | | Release CRT from | | | | |
| | | stick-up. | | | | |
| | | Hoist CRT above | | | | |
| | | stick-up. | | | | |
| | | Retract and hoist to | | | | |
| | | casing stabbing | | | | |
| | | position. | | | | |
| 1.1. | Pipe | Move THT/CTO to WC | | CTO open. | CTO will move to WC | THT in WC 203. |
| | Handler | 203 (optional): | | WC 203 selected. | 203. | |
| | | Verify TD 116 hoisted | | | Elevate to stick-up. | |
| | | above CTO working | | | ZMS will prevent | |
| | | area. | | | CTO start if TD 116 is | |
| | | Start CTO sequence | | | too low. | |
| | | to move THT/CTO to | | | | |
| | | WC 203. | | | | |
| 1.2. | Pipe | TDA 202 and LSA 228 | | CTO open. | | TDA 202 and |
| | Handler | extend casing to WC | | | | LSA 228 in WC |
| | | 203: | | | | 203. |
| | | Verify TD 116 is | | | | |
| | | retracted. | | | | |
| | | TDA 202 and LSA | | | | |
| | | 228 will extend casing | | | | |
| | | to WC 203 above stick- | | | | |
| | | up. | | | | |
| 1.3. | Pipe | Guide single casing | Visual/ | CTO in WC 203. | Close CTO BUT. | |
| | Handler | with CTO in WC 203: | CCTV | LSA 228 in WC 203. | Close stabbing guide. | |
| | | Verify casing at WC | | | | |
| | | 203. | | | | |
| | | Continue CTO | | | | |
| | | sequence. | | | | |
| 1.4. | Pipe | Close MUST for soft | Visual/ | CTO in WC 203. | Close MUST. | MUST to |
| | Handler | stabbing (optional): | CCTV | | Must will take some | Closed state. |
| | | Adjust CTO elevation | | | load if closed prior to | |
| | | and TD 116 elevation if | | | stabbing casing. | |
| | | required. | | | | |
| | | Continue CTO | | | | |
| | | sequence. | | | | |
| 1.5. | Pipe | Stab casing: | Visual/ | TDA 202 in WC 203. | TDA 202 will lower to | TDA 202 |
| | Handler | Lower TDA 202 to | CCTV | CTO in WC 203 with | stab casing and | unloaded. |
| | | stab casing in stick-up. | | stabbing guide closed. | continue lowering | |
| | | | | | (e.g., about one | |
| | | | | | meter). | |
| 1.6. | Pipe | Open and retract LSA | Visual/ | CTO stabbing guide | | LSA 228 Open |
| | Handler | 228: | CCTV | closed. | | status. |
| | | Open and retract LSA | | | | |
| | | 228 when casing has | | | | |
| | | entered stabbing | | | | |
| | | guide. | | | | |
| 1.7. | Pipe | CTO spin-in and MU: | Visual/ | Single casing stabbed | CTO will spin-in and | Casing |
| | Handler | Verify casing is | CCTV | in stick-up. | MU automatically per | Connected state. |
| | | stabbed in box. | | TD 116 unloaded, | casing data settings. | |
| | | Continue CTO | | elevator 129 below TJ | If Accept: Open | |
| | | sequence. | | to permit spinning. | spinner, guide, and | |
| | | Accept or reject MU. | | | clamps. | |
| | | | | | Return to park | |
| | | | | | position. | |
| 1.8. | Pipe | Load casing into ramp | Visual/ | Casing ready in | | |
| | Handler | 149: | CCTV | loading position. | | |
| | | Use CW 131 loading | | CW 131 in loading | | |
| | | fingers to load casing | | position. | | |
| | | single into ramp 149. | | | | |
| 1.9. | Pipe | Run ramp 149 to rig | Visual/ | Casing loaded onto | Ramp 149 will tilt to | CW 131 |
| | Handler | floor 114: | CCTV | ramp 149. | rig floor 114 tubular | animated. |
| | | Verify casing is | | | position. | |
| | | loaded in ramp 149. | | | Skate 133 will move | |
| | | Move ramp toward | | | toward rig floor 114. | |
| | | pipe pick-up position. | | | Skate 133 will stop | |
| | | | | | with casing box inside | |
| | | | | | ramp 149. | |
| 2. | Driller | Stab and engage CRT: | Visual/ | Single casing | | CRT Connected |
| | | Verify casing is | CCTV | stabbed in stick-up. | | state. |
| | | stabbed and MU | | TDA 202 unloaded, | | |
| | | accepted. | | elevator (or gripper | | |
| | | Stab and engage | | 169) below TJ to | | |
| | | CRT. | | permit spinning. | | |
| | | | | CTO open. | | |
| 2.1. | Pipe | Open TDA 202 and | | Casing connected. | Open CTO BUT and | TDA 202 Open. |
| | Handler | move to pick up next | | CRT connected. | move THT to parked | |
| | | casing single: | | | position. | |
| | | Open TDA 202 and | | | | |
| | | move to CW 131 pick- | | | | |
| | | up position. | | | | |
| 3. | Driller | Open slips 161: | Visual | CRT connected. | | Slips 161 to |
| | | Open slips 161 | | Casing connected. | | Open state. |
| | | (command). | | | | DW 119 load. |
| | | Hoist to open slips | | | | |
| | | 161. | | | | |
| 4. | Driller | Lower drill string 120: | Visual | Slips 161 open. | Optional: The selected | MP 144 SPM |
| | | Verify slips 161 are | | Optional: MP 144 | MP 144 will pump a | and pressure. |
| | | open before lowering | | ready. | set number of strokes | |
| | | drill string 120. | | | at set rate with | |
| | | Optional: Fill casing | | | selected MP 144 and | |
| | | volume, if selected. | | | stop. | |
| | | Open IBOP. | | | | |
| | | Start MP 144. | | | | |
| | | Close IBOP. | | | | |
| 4.1. | Pipe | Push casing to pick-up | Visual | Ramp 149 in rig floor | Skate 133 will push | CW 131 in pick- |
| | Handler | position: | | 114 position. | casing a defined | up position. |
| | | Verify TDA 116 | | TDA 202 in CW 131 | distance forward. | TDA 202 in CW |
| | | elevator 129 is | | pick-up position. | | 131 pick-up |
| | | positioned in CW 131 | | TDA 202 open. | | position. |
| | | pick-up position. | | | | |
| | | Run skate 133 until | | | | |
| | | casing is positioned | | | | |
| | | above elevator 129. | | | | |
| 4.2. | Pipe | Close TDA 202: | Visual | Casing in CW 131 | Tubular interlock will | TD 202 to |
| | Handler | Hoist/tilt TDA 202 and | | pick-up position, above | prevent hoisting | Closed state. |
| | | close. | | TDA 202 elevator. | without closed | |
| | | | | | elevator (above | |
| | | | | | certain height). | |
| 5. | Pipe | Lift casing to rig floor | Visual | TDA 202 closed. | Hoisting will stop | LSA 228 guide |
| | Handler | 114 DF standby | | Verify LSA 228 is | prior to lifting casing | to Closed state. |
| | | position: | | positioned to receive | out of CW 131 without | LSA 228 |
| | | Verify TDA 202 is | | casing bottom before | guiding. | centralizer to |
| | | closed. | | hoisting. | LSA 228 centralizer | Closed state. |
| | | Hoist TDA 202 to pick | | TDA 202 above LSA | close when casing is | Indicate TDA |
| | | up single from CW | | 228 operating area. | close to vertical. | 202/LSA 228 in |
| | | 131. | | | TDA 202 and LSA | MOH 204 |
| | | Move LSA 228 to | | | 228 will position | position. |
| | | preset position to | | | casing above MOH | |
| | | prepare for guiding. | | | 204/ITC 236 with TDA | |
| | | Before casing lower | | | 202 elevator facing | |
| | | end leaves CW 131, | | | TD 116. | |
| | | close LSA 228 funnel. | | | | |
| | | Continue hoisting and | | | | |
| | | rotate TDA 202 until | | | | |
| | | casing is above MOH | | | | |
| | | 204 (rig floor 114 | | | | |
| | | standby position). | | | | |
| | | Continue step. 1.1. | | | | |
| 6. | Pipe | CW 131 retract to | Visual/ | | Skate 133 will move | |
| | Handler | loading position: | CCTV | | to loading position. | |
| | | Verify casing pin end | | | Ramp 149 will tilt to | |
| | | is clear of ramp 149. | | | loading position. | |
| | | Move CW 131 toward | | | | |
| | | FT loading position. | | | | |
| | | Continue step 1.6. | | | | |
| 7. | Driller | Set slips 161: | Visual | Stick-up at correct | | Slips 161 to |
| | | Set slips 161 at | | height. | | Closed state. |
| | | correct stick-up height. | | | | DW 119 load |
| | | Set off weight. | | | | indicator. |
| 8. | Driller | Check gain/loss: | Visual | | Trip tank or active | Volume control. |
| | | Check trip tank gain/ | | | tank gain/loss is | |
| | | loss or active gain/loss | | | determined and | |
| | | depending on selected | | | displayed. | |
| | | operation. | | | | |
| 9. | | Repeat sequence for | | | | |
| | | next casing. | | | | |

Different combinations of the aspects described above may also be utilized for building stands of two or more casing singles. Such casing stand building may be performed during drilling and other operations performed at WC 203. Such simultaneous operations, however, are coordinated to avoid conflicts and obstructions between the different machines and systems. For example, the elevator of the TDA 202 may have two different sizes of inserts to permit building casing stands while drilling. The change of head size may be done remote from the Pipe Handler's workstation 450 (or 452 or 454). When a casing stand building operation is to be performed, an operator 195 on the rig floor 114 may verify that various pieces of equipment are properly shut down and locked out, and then perhaps perform other preparations such as the examples set forth below in Table 13A.

TABLE 13A
Casing Stand Building Preparations

| Equipment | Responsible | Verifications |
|---|---|---|
| CW 131 | Operator 195 on | Travel path is unobstructed. |
| | rig floor 114. | Prepare for casing pick-up. |
| | | Casings are laid out correctly with aft end in line with skate 133 |
| | | for correct loading. |
| FIB 166 | Pipe Handler | Stands in FIB 166 slots per HMI. |
| | | Fingers closed. |
| | | Travel path is unobstructed. |
| TBR 254 | Pipe Handler | Travel path is unobstructed. |
| SGA 262 | Pipe Handler | Travel path is unobstructed. |
| LTC 244 | Operator 195 on | Travel path is unobstructed. |
| ITC 236 | rig floor 114. | Dies are clean and not worn. |
| UTC 242 | | |
| THP | Operator 195 on | Travel path is unobstructed. |
| Doper 209 | rig floor 114. | Water and correct dope available for doper 209. |
| LSA 228 | Operator 195 on | Travel path is unobstructed. |
| | rig floor 114. | |
| TDA 202 | Operator 195 on | Travel path is unobstructed. |
| | rig floor 114. | Correct dope is available for associated doper 209. |
| | | Correct inserts installed. |
| CTO: | Operator 195 on | CTO is rigged up in THA. |
| THA-CTO | rig floor 114. | Correct adaptors and stabbing guide funnel are installed. |
| | | Dies are correct, clean, and not worn. |
| | | Travel path is unobstructed. |
| Tubulars | Operator 195 on | Tubular 111 to be loaded on FT. |
| 111 | rig floor 114. | Tubulars 111 to be cleaned and doped, protectors removed. |

The well construction system 100, 200 can then be set-up for the casing stand building operation. Examples of such set-up may be as set forth below in Table 13B.

TABLE 13B
Casing Stand Building Set-Up

| Equipment | Responsible | Set-Up | HMI |
|---|---|---|---|
| Pipe | Pipe | Verify operator 195 on rig floor 114 | Verify Setback |
| handling: | Handler | completed pre-checks and deactivated | screen. |
| TBR 254, | | emergency stop for all pipe handling | Construction |
| SGA 262, | | equipment. | Program setup |
| UTC 242, | | Open Construction Program screen on | wizard. |
| LTC 244, | | touchscreen 522, 524. | After startup: Check |
| ITC 236, | | Select Casing Stand Building mode. | for green light in |
| THP 207, | | Select setup wizard to open pop-up on front | Construction |
| TDA 202, | | screen 532, 534, 536. Verify settings: | Program status |
| LSA 228, | | Select slot, direction for racking stands. | header on front |
| RN 151, | | Select casing size/type. | screen 532, 534, |
| CW 131 | | Select CTO (with THA) to use. | 536. |
| | | CTO MU torque. | |
| | | Perform pin/box doping. | |
| | | Stick-up target. | |
| | | Select “activate all machines” to startup and | |
| | | prepare all machines. | |
| All | Pipe | Verify all relevant machines are enabled in | |
| machines | Handler | zone management system and tubular | |
| | | interlock system. | |
| Tubulars | Pipe | All tubulars 111 to be registered in | |
| 111 | Handler | electronic tally system. | |

After such preparations and set-up, the operator 195 may vacate the rig floor 114, and the equipment may be configured to be ready for remote control (e.g., by deactivating emergency stops). An example casing stand building sequence may start with the MOH 204 and THP 207 empty, the ITC 236 retracted, and the CW 131 feeding table pre-loaded with casing singles (perhaps already cleaned and doped). Example steps of the casing stand building sequence may be as set forth below in Table 13C. In such example, among others within the scope of the present disclosure, the pipe handling equipment may be operated automatically via the Construction Program, and the step execution of the pipe handling equipment may be controlled automatically by one or two operators 195 at the associated workstation(s) 450, 452, 454. The Construction Program may also feature configurable step confirmations. The casing stand building sequence controlled by the Construction Program may be stopped or interrupted at any time, and some or all functions may be operated manually by the one or two operators 195 at the associated workstation(s) 450, 452, 454.

TABLE 13C
Casing Stand Building Operation

| | Operator | | Line of | Equipment | Equipment | |
|---|---|---|---|---|---|---|
| | 195 | Operation | Sight | precondition | Functionality | HMI |
| 1. | Pipe | Load casing single into | Visual/ | Casing ready in | | |
| | Handler | ramp 149: | CCTV | loading position. | | |
| | | Verify ramp 149 is | | CW 131 in loading | | |
| | | empty and in position. | | position. | | |
| | | Use loading fingers to | | | | |
| | | load casing single into | | | | |
| | | ramp 149. | | | | |
| 2. | Pipe | Run ramp 149 to pick- | Visual/ | Casing loaded on | Ramp 149 will tilt | |
| | Handler | up position: | CCTV | ramp 149. | to rig floor 114 | |
| | | Verify casing is | | | tubular position. | |
| | | loaded in ramp 149. | | | Skate 133 will | |
| | | Move ramp 149 | | | move toward rig | |
| | | toward pipe pick-up | | | floor 114. | |
| | | position. | | | Skate 133 will | |
| | | | | | stop with casing | |
| | | | | | box on ramp 149. | |
| 3. | Pipe | Move TDA 202 to pick- | Visual | TDA 202 open. | | |
| | Handler | up position: | | | | |
| | | Tilt TDA 202. | | | | |
| | | Lower and extend | | | | |
| | | TDA 202 to CW 131 | | | | |
| | | pick-up position (above | | | | |
| | | THP 207). | | | | |
| 4. | Pipe | Present casing above | Visual | Ramp 149 in pick-up | Skate 133 will move | CW 131 |
| | Handler | TDA 202: | | position. | forward a defined | position. |
| | | Run skate 133 until | | 202 TDA in receive | distance depending | |
| | | casing positioned | | position. | on casing size. | |
| | | above the TDA 202 | | | | |
| | | elevator (e.g., gripper | | | | |
| | | 169). | | | | |
| 5. | Pipe | Latch TDA 202: | Visual | Casing is positioned | Tubular interlock | TDA 202 to |
| | Handler | Hoist TDA 202 to | | correctly above TDA | will prevent hoisting | Closed state. |
| | | latch onto casing. | | 202 elevator, | without closed | |
| | | Close TDA 202. | | | elevator (above | |
| | | | | | certain height). | |
| 6. | Pipe | Lift casing to vertical | Visual | TDA 202 closed. | Hoisting will stop | LSA 228 guide |
| | Handler | position above MOH | | Verify LSA 228 is | prior to lifting casing | to Closed state. |
| | | 204: | | positioned to receive | out of CW 131 without | LSA 228 |
| | | Verify TDA 202 is | | casing bottom before | guiding. | centralizer to |
| | | closed. | | hoisting. | LSA 228 centralizer | Closed state. |
| | | Hoist TDA 202 to | | TDA 202 above LSA | close when casing is | Show TDA 202/ |
| | | pick-up casing single | | 228 operating area. | close to vertical. | LSA 228 in MOH |
| | | from CW 131. | | | TDA 202 and LSA | 204 position. |
| | | Move LSA 228 to | | | 228 will position | |
| | | preset position to | | | casing above MOH | |
| | | prepare for guiding. | | | 204/ITC 236. | |
| | | Before casing lower | | | | |
| | | end leaves CW 131, | | | | |
| | | close LSA 228 funnel. | | | | |
| | | Continue hoisting | | | | |
| | | TDA 202 until the | | | | |
| | | casing is above MOH | | | | |
| | | 204. | | | | |
| 6.1. | Pipe | CW 131 retract to | Visual/ | | Skate 133 will move | Animate |
| | Handler | loading position: | CCTV | | to loading position. | position. |
| | | Verify casing pin end | | | Ramp 149 will tilt to | |
| | | is clear of ramp149. | | | loading position. | |
| | | Move CW 131 toward | | | | |
| | | FT loading position. | | | | |
| 6.2. | Pipe | CW 131 load and | Visual/ | | See steps 1 and 2. | |
| | Handler | present next casing | CCTV | | | |
| | | single: | | | | |
| | | Pick up next casing | | | | |
| | | single per steps 1 and | | | | |
| | | 2. | | | | |
| 7. | Pipe | Stab/position first | Visual | Casing bottom clear | TDA 202 is rotated | Indicate LSA |
| | Handler | casing in MOH 204/ | | of CW 131. | when casing single | 228, ITC 236, |
| | | ITC 236: | | LSA 228 close when | is lowered into MOH | and LTC 244 |
| | | Verify TDA 202/LSA | | casing close to vertical. | 204 with elevator | guide/grip |
| | | 228 are above MOH | | LTC 244 open above | opening facing Pipe | states. |
| | | 204. | | MOH 204. | Handler Operator | Indicate LSA |
| | | Lower casing single | | | 195 (permits open | 228, ITC 236, |
| | | into ITC 236/LSA 228. | | | and retract outside | and LTC 244 |
| | | Extend ITC 236 when | | | WC 203 area). | positions. |
| | | pin end below guide. | | | | |
| | | Close ITC 236 guide. | | | | |
| | | Open and retract LSA | | | | |
| | | 228. | | | | |
| | | Close LTC 244 guide | | | | |
| | | when pin end above | | | | |
| | | MOH 204. | | | | |
| | | Continue lowering | | | | |
| | | casing inside MOH | | | | |
| | | 204. | | | | |
| | | Stop with stick-up of | | | | |
| | | about one meter. | | | | |
| 8. | Pipe | Close ITC 236 clamp | Visual/ | | | ITC 236 and |
| | Handler | on casing: | CCTV | | | LTC 244 to |
| | | Verify correct stick- | | | | Closed state. |
| | | up. | | | | |
| | | Close ITC 236 guide | | | | |
| | | and clamps. | | | | |
| | | Open and retract LTC | | | | |
| | | 244. | | | | |
| 9. | Pipe | Transfer weight to ITC | Visual/ | ITC 236 closed. | Verify weight | TDA 202 load |
| | Handler | 236 and open TDA | CCTV | Weight transferred. | transferred prior to | indicator. |
| | | 202: | | | opening TDA 202. | TDA to Open |
| | | Lower TDA 202 to | | | | state. |
| | | transfer casing weight | | | | |
| | | to ITC 236. | | | | |
| | | Open TDA 202 and | | | | |
| | | retract from stick-up. | | | | |
| | | Move TDA 202 to CW | | | | |
| | | 131 pick-up position. | | | | |
| 10. | Pipe | Present second casing | Visual | Ramp 149 in tubular | Skate 133 will move | |
| | Handler | single above TDA 202 | | pick-up position. | forward a defined | |
| | | elevator: | | TDA 202 in tubular | distance depending | |
| | | Verify TDA 202 | | pickup position. | on casing size (see | |
| | | elevator open and | | | step 4). | |
| | | below tubular pick-up | | | | |
| | | position. | | | | |
| | | Run skate 133 until | | | | |
| | | casing is positioned | | | | |
| | | above TDA 202 | | | | |
| | | elevator. | | | | |
| 11. | Pipe | Latch TDA 202 on | Visual | Second casing single | Tubular interlock | TDA 202 to |
| | Handler | second casing single: | | is positioned correctly | will prevent hoisting | Closed state. |
| | | Hoist TDA 202 to | | above TDA 202 | without TDA 202 | |
| | | latch onto second | | elevator. | elevator closed | |
| | | casing single. | | | (above certain | |
| | | Close TDA 202. | | | height). | |
| 12. | Pipe | Lift casing to vertical | Visual | TDA 202 closed. | Hoisting will stop | Indicate LSA |
| | Handler | position above MOH | | Verify LSA 228 is | prior to lifting casing | 228 guide |
| | | 204: | | positioned to receive | single out of CW 131 | position. |
| | | Verify TDA 202 is | | casing bottom before | without guiding. | Indicate TDA |
| | | closed. | | hoisting. | LSA 228 centralizer | 202/LSA 228 in |
| | | Hoist TDA 202 to pick | | TDA 202 above LSA | close when casing | MOH 204 |
| | | up casing single from | | 228 operating area. | single is close to | position. |
| | | CW 131. | | | vertical. | |
| | | Move LSA 228 to | | | TDA 202 and LSA | |
| | | preset position to | | | 228 will position | |
| | | prepare for guiding. | | | casing single tubular | |
| | | Before casing single | | | above MOH 204/ITC | |
| | | lower end leaves CW | | | 236. | |
| | | 131, close LSA 228 | | | | |
| | | funnel. | | | | |
| | | Continue hoisting | | | | |
| | | TDA 202 until casing | | | | |
| | | single is above MOH | | | | |
| | | 204. | | | | |
| 13. | Pipe | CW 131 retract to | Visual/ | | CWM 131 pipe | Indicate |
| | Handler | loading position: | CCTV | | feeder will move to | positions. |
| | | Verify casing pin end | | | loading position. | |
| | | is clear of ramp 149. | | | Ramp 149 will tilt to | |
| | | Move CW 131 toward | | | loading position. | |
| | | FT loading position. | | | | |
| 14. | Pipe | CW 131 load and | Visual/ | | See steps 1 and 2. | |
| | Handler | present third casing | CCTV | | | |
| | | single (if applicable): | | | | |
| | | Pick up next casing | | | | |
| | | single per steps 1 and | | | | |
| | | 2. | | | | |
| 15. | Pipe | Move THA/CTO to | | CTO open. | CTO will move to | THA/CTO in |
| | Handler | MOH 204: | | WC 203 selected. | MOH 204. | MOH 204. |
| | | Verify that casing is | | LSA 228 in WC 203. | Elevate to stick-up. | |
| | | located above MOH | | | ZMS will stop CTO if | |
| | | 204 and LSA 228 | | | TD 116 or LSA 228 is | |
| | | above CTO working | | | too low. | |
| | | area. | | | | |
| | | Start CTO sequence | | | | |
| | | to move THT to MOH | | | | |
| | | 204. | | | | |
| 16. | Pipe | Close CTO BUT: | Visual/ | CTO in MOH 204. | CTO BUT will close. | CTO BUT to |
| | Handler | Adjust/verify correct | CCTV | | CTO stabbing guide | Closed state. |
| | | CTO elevation, | | | will close. | CTO SG to |
| | | Continue CTO | | | | Closed state. |
| | | sequence. | | | | |
| 17. | Pipe | Close MUST for soft | Visual/ | CTO in WC 203. | MUST will close. | MUST to |
| | Handler | stabbing (optional): | CCTV | | MUST will take some | Closed state. |
| | | Adjust CTO elevation | | | load if closed prior to | |
| | | and TDA 202 elevation | | | stabbing casing (soft | |
| | | if required. | | | stab). | |
| | | Continue CTO | | | | |
| | | sequence. | | | | |
| 18. | Driller | Stab casing: | Visual/ | CTO in WC 203 with | Weight transferred | CTO SG to |
| | | Lower TDA 202 to | CCTV | stabbing guide | to MUST per casing | Open state. |
| | | stab casing (soft stab). | | closed. | data input. | TDA 202 weight |
| | | Open CTO stabbing | | | | indicator. |
| | | guide (e.g., for better | | | | |
| | | view). | | | | |
| 19. | Pipe | Open and retract LSA | Visual/ | CTO stabbing guide | | LSA 228 to |
| | Handler | 228: | CCTV | closed. | | Open status. |
| | | Open and retract LSA | | | | |
| | | 228 when casing has | | | | |
| | | entered stabbing | | | | |
| | | guide. | | | | |
| 20. | Pipe | CTO spin-in and MU: | Visual/ | Casing stabbed in | CTO will spin-in and | Casing |
| | Handler | Verify casing is | CCTV | stick-up. | MU automatically per | connected state. |
| | | stabbed in box. | | TDA 202 unloaded, | casing data settings. | |
| | | Continue CTO | | elevator below TJ to | If Accept: Open | |
| | | sequence. | | permit spinning. | spinner, guide, and | |
| | | Accept or reject MU. | | | clamps. | |
| | | | | | Return to park | |
| | | | | | position. | |
| | | | | | If not accepted: | |
| | | | | | Evaluate break-out, | |
| | | | | | spin-out, and new | |
| | | | | | attempt. | |
| 21. | Pipe | Lower casing double | Visual/ | CTO has completed | | TDA 202/LSA |
| | Handler | into MOH 204 (if | CCTV | MU sequence with | | 228 close/open |
| | | applicable): | | accepted MU. | | status. |
| | | Verify connection is | | | | TDA 202 load. |
| | | made-up. | | | | LTC 244/ITC 236 |
| | | Hoist TDA 202 to pick | | | | status. |
| | | up weight. | | | | |
| | | Open ITC 236 guide | | | | |
| | | and clamps. | | | | |
| | | Lower casing double | | | | |
| | | to correct stick-up. | | | | |
| | | Stop at selected stick- | | | | |
| | | up (e.g., about one | | | | |
| | | meter). | | | | |
| | | Close ITC 236 guide | | | | |
| | | and clamps. | | | | |
| | | Lower TDA 202 to | | | | |
| | | transfer weight to ITC | | | | |
| | | 236. | | | | |
| | | Open TDA 202 and | | | | |
| | | retract from stick-up. | | | | |
| 22. | Pipe | Repeat steps 10-20 for | | | | |
| | Handler | third single (if | | | | |
| | | applicable). | | | | |
| 23. | Pipe | Move casing stand to | Visual/ | RN 151 has | | Weight transfer. |
| | Handler | THP 207: | CCTV | completed MU | | |
| | | LTC 244 extends to | | sequence with correct | | |
| | | casing stand in MOH | | torque. | | |
| | | 204 position and close | | Complete casing | | |
| | | guide. | | stand in MOH 204. | | |
| | | Hoist TDA 202 to pick | | | | |
| | | up weight. | | | | |
| | | Open ITC 236 guide | | | | |
| | | and clamps. | | | | |
| | | Retract ITC 236 | | | | |
| | | head. | | | | |
| | | TDA 202 will lift | | | | |
| | | casing stand from | | | | |
| | | MOH 204 and stop | | | | |
| | | with pin end above | | | | |
| | | THP doper 209. | | | | |
| | | TDA 202 and LTC | | | | |
| | | 244 move casing stand | | | | |
| | | to above THP 207. | | | | |
| | | UTC 242 extends to | | | | |
| | | casing stand and | | | | |
| | | closes. | | | | |
| | | TDA 202 opens and | | | | |
| | | retracts from casing | | | | |
| | | stand. | | | | |
| 24. | Pipe | Set back casing stand: | Visual/ | UTC 242 and LTC | | TBR 254/SGA |
| | Handler | TBR 254 and SGA | CCTV | 244 closed on casing | | 262 status. |
| | | 262 move to THP 207 | | stand in THP 207. | | TBR 254 load. |
| | | and close guide and | | TDA 202 retracted | | |
| | | clamps on casing | | from casing stand in | | |
| | | stand. | | THP 207. | | |
| | | UTC 242 and LTC | | | | |
| | | 244 open and retract. | | | | |
| | | TBR 254 and SGA | | | | |
| | | 262 set back casing | | | | |
| | | stand to selected | | | | |
| | | position in FIB 166. | | | | |
| 25. | Pipe | TBR 254 and SGA 262 | | UTC 242/LTC 244 | TBR 254 clamp and | TBR 254 clamp |
| | Handler | move to THP 207: | | closed on casing | guide and SGA 262 | and guide and |
| | | Open TBR 254 and | | stand. | guide will open. | SGA 262 guide |
| | | SGA 262 in FIB 166. | | | TBR 254 will hoist | to Open state. |
| | | Move toward THP | | | before it retracts out of | |
| | | 207/next casing stand. | | | FIB 166. | |
| | | Continue step 1. | | | | |

For tripping-in casing stands without the CRT, an operator 195 on the rig floor 114 may verify that various pieces of equipment are properly shut down and locked out, and then perhaps perform other preparations such as the examples set forth below in Table 14A.

TABLE 14A
Preparations for Tripping-In Casing Stands Without CRT

| Equipment | Responsible | Verifications |
|---|---|---|
| FIB 166 | Operator 195 on rig floor 114. | Casing stands (111) exist in FIB 166 |
| Setback 164 | | slots per HMI/tally. |
| | | Fingers are closed. |
| | | Travel path is unobstructed. |
| TBR 254 | Operator 195 on rig floor 114. | Travel path is unobstructed. |
| SGA 262 | | Gripper inserts/dies are clean, not worn. |
| LTC 244 | Operator 195 on rig floor 114. | Travel path is unobstructed. |
| ITC 236 | | Gripper inserts/dies are clean, not worn. |
| UTC 242 | | |
| LSA 228 | Operator 195 on rig floor 114. | Travel path is unobstructed. |
| TDA 202 | Operator 195 on rig floor 114. | Travel path is unobstructed. |
| | | Correct inserts in TDA 202 |
| | | elevator/grippers. |
| CTO | Operator 195 on rig floor 114. | CTO is rigged up in THA (or THT). |
| THA-CTO | | Correct adaptors and stabbing guide |
| (primary) | | funnel is installed. |
| THT-CTO | | Dies are correct, clean, and not worn. |
| (backup) | | Travel path is unobstructed. |
| Slips 161 | Operator 195 on rig floor 114; and/or | Correct inserts/dies. |
| | “Driller” 195 at workstation 452. | Inserts/dies are clean, not worn. |
| TD 116 | Operator 195 on rig floor; and/or | Correct inserts/dies in elevator 129. |
| | “Driller” 195 at workstation 452. | Correct saver sub status. |
| | | Travel path is unobstructed. |
| DW 119 | Operator 195 on rig floor; and/or | Checked. |
| | “Driller” 195 at workstation 452. | |

The well construction system 100, 200 can then be set-up for the non-CRT casing stand trip-in sequence. Examples of such set-up may be as set forth below in Table 14B.

TABLE 14B
Set-Up for Tripping-In Casing Stands Without CRT

| Equipment | Responsible | Set-Up | HMI |
|---|---|---|---|
| Pipe | Pipe | Verify operator 195 on rig floor 114 | Verify Setback screen. |
| handling: | Handler | completed pre-checks and deactivated | Construction Program |
| TBR 254, | | emergency stop for all pipe handling | setup wizard. |
| SGA 262, | | equipment. | After startup: Check for |
| UTC 242, | | Open Construction Program screen on | green light in |
| LTC 244, | | touchscreen 522, 524. | Construction Program |
| THP 207, | | Select Trip In Casing mode. | status header on front |
| TDA 202, | | Select setup wizard to open pop-up on | screen 532, 534, 536. |
| LSA 228, | | front screen 532, 534, 536. Verify | |
| THA- | | settings: | |
| CTO | | Select casing type and verify casing | |
| | | data (size, weight, MU loss, | |
| | | torque settings, etc.). | |
| | | Select CTO to use. | |
| | | Stick-up target. | |
| | | Select “activate all machines” to startup | |
| | | and prepare all machines. | |
| TD 116, | Driller | Verify operator 195 on rig floor 114 | Verify Setback screen. |
| DW 119, | | completed pre-checks and deactivated | Construction Program |
| MP 144, | | emergency stop for all pipe handling | setup wizard. |
| Trip tank | | equipment. | After startup: Check for |
| | | Open Construction Program screen on | green light in |
| | | touchscreen 522, 524. | Construction Program |
| | | Select Trip In Casing mode. | status header on front |
| | | Select setup wizard to open pop-up on | screen 532, 534, 536. |
| | | front screen 532, 534, 536. Verify | |
| | | settings: | |
| | | Stick-up target. | |
| | | Set DW 119 upper/lower stops. | |
| | | Set maximum lowering speed. | |
| | | Set minimum slack off weight. | |
| | | Trip tank 1/2/auto. | |
| | | Trip tank low/high levels. | |
| | | Active tanks selected and lined up. | |
| | | Set alarm limits for gain/loss. | |
| | | Select MP 144 for filling casing. | |
| | | MP 144 liner size setting and pump | |
| | | efficiency. | |
| | | Set number of strokes for filling | |
| | | casing stand (selected MP 144 will | |
| | | stop after set number of strokes). | |
| | | Select “activate all machines” to startup | |
| | | and prepare all machines. | |
| TD 116 | Driller | Verify operator 195 on rig floor 114 | Verify operator screen, |
| | | completed pre-checks. | system status/alarms. |
| | | Activate TD 116 from touchscreen 522, | |
| | | 524. | |
| | | Select Operation screen on touchscreen | |
| | | 522, 524. | |
| DW 119 | Driller | Activate DW 119 from touchscreen 522, | Verify operator screen, |
| | | 524. | system status/alarms. |
| All | Driller | Verify all relevant machines are enabled | Verify operator screen, |
| machines | | in zone management system and | system status/alarms. |
| | | tubular interlock system. | |

After such preparations and set-up, the operator 195 may vacate the rig floor 114, and the equipment may be configured to be ready for remote control (e.g., by deactivating emergency stops). The sequence for non-CRT tripping-in casing stands may start with the top drive 116 in lower position at WC 203, with the slips 161 closed around a casing stick-up of about one meter. Another casing stand 111 may be in the TDA 202/LSA 228, lifted from THP 207 to stick-up level above the MOH 204, with the TDA 202 elevator facing the top drive 116. The THP 207, UTC 242, and LTC 244 may be open and retracted. The TBR 254 and SGA 262 may be empty (e.g., on the way to pick up a new casing stand from the FIB 166). Example steps of the non-CRT tripping-in casing stand sequence may be as set forth below in Table 14C.

TABLE 14C
Tripping-In Casing Stands Withou CRT Operation

| | Operator | | Line of | Equipment | Equipment | |
|---|---|---|---|---|---|---|
| | 195 | Operation | Sight | precondition | Functionality | HMI |
| 1. | Driller | Open TD 116 elevator | Visual/ | Slips 161 must be | Elevator 129 Open is | TD 116 elevator |
| | | 129: | CCTV | closed before opening | not selectable if slips | 129 to Open |
| | | Verify slips 161 are | | elevator 129. | 161 are not closed, | state. |
| | | closed. | | | | |
| | | Open elevator 129. | | | | |
| 1.1. | Pipe | TBR 254 and SGA 262 | Visual/ | TBR 254 and SGA | TBR 254 will move | TBR 254 and |
| | Handler | pick up new casing | CCTV | 262 grip/guide open. | into FIB 166 elevated | SGA 262 grip/ |
| | | stand: | | Selected FIB 166 | above open latches. | guide to Closed |
| | | Move TBR 254 and | | position “valid.” | Adjustments available. | state. |
| | | SGA 262 to selected | | | TBR 254 and SGA | |
| | | finger/slot in FIB 166. | | | 262 grip/guide will | |
| | | Close TBR 254 and | | | Close. | |
| | | SGA 262 guides and | | | | |
| | | clamp on stand. | | | | |
| 2. | Driller | Retract and move TD | Visual/ | TD 116 pipe handler | | DW 119 Upper |
| | | 116 to latching height: | CCTV | position facing TDA | | Stop setting. |
| | | Verify elevator 129 is | | 202. | | |
| | | open. | | | | |
| | | Retract TD 116 to | | | | |
| | | clear TJ. | | | | |
| | | Hoist TD 116 elevator | | | | |
| | | 129 to stand latch | | | | |
| | | height (upper stop or | | | | |
| | | calculated stop point). | | | | |
| 2.1. | Pipe | TDA 202 move stand | Visual/ | TD 116 retracted. | Tilt towards WC 203. | TDA 202 Load |
| | Handler | to WC 203: | CCTV | | TDA 202 dope top | indication. |
| | | Continue lifting TDA | | | box if preselected | |
| | | 202 and extend to WC | | | (automatic). | |
| | | 203 (above stick-up). | | | | |
| | | LSA 228 guide to WC | | | | |
| | | 203 when pin end | | | | |
| | | above rig floor. | | | | |
| 2.2. | Pipe | Move THA/CTO to WC | | CTO open. | CTO will move to WC | THA/CTO in |
| | Handler | 203: | | WC 203 selected. | 203. | WC 203. |
| | | Verify stand is located | | LSA 228 in WC 203. | Elevate to stick-up. | |
| | | in WC 203 and LSA | | | ZMS will prevent | |
| | | 228 is above CTO | | | CTO start if TD 116 or | |
| | | working area. | | | LSA 228 is too low. | |
| | | Start CTO sequence | | | | |
| | | to move THT to WC | | | | |
| | | 203. | | | | |
| | | Optional: Move THT/ | | | | |
| | | CTO to WC 203 when | | | | |
| | | TD 116 is above THA, | | | | |
| | | if selected. | | | | |
| 2.3. | Pipe | Close CTO BUT: | Visual/ | CTO in WC 203. | Close CTO BUT. | CTO BUT to |
| | Handler | Adjust/verify correct | CCTV | | Close stabbing guide. | Closed state. |
| | | CTO elevation. | | | | CTO SG to |
| | | Continue CTO | | | | Closed state. |
| | | sequence. | | | | |
| 2.4. | Pipe | Close MUST for soft | Visual/ | CTO in WC 203. | Close MUST. | MUST to |
| | Handler | stabbing (optional): | CCTV | | MUST will take some | Closed state. |
| | | Adjust CTO elevation | | | load if closed prior to | |
| | | and TD 116 elevation if | | | stabbing the casing. | |
| | | required. | | | | |
| | | Continue CTO | | | | |
| | | sequence. | | | | |
| 2.5. | Driller | Stab casing: | Visual/ | TD 116 link tilt float. | Weight transferred to | CTO SG to |
| | | Lower TD 116 to stab | CCTV | CTO in WC 203 with | MUST per casing | Open state. |
| | | casing (soft stab). | | stabbing guide closed. | data input. | |
| | | Open CTO stabbing | | | | |
| | | guide. | | | | |
| 2.6. | Pipe | Open and retract LSA | Visual/ | CTO stabbing guide | | LSA 228 Open |
| | Handler | 228: | CCTV | closed. | | status. |
| | | Open and retract LSA | | | | |
| | | 228 when casing has | | | | |
| | | entered stabbing | | | | |
| | | guide. | | | | |
| 2.7. | Pipe | CTO spin-in and MU: | Visual/ | Stand stabbed in | CTO will spin-in and | Casing |
| | Handler | Verify casing is | CCTV | stick-up (TD 116 | MU automatically per | Connected state. |
| | | stabbed the box. | | unloaded, elevator | casing data settings. | |
| | | Continue CTO | | 129 below TJ to | If Accept: Open | |
| | | sequence. | | permit spinning). | spinner, guide, and | |
| | | Accept or reject MU. | | | clamps, then return to | |
| | | | | | park position. | |
| 2.8. | Pipe | TBR 254 and SGA 262 | Visual/ | THP 207 empty. | TBR 254 cannot | Indicate open |
| | Handler | move stand to THP | CCTV | UTC 242/LTC 244 | open with weight. | latches. |
| | | 207: | | open. | TBR 254 grip open | TBR 254 load |
| | | Open FIB 166 latches | | Correct pipe detected | when unloaded. | indication, |
| | | for selected row. | | in TBR 254 and SGA | FIB 166 latches will | unload. |
| | | Verify latches open | | 262. | not open with TBR | |
| | | (visual/CCTV). | | | 254 head in low | |
| | | TBR 254 lift stand | | | position. | |
| | | and move out of FIB | | | | |
| | | 166 to THP 207. | | | | |
| | | FIB 166 latches will | | | | |
| | | close as stand moves | | | | |
| | | out of FIB 166. | | | | |
| | | Set down stand on | | | | |
| | | THP 207. | | | | |
| 2.9. | Pipe | UTC 242 and LTC 244 | Visual/ | TBR 254 and SGA | UTC 242 and LTC | UTC 242 and |
| | Handler | extend to THP 207 and | CCTV | 262 with stand in THP | 244 extend and close. | LTC 244 to |
| | | close: | | 207. | | Closed state. |
| | | UTC 242 and LTC | | | | |
| | | 244 extend to THP | | | | |
| | | 207. | | | | |
| | | UTC 242 and LTC | | | | |
| | | 244 close. | | | | |
| 2.10 | Pipe | TBR 254 and SGA 262 | | UTC 242/LTC 244 | | TBR 254 and |
| | Handler | open and move toward | | closed on stand. | | SGA 262 to |
| | | FIB 166: | | | | Open state. |
| | | Open TBR 254 | | | | |
| | | clamps and guide and | | | | |
| | | SGA 262 guide. | | | | |
| | | Move toward FIB 166/ | | | | |
| | | next stand. | | | | |
| | | Continue step 1.1 | | | | |
| 3. | Driller | Extend TD 116 and | Visual/ | TDA 202 below TJ. | | Elevator 129 |
| | | latch elevator 129: | CCTV | | | Closed state. |
| | | Extend TD 116 to WC | | | | Indicate TD 116 |
| | | 203. | | | | in WC 203. |
| | | Latch elevator 129 | | | | |
| | | (automatic close on | | | | |
| | | impact). | | | | |
| 3.1. | Pipe | TDA 202 open and | Visual/ | Elevator 129 closed. | TDA 202 will retract | TDA 202 |
| | Handler | move to THP 207: | CCTV | | from WC 203, rotate, | elevator Open |
| | | Verify TD 116 | | | and lower until | state. |
| | | elevator 129 is closed. | | | elevator (e.g., gripper | TDA 202 |
| | | Open elevator 129. | | | 169) faces toward | position |
| | | Retract to vertical | | | THP 207. | animation. |
| | | link. | | | | |
| | | Rotate and lower to | | | | |
| | | stand in THP 207. | | | | |
| 4. | Driller | Open slips 161: | Visual | TD 116 elevator 129 | | Slips 161 to |
| | | Open slips 161 | | must be closed. | | Open state. |
| | | (command). | | CTO has completed | | DW 119 load. |
| | | Hoist to take weight | | MU sequence | | |
| | | and open slips 161. | | with accepted | | |
| | | | | connection. | | |
| 5. | Driller | Lower casing string in | Visual | Slips 161 open. | MP 144 will stop after | Settings: DW |
| | | wellbore 102: | | | set number of | 119 lowering |
| | | Verify slips 161 are | | | strokes, if selected. | speed and |
| | | open before lowering | | | | minimum slack- |
| | | casing string. | | | | off weight. |
| | | Open IBOP and start | | | | IBOP open. |
| | | MP 144 to fill casing, if | | | | MP 144 |
| | | selected. (Extend | | | | running. |
| | | filling tool, if installed). | | | | |
| 5.1. | Pipe | TDA 202 and LSA 228 | Visual/ | TDA 202 elevator | TDA 202 tilt out/ | |
| | Handler | extend to stand in THP | CCTV | must be open. | extend elevator until | |
| | | 207: | | LSA 228 guide funnel | contact with stand in | |
| | | Tilt out/extend TDA | | must be open. | THP 207. | |
| | | 202 elevator until | | | | |
| | | contact with stand in | | | | |
| | | THP 207 below TJ. | | | | |
| 5.2. | Pipe | TDA 202 and LSA 228 | Visual/ | TDA 202 elevator | | TDA 202 |
| | Handler | latch onto stand in THP | CCTV | must be in THP 207 | | elevator to |
| | | 207: | | position. | | Closed state. |
| | | Close TDA 202 | | | | LSA 228 guide |
| | | elevator. | | | | to Closed state. |
| | | Close LSA 228 guide | | | | |
| | | funnel. | | | | |
| 5.3. | Pipe | UTC 242 and LTC 244 | Visual/ | TDA 202 elevator | UTC 242 and LTC | UTC 242 and |
| | Handler | open and retract. | CCTV | must be closed. | 244 open and retract. | LTC 244 to Open |
| | | | | | | state. |
| | | | | | | UTC 242 and |
| | | | | | | LTC 244 position |
| | | | | | | animation. |
| 5.4. | Pipe | TDA 202 move stand | Visual/ | UTC 242 or LTC 244 | TDA 202 hoist, tilt to | TDA 202 Load |
| | Handler | to rig floor: | CCTV | open. | vertical, rotate 180 | indication. |
| | | TDA 202 lift stand | | | degrees to face TD | TDA 202 |
| | | guided by the LSA 228 | | | 116. | position |
| | | (e.g., about nine | | | TDA 202 dope top | animation. |
| | | meters) to rig floor 114 | | | box if preselected | |
| | | standby position. | | | (automatic). | |
| | | Continue step 2.2 | | | | |
| 6. | Driller | Set slips 161: | Visual | Stick-up at correct | | Slips 116 to |
| | | Set slips 161 at | | height. | | Closed state. |
| | | correct stick-up height. | | | | DW 119 load |
| | | Set off weight. | | | | indicator. |
| | | | | | | Tally update. |
| 7. | Driller | Check trip tank or | Visual | Slips 161 closed. | Trip tank gain/loss is | Trip Sheet/ |
| | | active volume, | | | determined and | Volume control. |
| | | gain/loss: | | | displayed. | |
| | | Trip tank or active | | | | |
| | | gain/loss. | | | | |
| | | Repeat all steps for | | | | |
| | | next stand. | | | | |

Different combinations of the aspects described above may also be utilized for running large-diameter casing (LDC) from the CW 131 with the top drive 116 and CRT. For example, LDC may have an outer diameter of about 13.375 inches (about 34 centimeters) or larger. Preparations for such operation may include the examples set forth below in Table 15A.

TABLE 15A
Preparations for Running LDC from CW with TD and CRT

| Equipment | Responsible | Verifications |
|---|---|---|
| CW 131 | Operator 195 on | Travel path is unobstructed. |
| | rig floor 114. | Casings are laid out correct with aft end in line with skate 133 |
| | | for correct loading. |
| | | Prepare to pick up casing. |
| CTO: | Operator 195 on | Casing backup tong (CBU) is rigged up in THT. |
| THT + CBU | rig floor 114. | CBU adjusted for casing size. |
| | | Dies are correct, clean, and not worn. |
| | | Travel path is unobstructed. |
| LSA 228 | Operator 195 on | Travel path is unobstructed. |
| | rig floor 114. | |
| Slips 161 | Operator 195 on | Correct inserts in slips 161. |
| Rotary | rig floor 114. | Dies are clean and not worn. |
| Table | | Rotary table rotation lock activated. |
| TD 116 | Operator 195 on | Correct pick-up elevator 129. |
| | rig floor 114. | Check elevator link extension chains. |
| | | Operator screen, system status. |
| | | Travel path is unobstructed. |
| | | CRT installed and tested. |
| DW 119 | Operator 195 on | Checked. |
| | rig floor 114. | |
| Tubulars | Operator 195 on | Tubulars 111 to be laid out on CW 131. |
| 111 | rig floor 114. | Tubulars 111 to be cleaned and doped, protectors removed |
| | | (other implementations may be used for casing with protectors). |
| | | Casings measured, marked, and tally updated. |

The well construction system 100, 200 can then be set-up for the operation. Examples of such set-up may be as set forth below in Table 8B.

TABLE 15B
Set-Up for Running LDC from CW with TD and CRT

| Equipment | Responsible | Set-Up | HMI |
|---|---|---|---|
| Pipe | Pipe | Verify operator 195 on rig floor 114 | Verify Setback |
| handling: | Handler | completed pre-checks and deactivated | screen. |
| LSA 228, | | emergency stop for all pipe handling | Construction |
| CBU, | | equipment. | Program setup |
| CW 131 | | Open Construction Program screen on | wizard. |
| | | touchscreen 522, 524. | After startup: Check |
| | | Select Running 13 3/8″ Casing from CW | for green light in |
| | | with TD and CRT mode. | Construction |
| | | Select setup wizard to open pop-up on front | Program status |
| | | screen 532, 534, 536. Verify settings: | header on front |
| | | Select casing size. | screen 532, 534, |
| | | Select CBU to use. | 536. |
| | | Stick-up target. | |
| | | Select “activate all machines” to startup and | |
| | | prepare all machines. | |
| TD 116, | Driller | Verify operator 195 on rig floor 114 | Verify Setback |
| DW 119, | | completed pre-checks and deactivated | screen. |
| MP 144 | | emergency stop for all pipe handling | Construction |
| | | equipment. | Program setup |
| | | Open Construction Program screen on | wizard. |
| | | touchscreen 522, 524. | After startup: Check |
| | | Select Running 13 3/8″ Casing from CW | for green light in |
| | | with TD and CRT mode. | Construction |
| | | Select setup wizard to open pop-up on front | Program status |
| | | screen 532, 534, 536. Verify settings: | header on front |
| | | Stick-up target. | screen 532, 534, |
| | | Set TD elevator link length. | 536. |
| | | Set DW 119 upper/lower stops. | |
| | | Set maximum lowering speed. | |
| | | Set minimum slack off weight. | |
| | | Trip tank 1/2/auto. | |
| | | Trip tank low/high levels. | |
| | | Verify active tanks are selected and | |
| | | lined up. | |
| | | Select MP 144 (to fill casing, optional). | |
| | | Verify MP 144 pressure limit setting. | |
| | | Assign pumps to master slider. | |
| | | Set number of strokes and SPM to fill | |
| | | casing (optional). | |
| | | Set ramp-up parameters. | |
| | | Verify correct elevator setting | |
| | | (manual/remote). | |
| | | Select “activate all machines” to startup and | |
| | | prepare all machines. | |
| TD 116 | Driller | Verify operator 195 on rig floor 114 | Verify operator |
| | | completed pre-checks. | screen, system |
| | | Activate TD 116 from touchscreen 522, | status/alarms. |
| | | 524. | |
| | | Verify correct elevator 129 setting | |
| | | (manual/remote). | |
| | | Select Operation screen on touchscreen 522, | |
| | | 524. | |
| DW 119 | Driller | Activate DW 119 from touchscreen 522, | Verify operator |
| | | 524. | screen, system |
| | | Set maximum lowering speed. | status/alarms. |
| | | Set minimum slack off weight. | |
| Slips 161, | Driller | Verify correct setting for slips 161 | Verify operator |
| Rotary | | (manual/remote). | screen, system |
| table | | | status/alarms. |
| All | Driller | Verify all relevant machines are enabled in | |
| machines | | zone management system and tubular | |
| | | interlock system. | |
| Tubulars | Pipe | All tubulars 111 are registered. | |
| 111 | Handler | | |

After such preparations and set-up, the operator 195 may vacate the rig floor 114, and the equipment may be configured to be ready for remote control (e.g., by deactivating emergency stops). An example of this sequence may start with a casing stick-up (e.g., about 1.5 meters) at WC 203, with the slips 161 closed and the CRT engaged. Casing may be laid out on the CW 131 casing side (e.g., Driller's side), having been cleaned, doped, and tallied, and with protectors removed. The catwalk ramp 149 may be loaded with casing. The TDA 202 may be parked outside the collision area (e.g., top of the mast), and the LSA 228 may be ready. Example steps of the sequence may be as set forth below in Table 15C.

TABLE 15C
Sequence for Running LDC from CW with TD and CRT

| | Operator | | Line of | Equipment | Equipment | |
|---|---|---|---|---|---|---|
| | 195 | Operation | Sight | precondition | Functionality | HMI |
| 1. | Driller | Release CRT from | Visual/ | Slips 161 must be | | CRT to |
| | | stick-up: | CCTV | closed before | | Disconnect |
| | | Verify slips 161 are | | releasing CRT. | | state. |
| | | closed and links/ | | | | |
| | | elevator tilted towards | | | | |
| | | CW 131. | | | | |
| | | Release CRT from | | | | |
| | | stick-up. | | | | |
| | | Hoist TD 116 to CW | | | | |
| | | 131 pick-up position | | | | |
| | | (above casing). | | | | |
| 1.1. | Pipe | Push casing to rig floor | Visual/ | | Skate 133 will move | CW 131 to CW |
| | Handler | 114 pick-up position: | CCTV | | forward a set | 131 pick-up |
| | | Verify TD elevator | | | distance. | position. |
| | | 129 is above CW 131 | | | | |
| | | pick-up position. | | | | |
| | | Activate CW 131 | | | | |
| | | sequence to move | | | | |
| | | casing to CW 131 pick- | | | | |
| | | up position. | | | | |
| 2. | Driller | Latch pick-up elevator | Visual | CW 131 in pick-up | | |
| | | 129: | | position. | | |
| | | Extend links above | | | | |
| | | casing. | | | | |
| | | Lower TD 116 to latch | | | | |
| | | elevator 129. | | | | |
| | | Engage safety pin | | | | |
| | | (manual). | | | | |
| 3. | Driller | TD 116 hoist casing | Visual | TD elevator 129 | Hoisting will stop prior | |
| | | from CW 131: | | closed, | to lifting casing out of | |
| | | Hoist TD 116 to pick | | Link tilt float: Elevator | CW 131 without | |
| | | up casing from CW | | 129 in WC 203 above | guiding. | |
| | | 131. | | RN 151 working area. | | |
| | | Activate link tilt float | | | | |
| | | or move elevator 129 | | | | |
| | | to vertical position. | | | | |
| 3.1. | Pipe | LSA 228 extend to | Visual/ | TD 116 above LSA 228 | | LSA 228 funnel |
| | Handler | guide casing above | CCTV | operating area. | | to Closed state. |
| | | CW 131: | | | | |
| | | Move LSA 228 to | | | | |
| | | preset position to | | | | |
| | | receive casing above | | | | |
| | | CW 131. | | | | |
| | | Before casing lower | | | | |
| | | end leaves CW 131, | | | | |
| | | close LSA 228 funnel. | | | | |
| 3.2. | Pipe | Move THT/CBU to WC | | CBU open. | CBU will move to WC | CBU in WC |
| | Handler | 203: | | | 203. | 203. |
| | | Verify TD 116 hoisted | | | Elevate to stick up. | |
| | | above CBU working | | | ZMS will prevent | |
| | | area. | | | CBU start if TD 116 is | |
| | | Start CBU sequence | | | too low. | |
| | | to move THT/CBU to | | | | |
| | | WC 203. | | | | |
| 3.3. | Pipe | LSA 228 tail in casing | Visual | Casing bottom clear | | LSA 228 |
| | Handler | to WC 203: | | of CW 131 and | | centralizer to |
| | | TD continues | | elevated above stick- | | Closed state. |
| | | hoisting. | | up. | | |
| | | LSA 228 tail in casing | | LSA 228 funnel close. | | |
| | | towards WC 203 when | | | | |
| | | pin end is above stick- | | | | |
| | | up. | | | | |
| | | LSA 228 centralizer | | | | |
| | | will close when casing | | | | |
| | | is close to WC 203. | | | | |
| 3.4. | Pipe | Guide casing single | Visual/ | CBU in WC 203. | Close CBU BUT. | CBU BUT to |
| | Handler | with CBU in WC 203: | CCTV | LSA 228 in WC 203. | Close stabbing guide. | Closed state. |
| | | Verify casing single | | | | CBU guide to |
| | | located in WC 203. | | | | Closed state. |
| | | Continue CBU | | | | |
| | | sequence. | | | | |
| 3.5. | Pipe | Stab casing: | Visual/ | TD 116 in WC 203. | | |
| | Handler | Lower TD 116 to stab | CCTV | CBU in WC 203 with | | |
| | | casing in stick-up. | | stabbing guide closed. | | |
| | | Continue lowering to | | | | |
| | | stab CRT. | | | | |
| 3.6. | Pipe | Open and retract LSA | Visual/ | CTO stabbing guide | | LSA 228 Open |
| | Handler | 228: | CCTV | closed. | | status. |
| | | Open and retract LSA | | | | |
| | | 228 when casing has | | | | |
| | | entered stabbing | | | | |
| | | guide. | | | | |
| 3.7. | Pipe | CW 131 retract to | Visual/ | | Skate 133 will move | CW 131 |
| | Handler | loading position: | CCTV | | to loading position. | animation. |
| | | Verify casing pin end | | | Ramp 149 will tilt to | |
| | | is clear of ramp 149. | | | loading position. | |
| | | Move CW 131 toward | | | | |
| | | FT loading position. | | | | |
| 4. | Driller | Stab CRT, spin-in, and | Visual/ | Casing single | TD 116/CRT will | CBU closed for |
| | | MU: | CCTV | stabbed in stick-up | automatically spin-in | backup. |
| | | Verify casing is | | (TD elevator 129 | and MU. | Casing |
| | | stabbed and elevator is | | below TJ to permit | | Connected state. |
| | | unloaded (elevator | | spinning). | | CRT Engaged |
| | | sliding down). | | CBU slips back up. | | state. |
| | | Verify CBU closed for | | | | |
| | | backup. (Optional: or | | | | |
| | | slips 161 closed for | | | | |
| | | backup). | | | | |
| | | Stab and engage | | | | |
| | | (lock) CRT. | | | | |
| | | Spin-in and MU | | | | |
| | | casing connection. | | | | |
| 4.1. | Pipe | Open CBU and move | | Casing connected. | Open CBU BUT and | CBU open. |
| | Handler | to parked position: | | CRT connected. | move THT to parked | CBU parked. |
| | | Verify casing has | | | position. | |
| | | been made-up. | | | | |
| | | Continue CBU | | | | |
| | | backup sequence. | | | | |
| 5. | Driller | Open slips 161: | Visual | TD 116/CRT has | | Slips 161 to |
| | | Open slips 161 | | completed MU | | Open state. |
| | | (command). | | sequence with correct | | DW 119 load. |
| | | Hoist to take up | | torque (CRT | | |
| | | weight and open slips | | connected). | | |
| | | 161. | | | | |
| 6. | Driller | Run-in-Hole: | Visual | Slips 161 open. | | |
| | | Verify slips 161 are | | Optional: MP 144 | Optional: The selected | MP 144 SPM, |
| | | open before lowering | | ready. | MP 144 will pump a | total strokes, |
| | | casing string into | | | set number of strokes | and pressure. |
| | | wellbore 102. | | | at set rate with | |
| | | Optional: Fill casing, if | | | selected MP 144 and | |
| | | selected. | | | stop. | |
| | | Open IBOP. | | | | |
| | | Start MP 144 | | | | |
| | | (casing fill mode). | | | | |
| | | Close IBOP. | | | | |
| 6.1. | Pipe | Load next casing onto | Visual/ | Casing ready in | | |
| | Handler | ramp 149: | CCTV | loading position. | | |
| | | Use loading fingers to | | CW 131 in loading | | |
| | | load another casing | | position. | | |
| | | into ramp 149. | | | | |
| 7. | Driller | Open pick-up elevator | Visual | | | |
| | | and tilt out: | | | | |
| | | When elevator is | | | | |
| | | close to rig floor 114, | | | | |
| | | an operator 195 | | | | |
| | | removes safety pin and | | | | |
| | | opens elevator. | | | | |
| | | When the operator is | | | | |
| | | out of the area, tilt links | | | | |
| | | out and continue | | | | |
| | | lowering. | | | | |
| 7.1. | Pipe | Run ramp 149 to rig | Visual/ | Casing loaded onto | Ramp 149 will tilt to | CW 131 |
| | Handler | floor: | CCTV | ramp 149. | rig floor 114 tubular | animated. |
| | | Verify casing is | | | position. | |
| | | loaded in ramp 149. | | | Skate 133 will move | |
| | | Move ramp 149 | | | toward rig floor 114. | |
| | | toward pipe pick-up | | | Skate 133 will stop | |
| | | position. | | | with casing box inside | |
| | | | | | ramp 149. | |
| 8. | Driller | Set slips161: | Visual | Stick-up at correct | | Slips 161 to |
| | | Set slips 161 at | | height. | | Closed state. |
| | | correct stick-up height. | | | | DW 119 load |
| | | Set off weight. | | | | indicator. |
| 9. | Driller | Check gain/loss: | Visual | | Trip tank or active | Volume control. |
| | | Check trip tank gain/ | | | tank gain/loss is | |
| | | loss or active gain/loss | | | determined and | |
| | | depending on selected | | | displayed. | |
| | | operation. | | | | |
| 10. | | Repeat sequence for | | | | |
| | | next casing. | | | | |

For tripping-out drill collar stands, an operator 195 on the rig floor 114 may verify that various pieces of equipment are properly shut down and locked out, and then perhaps perform other preparations such as the examples set forth above in Table 11A. The well construction system 100, 200 can then be set-up for the drill collar stand trip-out sequence. Examples of such set-up may be as set forth below in Table 16A.

TABLE 16A
Set-Up for Tripping-Out Drill Collar Stands

| Equipment | Responsible | Set-Up | HMI |
|---|---|---|---|
| Pipe | Driller/ | Verify operator 195 on rig floor 114 | Verify Setback screen. |
| handling: | Pipe | completed pre-checks and deactivated | Construction Program |
| TBR 254, | Handler | emergency stop for all pipe handling | setup wizard. |
| SGA 262, | | equipment. | After startup: Check for |
| UTC 242, | | Open Construction Program screen on | green light in |
| LTC 244, | | touchscreen 522, 524. | Construction Program |
| THP 207, | | Select Tripping mode. | status header on front |
| LSA 228, | | Select setup wizard to open pop-up on | screen 532, 534, 536. |
| RN 151 | | front screen 532, 534, 536. Verify | |
| | | settings: | |
| | | Select slot, direction for setting back | |
| | | drill collar stands. | |
| | | Select pipe type. | |
| | | Select RN 151 to use. | |
| | | RN 151 MU torque. | |
| | | Select pin/box doping. | |
| | | Stick-up target. | |
| | | Select “activate all machines” to startup | |
| | | and prepare all machines. | |
| TD 116, | Driller | Verify operator 195 on rig floor 114 | Verify Setback screen. |
| DW 119, | | completed pre-checks and deactivated | Construction Program |
| MP 144, | | emergency stop for all pipe handling | setup wizard. |
| Trip tank | | equipment. | After startup: Check for |
| | | Open Construction Program screen on | green light in |
| | | touchscreen 522, 524. | Construction Program |
| | | Select Tripping DC mode. | status header on front |
| | | Select setup wizard to open pop-up on | screen 532, 534, 536. |
| | | front screen 532, 534, 536. Verify | |
| | | settings: | |
| | | Stick-up target. | |
| | | Set DW 119 upper/lower stops. | |
| | | Set maximum lowering speed. | |
| | | Set minimum slack off weight. | |
| | | Trip tank 1/2/auto. | |
| | | Trip tank low/high levels. | |
| | | Select “activate all machines” to startup | |
| | | and prepare all machines. | |
| TD 116 | Driller | Verify operator 195 on rig floor 114 | Verify operator screen, |
| | | completed pre-checks. | system status/alarms. |
| | | Activate TD 116 from touchscreen 522, | |
| | | 524. | |
| | | Select Operation screen on touchscreen | |
| | | 522, 524. | |
| DW 119 | Driller | Activate DW 119 from touchscreen 522, | Verify operator screen, |
| | | 524. | system status/alarms. |
| All | Driller | Verify all relevant machines are enabled | Verify operator screen, |
| machines | | in zone management system and | system status/alarms. |
| | | tubular interlock system. | |

After such preparations and set-up, the operator 195 may vacate the rig floor 114, and the equipment may be configured to be ready for remote control (e.g., by deactivating emergency stops). The sequence for tripping-out drill collar stands may start with a drill collar stand 111 stick-up at WC 203, with the top drive 116 elevator 129 closed on the stick-up and the slips 161 closed. The UTC 242 and LTC 244 may be closed on another drill collar stand 111 in the THP 207, with washing and doping of the pin already completed. The TDA 202 may be parked outside the collision area, and the LSA 228, TBR 254, and SGA 262 may each be empty. Example steps of the drill collar stand tripping-out sequence may be as set forth below in Table 16B.

TABLE 16B
Tripping-Out Drill Collar Stands Operation

| | Operator | | Line of | Equipment | Equipment | |
|---|---|---|---|---|---|---|
| | 195 | Operation | Sight | precondition | Functionality | HMI |
| 1. | Driller | Open slips 161 and | Visual/ | Elevator 129 must be | Slips 161 Open is | Slips 161 to |
| | | hoist drill string 120: | CCTV | closed before opening | not selectable if | Open state. |
| | | Verify TD elevator | | slips 161. | elevator 129 is not | Settings: DW |
| | | 129 is closed under TJ. | | | closed. | 119 hoisting |
| | | Open slips 161. | | | Slips 161 Open | speed and |
| | | Hoist to take weight | | | command is reset | maximum |
| | | and verify slips 161 | | | after a set time if slips | overpull. |
| | | open. | | | 161 are not opened. | |
| 1.1. | Pipe | TBR 254 and SGA 262 | Visual/ | TBR 254 and SGA | TBR 254 and SGA | TBR 254 and |
| | Handler | will pick up stand from | CCTV | 262 grip/guide open. | 262 grip/guide will | SGA 262 grip/ |
| | | THP 207: | | | close automatically. | guide to Closed |
| | | Move TBR 254 and | | | | states. |
| | | SGA 262 to THP 207. | | | | |
| | | Close guides and | | | | |
| | | clamp on stand. | | | | |
| 1.2. | Pipe | UTC 242 and LTC 244 | Visual/ | TBR 254 and SGA | UTC 242 and LTC | UTC 242 and |
| | Handler | open and retract: | CCTV | 262 closed on stand | 244 open and retract. | LTC 244 to |
| | | UTC 242 and LTC | | in THP 207. | | Open state- |
| | | 244 open guides. | | | | retracted. |
| | | UTC 242 and LTC | | | | |
| | | 244 retract from THP | | | | |
| | | 207. | | | | |
| 1.3. | Pipe | TBR 254 and SGA 262 | Visual/ | Valid FIB 166 position | TBR 254 and SGA | TBR 254 load. |
| | Handler | move toward FIB 166 | CCTV | selected. | 262 will follow | FIB 166 latches |
| | | with stand: | | | predefined path. | to Open state. |
| | | Lift stand from THP | | | FIB 166 latches will | FIB 166 latches |
| | | 207. | | | open when stand is | to Closed state. |
| | | Move to selected | | | outside selected FIB | |
| | | position in FIB 166. | | | 166 row. | |
| | | | | | FIB 166 latches will | |
| | | | | | close prior to setting | |
| | | | | | down the stand. | |
| | | | | | Set down stand on | |
| | | | | | selected position. | |
| 1.4. | Pipe | Move RN 151 to WC | Visual/ | RN tongs open. | RN 151 will move to | TJ (stick-up) |
| | Handler | 203: | CCTV | WC 203 selected. | WC 203. | assist |
| | | Verify TD 116 is | | | Elevate RN 151 to | indication. |
| | | hoisted above RN 151 | | | stick-up. | |
| | | working area. | | | RN 151 will stop/wait | |
| | | Start RN 151 break- | | | outside WC 203 area if | |
| | | out sequence to move | | | TD 116 is moving. | |
| | | RN 151 to WC 203. | | | | |
| 1.5. | Pipe | LSA 228 move to WC | Visual/ | | LSA 228 will stop/ | |
| | Handler | 203: | CCTV | | wait outside WC 203 | |
| | | LSA 228 move to WC | | | area if TD 116 is | |
| | | 203. | | | moving. | |
| 2. | Driller | Set slips 161: | Visual/ | | | DW 119 Upper |
| | | Verify required stick- | CCTV | | | stop setting. |
| | | up height. | | | | |
| | | Set slips 161 | | | | |
| | | (command). | | | | |
| | | Set off weight. | | | | |
| 2.1. | Pipe | RN 151 break-out and | CCTV | Slips 161 closed. | Break-out and spin- | RN 151 |
| | Handler | spin-out: | | | out. Double break-out | indication. |
| | | Verify slips 161 | | | available if required. | Stand not |
| | | closed and weight set | | | Open RN 151 | connected. |
| | | off. | | | spinner, guide, and | |
| | | Adjust RN 151 | | | clamps. | |
| | | elevation if required. | | | Return RN 151 to | |
| | | Continue RN 151 | | | park position. | |
| | | sequence. | | | | |
| | | Note: Spin-out | | | | |
| | | carefully. Manual | | | | |
| | | mode available. | | | | |
| 2.2. | Pipe | LSA 228 guide close: | Visual/ | Slips 161 closed. | LSA 228 will not close | LSA 228 in WC |
| | Handler | Verify LSA 228 in WC | CCTV | | in WC 203 if slips 161 | 203. |
| | | 203 and slips 161 | | | are not closed. | LSA 228 guide |
| | | closed, | | | | funnel to Closed |
| | | Close LSA 228 guide | | | | state. |
| | | funnel. | | | | |
| 3. | Driller | Hoist stand from stick- | Visual/ | RN finished spin-out, | The stand is lifted | |
| | | up: | CCTV | BUT open. | carefully. Lifting is | |
| | | Verify RN 151 is | | LSA 228 funnel | stopped if stand | |
| | | finished and open and | | closed. | catches on threads in | |
| | | LSA 228 is closed. | | | TJ. | |
| | | Option: If second RN | | | | |
| | | 151 is used, first RN | | | | |
| | | 151 should be | | | | |
| | | retracted. | | | | |
| | | Hoist stand above | | | | |
| | | stick-up. | | | | |
| 3.1. | Pipe | LSA 228 guides stand | Visual/ | RN 151 open. | | Animated |
| | Handler | to THP 207: | CCTV | Optional: Second RN | | positions. |
| | | Verify pin above stick- | | 151 open and | | |
| | | up. | | retracted. | | |
| | | LSA 228 guides stand | | | | |
| | | toward THP 207. | | | | |
| | | UTC 242 and LTC | | | | |
| | | 244 extend to DCH. | | | | |
| 4. | Driller | Lower stand to THP | Visual/ | | TD 116 will stop with | |
| | | 207: | CCTV | | elevator 129 above | |
| | | Verify stand (pin end) | | | UTC 242. | |
| | | is outside rig floor 114. | | | | |
| | | Lower stand to THP | | | | |
| | | 207 guided by LSA | | | | |
| | | 228. | | | | |
| | | Tilt links out toward | | | | |
| | | UTC 242. | | | | |
| 4.1. | Pipe | TD and LSA 228 move | Visual/ | UTC 242 open. | DW 119 will slow | UTC 242 |
| | Handler | stand to DCH: | CCTV | LSA 228 guide funnel | down above DCH. | animated in |
| | | TD 116 and LSA 228 | | closed. | UTC 242 closes | DCH. |
| | | move toward DCH. | | UTC 242 open in | when stand is inside | LSA 228 |
| | | LTC 244 closes when | | DCH. | UTC 242. | extend. |
| | | stand is close to DCH. | | LTC 244 closes when | LTC 244 is extended | LTC 244 to |
| | | Set down stand on | | stand is below LTC | and closed. | Closed state. |
| | | DCH. | | 244. | | UTC 242 to |
| | | TD links tilted out | | | | Closed state. |
| | | toward UTC 242. | | | | LSA 228 open. |
| | | UTC 242 closes when | | | | |
| | | stand is inside guide. | | | | |
| | | LSA 228 opens and | | | | |
| | | retracts. | | | | |
| 5. | Driller | Open TD elevator 129, | Visual/ | UTC 242 closed. | | Elevator 129 to |
| | | lower to stick-up: | CCTV | | | Open state. |
| | | Verify UTC 242 and | | | | |
| | | LTC 244 are closed. | | | | |
| | | Open elevator 129. | | | | |
| | | Tilt links vertical | | | | |
| | | (float). | | | | |
| | | Lower TD 116 to | | | | |
| | | stick-up. | | | | |
| 5.1. | Pipe | UTC 242 and LTC 244 | Visual/ | TD elevator 129 | UTC 242 and LTC | UTC 242 and |
| | Handler | tilt stand to vertical | CCTV | open. | 244 will stop in | LTC 244 Closed. |
| | | position: | | | vertical position. | UTC 242 and |
| | | UTC 242 and LTC | | | | LCS to DCH. |
| | | 244 extend to tilt stand | | | | Doper |
| | | toward WC 203. | | | | animated. |
| | | Wash and dope pin, if | | | | |
| | | preselected. | | | | |
| 6. | Driller | Extend TD 116 and | Visual | RN 151 retracted. | | Elevator 129 |
| | | latch elevator 129: | | | | Closed state. |
| | | Extend TD 116 to WC | | | | Indicate TD 116 |
| | | 203. | | | | in WC 203. |
| | | Latch elevator 129 | | | | |
| | | (automatic close on | | | | |
| | | impact). | | | | |
| 7. | Driller | Check trip tank | Visual | | Trip tank gain/loss is | Trip Sheet/ |
| | | volume, gain/loss: | | | determined and | Volume control. |
| | | Trip tank gain/loss. | | | displayed. | |
| | | Repeat all steps for | | | | |
| | | next tubular. | | | | |
| | | Continue on step 1. | | | | |
| 7.1. | Pipe | TBR 254 and SGA 262 | Visual/ | UTC 242 and LTC | TBR 254 clamp and | TBR 254 clamp |
| | Handler | move to THP 207: | CCTV | 244 closed on stand. | guide and SGA 262 | and guide and |
| | | Open TBR 254 and | | | guide will open. | SGA 262 guide |
| | | SGA 262 in FIB 166. | | | TBR 254 will hoist | to Open states. |
| | | Move toward THP | | | before it retracts out of | |
| | | 207/next stand. | | | FIB 166. | |
| | | Continue step 1.1. | | | | |

The zone management system (ZMS) mentioned in the sequences above define a zone for each physical component of the IWCS for which collisions are to be avoided. The zone is a three-dimensional space defined according to a coordinate system common of the IWCS. Each zone pertains to one or more different pieces of equipment, including those structures or components that are stationary as part of the IWCS. The zone is attached to the equipment and travels with the equipment. The size of the zone may change (expand or shrink) depending on the transport speed of the related equipment, or the transport speed of surrounding equipment. Some machinery and equipment is complex enough to warrant using multiple zones within the machinery, and the ZMS maintains information pertaining to the zones of the different subcomponents. The ZMS monitors the zones to prevent collisions.

FIG. 24 depicts a component 1140 that is a subject of the ZMS. The component 1140 can be any component of the IWCS. The component 1140 has a zone 1141 that at least partially envelops the component 1140. The zone 1141 may be larger than the component 1140 such that a buffer zone is created between the extremities of the component 1140 and the zone 1141 to further help avoid collisions between components. A database 1142 stores characteristics of the components tracked by the ZMS. The database 1142 may store information related to position, size, shape, weight, motion path, tolerance, impact sensitivity, reference point, center of mass 1143, and attachment points. A processing system 1144 of the ZMS may execute the logic and calculations. The processing system 1144 may be an instance of the processing system 1000 shown in FIG. 23.

The position of the component 1140 can be expressed in terms of coordinates relative to one or more coordinate systems. Each coordinate system can be an x-y-z system, a polar coordinate system, or another type of coordinate system. The coordinate system can be centered on any arbitrary point, such as a north-west extreme of the rig floor 114 (FIG. 1) or the intersection of the well center and the rig floor 114, among other examples. The position of the component 1140 is monitored and continuously compared against the position of other relevant components of the IWCS. The position information of a component, in conjunction with the size, and/or shape information of the component, may be used to describe the equipment and its associated zone in the three-dimensional space of the coordinate system in relation to other components of the IWCS. The ZMS system can detect when a collision between two or more components is imminent and, consequently, issue a warning or take action to prevent the collision.

The component sizes are stored by the database 1142 to help calculate the zones 1141. The database 1142 may be at least a portion of an instance of the processing system 1000 shown in FIG. 23. The database 1142 can store the sizes of the components 1140 in terms of coordinates at various extremities of the component 1140. If the component 1140 has a generally cubic shape, the size can be described by the edges and the orientation of the cube or other coordinate system. If the shape of the component 1140 is more complex, more coordinates can be used to define size and shape. The size and/or shape information of each component 1140 is used to define the corresponding size and/or shape of the associated zones 1141. The zone 1141 may fully envelop the physical component 1140, or may encompass just a part of the physical component 1140 that may collide with other components 1140. The size of the zone 1141 may also expand in a direction aligned with movement of that component 1140, and/or in a direction of another approaching component 1140. The extent of this expansion may depend on the speed of the moving component(s) 1140.

The database 1142 also tracks the weight of the components 1140, which the ZMS may use to determine how much force is required to move or stop motion of a component 1140. The weight of a component 1140 may be known, such as when entered during sequence set-up, while in other cases the IWCS may comprise sensors configured to determine the weight of the component 140. For example, if the component 1140 is the top drive 116 connected to the drill string 120, the weight of the component 1140 varies depending on the length and other parameters of the drill string 120. The sensors may perform weight measurements to determine weight as needed.

The positions of the various components 1140 of the IWCS varies from time to time. The motion path of each component 1140 can also be stored by the database 1142. The motion path of a component 1140 could be a complete path, such as when a component 1140 could travel from one position to another position. Alternatively, the motion path of the component 1140 could be just the direction in which the component 1140 may travel, with no defined end point. The database 1142 can store a routine path of motion for the components 1140. For example, an iron roughneck 151 has a movement path between retracted and expanded positions. The trajectory of the path can be known ahead of time. The ZMS processing system 1144 can be informed of a proposed motion path for a given component 1140, and can calculate whether the component 1140 can make the proposed movement at the proposed time without intersecting with a zone of another component of the IWCS. If so, the ZMS processing system 1144 approves the movement. Alternatively, when the component 1140 is commanded to move in a particular direction, the zone 1141 associated with the component 1140 may be expanded in the direction of the intended movement. The extent of the zone 1141 expansion may depend on the speed of the associated component 1140. With the expanded zone 1141 for a component 1140, the ZMS processing system 1144, may calculate whether the expanded zone 1141 could intersect with a zone 1141 of another component 1140 of the IWCS. If not, the ZMS processing system 1144 approves the movement. In addition, when a component 1140 is commanded to move in a particular direction, the zones 1141 associated with surrounding components 1140 that may come in contact with the moving component 1140 may be expanded in the direction of the incoming component 1140. The extent of the zone 1141 expansion may depend on the speed of the incoming component 1140. The ZMS processing system 1144 may perform similar calculations to evaluate whether a zone 1141 intersection may occur and react accordingly. The movement of the components 1140 can be under the direction and control of the Construction Program, so actions controlled by the Construction Program may be subject to the approval of the ZMS processing system 1144 to prevent collisions between components 1140.

The movement of one or more portable components may be unscheduled. A portable component is an object that is not part of the IWCS equipment, but may be present during the operation. For example, a human operator 195 on the rig floor 114 may be a portable object. The ZMS processing system 1144 is equipped to detect and monitor unscheduled movement of the portable components. For example, the various cameras, sensors, and other measuring equipment described above can be used to identify the portable component and detect its movement. The ZMS processing system 1144 can establish a zone associated with the portable component, evaluate its risk for colliding with surrounding equipment, and issue a warning and/or take action to prevent a collision. The ZMS processing system 1144 may move other components 1140 out of the way, or may stop the movement of other components 1140, to avoid a collision. The ZMS processing system 1144 may also calculate an expected damage for a given collision, and may include logic to permit the ZMS processing system 1144 to determine a course of action under a given set of circumstances. For example, if the top drive 116 is moving down toward the rig floor 114 when the ZMS processing system 1144 detects an operator 195 walking toward well center, the ZMS processing system 1144 may immediately establish a zone 1141 around the operator 195 and evaluate whether this zone 1141 would intersect with the zone 1141 associated with the top drive 116. Depending on safety policy established for the operation, the ZMS processing system 1144 may take a number of measures to avoid collision between the top drive 116 and the operator 195, such as triggering an alarm, slowing movement of the top drive 116, and/or emergency stop of top drive 116, among other examples.

The database 1142 can store information relating to a tolerance for a given component 1140. The tolerance can be defined as a distance from the edge of the physical structure of the component 1140 and the corresponding edge of the defined zone 1141. The nature of the component 1140 and the environment in which it is being used can factor into determining the tolerance. Generally, the faster the speed of the component 1140, the larger the tolerance in the direction of the movement. Alternatively, the faster the speed of the incoming component 1140, the larger the tolerance in the direction of the incoming component 1140. It is also possible that the more sensitive the component 1140, the larger the tolerance can be. The constraints of the environment may also determine what the tolerance is. For example, if the component 1140 is to be installed into predefined space where it is next to another component, then the tolerance can be adjusted accordingly so as not to trigger an alarm or corrective action when installed in the desired location. The tolerance may also be altered during movement, such that when a given component 1140 is stationary, the tolerance can be smaller, and when the component 1140 is moving, the tolerance (and, thus, the zone 1141) can be temporarily enlarged.

Various components are made of different materials and some are more delicate than others. The nature of the component's resistance to collision can be factored into the calculation of the zone 1141. The notion of impact sensitivity may be more than physical impact, and can include chemical, thermal, vibrational, and electromagnetic contact. Thus, the zone 1141 of a component 1140 can be enlarged or reduced according to the collision, chemical, thermal, vibrational, electromagnetic, and other sensitivity of the component 1140.

The components 1140 each generally have a physical body, and to properly address the location of the component 1140 and its proximity to other components, the component 1140 can be given a reference point and the dimensions of the component 1140 can be defined with reference to the reference point. The reference point can be arbitrarily chosen, or it can have some importance. For example, the reference point can coincide with the center of mass 1143, an important corner, an edge, or another significant point on the component 1140. If a component 1140 is routinely rotated, the reference point and geometry of the component 1140 can be updated as it is rotated during service. The zone 1141 pertaining to the component can also be updated accordingly. Some components 1140 have are attachment points, such as hooks, rails, skids, eyelets, bolt patterns, or other physical connection points. This information can also be stored in the database 1142 to permit handling of the components. In the event of an impending collision, information on where an attachment point is located may prove useful and can determine what course of action is taken to prevent or mitigate a collision. Another type of attachment point are ports, such as valves, electrical outlets/ports, etc. Knowing the location and existence of these attachment points and ports can also prove useful and can determine the actions taken by the systems and methods of the present disclosure.

Different priorities may be associated with different components 1140. Each component 1140 can be given a priority relative to other components, and if there are two competing movement proposals, the higher priority can be given the green light and the lesser priority components will have to wait or find another movement path. The higher priority component can be referred to as the commanding component and the lesser component can be referred to as the lesser component or the subservient component.

A rig control system according to the present disclosure (which may be similar or identical to system 800 shown in FIG. 22) may comprise a communication network (e.g., ring network 900 from FIG. 22), a control workstation connected directly to the communication network (e.g., control workstation(s) 850 and/or 852 from FIG. 22), a plurality of control devices that are each connected directly to the communication network, at least some (maybe each) of which control devices may comprise or be a computer (PC or IPC) and/or a programmable logic controller (PLC) (e.g., PLCs 901, 911, 921, 931, 941, 951, 961, 971, 981, 991 from FIG. 22), a plurality of local control networks (e.g., subsystem network rings 909, 919, 929, 939, 949, 959, 969, 979, 989, 999 from FIG. 22) that are each connected to the communication network via a corresponding one of the plurality of control devices, and a plurality of local control devices, at least some (and maybe each) of which may comprise or be a computer (PC or IPC) and/or a programmable logic controller (PLC) (e.g., devices 902-905, 912-915, 922-925, 932-935, 942-945, 952-955, 962-965, 972-975, 982-984, 992-995 from FIG. 22) and each of which is connected (e.g., directly) to a corresponding one of the plurality of local control networks (in which case each is connected indirectly to the larger communication network). The communication network may comprise or be a single ring, star, or daisy-chain network, and/or may be fiberoptic. Each of the plurality of control devices may perform, be caused to perform, sense, measure, monitor, log, and/or the like an action (e.g., a mechanical, software, or other action) of a surface or downhole component (or group thereof), subsystem (or group thereof), and/or system (or group thereof). By virtue of their connection through the communication network, each of the plurality of control devices may directly or indirectly communicate with each other of the plurality of control devices. In an advantageous embodiment, the communication network is configured such that the plurality of control devices (and/or the plurality of local control devices) may (and, in some embodiments, do) perform substantially all control logic involved in direct operation of an array of individual tools/equipment and/or individual subsystems controlled by the rig control system, whereas the control workstations, e.g., via user-input data comprising, consisting essentially of, or being operating parameters and/or multi-tool/multi-subsystem tasks, substantially exchange data comprising, being, and/or derived from the user-input data with the plurality of control devices (and/or, through the plurality of local control networks, with the plurality of local control devices, and thus ultimately with various tools/equipment/subsystems controlled by the rig control system.

In this or another embodiment, or as a stand-alone embodiment, an analysis-while-drilling (AWD) control system according to the present disclosure (which may be similar or identical to system 800 shown in FIG. 22) may be operable to display and/or utilize a plurality of drilling-related parameters that can be and/or have been input by a user and/or that can be and/or have been calculated by one or more algorithms (e.g., based on parameters that can be or have been input by a user). The AWD control system may utilize as input data drilling-related parameters involving well configuration, drill string (including BHA) configuration, drilling-related sensor data/parameters (e.g., mud pit level sensors, standpipe pressure sensors, mud flow sensors, and the like), and drilling equipment data/parameters (e.g., directly from the corresponding equipment, such as drill string revolutions per minute (RPM), make-up torque, mud pump SPM, and the like). The AWD control system may provide output data that can be delivered to and/or used by workstation(s) display(s) (e.g., including the AWD display), a historical logging system (e.g., which may be comprised within and/or accessible via a remote computing resource environment such as environment 206 from FIGS. 3 and 4), a mud logging system (e.g., which may be comprised within and/or accessible via a remote computing resource environment such as environment 206 from FIGS. 3 and 4), etc. The AWD control system output data may comprise: drilling operation warnings and alarms, a kick calculator and kill sheet; sensor data and sensor data calculations for storage in a historical trending/logging system, dynamic tracking of data/parameters related to/indicative of a predetermined set of operating parameters, parameters and/or other information indicative of well configuration, and/or parameters and/or other information indicative of drill string (e.g., including BHA) configuration. The predetermined set of operating parameters may include, but may not necessarily be limited to: well depth/shape; bit depth; stands in hole; sectioned mud volumes; drill string volume, displacement, and weight; mud tank volumes, including active tank selection and loss/gain calculation information; trip tank difference volume; trip tank accumulated volume; mud pump total stroke counters (individual stroke count is tracked by/on behalf of each mud pump); mud pump SPM total; setting of mud pump liner capacities and efficiencies; mud flow into hole, individual and total; annular mud velocity per section; mud volume per section; total strokes per section; strokes to go per section; total minutes per section; minutes to go per section; mud return flow; bit runtime and revolutions; WOB; ROP; hook load; and standpipe pressure; inter aia.

The AWD system is operable for delivering high-quality calculations for real-time monitoring and alarming of complex drilling and tripping parameters. Input from following sources may the basis for AWD calculations: well and drill string configuration; and drilling parameter sensors, as mud pit level sensors, standpipe pressure sensors, and mud flow sensors; directly from the drilling equipment, such as drill string RPM, make-up torque, and mud pump SPM. The AWD system may output results to workstation displays (e.g., an AWD display screen viewable by the operator on a control workstation display), a historical logging system, and a mud logger system. The AWD system may have direct access to all necessary sensor signals, and may permit further understanding and comprehension by the operator.

The AWD system may provide determination and/or confirmation of: well and drill string configuration; dynamic tracking of well and bit depth; stands in well; dynamic calculation of sectioned mud volumes, drill string volume, displacements, and weight; mud tank volumes, including active tank selection and loss/gain calculation; trip tank difference volume; trip tank accumulated volume; mud pump total stroke counters (individual count may be performed by the individual mud pumps); total mud pump strokes per minute; settings of mud pump liner capacities and efficiencies; mud flow into hole, individual and total; dynamic calculation of annular mud velocity per section; dynamic calculation of mud volume per section; dynamic calculation of total strokes per section; dynamic calculation of strokes to go per section; dynamic calculation of total minutes per section; dynamic calculation of minutes to go per section; mud return flow; bit runtime and revolutions; WOB; ROP; hookload; standpipe pressure; casing pressure; cement pressure; kick calculator and kill sheet (e.g., following the “Drillers Method”)' sensors and calculations for storage in historical trending system; and operation warnings and alarms.

The AWD system may contain specific WITS (Well Site Information Transfer Standard) computations and triggers used to populate serial communication utilizing the WITS0 protocol. The AWD system may calculate data for the WITS records “RECORD1—General Time-based” and “RECORD11—Mud Tank Volumes—Time-based.” The WITS record “RECORD19—Hole and Drill String” may be used for configuration.

The AWD system may calculate mud active volume from the levels measured by the mud pit level instrumentation. The level sensors may be wired to the AWD system, or the AWD system may receive the level sensor data from the drilling fluid control system. Active tanks may be selected by the operator to be included as a part of the active volume. Any tank combination is possible for active volume. Once selected, the tank is automatically added to the active volume. All calculations involving active volume will be updated with the new value. The AWD screen may indicate the status of which tanks contribute into the mud active volume determination, which may always be visible to the operator.

The AWD system calculates data for the mud balance volume indicator showing loss/gain volume with an arrow for increasing/decreasing trend. System loss/gain is calculated as variation in active volume from a reset value.

The AWD system calculates bit and well depth automatically by use of hoist position, hook load, and slips status. Each time the bit moves in the well, or the well is being lengthened, the well and bit depths are automatically calculated by the AWD system. The update is dependent on a certain weight of the drill string, i.e., the ability to measure hook load. In cases when the weight of the drill string is too low to obtain a reliable signal, it is possible to manually decide when the bit depth should be updated. The bit and well depth calculator also includes an automatic Stands In Hole counter based on an input average stand length.

The AWD system may have two options for depth calculations: “slips” for depth calculation active when the slips are not set; and “hookload” for depth calculation when load is in the elevator.

The AWD system may include individual SPM and stroke counters for each mud pump. In addition, there may be multiple (e.g., four) independent total strokes counters and total SPM for the active mud pumps. The operator may select which pumps to count into the active mud pumps for total counters.

The AWD system may include monitoring of the mud flow pumped into the drill string, as well as mud return flow. Calculation of flow in depends on configuration of liner capacity and efficiency factor set for the individual mud pumps. By use of these data and SPM, the AWD system may calculate the mud flow in per pump, in addition to total flow pumped into the well.

The mud return flow may be read directly from a mud return sensor, which an operator may choose via a sensor-select pop-up menu.

The ROP may be calculated as a result of well or bit depth increase over time. The operator may select whether the ROP calculation will be done from bit depth or well depth.

The WOB may be calculated as variation in hook load from a reset value.

The AWD system may include counters for bit revolutions and runtime. These counters may depend on top drive RPM and calculated mud flow in. Updating the counters may be done when the bit is on bottom.

The AWD system may display a well configuration used to configure well and drill string parameters, as well as to give a summarized view of the current configurations being used.

The well design entered in the AWD system includes number of well sections, as well as well diameter and planned length for each section. The choke and kill line design entered in the AWD system may include choke line ID, choke line joint ID, choke line joint fraction, choke line length, kill line ID, kill line joint ID, kill line joint fraction, and kill line length. The drill string design entered in the AWD system may include dimensions and length of each drill string section, including number of drill string sections, planned length, drill string capacity, drill string steel displacement, drill string closed displacement, average length of tubular tool joint, average length of stand, and number of tool joints per stand, among other examples.

The kick calculator may be used if the well kicks and the well must be shut in and circulated out to regain control over the well. The kick calculator does not start any equipment, sequences, or processes, and may be used at any time or point of the well. Inputs for the kick calculator may include measured depth, true vertical depth, measured shoe depth (e.g., second-lowest well section), vertical shoe depth, original mud weight, leak off test mud weight, leak off test pressure, shut in casing pressure, shut in drill pipe pressure, kick gain volume, kill pump selection, kill pump capacity (e.g., calculated from mud pumps configuration), kill pump speed, slow circulation rate pressure, safety margin, and selected choke/kill line to use, among other examples. The kick calculator may also use previously entered and/or measured parameters as string and well properties, riser dimensions, and kill and choke line properties. The volumes, shoe, and pump data may be gathered from the mud pumps and well configuration settings. The kick calculator may output initial circulation pressure, interim circulation pressure, final circulation pressure, kill mud weight, maximum mud weight, pressure drop per 100 strokes, gradient of influx, height of influx, surface to bit strokes and minutes, bit to shoe strokes and minutes, shoe to bop strokes and minutes, bop to choke strokes and minutes, and total circulation strokes and minutes, among other examples.

The AWD system may determine the trip tank difference via a comparison between expected drill string displacement tripped into the well and actual volume measured in the trip tank. Drill string displacement may depend on the drill string configuration and bit depth.

The AWD system may determine the trip tank accumulated volume as the total volume of mud during tripping in or out. The accumulator may be frozen when filling or draining to make it possible to fill or empty the trip tank without reflecting the accumulated value.

The AWD display screen may dynamically show the configured and drilled well and drill string graphically. The AWD display screen may also dynamically show mud volumes, strokes, and velocity for the different well sections. The AWD system may also track the mud front depth, which may be displayed textually (e.g., numerically) and graphically on the well animation. The AWD display screen may contain a graphical display of the well configuration and well section depths, a graphical display of the shoe, an animation of drilled well relative to well configuration, an animation of the drill string in the well, the mud front tracking (e.g., mud front depth value and graphical display), annular velocity per well section, open hole volume, and dynamic determination of total strokes and minutes, strokes and minutes to go, and volume for surface to bit, bit to shoe, bit to BOP, and bit to surface, well circulation, and full circulation, among other examples. The AWS display screen may also display other AWD parameters already determined by the AWD System, such as drill string displacement—open end, drill string displacement—closed end, drill string weight, stands in the well, active volume, mud flow in, bit revolutions, and bit runtime, among other examples. The AWD display screen may also summarize the configured well section lengths, and may display the depth of each section in addition to graphically indicating the shoe depth. If the actual well depth exceeds the configured well depth, the length of the deepest well section may automatically be updated so that volume, time, and stroke calculations are correct. Well and drill string animation may also be updated to reflect exceeded well depth.

When a well configuration is input to the AWD system, the well may be filled with a first color, and as drilling progresses, the well animation may correspondingly be filled with a second color according to the calculated well depth. The drill string may be graphically displayed with the second color or a third color in the configured well. Depth of the drill string will indicate the bit depth.

The mud front tracking position may be calculated in relation to the mud pump total strokes counter and the drill string and well configurations. It may be possible to track the mud front from the surface or the bit. When the operator selects to start tracking the mud front from the surface, and a selected total strokes counter is set to zero, a graphical symbol may indicate the mud front position moving from the surface towards the bit inside the drill string while mud is pumped into the well. When the stroke counter exceeds the number of strokes for surface to bit, another graphical symbol may indicate the mud front position in the annular volume going from bottom to surface. When the mud front indication reaches the surface, it may stay on the surface until the selected total stroke counter is reset. When the operator selects to start tracking the mud front from the bit (or bottom), and the selected total strokes counter is set to zero, a graphical symbol may indicate the mud front position in the annular volume starting from the bit and moving towards the surface. When the mud front indication reaches the surface, it may stay on the surface until the selected total stroke counter is reset. In addition to the graphical display of the mud front depth, there may also be a numerical display showing the depth. For example, the value may be a positive value if the mud front is moving towards the bit inside the drill string or towards surface in the annular volume.

The AWD system may calculate and display annular velocity with a numerical display for each of the well sections. If the drill string has several outer diameters inside the same well sections, the velocity calculated may be the average in the specific well section.

The AWD system may calculate the open hole volume according to the well configuration at current well depth.

The AWD system may dynamically calculate volume, total strokes, total minutes and strokes, and minutes to go for one or more of: surface to bit (drill string volume); bit to shoe (annular volume from bit to shoe); bit to surface (total annular volume); well circulation (drill string+annular volume); and full circulation (drill string+annular volume+active volume). The strokes and minutes to go may be calculated from the last reset of the selected total strokes counter. If the operator selected to start tracking from surface, strokes and minutes to go may be calculated starting from counting strokes from surface. If the operator selected to start tracking from bottom, strokes and minutes to go may be calculated starting from bit position. The surface to bit strokes and time to go may be be set to zero when the operator selects to start tracking from bottom.

Volume calculations may be related to the well and drill string configurations and the calculated bit depth. Strokes calculations may depend on calculated volumes and active mud pump capacity settings. Minutes to go calculations may depend on calculated volumes, active mud pump capacity settings, and mud pump total SPM.

A control system according to one or more aspects of the present disclosure (which may be similar or identical to system 800 shown in FIG. 22) may be operable to monitor and at least partially (e.g., completely) control drilling operations of a drilling rig and one or more of the following modules: drill pipe tripping in (with and/or without drill collar stand); drill pipe tripping out (with and/or without drill collar stand); drill pipe connecting; drill pipe stand-building (offline); drill pipe laydown standing (offline); casing stand-building; casing tripping in; stand breakdown; running casing from catwalk; picking up singles from catwalk; laying down singles from well center to catwalk; back-reaming; wet tripping; normal drilling shut-down; and emergency drilling shut-down (based on alarm conditions). One such example module involves running 13⅜″ casing from catwalk using top drive and casing running tool. This module sequence may start with top drive in lower position, casing running tool engaged, closed slips (e.g., approximately 1.5 meters stick up), catwalk machine feeding table loaded with (cleaned) tubulars, catwalk machine ramp loaded with casing (e.g., on its way up), tubular delivery arm parked in/near top of mast, and lower stabilizing arm ready. The module sequence may then include: (i) releasing casing running tool from stick up and hoisting top drive to pick up position; (ii) latching elevator; (iii) top drive/lower stabilizing arm hoisting the casing to well center and catwalk machine being moved to loading position; (iv) stabbing the casing; (v) loading another (e.g., the next) casing on catwalk machine ramp; (vi) running catwalk to drill floor; (vii) engaging casing running tool and making-up casing connection; (viii) opening backup tong and retracting tong handling trolley; (ix) lowering casing string and opening elevator; (x) tilting out elevator link(s) and setting slips; and (xi) optionally repeating some or all of these steps for additional (e.g., the next) casing(s), as desired.

A drilling system according to one or more aspects of the present disclosure (which may be similar or identical to system 800 shown in FIG. 22) may comprise at least partially (e.g., completely) automated control of equipment comprising, consisting essentially of, or consisting of each of: drawworks; top drive; iron roughneck; mud bucket; cathead(s); mousehole; mud system comprising mud pumps; catwalk; fingerboard; vertical pipe handler; CCTV system; riser tension system; top-mounted compensator; and optionally bottom hole assembly (BHA).

A control system according to one or more aspects of the present disclosure (which may be similar or identical to system 800 shown in FIG. 22) may be operable for controlling drilling operations in which automated tripping in and/or automated tripping out modules may be advantageously more efficient than manual tripping in and/or tripping out modules for an average human working crew. The control system may effectuate one, some, or all of the following: an automated average tripping in and/or tripping out speed [in stands/hour] that is at least 5% (e.g., at least 6%, at least 7%, at least 8%, at least 9%, or at least 10%) better/more than an average tripping in and/or tripping out speed of an average human working crew; an automated standard deviation from average tripping in and/or tripping out speed that is at least 50% (e.g., at least 55%, at least 60%, at least 65%, at least 70%, at least 75%, or at least 80%) better/lower than a standard deviation from an average tripping in and/or tripping out speed of an average human working crew; an automated average tripping in and/or tripping out slip-to-slip connection time [in seconds] that is at least 4% (e.g., at least 5%, at least 6%, or at least 7%) better/lower than an average tripping in and/or tripping out slip-to-slip connection time of an average human working crew; and an automated standard deviation from average tripping in and/or tripping out slip-to-slip connection time that is at least 50% (e.g., at least 55%, at least 60%, at least 65%, at least 70%, at least 75%, or at least 80%) better/lower than a standard deviation from an average tripping in and/or tripping out slip-to-slip connection time of an average human working crew.

A control system according to one or more aspects of the present disclosure (which may be similar or identical to system 800 shown in FIG. 22) may be operable for controlling drilling operations in which collisions are prevented between: (a) drawworks and one or more of iron roughneck, tong-handling trolley, tong-handling arm, catwalk, tubular delivery arm, lower stabilizing arm, and upper tubular constraint; (b) top drive and one or more of iron roughneck, tong-handling trolley, tong-handling arm, catwalk, tubular delivery arm, lower stabilizing arm, and upper tubular constraint; (c) iron roughneck and one or more of drawworks, top drive, catwalk, tubular delivery arm, lower stabilizing arm, intermediate tubular constraint, rotary table, power slips, well center connection, and mousehole connection; (d) tong-handling trolley and one or more of drawworks, top drive, catwalk, tubular delivery arm, lower stabilizing arm, rotary table, power slips, and well center connection; (e) tong-handling arm and one or more of drawworks, top drive, catwalk, tubular delivery arm, lower stabilizing arm, intermediate tubular constraint, rotary table, power slips, well center connection, and mousehole connection; (f) catwalk and one or more of drawworks, top drive, iron roughneck, tong-handling trolley, tong-handling arm, tubular delivery arm, lower stabilizing arm, pipes around stand hand-off position, and pipes by mousehole; (g) tubular delivery arm and one or more of drawworks, top drive, iron roughneck, tong-handling trolley, tong-handling arm, catwalk, lower stabilizing arm, transfer bridge rackers, upper tubular constraint, intermediate tubular constraint, lower tubular constraint, setback guide arm(s), stand hand-off position, rotary table, and power slips; (h) lower stabilizing arm and one or more of drawworks, top drive, iron roughneck, tong-handling trolley, tong-handling arm, catwalk, tubular delivery arm, and intermediate tubular constraint; (i) transfer bridge rackers and one or more of tubular delivery arm, upper tubular constraint, lower tubular constraint, setback guide arm(s), stand hand-off position, and fingerboard; (j) upper tubular constraint and one or more of drawworks, top drive, tubular delivery arm, transfer bridge rackers, lower tubular constraint, and setback guide arm(s); (k) intermediate tubular constraint and one or more of iron roughneck, tong-handling arm, tubular delivery arm, lower stabilizing arm, and mousehole connection; (l) setback guide arm(s) and one or more of tubular delivery arm, lower stabilizing arm, transfer bridge rackers, upper tubular constraint, and lower tubular constraint; (m) setback guide arms; (n) fingerboard and transfer bridge rackers; (o) lower tubular constraint and one or more of tubular delivery arm, lower stabilizing arm, transfer bridge rackers, upper stabilizing arm, and setback guide arm(s); (p) stand hand-off position and one or both of tubular delivery arm and transfer bridge rackers; and/or (q) rotary table/power slips and one or more of drawworks, top drive, iron roughneck, tong-handling trolley, tong-handling arm, tubular delivery alarm, lower stabilizing arm, and well center connection.

A control system according to one or more aspects of the present disclosure (which may be similar or identical to system 800 shown in FIG. 22) may be operable for controlling drilling operations in which a level of automation for various drilling operations can be selected by: generating a control screen facilitating selection of automation level; and facilitating selection of full (i.e., substantially complete) automation, semi-automation (e.g., confirmation by driller/operator to start a specific operational sequence, automating a first portion of a larger operational sequence such as waiting for a driller/operator to authorize completion and/or a second portion of the larger operational sequence, or the like), or manual control (e.g., via a joystick).

A control system according to one or more aspects of the present disclosure (which may be similar or identical to system 800 shown in FIG. 22) may be operable for controlling drilling operations and may comprise a customizable display screen on which a control screen is generated and which control screen may be operable to facilitate selection of scale and/or limits for indicator graphs (e.g., pie chart(s), linear bar graph(s), spider graph(s), and/or the like, as well as combinations thereof) that may graphically represent one or more aspects of the drilling operations. The selection of scale and/or limits may include, but are not necessarily limited to, minimum and maximum graph values; warning value limits; and graph scale.

A control system according to one or more aspects of the present disclosure (which may be similar or identical to system 800 shown in FIG. 22) may be operable for controlling drilling operations and may comprise a display of software objects (e.g., symbols, icons, buttons, and/or the like) that: may be displayed on a monitor or touchscreen; may be indicative of equipment/tool/device status via changing color, localized background color, adjacent or localized background symbol (e.g., check or X), flashing color, filled/unfilled object, and/or the like; may show operational status (e.g., high value, open, closed, running, idle, error, and/or the like); may show communication status (e.g., feedback error, communication error, and/or the like); may show control status (e.g., auto, manual, local, and/or the like); and may be displayed in association with displayed numerical values; inter alia.

A control system according to one or more aspects of the present disclosure (which may be similar or identical to system 800 shown in FIG. 22) may comprise an AWD display screen showing one, some, or all of the following information: (a) graphic display of well configuration and hole section depths; (b) graphic display of shoe; (c) animation of planned vs. actual well; (d) animation of drill string in well; (e) value and graphic display of mud front tracking/depth; (f) annular velocity per section; (g) open hole volume; (h) dynamic calculation of total strokes and minutes, strokes and minutes to go, and volume for at least the following: (i) Surface To Bit; (ii) Bit To Shoe; (iii) Bit To BOP; (iv) Bit To Surface; (v) Well Circulation; (vi) Full Circulation; (j) drill string displacement, open end and closed end; (k) drill string weight; (l) stands in hole; (m) active volume; (n) mud flow in; (o) bit revolutions; and (p) bit runtime.

A control system according to one or more aspects of the present disclosure (which may be similar or identical to system 800 shown in FIG. 22) may comprise an alarm system that can assist equipment operators/resource producers to operate equipment (e.g., drilling equipment) in an efficient and safe manner. The alarm system may be operable to: draw operator attention to alarms by use of colors, symbols, flashing, sounds, and other notations with distinct meaning; present descriptive and easy to understand alarm texts; use alarm priority with distinct meaning; logically group alarms; and keep an alarm rate as low as possible. The alarm system may additionally or alternatively utilize screen objects/symbols that are indicative of equipment or device and that may show status via changing color, localized background color, adjacent or localized background symbol, flashing color, filled or unfilled object, and/or the like. The alarm system may additionally or alternatively be configured: such that the driller/operator responds to all alarms; for intuitive navigation and alarm acknowledgment; to automatically log each alarm and alarm state change; and for high system availability and robustness.

A method of at least partially automating drilling operations according to one or more aspects of the present disclosure, which may be employed using one, some, or all of the (control) systems described herein, can comprise utilizing data indicative of operation or capability of a first piece of drilling equipment as an input parameter for controlling operation of a second piece of drilling equipment, wherein impact of the data indicative of the operation/capability of the first piece of drilling equipment is either not intuitively linked to or is counterintuitive to operation/capability of the second piece of drilling equipment. For example, an output parameter involving a piece of drilling equipment A may be used as an input parameter for operation of a piece of drilling equipment B, and an output parameter (e.g., similar to or different from the input parameter) involving the piece of drilling equipment B may be used as an input parameter for operation of a piece of drilling equipment C. In this example, one or more effects of operation/capability of a parameter involving the piece of equipment A is either not intuitively linked to or is counterintuitive in its applicability to the operation/capability of the piece of equipment C. In this example, the “piece of drilling equipment B” may represent a single piece of drilling equipment or a series of pieces of drilling equipment, an output parameter of each of which serves as an input parameter for the next piece of drilling equipment throughout the series (notably, it may be, although it need not be, the same output and/or input parameter throughout the series of drilling equipment).

In view of the entirety of the present disclosure, including the figures and the claims, a person having ordinary skill in the art will readily recognize that the present disclosure introduces an apparatus comprising an integrated well construction system (IWCS) operable for constructing a well via integrated control of a plurality of integrated control devices that collectively control a plurality of integrated subsystems of the IWCS, wherein the IWCS comprises: an IWCS communication network; the integrated control devices, each directly connected with the IWCS communication network; the integrated subsystems; and a control workstation directly connected with the IWCS communication network and operable to control each of the integrated control devices to thereby control the integrated subsystems.

Each integrated control device may control a corresponding one of the integrated subsystems.

The IWCS communication network may be a single, fiberoptic, ring-topology network.

The integrated subsystems may include at least: a rig control subsystem comprising a drawworks, a top drive, an iron roughneck, automated slips, and automated pipe handling equipment; a fluid circulation subsystem comprising a drilling fluid pump and drilling fluid reconditioning equipment; a managed pressure drilling control subsystem; a choke pressure control subsystem; a well pressure control subsystem; and a closed-circuit television subsystem.

Each subsystem may comprise: a subsystem network directly connected with the integrated control device of that subsystem; and a plurality of subsystem components each directly connected with the subsystem network. The subsystem components may each control, perform, sense, measure, and/or monitor an aspect of well construction performed in association with the subsystem comprising that subsystem component.

The control workstation may comprise a processor and a memory storing a construction program that, when executed by the processor, controls each integrated control device at least partially in response to data received from at least one other one of the integrated control devices.

The control workstation may comprise a processor and a memory storing a construction program that, when executed by the processor, controls each integrated control device during each of a plurality of predetermined operational sequences. The plurality of predetermined operational sequences may comprise: picking up single tubulars; making drilling connections; building tubular stands; tripping-in drill collar stands; tripping-out drill collar stands; tripping-out wet; backreaming; moving single tubulars from a well center to a catwalk using a top drive; moving tubular stands from the well center to the catwalk; moving casing from the catwalk to the well center using a casing tong; moving casing from the catwalk to the well center using a tubular delivery arm and a casing running tool; moving large diameter casing from the catwalk to the well center using the top drive and the casing running tool; building casing stands; and tripping-in casing stands without using the casing running tool. The construction program, when executed by the processor, may control the top drive, a drawworks, automated slips, a top drive elevator, an iron roughneck, a drilling fluid pumping system, the catwalk, an automated racker, an automated fingerboard, and the tubular delivery arm, via control of the integrated control devices, during performance of the predetermined operational sequences. The construction program may be configurable by a human operator to permit the operator to select human interaction levels during performance of the predetermined operational sequences. The construction program may be configurable by a human operator to permit the operator to select levels of automation of the IWCS during performance of the predetermined operational sequences. The construction program may be configurable by a human operator to permit the operator to select which machines of the IWCS will be controlled by the construction program during performance of each predetermined operational sequence. The construction program may be configurable by human operators to permit the operators to select which machines of the IWCS will be controlled by the construction program, and to select which machines of the IWCS will be supervised by which operator, during performance of each predetermined operational sequence. The construction program may be configurable by human operators to permit the operators to select which steps of each predetermined operational sequence will be performed and/or confirmed manually, and by which operator.

The IWCS may be operable for constructing a well without operation of other components not controlled by, monitored by, or otherwise in communication with any of the integrated control devices.

The IWCS may be operable for constructing a well without operation of other components not controlled by any of the integrated control devices.

The present disclosure also introduces an apparatus comprising a control workstation directly connected with a communication network and operable to control each of a plurality of integrated control devices each directly connected with the communication network, wherein each integrated control device controls a corresponding component of an integrated well construction system, whereby control of the integrated control devices, via operations of the control workstation, controls the integrated well construction system.

The integrated well construction system may be operable, via operations of the control workstation, for constructing a well exclusive of any component not controlled by any of the integrated control devices.

The present disclosure also introduces a computer program product comprising a tangible, computer-readable, non-transitory medium having instructions stored thereon for: automatically controlling a plurality of integrated control devices that control integrated subsystems of an integrated well construction system (IWCS) to perform combinations of a plurality of predetermined operational sequences for constructing a well; receiving, via operation of a control workstation by a human operator, a selection of one of the operational sequences to be performed by the IWCS; receiving, via operation of the control workstation by the human operator, settings for first machines of the IWCS to be operated during the selected operational sequence; and in response to receiving a single commencement input via operation of the control workstation by the human operator, automatically starting and controlling the first machines and second machines of the IWCS to perform the selected operational sequence using the received settings.

The automatic start and control of the first and second machines may perform the selected operational sequence without further human action.

The present disclosure also introduces a method comprising operating an integrated well construction system (IWCS) comprising a fiberoptic ring network, wherein the fiberoptic ring network comprises a plurality of nodes comprising: programmable logic controllers (PLCs) of individual pieces of machinery forming the IWCS; video feed; drilling operator control; high-level supervisory control; and combinations thereof.

The IWCS machinery PLCs may comprise: a drilling fluid pumping system PLC; a top drive PLC; a drawworks PLC; an automated slips PLC; an iron roughneck PLC; a catwalk PLC; an automated racker PLC; an automated fingerboard PLC; and a tubular delivery arm PLC.

The fiberoptic ring network may exchange data between the PLCs for coordinated control of the machinery.

The fiberoptic ring network may exchange data between one or more of the PLCs and the drilling operator for manual or semi-automatic control of the IWCS.

The fiberoptic ring network may exchange data between one or more of the PLCs and a supervisory controller for automatic and optimized control of the IWCS.

The present disclosure also introduces an apparatus comprising: a communication network; a plurality of integrated control devices each directly connected with the communication network, wherein each integrated control device controls a corresponding component of an integrated well construction system, and wherein the integrated well construction system is operable for constructing a well without other components not controlled by any of the integrated control devices; and a control workstation directly connected with the communication network and operable to control each of the integrated control devices to thereby control the integrated well construction system.

The present disclosure also introduces an apparatus comprising: a communication network; a plurality of integrated control devices each directly connected with the communication network, wherein each integrated control device controls a corresponding one of a plurality of integrated well construction components, and wherein the integrated well construction components are collectively operable for constructing a well exclusive of any component not controlled by any of the integrated control devices; and a control workstation directly connected with the communication network and operable to control each of the integrated control devices to thereby control the integrated well construction system.

The present disclosure also introduces an apparatus comprising: a communication network; a plurality of integrated control devices each directly connected with the communication network, wherein each integrated control device controls a corresponding one of a plurality of integrated well construction components, and wherein the integrated well construction components form an integrated well construction system operable for constructing a well without any other components; and a control workstation directly connected with the communication network and operable to control each of the integrated control devices to thereby control the integrated well construction system.

The present disclosure also introduces a method comprising causing a well construction system to perform a well construction operation, whereby data associated with the well construction operation is automatically collected and analyzed in real-time to determine a plurality of parameters based on the data, and wherein at least some of the determined parameters are used for controlling the well construction operation.

The data may be selected from: human operator inputs; equipment control, feedback, and interlock signals; surface sensor signals; and downhole sensor signals.

The well construction system may comprise a processing system comprising a processor and a memory having instructions recorded thereon for, when executed by the processor: automatically determining the parameters; and automatically controlling at least a portion of the well construction operation based at least partially on the determined parameters.

The well construction system may comprise a processing system comprising a processor and a memory having instructions recorded thereon for, when executed by the processor: automatically determining the parameters; and automatically displaying at least some of the determined parameters to a human operator in substantially real-time. The method may further comprise at least partially controlling, by the human operator, at least a portion of the well construction operation based at least partially on the displayed parameters. The displaying may comprise numbers, pictures, animations, or combinations thereof.

The determined parameters may comprise one or more of drilling fluid active volume, drilling fluid loss and/or gain, bit depth, wellbore depth, hook load weight and friction, drilling fluid pump strokes, drilling fluid stroke rate, rate of penetration, weight on bit, bit revolutions, bit runtime, well configuration, drill string configuration, choke configuration, kill line configuration, kick calculator, trip tank volume, trip tank difference determinations, and trip tank accumulated volume.

One of the determined parameters may be a kick determination based on: measured depth; true vertical depth; measured shoe depth; vertical shoe depth; original drilling fluid weight; leak off test drilling fluid weight; leak off test pressure; shut in casing pressure; shut in drill pipe pressure; kick gain volume; kill pump selection; kill pump capacity; kill pump speed; slow circulation rate pressure; safety margin; and selected choke/kill line.

The present disclosure also introduces a method comprising causing a well construction system to perform a well construction operation, whereby data associated with the well construction operation is automatically collected and analyzed in real-time to determine a plurality of parameters based on the data, and wherein at least some of the determined parameters each provide a basis for triggering at least one real-time well construction operation alarm.

The data may be selected from: human operator inputs; equipment control, feedback, and interlock signals; surface sensor signals; and downhole sensor signals.

The at least one real-time alarm may be a plurality of alarms comprising: high trip tank volume; low trip tank volume; high active drilling fluid volume; low active drilling fluid volume; high drilling fluid loss; low drilling fluid loss; high drilling fluid gain; low drilling fluid gain; high drilling fluid flow return; low drilling fluid flow return; high standpipe pressure; low standpipe pressure; drilling fluid pumping system total stroke rate; and drilling fluid pumping system total strokes.

The well construction system may comprise a processing system comprising a processor and a memory having instructions recorded thereon for, when executed by the processor: automatically determining the parameters; and automatically triggering the at least one real-time alarm based on at least one of the determined parameters.

The determined parameters may comprise one or more of drilling fluid active volume, drilling fluid loss and/or gain, bit depth, wellbore depth, hook load weight and friction, drilling fluid pump strokes, drilling fluid stroke rate, rate of penetration, weight on bit, bit revolutions, bit runtime, well configuration, drill string configuration, choke configuration, kill line configuration, kick calculator, trip tank volume, trip tank difference determinations, and trip tank accumulated volume.

The present disclosure also introduces an apparatus comprising an analysis-while-drilling (AWD) control system utilized in conjunction with a well construction system during a well construction operation, wherein inputs for the AWD control system comprise: intended configuration of a well being constructed by the well construction system during the well construction operation; configuration of a drill string being used by the well construction system during the well construction operation; signals from drilling parameter sensors; and drilling equipment parameters. Outputs from the AWD control system comprise real-time determination of: depth and trajectory of the well; bit depth; number of drill string tubulars and/or stands in the well; drill string volume, displacements, and weight; drilling fluid tank volumes and tank selections; drilling fluid loss and/or gain; trip tank difference volume; trip tank accumulated volume; total and/or per-section strokes and/or strokes-to-go of drilling fluid pumping system; total stroke rate of drilling fluid pumping system; drilling fluid pumping system liner capacities and efficiencies; individual and total drilling fluid flow into the well; annular drilling fluid velocity; total and/or per-section drilling fluid volumes; total minutes and/or minutes-to-go per section; drilling fluid return flow; bit runtime and revolutions; weight-on-bit; rate of penetration; hook load; and standpipe pressure. The outputs from the AWD control system may further comprise a kick calculator and a kill sheet. The outputs from the AWD control system may further comprise sensors and calculations for storage in a historian associated with the well construction system. The outputs from the AWD control system may further comprise well construction operation warnings and alarms.

The drilling parameter sensors may comprise drilling fluid tank level sensors, standpipe pressure sensors, cement manifold pressure sensors, and drilling fluid flow sensors.

The drilling equipment parameters may comprise drill string revolutions per minute, make-up torque, hoist position, hook load, slips status, average stand length, average tubular length, liner capacities and efficiencies of individual drilling fluid system pumps, top drive revolutions per minute, choke like parameters, kill line parameters, number of drill string sections, drill string capacity, drill string steel displacement, and drill string closed displacement.

The present disclosure also introduces an apparatus comprising a control workstation directly connected with a communication network and operable to control each of a plurality of control devices each directly connected with the communication network, wherein each control device controls a corresponding component of an integrated well construction system, whereby control of the control devices, via operations of the control workstation, controls the integrated well construction system, wherein the control workstation comprises a display, a processor, and a memory storing: a construction program that, when executed by the processor, controls each control device; and an analysis-while-drilling (AWD) program. Inputs for the AWD system comprise: intended configuration of a well being constructed by the well construction system during the well construction operation; configuration of a drill string being used by the well construction system during the well construction operation; signals from drilling parameter sensors; and drilling equipment parameters. When executed by the processor, the AWD program generates in real-time, and displays in real-time in an AWD screen on the display, one or more of: a graphic display of the intended configuration and/or an actual configuration of the well, including depths; a graphic display of a shoe in the well; an animation of the intended and actual configurations of the well; an animation of the drill string in the well; value textual and/or graphic display of drilling fluid front tracking and/or depth; annular velocity per section; open hole volume; total strokes and minutes, strokes and minutes-to-go, and volume for one or more of: surface to bit; bit to shoe; bit to blow-out preventer; bit to surface; well circulation; full circulation; drill string displacement, open end and closed end; drill string weight; number of tubulars in the well; active volume; drilling fluid flow into the well; bit revolutions; and bit runtime.

The present disclosure also introduces an apparatus comprising a control workstation for use with an integrated well construction system (IWCS), wherein the IWCS is operable for constructing a well via integrated control of a plurality of integrated control devices that collectively control a plurality of integrated subsystems of the IWCS, and wherein the control workstation comprises a human-machine interface (HMI) comprising a display, a touchscreen, a joystick, and a processing system comprising a processor and a memory having a construction program thereon that, when executed by the processor: presents a human operator of the control workstation with a setup wizard guiding the operator through entering operating parameters for one or more well construction machines of the integrated subsystems to perform a well construction sequence; and controls the integrated control devices, and thus the integrated subsystems, to perform the well construction sequence based on the entered operating parameters.

The well construction sequence may be selected from: picking up single tubulars; making drilling connections; building tubular stands; tripping-in drill collar stands; tripping-out drill collar stands; tripping-out wet; backreaming; moving single tubulars from a well center to a catwalk using a top drive; moving tubular stands from the well center to the catwalk; moving casing from the catwalk to the well center using a casing tong; moving casing from the catwalk to the well center using a tubular delivery arm and a casing running tool; moving large diameter casing from the catwalk to the well center using the top drive and the casing running tool; building casing stands; and tripping-in casing stands without using the casing running tool.

The entered operating parameters may be for one or more of a top drive, a drawworks, automated slips, a top drive elevator, an iron roughneck, a drilling fluid pumping system, a catwalk, an automated racker, an automated fingerboard, and a tubular delivery arm.

The entered operating parameters may comprise speed limitations of at least one of the well construction machines.

The entered operating parameters may comprise travel stops of at least one of the well construction machines.

The entered operating parameters may comprise maximum limitations of at least one of the well construction machines.

The entered operating parameters may comprise target settings of at least one of the well construction machines.

The entered operating parameters may comprise target settings of the well construction sequence.

The entered operating parameters may comprise automation levels. The automation levels may be selected from: automated control by the construction program; automated control by the construction program after confirmation by the human operator; and manual operation by the human operator.

The human operator may cause commencement of the well construction sequence by actuating a button on the touchscreen.

The human operator may cause commencement of the well construction sequence by actuating the joystick to ramp up the speed of the well construction machines.

The construction program may permit the human operator to take manual control of one or more of the well construction machines during the well construction sequence.

The construction program may permit the human operator to change an operating parameter of one or more of the well construction machines during the well construction sequence.

The well construction sequence may be a tripping-in or tripping-out sequence, which may be performed with an average stands-per-hour tripping-in or tripping-out speed that is at least five percent faster than attainable by an average human working crew not using the IWCS.

The well construction sequence may be a tripping-in or tripping-out sequence, which may be performed with a standard deviation from average tripping-in or tripping-out speed that is at least fifty percent lower than attainable by an average human working crew not using the IWCS.

The well construction sequence may be a tripping-in sequence, which may be performed with an average slips-to-slips connection time that is at least four percent faster than attainable by an average human working crew not using the IWCS.

The well construction sequence may be a tripping-in sequence, which may be performed with a standard deviation from average slips-to-slips connection time that is at least fifty percent lower than attainable by an average human working crew not using the IWCS.

The present disclosure also introduces an apparatus comprising an integrated well construction system (IWCS) operable for constructing a well via integrated control of a plurality of integrated control devices that collectively control a plurality of integrated subsystems of the IWCS, wherein the IWCS comprises a processing system comprising a processor and a memory having a construction program thereon that, when executed by the processor: controls each integrated control device, and thus each integrated subsystem, during each of a plurality of predetermined operational sequences; and prevents collisions between machines of the IWCS.

The IWCS machines prevented from colliding by the construction program may comprise: a drawworks; an iron roughneck; a tong-handling trolley; a tong-handling arm; a catwalk; a tubular delivery arm; a lower stabilizing arm; an upper tubular restraint; an intermediate tubular restraint; a lower tubular restraint; a top drive; a top drive elevator; a fingerboard; a transfer bridge racker; and a setback guide arm. The construction program may further prevent collisions between: the IWCS machines; tubulars being transported by any of the IWCS machines; tubulars sticking up out of the well; tubulars in a mousehole of the IWCS; and tubulars in a hand-off position of the IWCS. The construction program may prevent collisions between: a drawworks and one or more of a catwalk, an iron roughneck, a lower stabilizing arm, a tong-handling arm, a tong-handling trolley, a tubular delivery arm, and an upper tubular constraint; and/or a top drive and one or more of the iron roughneck, the tong-handling trolley, the tong-handling arm, the catwalk, the tubular delivery arm, the lower stabilizing arm, and the upper tubular constraint; and/or the iron roughneck and one or more of the drawworks, the top drive, the catwalk, the tubular delivery arm, the lower stabilizing arm, an intermediate tubular constraint, a rotary table, automated slips, a tubular sticking up out of the well, and a tubular sticking up out of a mousehole of the IWCS; and/or the tong-handling trolley and one or more of the drawworks, the top drive, the catwalk, the tubular delivery arm, the lower stabilizing arm, the rotary table, the automated slips, and a tubular sticking up out of the well; and/or the tong-handling arm and one or more of the drawworks, the top drive, the catwalk, the tubular delivery arm, the lower stabilizing arm, the intermediate tubular constraint, the rotary table, the automated slips, a tubular sticking up out of the well, and a tubular sticking up out of a mousehole; and/or the catwalk and one or more of the drawworks, the top drive, the iron roughneck, the tong-handling trolley, the tong-handling arm, the tubular delivery arm, the lower stabilizing arm, a tubular in a hand-off position of the IWCS, and a tubular sticking up out of a mousehole; and/or the tubular delivery arm and one or more of the drawworks, the top drive, the iron roughneck, the tong-handling trolley, the tong-handling arm, the catwalk, the lower stabilizing arm, a transfer bridge racker, the upper tubular constraint, the intermediate tubular constraint, a lower tubular constraint, a setback guide arm, a tubular in the hand-off position, the rotary table, and the automated slips; and/or the lower stabilizing arm and one or more of the drawworks, the top drive, the iron roughneck, the tong-handling trolley, the tong-handling arm, the catwalk, the tubular delivery arm, and the intermediate tubular constraint; and/or the transfer bridge racker and one or more of the tubular delivery arm, the upper tubular constraint, the lower tubular constraint, the setback guide arm, a tubular in the hand-off position, and a fingerboard; and/or the upper tubular constraint and one or more of the drawworks, the top drive, the tubular delivery arm, the transfer bridge rackes, the lower tubular constraint, and the setback guide arm; and/or the intermediate tubular constraint and one or more of the iron roughneck, the tong-handling arm, the tubular delivery arm, the lower stabilizing arm, and a tubular in the mousehole; and/or the setback guide arm and one or more of the tubular delivery arm, the lower stabilizing arm, the transfer bridge racker, the upper tubular constraint, and the lower tubular constraint; and/or the fingerboard and the transfer bridge racker; and/or the lower tubular constraint and one or more of the tubular delivery arm, the lower stabilizing arm, the transfer bridge racker, the upper stabilizing arm, and the setback guide arm; and/or a tubular in the hand-off position and one or both of the tubular delivery arm and the transfer bridge racker; and/or the automated slips and one or more of the drawworks, the top drive, the iron roughneck, the tong-handling trolley, the tong-handling arm, the tubular delivery arm, and the lower stabilizing arm.

The present disclosure also introduces a method comprising constructing a well utilizing each of a plurality of automatically controlled well construction machines, including: a drawworks; an iron roughneck; a tong-handling trolley; a tong-handling arm; a catwalk; a tubular delivery arm; a lower stabilizing arm; an upper tubular restraint; an intermediate tubular restraint; a lower tubular restraint; a top drive; a top drive elevator; a fingerboard; a transfer bridge racker; a setback guide arm; a mousehole; a mousehole; a drilling fluid pumping system; and a drilling fluid recondition system.

The present disclosure also introduces a system operable to completely control each of a plurality of predetermined operational sequences of a well construction operation, wherein the sequences include: picking up single tubulars; making drilling connections; building tubular stands; tripping-in drill collar stands; tripping-out drill collar stands; tripping-out wet; backreaming; moving single tubulars from a well center to a catwalk using a top drive; moving tubular stands from the well center to the catwalk; moving casing from the catwalk to the well center using a casing tong; moving casing from the catwalk to the well center using a tubular delivery arm and a casing running tool; moving large diameter casing from the catwalk to the well center using the top drive and the casing running tool; building casing stands; and tripping-in casing stands without using the casing running tool.

The present disclosure also introduces a control system for controlling drilling operations in which a level of automation for various operations can be selected. It may generate a control screen facilitating selection of level of automation. It may facilitate selection of full automation, semi-automation (e.g., confirmation by driller to start a specific sequence), or manual control (e.g., via a joystick).

The present disclosure also introduces a control system for controlling drilling operations comprising: a customizable display; a control screen facilitating selection of scale and limits for indicator graphs (e.g., circular bar graph, linear bar graph); customizable selections including minimum and maximum graph values, warning value limits, and scale.

The present disclosure also introduces a control system for controlling drilling operations, including a display of software objects (symbols, icons, buttons, etc.) that: are displayed on a monitor or touchscreen; are indicative of equipment or device status via changing color, localized background color, adjacent or localized background symbol (e.g., check or X), flashing color, filled or unfilled object, etc.; show operational status (e.g., high value, open, closed, running, idle, error, etc.); show communication status (e.g., feedback error, communication error, etc.); show control status (e.g., auto, manual, local, etc.); and/or can be displayed in association with displayed numerical values.

The present disclosure also introduces a rig control system comprising a communication network. The communication network may be a single ring, star, or daisy-chain network. The communication network may be fiberoptic. The rig control system also comprises a control workstation connected directly to the network. The rig control system also comprises multiple different control devices. Each control device may perform, cause the performance of, sense, measure, monitor, and/or log a mechanical, software, or other action of a mechanical, software, or other surface or downhole component (or group thereof), subsystem (or group thereof), or system (or group thereof). Each control device may be connected directly to the communication network. Each control device may communicate (directly or indirectly) with each other control device. Each control device may act at least partially in response to, or act at least partially based on, or otherwise use data from at least one other control device. For example, each control device may have an input from (the control device(s) of) another rig component (or group thereof), rig subsystem (or group thereof), or rig system (or group thereof). Each control device may be a computer (PC or IPC) or a PLC. The rig control system may also comprise multiple local control networks. Each local control network may be connected with the communication network, such as via a corresponding one of the control devices. The rig control system may also comprise multiple local control devices. Each local control device may be connected directly with a corresponding local control network. Each local control device may be a computer (PC or IPC) or a PLC. The control devices connected directly to the communication network may perform all control logic, and the control workstation may be (at least mostly) a data exchange.

The present disclosure also introduces an alarm system that helps operators to operate equipment and processes in an efficient and safe manner. The alarm system may utilize screen objects/symbols that: are indicative of equipment or device; show status via changing color, localized background color, adjacent or localized background symbol, flashing color, filled or unfilled object, etc.; are designed to draw operator attention to alarms by use of colors, symbols, flashing, sounds, and other notations with distinct meaning, present descriptive and easy to understand alarm texts, use alarm priority with distinct meaning, logically group alarms, keep the alarm rate as low as possible, ensure operators responds to all alarms, permit intuitive navigation and alarm acknowledgement, permit logging all alarms and alarm state changes, and provide high system availability and robustness.

The present disclosure also introduces an analysis-while-drilling (AWD) control system that is operable to show a large number of drilling related parameters determined by sophisticated algorithms. The AWD inputs may include: well configuration; drill string (including BHA) configuration; drilling parameter sensors (e.g., mud pit level sensors, standpipe pressure sensors, mud flow sensors); and drilling equipment parameters (e.g., directly from the equipment, such as drill string RPM, make-up torque, mud pump SPM). The AWD outputs may be delivered to and/or used by: workstation(s) display(s), including an AWD display; a historical logging system; and/or a mud logger system. The AWD outputs may include well configuration, drill string (including BHA) configuration, and dynamic tracking of: the well; bit depth; stands in hole; sectioned mud volumes; drill string volume, displacements, and weight; mud tank volumes, including active tank selection and loss/gain calculation; trip tank difference volume; trip tank accumulated volume; mud pump total stroke counters (individual count may be done in mud pumps); mud pump SPM total; mud pump liner capacities and efficiencies; mud flow into hole, individual and total; annular mud velocity per section; mud volume per section; total strokes per section; strokes to go per section; total minutes per section; minutes to go per section; mud return flow; bit runtime and revolutions; WOB; ROP; hook load; and standpipe pressure. The AWD outputs may also include: kick calculator and kill sheet; sensors and calculations for storage in historical trending system; drilling operation warnings and alarms.

The present disclosure also introduces an AWD display screen showing: graphic display of well configuration and hole section depths; graphic display of shoe; animation of planned vs. actual well; animation of drill string in well; value and graphic display of mud front tracking/depth; annular velocity per section; open hole volume; dynamic calculation of total strokes and minutes, strokes and minutes to go, and volume for Surface To Bit, Bit To Shoe, Bit To BOP, Bit To Surface, Well Circulation, Full Circulation, drill string displacement (open end and closed end), drill string weight, stands in hole, active volume, mud flow in, bit revolutions, and bit runtime.

The present disclosure also introduces automated tripping-in (or tripping-out) resulting in: an automated average tripping-in speed (e.g., in stands/hour) that is at least 5% faster than an average human working crew; and/or an automated standard deviation from average tripping-in speed that is at least 50% lower than for an average human working crew; and/or an automated average tripping-in slip-to-slip connection time that is at least 4% faster than an average human working crew; and/or an automated standard deviation from average tripping-in slip-to-slip connection time that is at least 50% lower than for an average human working crew.

The present disclosure also introduces a method of automating drilling operations that requires entry of at least a given group of input parameters and requires ability to exercise automated control over at least a given group of equipment related to drilling operations.

The present disclosure also introduces a control system for controlling drilling operations in which a level of automation for various operations can be selected. It may generate a control screen facilitating selection of level of automation. It may facilitate selection of full automation, semi-automation (e.g., confirmation by driller to start a specific sequence), or manual control (e.g., via a joystick).

The present disclosure also introduces a control system for controlling drilling operations comprising: a customizable display; a control screen facilitating selection of scale and limits for indicator graphs (e.g., circular bar graph, linear bar graph); and customizable selections, including: minimum and maximum graph values, warning value limits, and scale.

The present disclosure also introduces a control system for controlling drilling operations, including a display of software objects (symbols, icons, buttons, etc.) that: are displayed on a monitor or touchscreen; are indicative of equipment or device status via changing color, localized background color, adjacent or localized background symbol (e.g., check or X), flashing color, filled or unfilled object, etc.; show operational status (e.g., high value, open, closed, running, idle, error, etc.); show communication status (e.g., feedback error, communication error, etc.); show control status (e.g., auto, manual, local, etc.); and/or can be displayed in association with displayed numerical values.

The foregoing outlines features of several embodiments so that a person having ordinary skill in the art may better understand the aspects of the present disclosure. A person having ordinary skill in the art should appreciate that they may readily use the present disclosure as a basis for designing or modifying other processes and structures for carrying out the same purposes and/or achieving the same advantages of the embodiments introduced herein. A person having ordinary skill in the art should also realize that such equivalent constructions do not depart from the scope of the present disclosure, and that they may make various changes, substitutions and alterations herein without departing from the spirit and scope of the present disclosure.

The Abstract at the end of this disclosure is provided to permit the reader to quickly ascertain the nature of the technical disclosure. It is submitted with the understanding that it will not be used to interpret or limit the scope or meaning of the claims.

What is claimed is:

1. An apparatus comprising:
an integrated well construction system (IWCS) operable for constructing a well via integrated control of a plurality of integrated control devices that collectively control a plurality of integrated subsystems of the IWCS, wherein the IWCS comprises a processing system comprising a processor and a memory having a construction program thereon that, when executed by the processor:
controls each integrated control device, and thus each integrated subsystem, during each of a plurality of predetermined operational sequences; and
prevents collisions between machines of the IWCS.

2. The apparatus of claim 1 wherein the IWCS machines prevented from colliding by the construction program comprise:
a drawworks;
an iron roughneck;
a tong-handling trolley;
a tong-handling arm;
a catwalk;
a tubular delivery arm;
a lower stabilizing arm;
an upper tubular restraint;
an intermediate tubular restraint;
a lower tubular restraint;
a top drive;
a top drive elevator;
a fingerboard;
a transfer bridge racker; and
a setback guide arm.

3. The apparatus of claim 2 wherein the construction program further prevents collisions between:
the IWCS machines;
tubulars being transported by any of the IWCS machines;
tubulars sticking up out of the well;
tubulars in a mousehole of the IWCS; and
tubulars in a hand-off position of the IWCS.

4. The apparatus of claim 2 wherein the construction program prevents collisions between:
a drawworks and one or more of a catwalk, an iron roughneck, a lower stabilizing arm, a tong-handling arm, a tong-handling trolley, a tubular delivery arm, and an upper tubular constraint; and/or
a top drive and one or more of the iron roughneck, the tong-handling trolley, the tong-handling arm, the catwalk, the tubular delivery arm, the lower stabilizing arm, and the upper tubular constraint; and/or
the iron roughneck and one or more of the drawworks, the top drive, the catwalk, the tubular delivery arm, the lower stabilizing arm, an intermediate tubular constraint, a rotary table, automated slips, a tubular sticking up out of the well, and a tubular sticking up out of a mousehole of the IWCS; and/or
the tong-handling trolley and one or more of the drawworks, the top drive, the catwalk, the tubular delivery arm, the lower stabilizing arm, the rotary table, the automated slips, and a tubular sticking up out of the well;
and/or the tong-handling arm and one or more of the drawworks, the top drive, the catwalk, the tubular delivery arm, the lower stabilizing arm, the intermediate tubular constraint, the rotary table, the automated slips, a tubular sticking up out of the well, and a tubular sticking up out of a mousehole; and/or
the catwalk and one or more of the drawworks, the top drive, the iron roughneck, the tong-handling trolley, the tong-handling arm, the tubular delivery arm, the lower stabilizing arm, a tubular in a hand-off position of the IWCS, and a tubular sticking up out of a mousehole; and/or
the tubular delivery arm and one or more of the drawworks, the top drive, the iron roughneck, the tong-handling trolley, the tong-handling arm, the catwalk, the lower stabilizing arm, a transfer bridge racker, the upper tubular constraint, the intermediate tubular constraint, a lower tubular constraint, a setback guide arm, a tubular in the hand-off position, the rotary table, and the automated slips; and/or
the lower stabilizing arm and one or more of the drawworks, the top drive, the iron roughneck, the tong-handling trolley, the tong-handling arm, the catwalk, the tubular delivery arm, and the intermediate tubular constraint; and/or
the transfer bridge racker and one or more of the tubular delivery arm, the upper tubular constraint, the lower tubular constraint, the setback guide arm, a tubular in the hand-off position, and a fingerboard; and/or
the upper tubular constraint and one or more of the drawworks, the top drive, the tubular delivery arm, the transfer bridge rackes, the lower tubular constraint, and the setback guide arm; and/or
the intermediate tubular constraint and one or more of the iron roughneck, the tong-handling arm, the tubular delivery arm, the lower stabilizing arm, and a tubular in the mousehole; and/or
the setback guide arm and one or more of the tubular delivery arm, the lower stabilizing arm, the transfer bridge racker, the upper tubular constraint, and the lower tubular constraint; and/or
the fingerboard and the transfer bridge racker; and/or
the lower tubular constraint and one or more of the tubular delivery arm, the lower stabilizing arm, the transfer bridge racker, the upper stabilizing arm, and the setback guide arm; and/or
a tubular in the hand-off position and one or both of the tubular delivery arm and the transfer bridge racker; and/or
the automated slips and one or more of the drawworks, the top drive, the iron roughneck, the tong-handling trolley, the tong-handling arm, the tubular delivery arm, and the lower stabilizing arm.

5. A method comprising:
constructing a well utilizing each of a plurality of automatically controlled well construction machines, including:
a drawworks;
an iron roughneck;
a tong-handling trolley;
a tong-handling arm;
a catwalk;
a tubular delivery arm;
a lower stabilizing arm;
an upper tubular restraint;
an intermediate tubular restraint;
a lower tubular restraint;
a top drive;
a top drive elevator;
a fingerboard;
a transfer bridge racker;
a setback guide arm;
a mousehole;
a mousehole;
a drilling fluid pumping system; and
a drilling fluid recondition system.

6. A system operable to completely control each of a plurality of predetermined operational sequences of a well construction operation, wherein the sequences include:
picking up single tubulars;
making drilling connections;
building tubular stands;
tripping-in drill collar stands;
tripping-out drill collar stands;
tripping-out wet;
backreaming;
moving single tubulars from a well center to a catwalk using a top drive;
moving tubular stands from the well center to the catwalk;
moving casing from the catwalk to the well center using a casing tong;
moving casing from the catwalk to the well center using a tubular delivery arm and a casing running tool;
moving large diameter casing from the catwalk to the well center using the top drive and the casing running tool;
building casing stands; and
tripping-in casing stands without using the casing running tool.
